(19) United States
(12) Patent Application Publication
(10) Pub. No.: US 2006/0182055 A1
(43) Pub. Date: Aug. 17, 2006

(54) Location aware wireless data gateway

(76) Inventors: John R. Coffee, Gilbert, AZ (US); Kevin M. Marvin, Gilbert, AZ (US); Larry Fox, Gilbert, AZ (US); David A. Dye, Phoenix, AZ (US); Craig Hier, Chandler, AZ (US); Paul Ballew, Chandler, AZ (US); Craig Howard, Chandler, AZ (US); Robert J. Allen, Chandler, AZ (US); Kirk Bingernan, Phoenix, AZ (US); Brad Garn, Chandler, AZ (US)

Correspondence Address: COOPER & DUNHAM, LLP, 1185 AVENUE OF THE AMERICAS, NEW YORK, NY, 10036, US

(21) Appl. No.: 11/334,104

(22) Filed: Jan. 18, 2006

Related U.S. Application Data
(63) Continuation of application No. 09/659,850, filed on Sep. 11, 2000.

(51) Int. Cl. H04Q 7/00

(52) U.S. Cl. 370/328; 370/401

(57) ABSTRACT

A wireless gateway is provided that connects mobile and remote assets or employees to business enterprise users through multiple wireless networks and the Internet by using web served applications. The central core of the gateway is a location aware business component that sends and receives location based information to and from remote and mobile assets and applies business logic to the location data to enhance and automate business applications run by the enterprise user. This functionality considerably exceeds that of a traditional wireless gateway, which simply manages messages passed through multiple wireless networks but does nothing with the content of the messages. The business logic component provides a common interface and protocol for handling location information and allows applications that follow the protocol to interface with the gateway to take advantage of location information by using location data to trigger events or to tag events, messages, or other data.

### BACKGROUND OF THE INVENTION

1. Field of the Invention

The present invention relates generally to systems and methods for monitoring remote and mobile business assets, by location, usage, activity, assignment, and so forth, and enabling data communication or messaging between the asset owner or user and the asset. More particularly, the invention relates to improved techniques for such monitoring, through devices carried by the asset and designed to detect and report indicia of the aspect of the asset to be monitored, and to improvements in the communication path such as wireless data networks between the owner or user and the asset-appended device, including a location aware wireless gateway.

2. Brief Review of the Prior Art

Businesses that operate fleets of vehicles, have a mobile workforce, have remote fixed assets, or rent mobile equipment have the difficult task of managing these assets or employees efficiently. Getting data from these assets that indicates what they are doing and where and when they are doing it, into applications that managers are using to run their businesses is of critical importance.

Voice radios or mobile telephones have been used for many years for communication with vehicle drivers and service technicians, but voice does not work for equipment and voice does not integrate automatically or reliably to other electronic information systems. Several wireless data networks or transport mechanisms are now available. These include: GRID DATA™ (trademark of Grid Data, Inc. for its goods and services employed in or employing wireless data networks, and which are the subject of a co-pending United States patent application), ARDIS® (trademark of American Mobile), cellular digital packet data (CDPD), code division multiple access (CDMA) and time division multiple access (TDMA), personal communications system (PCS), Mobitex® (trademark of Ericsson), Aeris® Microburst™ (trademarks of Aeris.net), Orbcomm® (trademark of Orbcomm Global, L.P.), and others. Each of these networks has different coverage areas, capacity, pricing, and usage schemes so that not any one network is optimal for all applications. For all of these networks, however, overall capacity (bandwidth) is increasing quickly and pricing is falling. A wireless network gateway makes connections to multiple wireless networks. Customers have one connection point to the gateway that routes messages through the wireless network using the most appropriate and cost effective method for the customers' businesses.

The Global Positioning System (GPS) makes determining accurate location of vehicles relatively easy and inexpensive to accomplish. One drawback of GPS based position determination is that coarse/acquisition (C/A) code typically has errors on the order of 100 meters when selective availability (SA) is on and requires augmentation with differential corrections to remove errors in the signal to an error level of typically less than 5 meters. Some wireless networks designed for vehicle location and telemetry purposes, such as the GRID DATA™ network, provide differential corrections automatically. Other networks make it more difficult and expensive, but over time may be cost effective. In the near future, the FAA Wide Area Augmentation System will be operational; most commercial GPS receivers will be able to automatically receive this differential augmentation signal.

A second drawback of GPS is the lack of signal availability when the satellites are obscured by foliage or structures. This requires GPS to be augmented by other sensors, such as dead reckoning inputs from a vehicle speed sensor, or from triangulation techniques from wireless network signals. The latter solution is attractive because it can work as a hand held unit away from a vehicle.

The ubiquity of the Internet makes it possible to transfer data between the enterprise customers and their mobile assets operating on wireless networks through a central wireless network gateway. As available wireless bandwidth is increasing, so is Internet bandwidth to the enterprise. High bandwidth Internet makes it possible to serve sophisticated business applications and to distribute large volumes of data to individual users in the enterprise from the wireless gateway. Serving of applications eliminates the up front cost of purchasing software and removes the software support tasks from the customer, and it enables easier support and upgrading by the service provider. The Internet allows access to data and applications from almost anywhere at any time.

The convergence of these three technological advances: low cost and expanding wireless data bandwidth, low cost GPS based location sensors, and expanding Internet availability and bandwidth, reduce the device and recurring air time costs to use location based data to manage remote assets. In order to effectively use any kind of data, applications that the business uses must be able to incorporate it and process it with other business information in meaningful ways. Data without applications is useless; therefore, common business applications such as work order management, scheduling and dispatching, inventory tracking, vehicle maintenance, and text messaging all need a common interface to receive asset location data. A standard interface and set of business rules is required to allow the wide variety of business applications to treat location information in a common way.

### SUMMARY OF THE INVENTION

The current invention solves this problem by deploying special location aware business logic to the mobile devices and network operations center. Applications and data are provided to customers over the Internet from the network operations center. Text messaging and mapping is provided as a core functionality. Standard protocol interfaces are provided to the core location business logic and database as well as the mapping and messaging to enable other business applications to use the wireless networks and location information. One example of location aware business logic is the ability to send a location of interest to a mobile device. The mobile device then can report when it has arrived or left the location. The ability to send location information and receive status is extended to any application, such as dispatching, to enable it to track work order status. Interfaces to mapping functions allow the application to view and define locations of interest.

The invention enables business applications to become location aware, i.e., to use information about the location of assets, vehicles, and employees to enable the user of those applications to manage them more efficiently. The gateway system of the invention consists of wireless devices in vehicles, handheld units and other mobile assets of the business enterprise which is the customer of the system, connected to a wireless gateway through one of several wireless data networks, and the customers who manage those assets connect to the gateway through the Internet using browsers. Location data are used by applications utilized by the customer; the applications are served over the Internet. The core of the system is location aware business logic in the gateway that ties the assets (e.g., the customer's vehicles) and applications together through a common set of protocols and interfaces. The core business logic and the applications are implemented at the system and services supplier's web site.

The core business logic component manages customer login accounts and access to remote asset data. It also manages wireless device communications and access to the appropriate networks. All data communications between the customer at the enterprise and the vehicle devices or other remote users are routed through the core business logic, with the core providing the database and interfaces to applications. The mapping and messaging applications are more tightly coupled to the core business logic than other applications since location information and message routing are basic functions of the gateway. These functions are directly accessible from other applications and behave based on the business rules established in the core component.

The primary functions of the location aware business logic are to associate location information with other data generated by the mobile assets or traditional business applications and to enable the creation of new applications that were not possible before. For example, the gateway and the vehicles have a concept ofjob sites. These are locations where work is to be performed. Work order management and dispatching applications maintain work orders and schedules but are unable by themselves to keep track of where vehicles or personnel are actually located at any given time relative to work sites. When a work order is created, the gateway creates and stores a job site. When a vehicle is dispatched, the gateway sends the site information to the vehicle. When the vehicle arrives at the site, it automatically transmits data back to the gateway. The gateway then passes the event to the work order management application which can then automatically change the status of the work order.

Because of the importance of location information, the mapping application is a principal part of the user interface. Mapping functions can be initiated by other applications and functions of other applications can be initiated from the mapping interface. Since the map is intended for real-time business use, it must be both fast and interactive. To achieve these requirements, traditional web served mapping methods that involve simple image delivery are not adequate. The street level map data and map control application must reside on the user's local computer with location information provided through a second data channel directly from the application server instead of the web server. This unique implementation enables seamless location data updates and smooth interaction with the map and the vehicles depicted on it, and retains the advantages of Internet delivery of code and map database updates. The data channel also provides for procedure calls to and from other applications and the core business logic.

Vehicles provide location data in the form of geodetic position, along with speed and heading, periodically and in response to the detection of certain events that are reported through the messaging application. All data is stored in the business component's database, and the mapping application displays these positions as they are received or displays historical location data when requested. Periodic position reports are typically available at one minute intervals. While position data is not often required at this rate for monitoring of a vehicle in real time, it is required for detailed auditing of position history when the need arises. What is required in real time is location tied to event reports from vehicles. Examples of event reports are speeding exceptions, unauthorized stops, text messages initiated by field personnel, and automated status reporting such as arrival at a job site.

It is necessary that the navigational state information from each vehicle's wireless device (tracker) be provided to the gateway for the gateway to provide the location services. Efficient methods of providing frequent periodic location reports, guaranteeing delivery of those reports, and tagging events reported by the wireless devices with location information are important aspects of the invention.

One example of enhancement of business applications by Internet delivery of location information is in the package delivery business. Currently, many package delivery companies provide their clients the ability to track packages over the Internet by giving the inquiring client the history of when the package arrived and left certain sorting facilities. Once the package is on a truck, no one knows where it is until the driver enters the information concerning its having been delivered. With vehicle location data feeding the tracking and routing applications in the system of the present invention, the package delivery business operators and their clients are able to see the actual location of the package, the truck's route, and an estimated time of arrival.

The number of potential applications is endless. The critical factor in making these applications possible is removing the wireless and location integration problems from the business application developer and making the applications available over the Internet. The location aware wireless gateway does this by providing the application developers with a standard interface and a core set of business rules to follow in order to make use of location information. Serving these applications over the Internet allows them to interact with the other applications that use the same core business rules. This enables the application developers to focus on their areas of expertise and take advantage of other applications where prudent.

### BRIEF DESCRIPTION OF THE DRAWINGS

The above and still further objectives, aims, features, aspects and attendant advantages of the present invention will become apparent from a consideration of the following detailed description of the best mode presently contemplated for practicing the invention, with reference to certain preferred embodiments and methods, in conjunction with the accompanying drawings, in which:

FIG. 1 is a diagram of the overall gateway system of the invention, illustrating the data flow between the business enterprise user and remote assets through the Internet, location aware business component, and wireless networks;

FIG. 2 is a more detailed block diagram of software architecture and data flow in the gateway system of FIG. 1;

FIG. 3 illustrates the message routing and network server architecture of the wireless gateway portion of the overall system.; FIG. 3A shows the sequence of operations performed by a message router to resend unacknowledged messages, and FIG. 3B shows the sequence of operations performed by the router in assuming a message is undeliverable and reporting a failure to a customer server, in managing limited guaranteed delivery from the gateway to the tracker; and FIGS. 3C, 3D, and 3E, respectively, show the process flows for sending text, pre-defined, and user data messages to trackers;

FIG. 4 illustrates the Customer Interface Server software architecture and data flow;

FIG. 5 is an exemplary screen of the web browser mapping user interface;

FIG. 6 is a block diagram of the web based mapping application architecture;

FIG. 7 is a simplified perspective view of a fixed vehicle mounted wireless tracking device (tracker, a data computer);

FIG. 8 is a simplified perspective view of a vehicle mounted display terminal;

FIG. 9A is a simplified block diagram of a fixed mounted wireless tracking device as it interacts with the gateway, display, and vehicle mounted sensors; FIG. 9B is a simplified block diagram of a hybrid handheld/fixed mounted wireless device architecture; and FIG. 9C is a simplified block diagram of a location enabled purely handheld device in which all of the location aware software is located at or in the handheld device;

FIG. 10 illustrates the subsystems contained in the overall software system structure;

FIG. 11 is a functional diagram of the vehicle display function structure;

FIG. 12A is a functional diagram illustrating the sequence of operations performed for a Get Last Reported Information function; FIG. 12B is a diagram showing the detailed design of the Get Last Reported Information function sequence;

FIG. 13A is diagram illustrating the sequence of functional steps performed for changing asset display and symbol in the manage vehicle display use case; FIG. 13B is a diagram of the detailed design of the change asset display and symbol function sequence;

FIG. 14A is diagram illustrating the sequence of functional steps performed for locating a vehicle on the display; FIG. 14B is a diagram of the detailed design of the locate vehicle function sequence;

FIG. 15A is diagram illustrating the sequence of functional steps for performing a playback of vehicle location history; FIG. 15B is a diagram of the detailed design of the playback history function sequence;

FIG. 16A is diagram illustrating the sequence of functional steps for performing an update real-time location request; FIG. 16B is a diagram of the detailed design of the update real-time location function sequence;

FIG. 17 is a functional diagram of the messaging function structures;

FIG. 18A is diagram illustrating the sequence of functional steps for performing a send dispatcher initiated message; FIG. 18B shows the user interface for sending dispatcher initiated messages;

FIG. 19A is diagram illustrating the sequence of functional steps for performing a send messages function; FIG. 19B is a diagram of the detailed design of the send messages function sequence;

FIG. 20A shows the sequence of functional steps performed by View Message Folder function; FIGS. 20B, 20C and 20D show detailed design of View Message Folder inbox sequence, outbox sequence and lists sequence, respectively; and FIG. 20E shows the View Message Folder user interface display;

FIG. 21 is diagram illustrating the sequence of functional steps for performing an identify message function;

FIG. 22 is a functional diagram of the map navigation function structure;

FIG. 23A illustrates the process flow for the Search function; FIG. 23B shows the Search function interface with a highlighted address;

FIG. 24 illustrates a thumbnail map interface on the display;

FIG. 25 shows a typical job site on the map display;

FIG. 26 is a functional diagram of the dispatching function structure;

FIG. 27 is a functional diagram of the work site management function structure;

FIG. 28 is a functional diagram of the project and work order management function structure;

FIG. 29 shows the primary user map interface for the dispatching and work order management applications;

FIG. 30A shows the functional steps performed by the Work Order Management Application to dispatch a vehicle if a work order is selected for dispatch; FIG. 30B illustrates the user interface used to send the dispatch message;

FIG. 31A shows the functional steps performed by the Maintain Project Order and Work Order function; FIG. 31A illustrates the user interface for that function; FIG. 31C shows the work order state transition;

FIG. 32 shows the functional steps performed for Change Work Order State;

FIG. 33A shows the steps performed by the View Project/Work Order List function;

and FIG. 33B shows the steps performed by the Search Project/Work Order List function;

FIG. 34A shows the user interface for work site creation and the modification, removal, and location functions; FIG. 34B shows the functional steps performed by the create work site function;

FIG. 35 shows the functional steps performed by the modify work site function;

FIG. 36 shows the functional steps performed by the remove work site function;

FIG. 37 shows the functional steps performed by the assign home site function;

FIG. 38 shows the functional steps performed by the find work site function;

FIG. 39 shows the functional steps performed by the select work site function;

FIG. 40 is a functional diagram of the customer asset management function structure;

FIG. 41 is a functional diagram of the client management function structure;

FIG. 42 is a functional diagram of the customized feature management function structure;

FIG. 43 is a functional diagram of the maintain code/lookup table function structure;

FIG. 44 is a functional diagram of the customer setup function structure;

FIG. 45 is a functional diagram of the system access function structure;

FIG. 46 is a functional diagram of the role management function structure;

FIG. 47A illustrates the user interface for the view resource list and maintain resource functions; and the functional steps performed for both of those functions are shown in FIG. 47B and continued in FIG. 47C;

FIG. 48A shows the user interface for the view vehicle list and maintain vehicle functions; and the functional steps performed by the view vehicle list and maintain vehicle functions are shown in FIG. 48B and continued in FIG. 48C;

FIG. 49A shows the maintain sensor user interface; FIG. 49B is the functional sequence of steps performed by the maintain sensor function; and FIG. 49C is the detailed design of the maintain sensor sequence;

FIG. 50A shows the view sensor list user interface; FIG. 50B shows the functional steps performed by the view sensor list function; and FIG. 50C shows the detailed design of the view sensor list function;

FIG. 51A shows the view client and maintain client user interface; and FIG. 51B shows the functional steps performed by the view client and maintain client functions;

FIG. 52A shows the functional steps performed by the manage map data display function; and FIG. 52B shows the detailed design of the manage map data display sequence;

FIG. 53A shows the functional steps performed by the manage map detail display function; and FIG. 53B shows the detailed design of the manage map detail display sequence;

FIG. 54A shows the functional steps performed by the manage map default area function; and FIG. 54B shows the detailed design of the manage map default area sequence;

FIG. 55 illustrates a typical vehicle symbol;

FIG. 56A shows the functional steps performed when a message is created by the maintain messages function; FIG. 56B shows the detailed design of the maintain messages sequence for message creation; FIG. 56C shows the functional steps performed when a message is changed/deleted by the maintain messages function; and FIG. 56D shows the detailed design of the maintain messages sequence for message change/deletion;

FIG. 57A shows the functional steps performed for the view message list function; and FIG. 57B shows the detailed design of the view message list sequence;

FIG. 58A shows the view job type list and maintain job types common user interface; and FIG. 58A shows the functional steps of the view job type list and maintain job types functions;

FIG. 59A shows the main user interface for gateway administration; FIG. 59B shows the user interface for creating a new customer; FIG. 59C shows the user interface for modifying a customer;

FIG. 60A shows the login user interface; FIG. 60B shows the functional steps performed by the login function; FIG. 60C shows the detailed design for the login sequence;

FIG. 61A shows the functional steps performed by the logout function; and FIGS. 61B and 61C show a detailed sequence of the logout function for the cases in which the user initiates the logout, and in which the connection is lost, respectively;

FIG. 62A shows the user change password interface; FIG. 62B shows the gateway administrator change password interface; FIG. 62C shows the change password functional steps for a user initiated change; and FIG. 62D shows the detailed design for the change password sequence;

FIG. 63 shows the user interface for changing or expiring a user account;

FIG. 64 illustrates an event selection screen of the user interface for reporting;

FIG. 65 illustrates a group creation screen of the user interface for reporting;

FIG. 66 illustrates an exemplary run time report;

FIG. 67 illustrates an exemplary fleet summary report of pour time and trip time;

FIG. 68 is a pie chart of the fleet summary report of FIG. 67;

FIG. 69 is an event report showing multiple types of events;

FIG. 70 is an engine on time report;

FIG. 71 is an engine on time trend report; and

FIG. 72 is a functional diagram of the reporting function structure.

### DETAILED DESCRIPTION OF THE PREFERRED EMBODIMENT

The invention provides a wireless gateway that connects mobile and remote assets or employees to business enterprise users through multiple wireless networks and the Internet by using web served applications. The central core of the gateway is a location aware business component that sends and receives location based information to and from remote and mobile assets and applies business logic to the location data to enhance and automate business applications run by the enterprise user. This functionality considerably exceeds that of a traditional wireless gateway, which simply manages messages passed through multiple wireless networks but does nothing with the content of the messages. The business logic component provides a common interface and protocol for handling location information and allows applications that follow the protocol to interface with the gateway to take advantage of location information by using location data to trigger events or to tag events, messages, or other data.

A web site serves as a portal to provide business applications for companies with vehicle fleets, remote assets, or employees. In the main, the site provides a gateway to wireless networks that provide data from and communication capabilities with customers' vehicles. The communicated data is primarily associated with location information but provides other information regarding vehicle and operator activity as well. The customers' vehicles are outfitted with data computers that operate on a wireless network. Core functions of the system include location related reporting, messaging and system administration. Dispatching, vehicle maintenance tracking, accounting capabilities and industry tailored ERP (enterprise resource planning) applications can all be served through the web site.

Business applications are enabled to become location aware through use of the system's wireless gateway, and to utilize information about the location of their respective assets, vehicles, and employees for more efficient management of them. Available applications are tailored to each customer's and/or industry needs, and fees charged to customers may be based on applications served. Applications are preferably segregated into the following broad categories: location and messaging, reporting, dispatching, maintenance, ERP and accounting, business marketplaces, and other services. Reporting is included within all applications; while full-featured dispatching capabilities include order entry and invoicing functions.

I. Architecture

A. General

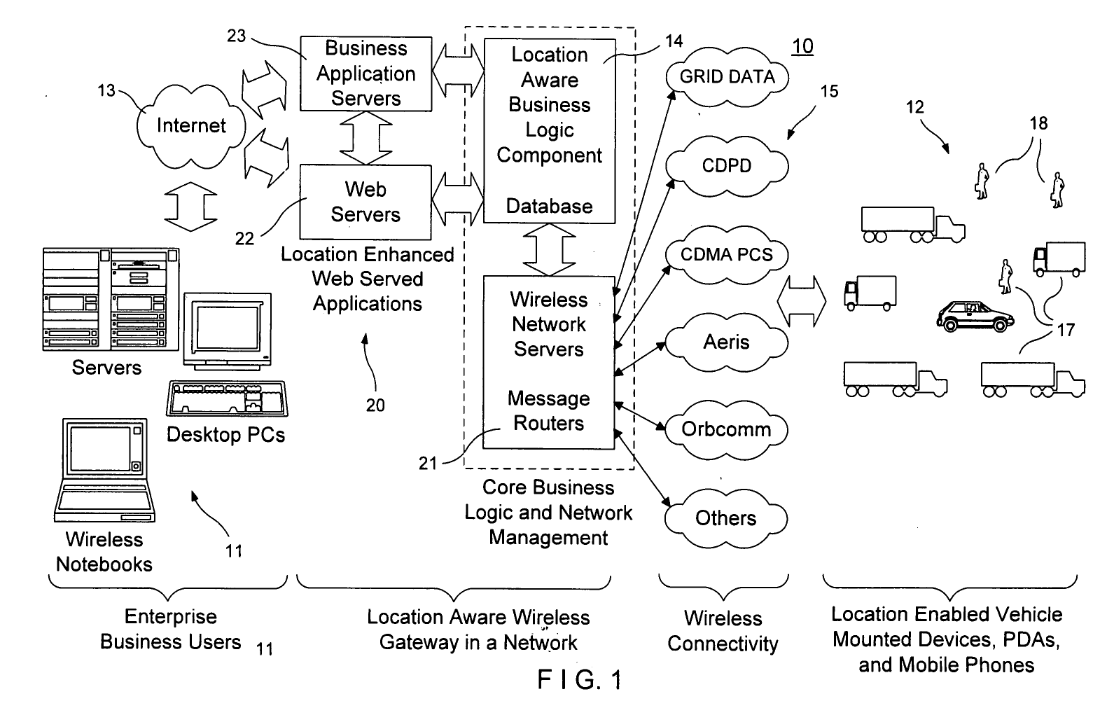

The overall gateway system 10 of the invention, illustrating the data flow between the business enterprise users 11 and remote assets 12 through the Internet 13, location aware business component 14, and wireless networks 15 is illustrated in FIG. 1. The system includes wireless devices in vehicles 17 and handheld units of individuals 18 connected to a wireless gateway 20 through one of several wireless data networks 15. Customers (i.e., the business enterprise users of gateway system 10) manage their mobile assets (which may include vehicles 17, employees 18 and packages (not shown), among other things) through connections to the gateway 20 through the Internet 13 using browsers. The customers employ applications making use of location data pertaining to their respective mobile assets, and those applications are served over the Internet.

As generally used in this specification, the term “customer” refers to a business that owns vehicles or remote assets that receives application and data services from the system(s) or in the method(s) of the invention; “users” are employees of the “customer” that use the applications and access data; “clients” are customers of “customers,” and clients may also be “customers.” This “client,” however, is not to be confused with client applications in client/server software architectures.

The core of the system is the location aware business logic component 14 in gateway 20 that ties the vehicles 17 (and other mobile assets 12) and applications together through a common set of protocols and interfaces. The core business logic and the applications are implemented as the web site of the invention, griddata.com™. The location aware wireless gateway 20 is responsible for the management of all data required to provide customers with the ability to monitor and communicate with their vehicles. Data management includes providing customers access to their data in real-time, and access to meaningful reports required for more efficient utilization of their vehicles. Data management also enables the gateway provider to monitor/analyze network performance and to bill customers according to number of applications and usage.

The wireless devices (also referred to herein as “trackers”, and occasionally as “tracking computers”) in vehicles, handheld units and installed in or on a customer's other mobile assets all have hardware and software to enable them to determine the respective tracker's location (for example, using GPS). For the sake of convenience and simplicity, the terms “asset” and “vehicle” are sometimes used interchangeably throughout this specification and in the claims, but it will be understood that asset may refer to anything (including human resources) which is employed, owned, leased, delivered or otherwise of value to the customer's business and which is typically intended to undergo movement outside the customer's premises. The installed trackers report location data for their respective vehicles and other status information through the respective wireless network used in the system 10. The trackers also contain software to support location aware dispatching and to automatically report when the vehicle (such as ready-mix concrete truck) has arrived at and left a job site. These vehicle-mounted wireless devices can also run other types of business specific logic and report on sensor outputs.

Gateway 20 may utilize multiple types of wireless networks 15 (e.g., CDPD, Orbcomm®, etc.); however, the server software applications hide most of the details related to different networks. As a result, the customer/end-user is not bothered—such as by data formatting, error correction algorithms, and guaranteed delivery—with the details of the specific network being used. Users simply access location information from the core business logic of the gateway and other information from applications integrated with the gateway.

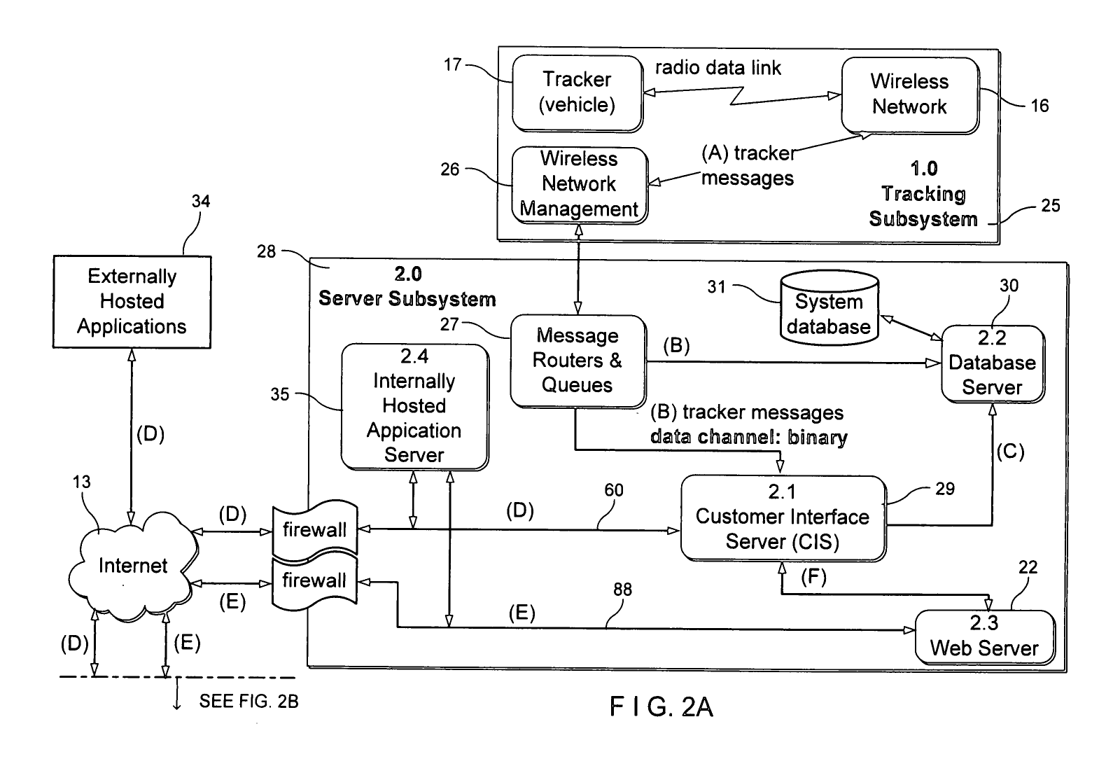

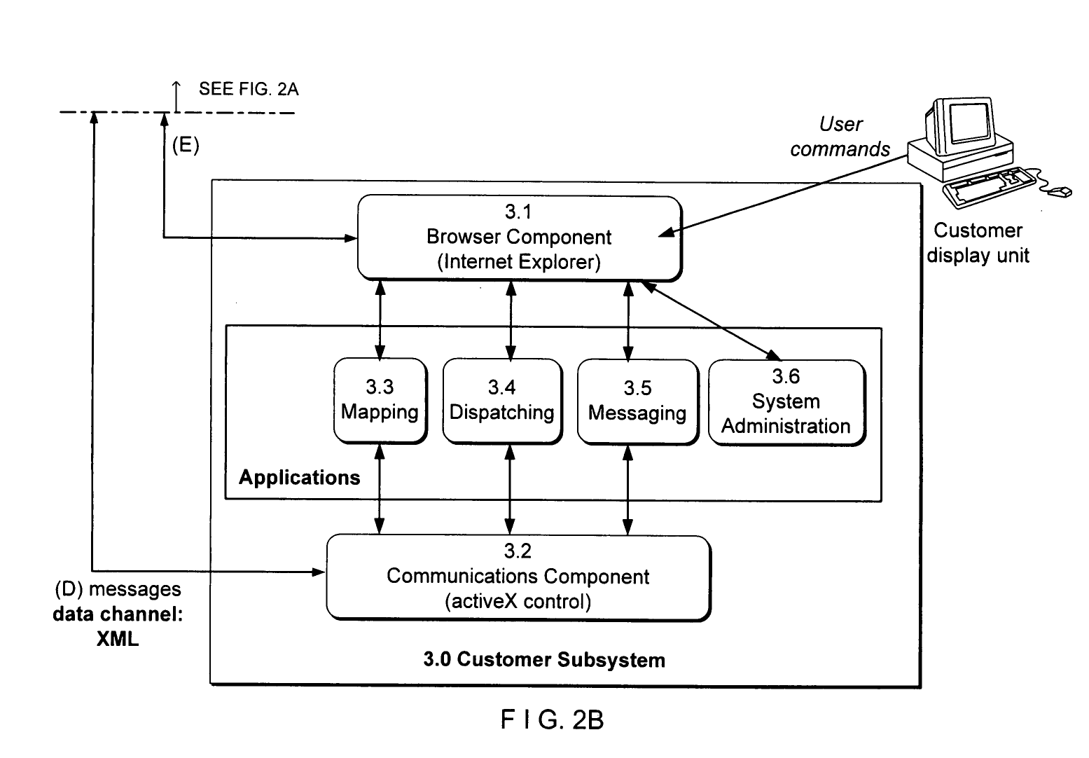

Applications are hosted on web servers 22 and application servers 23 located within a gateway network operations center or remotely hosted by another application service provider or on site at large customers' own facilities. Applications access location data through Customer Interface Servers 29 (FIG. 2) that implement the core location aware business logic and control access to the database and wireless gateway. Customer enterprise users run applications through a web browser. Business applications are integrated with and built on core gateway applications such as mapping, messaging, work site management, and administration functions for managing access to data.

B. Data Flow

System data flow is shown in FIG. 2, a more detailed block diagram of software architecture and data flow in the gateway system. Each data flow illustrated in FIG. 2 is referred to here as a data channel. Labels for data channels and subsystem elements identify the data content, formatting, and protocols for each major data flow between subsystems and subsystem elements. Only labeled data channels are shared by software outside the system. Thus, externally hosted software applications may only interact with the system via the extensible markup language (XML) protocol (data channel D).

As shown in FIG. 2, Data Channel A (at tracking subsystem 25) is used to route tracker messages, consisting of all of the wireless transmissions to and from the remote wireless devices (the trackers 17), via the wireless network 15 and the wireless network management 26 which include the wireless network servers 21. Of these messages, real time location data provide the highest volume of information flow. The data content, formatting, and update frequencies are dependent on the characteristics of the particular wireless network being used. A summary of the characteristics of Data Channel A is shown in Table 1 of Appendix B of this specification (all Tables subsequently referred to herein in bold text accompanied by a number will be understood to be in Appendix B—not to be confused with lookup tables that may be used in the system).

Data Channel B routes the tracker message data within the wireless gateway between the appropriate wireless network servers and the message queues 27 (spanning tracking subsystem 25 and server subsystem 28. Messages are routed to customers through the Customer Interface Server (CIS, sometimes referred to herein as Customer Server) 29 and logged in the database via server 30. A summary of the characteristics of Data Channel B is shown in Table 2.

Data Channel C is used for database queries, implementing Structured Query Language (SQL) requests to the database via server 30 to retrieve historical data provided by the trackers (e.g., vehicle position history). The CIS 29 also uses the database to manage customer business and administrative data such as work sites, user IDs and passwords, vehicle sensor configurations, etc. A summary of the characteristics of Data Channel C is shown in Table 3.

Data Channel D provides an XML interface for all real time tracker messages to be pushed to web based applications, such as mapping, and other integrated applications. This interface also supports a complete command response protocol to enable any application to take advantage of the wireless network interfaces and location aware business logic in the gateway. A summary of the characteristics of Data Channel D is shown in Table 4.

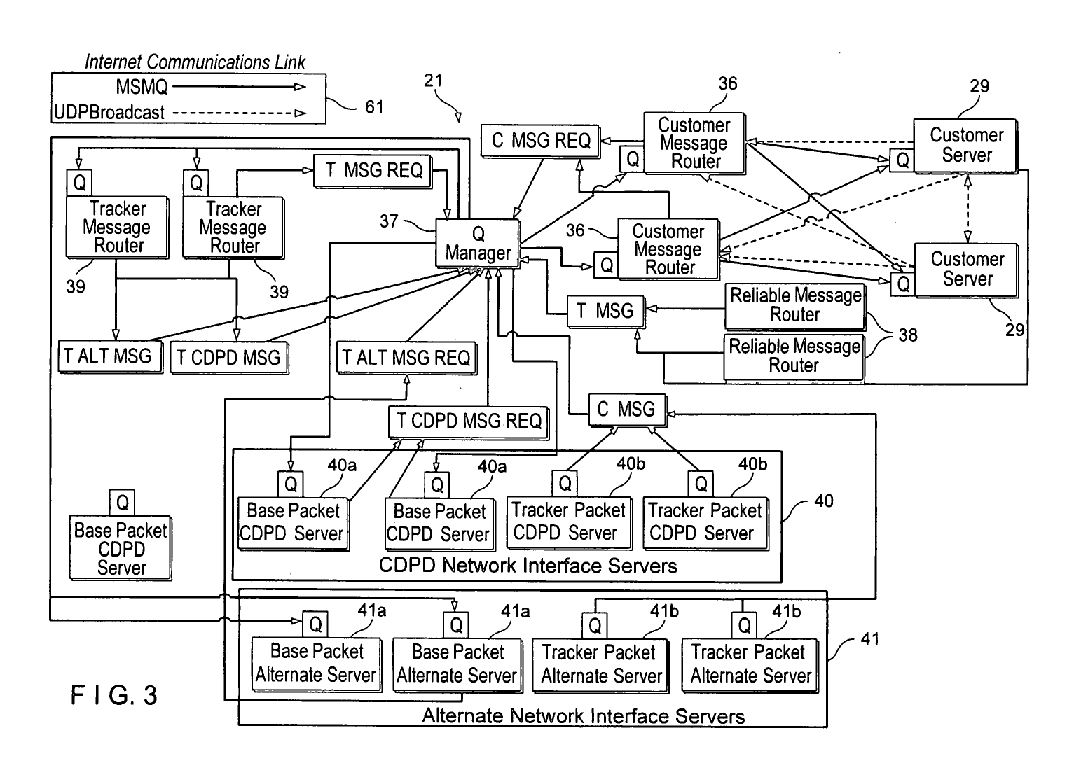

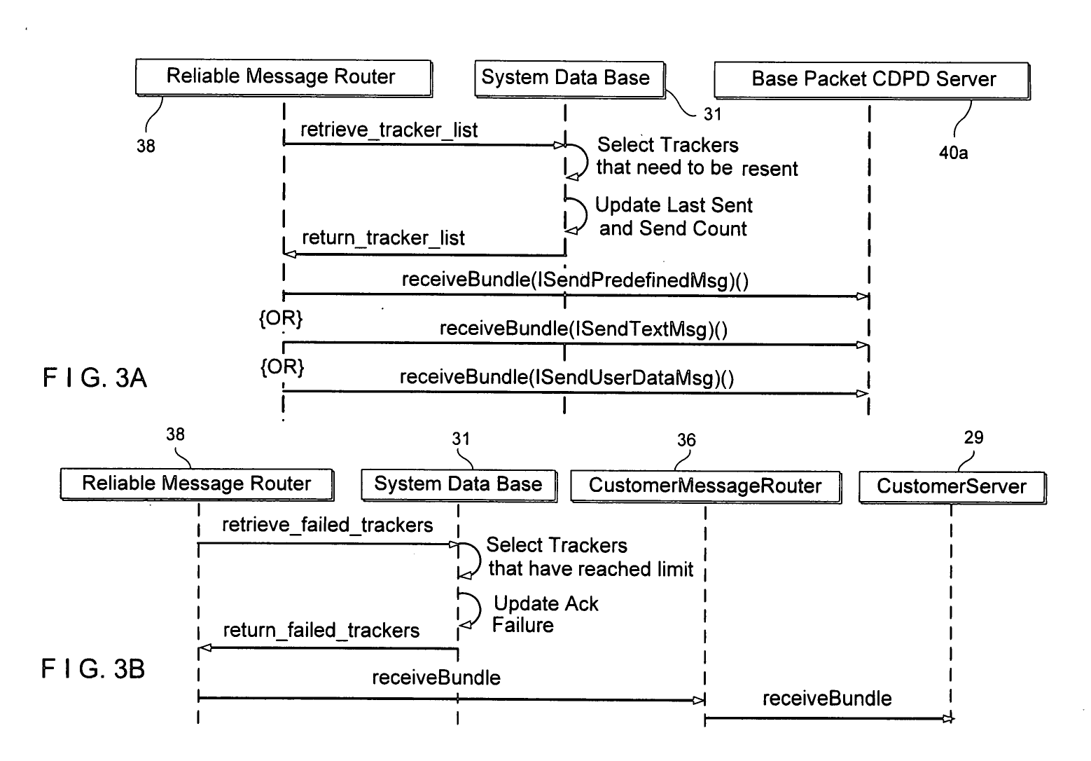

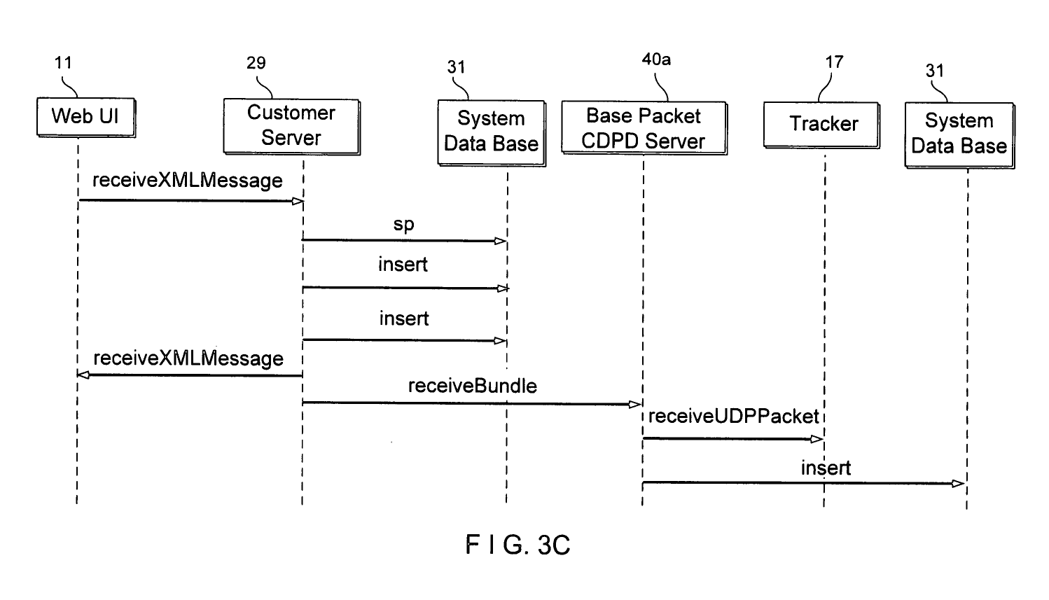

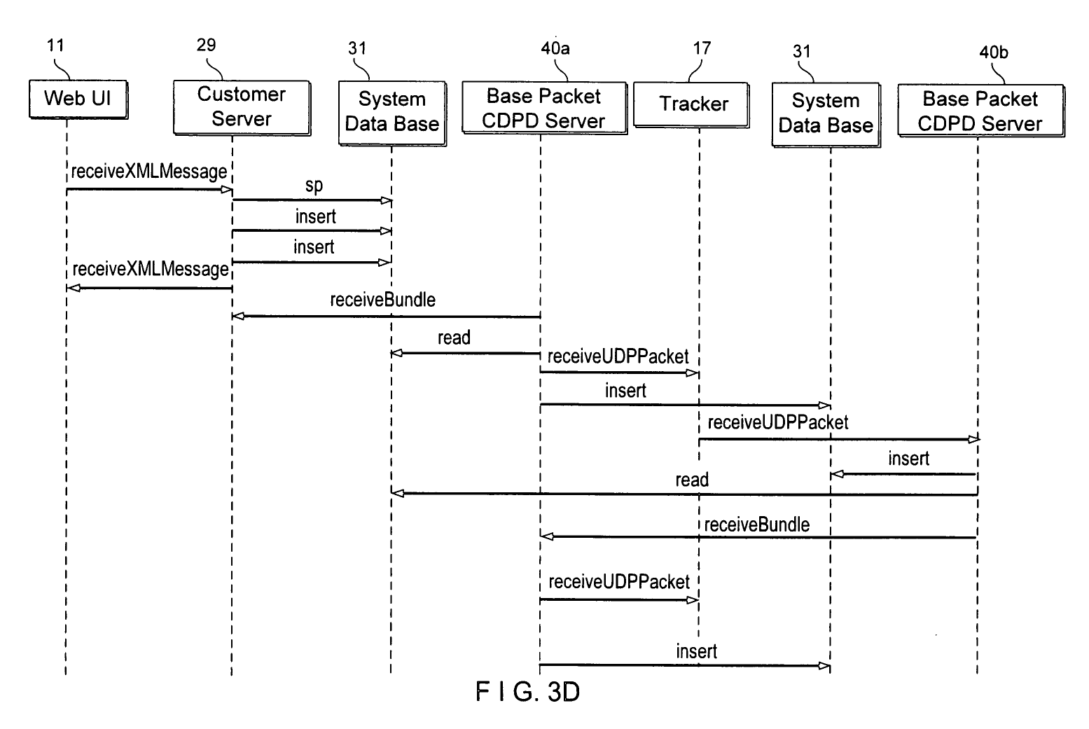

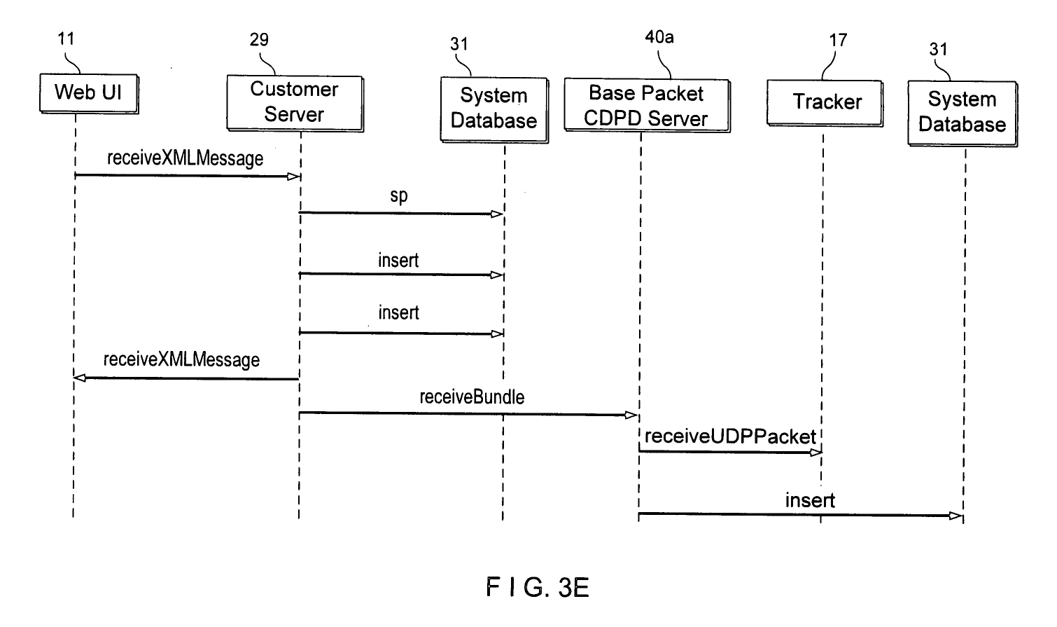

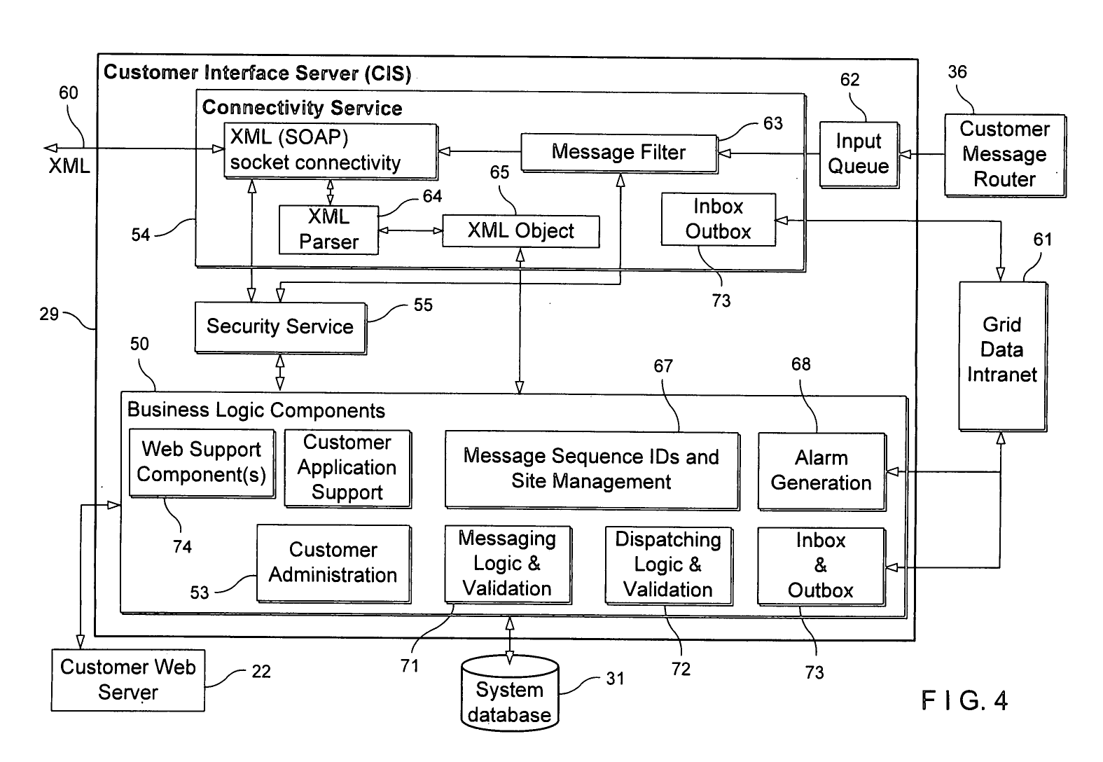

Data Channel E handles all web-like data requests and responses. Hypertext transfer protocol (HTTP) data is not encrypted, and HTTP secure (HTTPS) data is encrypted using standard protocols like Secure Socket Layer 3 (SSL3) when transmitted across the Internet 13. User configuration data is posted to the Server Subsystem 28 for storage in the system database 31 (e.g., FIGS. 3A, 4) via server 30. Most user interface components for web based applications use this data channel. A summary of the characteristics of Data Channel E is shown in Table 5.

Data Channel F carries command data between CIS 29 and web server 22. The CIS makes database queries on behalf of web servers and applications using the XML interface. This insulates the database from indiscriminant queries, and forces queries to conform to the business logic rules of the gateway. A summary of the characteristics of Data Channel F is shown in Table 6.

C. Wireless Gateway System Architecture

The wireless gateway 20 (FIG. 1) consists of wireless network servers and message routers 21 that connect vehicles or other mobile assets to the CIS 29 (FIG. 2). The network servers and routers maintain the message management logic for each network and route messages between the wireless networks 15 and the CIS 29. The architecture of the network server and message router 21 of the wireless gateway portion of the overall gateway system 10 is shown in block diagram form in FIG. 3.

Each block in FIG. 3 represents a software application. These applications are normally run on physically separate machines, and multiple instances of the applications are run to provide redundancy and fault recovery. Hardware running the applications use Microsoft operating systems and are clustered to provide redundancy. Load directors are used to distribute the computational load between multiple machines running the same application. The applications include Customer Servers (CIS's) 29, Customer Message Routers 36, Q (queue) Manager 37, Reliable Message Servers 38, and Tracker Message Routers 39. Applications are also present for managing each connected wireless network, in the form of CDPD (Cellular Digital Packet Data) Network Interface Servers 40 and Alternate Network Interface Servers 41. Other server applications include Network and Engineering Database (NED) Server, Alarm Server, and Tracker Configuration Server (these server applications not shown in FIG. 3).

The Q Manager 37 is at the center of the wireless network management portion of the gateway, with the responsibility for ensuring messages are reliably passed between all of the other applications that communicate with the wireless networks. The Q Manager is based on the Microsoft (trademark of Microsoft Corporation) Message Queue (MSMQ) product, which has the advantages of cost relative to other queue managers, and support for Microsoft clustering technology. Applications place messages for other applications into the appropriate queues and read messages from their queues for processing. An advantage of a queuing system is that if all queue operations are transactional, messages cannot be lost in the event of a system failure.

However, MSMQ does have two disadvantages that must be addressed to enable it to work in this type of system. First, it does not support transactional reads on remote queues; and second, its message throughput is too slow to support high volume message traffic from thousands of wireless users on multiple networks. Solutions to these problems are as follows.

With respect to the transactional queue read problem, the Q Manager application enables transactional reads by performing queue reads on behalf of each application. Each application that receives messages has a local input queue from which it can perform a transactional read. The Q Manager has an input queue to receive requests from applications for reads from remote queues (queues local to the Q Manager are shown surrounding the Q Manager 37 block in FIG. 3). The Q Manager processes these requests by performing a transactional write of the appropriate data to the local input queue of the requesting application.

As for the second problem, a solution is achieved through message bundling for queue throughput enhancement The throughput of the Q Manager using MSMQ is very slow, roughly seven transactional messages per second for message sizes between 50 and 2000 bytes on a state of the art PC. This is not adequate for wireless network traffic that will generate hundreds of messages per second when tens of thousands of wireless devices are on line. The throughput problem is addressed by bundling small messages into larger, less frequent messages.

Two factors make bundling a good technique to increase message throughput. First, transactions add significant overhead to each message that is sent using MSMQ; and second, increasing MSMQ message size does not decrease MSMQ message throughput significantly (e.g., a 5 KB message takes approximately the same time to be delivered as a 50 B message). Typical wireless messages are short, usually 50-100 bytes. Throughput for messages of this size is roughly seven per second; however, if the size of the messages is increased until the throughput drops to just over 1 message/second, the message size is on the order of about 200 KB. If this large message is an aggregate of small messages, the equivalent throughput equates to approximately 4000 messages per second (assuming an average message size of 50 bytes). The above numbers apply to messages moving in a single direction (e.g., from the network servers to the customer servers). For these numbers, then, the total bidirectional maximum throughput would be approximately 8000 messages per second.

Message bundling is achieved by caching a number of messages over a period of time, then aggregating them into a single message, to achieve a message throughput improvement on the order of a factor of 600. This lends considerable scalability to the gateway's messaging backbone. The gateway uses a component object model (COM) object called MrBundle to cache messages over a fixed time interval and then bundle them into a single message. For the gateway, an interval of one second is used, which adds an average of 0.5 seconds to the message delivery time. Considering web connection and tracker update rates, half a second is virtually unnoticed by customers. An instance of MrBundle is used by each Customer Server, Customer Message Router, Network Interface Server, and Tracker Message Router. Messages are bundled up before being sent to the Q Manager, and are unbundled after being received from the Q Manager.

Customer Server or CIS 29, which will be described in more detail presently, is responsible for managing the flow of data between the wireless networks and customer software. This server authenticates customers, controls customer data access, pushes tracker packet data in real-time to customer applications, queues customer requests to the networks, and services customer database queries.

The Customer Message Router 36 determines which messages should be forwarded to one or more Customer Server 29 applications. The Customer Message Router makes routing/filtering decisions using a cached table (created by querying a User Support Database (USD) which is part of the CIS, and/or Network and Engineering Database) that associates tracker modules with an organization, and maps which Customer Servers are currently servicing a customer. While tracker messages represent the majority of messages routed by the Customer Message Router, the latter also routes system messages to the customer applications (e.g., broadcast messages from a Site Administrator).

The Reliable Message Router 38 periodically checks the Customer Support Database to see if any messages that have not been acknowledged should be resent. Messages that should be resent are generated by the Reliable Message Router for retransmission.

Network servers 40 and 41 communicate with trackers over each wireless network. The servers are designed to run in redundant pairs: two servers for transmitting data and two servers for receiving data. FIG. 3 shows CDPD network servers 40 and alternate network servers 41, the latter representing a group of servers for each network being serviced. The Base Packet Servers among network servers 40 and 41 are responsible for transmitting data to tracker modules and storing the raw data transmitted. The Tracker Packet Servers among network servers 40 and 41 are responsible for processing, storing, and forwarding data received from tracker modules.

A Tracker Configuration Server (not shown) is responsible for programming wireless devices “over the air.” Programming includes initial configuration of a device for a customer with parameters such as home sites, message lists, sensor configurations, as well as software updates. An Alarm Server (not shown) is responsible for processing alarm messages generated by all applications that generate alarms in the gateway. All server applications (including the Customer Server, Customer Message Router, Reliable Message Router, and Q Manager) generate alarm messages as required. Alarms generated by these applications are placed in a queue for Alarm Server processing. Alarms are monitored by site administrators using web based messaging and reporting tools similar to those used by customers.

Oracle (trademark of Oracle Corporation) 8i Enterprise database servers are used within the gateway to support all of the server applications. The database used primarily for message routing and network servers is the Network and Engineering Database (NED). The USD portion of the Customer Servers is used to support customer connections and business logic.

Several web server applications are used to support the network servers and message routers 21. Web pages are used to support monitoring, reporting, coverage analysis, internal data entry, and customer data entry screens. Several reports provide assistance to engineering, network (and alarm) monitoring, wireless device testing and production, installation, and customer service. Initial activation of wireless devices, system configuration, and provisioning of services is done through data entry interfaces. Service provisioning is performed either manually by site administrators or customer service personnel, or automatically by customers through the Internet.

D. Wireless Message Protocols

The wireless gateway 20 supports numerous wireless networks 15. Each network has its performance limitations and pricing models that make it necessary to tailor data transfer in order to optimize wireless bandwidth usage for each network. For the location services provided by the gateway, the navigational state information from each wireless device must be provided to the gateway.

Efficient methods of providing frequent periodic location reports, guaranteeing delivery of those reports, and tagging events reported by the wireless devices with location information are important aspects of the invention.

The wireless protocol for CDPD (cellular digital packet data) is described below by way of example. CDPD operates as a data add-on to the analog cellular telephone system. It provides packet data using Internet Protocol (IP) to wireless devices. An aspect of CDPD is that the air time subscriber is billed for all overhead associated with data transmission. This makes it expensive for small packet transmission normally associated with telemetry applications, such as location reporting. The need for frequent location information, and concomitant cost reduction, is addressed by bundling frequent reports into large packets. Overhead is further reduced by using user datagram protocol (UDP) rather than transmission control protocol (TCP) and implementing a guaranteed delivery protocol that is more amenable to a wireless environment.

TCP is the standard transmission protocol used over IP networks (TCP/IP). This protocol sends large blocks of data by splitting them into small packets, transmitting the packets and then reassembling the packets in the correct order on the receiving end, guaranteeing delivery and order. It also provides for error detection with a checksum. TCP is a reliable mechanism for transmitting data over networks that have low rates of data loss and reasonably short response times. These advantages come at the expense of a significant amount of overhead added to the original data to be transmitted. TCP adds 20 bytes of overhead to each packet transmitted and includes additional overhead in the form of acknowledge packets. This protocol may break a message across several IP packets, and each IP packet has its own 20 bytes of overhead.

TCP is not an efficient protocol for wireless systems for the following reasons: (a) since most wireless networks charge by the byte or connection time, the overhead is expensive to send; (b) the protocol to guarantee delivery was not designed for the poor reliability of wireless connections so it can retry excessively (increasing cost) or take too long to deliver data; and (c) its protocol requires continuous communication while transferring data, which is usually not cost effective or reliable when using circuit switched wireless systems because a dropped call to a cellular telephone, for example, requires the system to complete an additional call, and because data must be passed in both directions on a periodic basis, increasing data transmission cost.

For these reasons, wireless communication can be performed more efficiently using UDP over IP networks (UDP/IP) and software algorithms that are better suited to wireless interfaces to improve data delivery reliability. UDP has an 8 byte overhead compared to TCP's 20. The protocol itself does not guarantee delivery of data, but does not add the associated overhead of acknowledgments and connection maintenance. For example, a UDP packet is simply sent to its destination address—the sender does not know if it was received successfully. In contrast, the TCP protocol requires full bidirectional communication to send a packet, but delivery is guaranteed. UDP has a significant advantage for wireless interfaces because one way communication is often easier to establish than two way communication.

The wireless gateway servers 21 and trackers 12 of the present invention implement a limited guaranteed delivery protocol using UDP that is more appropriate for wireless interface than TCP. Limited guaranteed delivery ensures that the system will attempt to deliver messages of all kinds for a period of time. If the time period expires without successful delivery of the message, the user is notified of the failure. Each message successfully received is acknowledged back to the sender, and each message has a sequence number assigned to it to allow the order to be determined, if necessary. For wireless telemetry and messaging applications, messages are very short (typically less than a few hundred bytes), so breaking single messages into multiple packets is rarely required.

The Reliable Message Router (RMR) 38 (FIG. 3) manages the limited guaranteed delivery from the gateway 20 to the tracker 17. (The tracker 17 performs an identical function for messages sent to the gateway.) Each time a new message is sent by the Customer Server 29, the time that the message is sent is logged to the database 31 (FIG. 3A). When an acknowledgment of that message is received from a tracker, that is also logged to the database. FIG. 3A shows the sequence of operations performed by RMR 38 to resend unacknowledged messages. Periodically, every two minutes in the preferred embodiment, the RMR retrieves a list of trackers that require messages to be sent. The send time, number of retries attempted, and total time waiting to be acknowledged are updated. Those messages are then forwarded to Base Packet Server 40a or alternate Server 41a for retransmission.

It is assumed that most messages sent through the gateway are of little importance if not delivered promptly. Timers and retry counters are used to control when messages are undeliverable. An overriding retry count limit is set to 720 in the preferred embodiment. This allows for a retry every two minutes for 24 hours, before failure. This counter can be extended to a maximum of one week, for example, if required. A timer can be set by the user on most messages to indicate that delivery attempts for the message should stop before the overriding system limit. The user typically sets this timer at a few hours. If timers expire or the retry counts are exceeded, the RMR assumes the message is undeliverable and reports a failure to the Customer Server 29. This sequence is shown in FIG. 3B.

The primary use of bandwidth for a location-oriented service is the reporting of vehicle state information. Frequent periodic reports of vehicle location are important for reconstructing the path a vehicle drove—locations of events, such as speeding exceptions or vehicle equipment activation are important for the monitoring of safety or equipment usage. The trackers 17 minimize the bandwidth used by using a combination of packet bundling and data compression. Messages sent by the tracker can contain several packets of the same or different type. Putting multiple packets together minimizes the overhead used by the UDP packet headers.

Vehicle state information is compressed by sampling data at a short interval, such as one minute and bundling ten one-minute interval sample packets into a single message that is transmitted every ten minutes. The first packet is sent in its entirety; the subsequent packets are compressed by representing them as changes in location relative to the previous packet. This way, fewer bits of information are required to represent the location data. Furthermore, if an event occurs or message is received that must be acknowledged, any sampled vehicle state information is bundled with that message acknowledgment. To further reduce bandwidth, state information is not sampled at a high rate while the vehicle is stationary. A stationary vehicle tracker will sample and send a report at ten minute intervals. This behavior allows the user to receive data at the same real time rate, but save sending redundant samples.

Message and packet formats for the CDPD network, by way of example, are described in the following paragraphs. Base messages consist of packets sent from the gateway 20 to the trackers 17 (here, for example, identified with and located on vehicles) over the CDPD network. Tracker messages consist of packets sent from the trackers 17 to the gateway 20. Both the gateway and the trackers initiate the transmission of messages and send acknowledgments in response to receiving messages from the other. In the preferred embodiment, trackers cannot send messages directly to another tracker.

The base message data contain network control information, interval definitions, messaging/paging data, and user specific data. The format of the base message data packets broadcast to trackers is summarized in Table 7. The data packets are of fixed or variable length, depending on the type, and include user commands, messaging and tracker control commands. Data packet decoding occurs after error detection/correction and decryption. Each packet starts with a packet ID byte followed by the data in the packet.

Information flow is handled by message data that control network activity (network and tracker control packets), the message data being created by the Base Packet CDPD Server 40a in response to data received from trackers and from customer or system administrator command stations. Messaging and user data packets are created from commands by the users 11.

Each base message is encapsulated into a data packet wrapper (see Table 8) that is bound by control characters and has a cyclic redundancy check (CRC) to verify the packet data. This format allows the mobile computer comprising the tracker to distinguish between packets when plural packets are sent simultaneously. It also provides for minor error detection on the packets, using a simple 8 bit CRC to check that the data is good and that the correct number of bytes was sent.

Text message data packets are generated in response to messaging commands from user command stations. The maximum message length, for example, is 32739 characters. In addition, an optional 28 character response set may be appended. The text message packet format is summarized in Table 9, and is acknowledged by the tracker at the time the message is received, by use of a Message Response Acknowledge packet. Pre-defined message response sets are illustrated in Table 10.

A Pre-defined Message packet (Table 11) provides a shorter message format for “canned” user messages of the type that are frequently used by an individual customer. Since trackers know the text of these messages a priori, only a message ID and a 16 Bit CRC need be sent by the gateway. The message ID indicates its identity and, consequently, its substance, and the CRC is used as a check for the tracker to verify that the text matches the CRC of the known associated pre-defined message.

Pre-defined message CRC's are computed using the entire pre-defined message. As a result, a tracker may determine if the ID has been reassigned to a new message. Tracker modules that determine that a pre-defined ID has been associated with a new message (or do not know a specified pre-defined message) may request the entire pre-defined message using a “Pre-defined Message Request Packet.” Pre-defined Message Request packets are serviced by the CDPD servers 40a, 40b. When the Tracker Packet CDPD Server 40b receives such a packet, the Base Packet CDPD Server 40a provides the tracker with the pre-defined message in a Pre-defined Message Definition Packet.

A User Data message packet (defined in Table 12) supports generic, user specific data that are sent to trackers from user command stations 11. The format of the message is similar to the text message packet, having at most 32767 data bytes available for any customer purpose. This message can either be used by customer software or viewed via the web based reports.

The process flows for sending Text, Pre-defined, and User Data messages to trackers are shown in FIGS. 3C, 3D, and 3E, respectively. The basic flow for all three is similar, as follows. The user 11 initiates sending a message to the Customer Server 29. The Customer Server acknowledges receipt of the message to the user's web browser, stores the message in the database 31 and forwards it to the Base Packet CDPD server 40a. The Base Packet CDPD server 40a then sends the message to the destination tracker(s) 17 and stores the formatted data packet in the database. The tracker is later expected to acknowledge receipt of the message; otherwise the RMR 38 will act to resend the message as described previously.

The Pre-defined message sequence (FIG. 3D) is more complicated, because if the tracker 17 does not have a match with the message ID and the CRC, it must request the text of the message from the gateway in order to display the message to the mobile user. In this case, the Tracker Packet CDPD Server 40b receives a request for the definition of the message, obtains the definition from the database 31, and tells the Base Packet CDPD Server 40a to send the definition (Table 18) to the tracker.

A Set Intervals Definition packet (Table 13) informs the tracker of the length of all its intervals, including sampling rate, reporting rate, low power update rate and Built in Test (BIT) rate (discussed in more detail below). These values must be positive integers. If the tracker already has a repeating interval assigned, it will be reset to the one contained in the message. Trackers receiving a main repeating interval assignment may use the assigned interval until they request to exit the network. The tracker may receive a sampling interval of ‘0’. In this case, the reporting interval will indicate when the tracker should ask for another interval packet. If that reporting interval is also ‘0’, the tracker will not ask to be in the network again, and although it will respond to requests for data, it will not send position reports.

When a Text or Pre-defined text message is sent to a tracker, a pre-defined or custom response set may be identified. This response set indicates the text labels that should be associated with the mobile data terminal (i.e., tracker) soft keys when the message is displayed. When a soft key is pressed to respond to a message, the soft key number is returned to the CDPD Server in a “Message Response Tracker Packet.” A Message Response Acknowledge base message (Table 14) is used to acknowledge that the Tracker Packet CDPD Server 40b has successfully received a response packet. The tracker module will not discard a message response until it has successfully received an acknowledgment for that response, and if it does not receive an acknowledgment within a set brief interval (e.g., 20 seconds) it will resend the response.

The gateway's SITE DISPATCH (a trademark of Grid Data, Inc., the assignee of this application) feature provides automatic notification when a tracker arrives at or leaves from a specified rectangular geographic area. (The SITE DISPATCH™ notification feature is described in more detail in later paragraphs.) When a vehicle or asset is dispatched to a particular location by the user, the gateway sends a mathematical description of the location, or site, to the tracker using the SITE DISPATCH message (Table 15). The message contains the latitude/longitude coordinates of the southwest and northeast corners of the site. It also contains a test description from the user. Upon receipt of this message, the tracker module will acknowledge the message using the Message Response and User Data packet. When the tracker enters or exits the site, it sends a Site Status message which indicates the site ID number and a code that indicates entry or exit. This provides an automated indication to dispatch applications about when an asset or technician is on a job site for management of the status of work orders. The Site Status message is discussed in more detail below.

A User Data Acknowledge message (Table 16) acknowledges a reliable user data message sent by a tracker. Tracker modules retain a copy of all reliable user data packets until they receive this acknowledgment message from the CDPD Server, and, as in the situation described above, if the acknowledgment is not received within 20 seconds, the tracker will re-send the reliable user data packet.

A Site Purge Message packet (Table 17) requests a tracker to remove one of its known sites. Trackers receiving this packet will acknowledge the message using a Message Response packet and will cease providing a Site Status message for the site associated with the specified “Site ID.”

The Pre-defined Message Definition packet (Table 18, also referenced above) provides tracker modules with a text message associated with a specified pre-defined message ID. Tracker modules receiving this message will store the pre-defined message definition and subsequently use it to display the appropriate message upon receipt of a pre-defined message packet.

A Site Status Acknowledge message (defined in Table 19) is used to acknowledge a site status message sent by a tracker 17. Tracker modules will retain a copy of all site status packets until they receive this acknowledgment message from the Base Packet CDPD Server 40a, and if the acknowledgment is not received within 20 seconds, the tracker will re-send the site status packet.

A Tracker State and Status Block Acknowledge message (Table 20) acknowledges state and status data sent by the tracker. Tracker modules will retain a copy of all state and status block packets until they receive this acknowledgment message from the Base Packet CDPD Server 40a—and if not received within 20 seconds, the tracker will re-send the packet.

Tracker messages are transmitted from the trackers to the gateway over the CDPD network. Tracker data consist of navigation state information, responses to network related commands from the gateway, messaging responses, and user specific data.

Trackers initiate sending data such as navigation state, messages from the driver, or data from sensors, among others and respond with acknowledgments to data transmitted from the gateway. The trackers 17 send the data directly to the Tracker Packet CDPD Server 40b with the UDP protocol. The messages are routed from the CDPD service provider through the Internet to the servers. The messages are logged, processed, and passed in real time to users. In general, each tracker has a periodic interval intended for transmission of navigation state data. Other messages are transmitted as required, usually immediately in response to an event like arriving at a site, acknowledging messages from the gateway, or a driver initiated message.

Exemplary available tracker update repeating interval rates are summarized in Table 21. Due to the expense of CDPD air time, update rates faster than at ten minute intervals are impractical. With the efficiencies realized in data formatting and protocol implementation, the invention is able to provide the effect of more frequent reporting by sampling data at more frequent intervals, such as one minute and transmitting ten one-minute samples every ten minutes. For update intervals longer than one hour, the system use a polling mode of obtaining location reporting instead of automatic periodic reporting.

Each tracker message is encapsulated into a message wrapper (Table 22) which commences with a control character and the length of the message. This is followed by one or more tracker packet(s) and by a CRC to verify the packet data. This format allows the server to distinguish between two or more packets sent at the same time. It also provides for minor error detection on the packets, using a simple 8-bit CRC to check that the data are not corrupt and that the right number of bytes was sent.

Tracker packets are made up of packet specific contents and bit packed blocks of data that are common to several different packets. These common data blocks are defined in this paragraph. The tracker state consists of time, position, speed, and direction, with state byte and bit definitions shown in Table 23. Since the tracker can be in any CDPD cell, it must have the entire latitude and longitude from the GPS. If the CDPD tracker samples its position at a higher update rate than it reports the data, the state and status blocks are placed into a bundle. The first block of that bundle is the regular Tracker State Data Block, but subsequent blocks are a condensed version of the block as defined in Table 24. A Network Status Code (4 out of an available 8 of which are defined in Table 25) is used by trackers to exit the CDPD network. Additional codes can be defined as needed, to automate tracking service changes. Text, pre-defined, user data, site purge, site dispatch, and other messages are acknowledged by trackers to indicate receipt of the respective messages. Text, pre-defined, and site dispatch messages have two responses: a return receipt to indicate the field service technician read the message and a key code to indicate the his answer to the message, if required. Acknowledgments and responses are sent in a Message Acknowledgment/Response Block which has the format shown in Table 26. Each packet has an ID number that requires 4 bits for a total of 16 different packet types. Each packet reserves the first 4 bits for a ID Block.

Packet types are identified by packet ID; for example, space is provided for 16 different packet types, summarized in Table 27. Unused or spare data bits and bytes in the packets are set to zero. The packets themselves consist of the bit-packed data blocks described above. The packets have sequence ID numbers and are acknowledged by the gateway. The sequence ID numbers allow the tracker to know which messages are awaiting acknowledgment. Unacknowledged packets are re-sent by the tracker at one minute intervals while it is registered in the CDPD network. The tracker does not try to send data when it is outside network coverage, and, instead, stores packets for later transmission.

A Net Entry Request packet (Table 28) is used by tracker modules to obtain access to the gateway and to receive a periodic reporting interval for location information, with each module requesting its main repeating interval slot and registering its IP address with the server. The tracker will not know the status of the server before requesting network entry, so it must wait for a response to ensure that it is in the network. If it does not receive an acknowledgment within 60 seconds after sending a network entry request, the tracker module will re-send the request. When a data packet is received from an unknown IP address prior to a net entry request, a Set Interval Definition Packet with intervals of zero is sent to that address by the gateway. The tracker identified by that address must then send a Net Entry Request Packet to become known. Once recognized by the gateway, trackers can send a variety of different packet types depending upon the tracker state.

A State and Status Packet (Table 29) is normally transmitted periodically by trackers, containing full resolution tracker position, velocity, heading, network status information, and five user data bytes. These packets usually contain one or more Condensed Tracker State Data Blocks for the location samples between updates. These packets are normally transmitted in real-time so that up-to-date data are available to the enterprise user. If the vehicle operates outside of network coverage, away from metropolitan areas, for example, the tracker will store location data and transmit using this packet when the vehicle reaches an area that is covered by CDPD.

The User Data Packets provide for data that is not defined by the interface herein to be provided to applications or users. The gateway simply stores and passes these data through to users. The user data (referred to as the User Data Block in the packet being defined in Table 30) consists of a minimum of 1 byte and may be as long as a full tracker transmit packet, all defined by the user. As noted earlier herein, an important function of the location aware business logic is tagging an event report or other data with location information as shown in Table 30. This packet contains location, distance, time, and current site, if applicable. For user data that does not require location information, a user data only packet is defined in Table 31.

A Message Response packet containing an acknowledgment/response (Table 32) is transmitted in response to receipt of any type of message from the gateway. Responses are transmitted when the driver reads a text message or site dispatch message. When the driver presses a response button to one of these messages, the code representing the key pressed is sent by the tracker.

A Site Dispatch Message from the customer/user indicates the area of ajob site to the tracker module, which allows it to determine its arrival at and departure from the job site. The tracker sends a Site Status Packet (Table 33) indicating the tracker ID, site type, site ID, arrival/departure status, time of arrival/departure and the source of arrival/departure status. The site status packet is sent based on latitude and longitude if arrival/departure occurs (using the latitude and longitude values in the Site Dispatch message), and allows the user to manually indicate arrival/departure. The site source bit in the packet indicates how arrival/departure was determined.

A built-in test (BIT) packet (Table 34) is sent by the trackers to provide gateway administrators and engineers information to aid system testing and enable determining whether the tracker modules are functioning properly. Tracker modules provide the BIT packet at a rate specified in Table 13. All values supplied in a BIT Packet Data Block indicate values recorded since the last BIT packet was supplied to the Gateway. The tracker determines which BIT blocks should be included in a BIT Packet. The BIT Packet starts with a Packet ID and a count of the number of BIT Blocks contained in the message, followed by the respective Block ID and its data. The types of BIT data are defined in Table 35. The details of each BIT type are not shown; they include diagnostic information related to navigation reliability, network activity, input voltage, tracker temperature, and so forth.

When a tracker module receives a pre-defined message, it displays the known message associated with the specified message ID and 16-bit CRC. If the message associated with the specified message ID is unknown to the tracker, or the CRC of the known message fails to match the CRC in the pre-defined message packet, the tracker will request the message definition by sending a Pre-defined Message Definition Request packet (Table 36; also see Tables 11 and 18).

E. Customer Interface Server (CIS)

Each CIS 29 provides a unified customer interface regardless of the location of the customer enterprise or wireless network being used. The CIS provides for redundancy and load distribution. As load increases on the customer subsystem additional resources can be added in the way of more web servers or more CIS's. A block diagram of the CIS software architecture and data flow is illustrated in FIG. 4.

The primary functions of CIS 29 are to receive all system and asset data, redirect information to customers attached to a customer interface, send messages to assets, interact with the database, and implement the business logic required by the system. The three major components in the CIS are the connectivity manager 54, the security service 55, and the CIS business logic 50. The connectivity manager communicates information between the intranet, which connects to the wireless gateway message routers, and connected customers via the customer interface 60.

The input queue 62 receives real-time data messages from the CMR (Customer Message Router) 36. The intranet 61 (Ethernet or other Local Area Network (LAN)) connects the hardware components of the gateway 20 (FIG. 1) together. The various applications communicate with each other through this interface. The system supports multiple applications and computers to run them, such as CIS's 29, Web Servers 22, and routers 36 and 38, among others. Customer Server applications communicate with the other applications and each other through the connectivity service 54 and the inbox/outbox 73. One example of communication is coherency messages used to keep users updated on changes made by other users. If one user creates a site while connected to one CIS, that CIS sends a broadcast message to the other CIS's so all appropriate users have access to the new site. The business logic 50 supports most of the business logic functions for the connectivity manager 54, and, along with supporting the CIS, provides a common place for database access and back-end support to the web servers.

Business logic components 50 are not commingled with web server 22 components. Business logic components provide the security context for the data and applications. Optimization of the security component(s) and their usage is paramount. Since a web interface does not maintain a continuous connection, all web based transactions validate security every time a message is posted. This can be very inefficient so the business logic components cache a security context where appropriate, rather than essentially requiring a login every time a new page is displayed.

Security for both web applications and the connectivity service is attained through the security service 55, which is responsible for creating and maintaining a security context for any connected customer.

Customers connect using TCP/IP to access the CIS. CIS 29 uses a pure XML interface (data channel D) 60 implemented as a bidirectional messaging interface that provides a data transfer channel for real-time data that must be pushed to the customers' browsers. The XML interface is the primary connection point for applications, such as dispatching, to connect to the database 31 and gateway 20 and take advantage of the core location aware business logic 50.

All business applications developed for customer support exist on a group of web servers. The customer web server 22 is primarily responsible for servicing web requests, executing active server pages (ASP) or middleware business logic and delivering content and applications to end users. The web server 22 does not have any direct connection to the database 31 for support of business applications; access to the database must go through the location aware business logic 50.

An Oracle 8i Enterprise database is used to support all of the gateway functions. External and integrated applications maintain their own databases and use the XML interface to access location related data from the gateway. Depending on the application, modification to the core database may be required to integrate a new function into the gateway.

The connectivity service 54 is a functional unit comprised of the objects necessary to take information off the web site intranet (e.g., Grid Data™ Intranet) 61, process this information and transmit relevant data to the appropriate connected customers. This service is responsible for four primary functions: (1) providing the mechanism for TCP/IP connection to the CIS for customers connecting over the Internet; (2) managing the removal of items from its input queue 62, from the intranet 61, and routing them to the appropriate connected customers; (3) having a message filter component 63 that allows connected customers to restrict the flow of their outbound data; and (4) providing the functionality necessary to parse messages (XML parser 64) and to create an object 65 that executes a command similar to a remote procedure call (RPC).

Message filter 63 is responsible for restricting the outgoing flow of tracker data to the XML socket connectivity manager for vehicles that are not required to be displayed or used by any of the web based applications. An individual user may not want to see or may not be allowed to see all vehicles owned by a customer. Data related to those vehicles are not transmitted; this is done both for security and to reduce required Internet bandwidth. The message filter component provides the following functions: (1) restricts the outgoing flow of tracker information after receiving a command to disable a tracker; (2) requires a call to the security component to verify dataset access to enable a tracker, and upon validating enablement of the tracker, allows messages to commence to the connected customer; and (3) receives notice of a tracker having been added or removed, by communication from automated processes.

The input queue 62 is the main point of delivery for system and tracker messages to the message filter component 63.

The security service 55 manages a secured access by customers using either the web interface or the XML interface, providing a mechanism for determining access privileges to the primary functions of the CIS and any data potentially available to a user.

User accounts are managed using the concepts of roles and datasets. Roles define classes of users; typical roles could be Dispatcher, Order Entry Clerk, Supervisor, and Administrator. The roles define a template for data and application access privileges. For example, an Order Entry clerk may be able to enter orders into a work order management application, but is not allowed to send dispatch messages, view fleet performance reports, or add users to the system. An administrator may have all of these privileges. With users belonging to certain classes, this mechanism allows simplification of the security system so that only a user's role needs to be checked for access to a certain part of the system. Datasets are partitions of the full set data logged into the database that are accessible only by certain customers or users. Data are normally partitioned by a time range and an owner. Datasets can be used to partition data between users; for example, a customer with two dispatchers may have each one responsible for a different group of vehicles. In this case, the dataset business logic will prevent access by the dispatchers to data from each other's vehicles. Roles provide a mechanism to define a type of user and the features available to it. Datasets are implemented to provide a means to restrict the visibility of vehicles a customer's user can see at any given time. The security service also provides support for the functions of: (1) user login and logoff; (2) encryption and decryption of credentials; (3) maintenance of cached security (roles and datasets); and (4) miscellaneous audit and statistical functions.

An important use for datasets is Client Administration Rights. Fleet owners will often lease vehicles or subcontract vehicles to their clients. Clients of customers who are themselves gateway customers need to be able to manage and dispatch those vehicles as if they were their own. These clients can be assigned administration rights to the vehicles by the owning customer through the datasets. To accomplish this, the owning customer, through an administration web page, selects the vehicles and time frame for which the client is allowed to access data for those vehicles. The client customer can then receive location data in real time and send messages to those vehicles during that time window. Outside of that window there is no real time access; however, events and other data logged during that time window are always available to the client.

A message sequence ID & site management component 67 is responsible for management of the internal requirements for messaging and sites. Its primary responsibilities are: (1) creating message sequence ID's and de-referencing incoming message sequence ID's; (2) managing message response set ID's and dynamic response sets which includes the de-referencing of the response set used for a particular message; and (3) creating site ID's when a new work site is being created.

An alarm generation component 68 is used by the connectivity service 54 to provide information on connections, disconnections, and authentication failures.

Data related to customers that are required for customization and management of the customers' accounts are stored in the system database 31. Each user can customize the environment to his liking by configuring items like initial map views and types of real time data for which he would like audible notification. The system also tracks code and data versions to ensure that the user has the latest of both and can automatically download updates. A customer application support (and profiles) component 70 provides the functions of: (1) facilitating the storage and retrieval of user parameters and configuration information for customer applications; and (2) managing application version checks with the client that includes keeping track of map data updates.

A message logic & validation component 71 is responsible for the general maintenance and validation of all features of messaging for both the CIS 29 and the web servers 22. Messaging tasks initiated from a web server use this component for business logic implementation of all messaging related functions.

A dispatching logic & validation component 72 is responsible for dispatching and dispatch validation for all of the features implemented in the CIS and the web servers. Dispatching tasks initiated from the web server use this component for business logic implementation of all dispatching related functions.

An inbox component of inbox & outbox components 73 is responsible for listening to customer server 22 broadcast messages, and acts to maintain coherency between multiple customer servers. For example, when a site is created or purged, a customer server or other device sends a broadcast message, and the inbox listens for and routes the message to any connected customers it refers to. The outbox component is responsible for sending customer server 22 broadcast messages and customer message router (CMR) 27 broadcast messages, and acts to maintain coherency between multiple customer servers. For example, when a site is created or purged, the customer server sends a broadcast message indicating the operation that took place, and the broadcast message is sent by the outbox to identify to the CMR the trackers related to the customer server.

Customer administration component 53 is responsible for the general administration and validation of all features related to administration for both the CIS and the web servers. Administrative tasks initiated from the web server use the customer administration component to provide business logic. This component supports the functions of: (1) customer asset management; (2) client management; (3) customized feature management; and (4) maintaining Code/Lookup Tables.

Finally, a web support component 74 supports integration of web based applications, providing services for those applications for proper security, dataset, and function (role) access.

F. AML Data Channel Message Formats and Protocol

The XML (eXtensible Markup Language) data channel D 60 (FIG. 2) provides for all real time tracker messages to be pushed to web based applications, such as mapping, and other integrated applications. It also supports a complete command response protocol to enable any application to take advantage of the wireless network interfaces and location aware business logic 50 in the gateway 20. In an exemplary embodiment the protocol defined below uses the Microsoft XML parser shipped with Internet Explorer 5.0. The schema is intended to define and validate an XML payload that is passed between the CIS 29 and the client ActiveX control (“ActiveX” is Microsoft technology for an object oriented application architecture).

All messages are generally formatted identically in a standard message format. The message body contains the XML representation described under each message. All messages are sent and received in the format as shown in the examples below. Table 37 describes the items represented in any message.

MSG_LENGTH
<MESSAGE_NAME REQID SOURCE NAMESPACE>
MSG_BODY_TEXT
</MESSAGE_NAME>

A typical message is similar to that shown below. All optional parameters are included for completeness, and the text of this message is as it would appear exactly, since XML data is very sensitive to inadvertent punctuation and spaces.

```
<CustomerMessage RequestID=“1” Source=“XML_CHANNEL”
xmlns=“urn:schemas-griddata:LoginResponse”>
  <BodyInformation>
    <SubElement>
    </SubElement>
  </Bodylnformation>
</CustomerMessage>
```

Assumptions are that:
The RequestID parameter in all messages that include this parameter is automatically inserted if accessed through the CIS ActiveX control.
Date/Time values are specified in GMT (Greenwich Mean Time) unless otherwise specified. Example: Saturday, Nov. 1, 1997 10:15:00 UTC
Text fields that represent information, unless otherwise stated, are 64 characters in length maximum.

A CIS connection takes place as follows. The client application connects with a socket, and the CIS generates a login request which has an encryption key available to the client for encrypting messages. The encryption key is sent to the client application through a Login Response message, and the client application then returns a Login Result message that contains the result of the login attempt.

CIS connection related commands include a login request message with the format shown immediately below, containing a key value that is a base 64 encoded public key for use by the client in all requests requiring encryption. Table 38 illustrates the login field list for requests.

<LoginRequest xmlns=“urn:schemas-griddata:LoginRequest”>
<Key></Key>
</LoginRequest>

The connection related commands also include a login response message having the format shown immediately below that contains an encrypted version of the users credentials, including the customer name, user name, and password. This credential string is encrypted using the public key received from the login request. The encrypted credential string is then base 64 encoded for transmission to the server. Table 39 shows the message field definitions.

<LoginResponse xmlns=“urn:schemas-griddata:LoginResponse”>
<Credentials></Credentials>
</LoginResponse>

The login result message (format shown below) always returns a value. If it returns a failure, the client should expect that the socket will disconnect automatically. Table 40 gives message field definitions.

```
<LoginResult xmlns=“urn:schemas-griddata:LoginResult”>
  <Status></Status>
  <Identifier></Identifier>
  <SystemMessage></SystemMessage>
</LoginResult>
```

Logout is similar, with the logout request message format as follows.

<Logout xmlns=“urn:schemas-griddata:Logout”>

</Logout>

The logout response message has the format shown below, with message field definitions given in Table 41.

<Logout xmlns=“urn:schemas-griddata:Logout”>
<SystemMessage></SystemMessage>
</Logout>

The user is allowed to change his password at any time; the application use s the following message to accomplish this. A change password message contains an encrypted version of the users credentials, including the customer name, user name, and password. This credential string is encrypted using the public key received from the login request, and is then base 64 encoded for transmission to the server. The change password request message format is shown below, with message field definitions given in Table 42.

<ChangePasswordRequestID=“”xmlns=‘urn:schemas-griddata:Change
Password>
<OriginalCredentials></OriginalCredentials>
<NewCredentials></NewCredentials>
</ChangePassword>

The change password response message is shown below, and field definitions are given in Table 43.

<ChangePasswordRequestID=“”xmlns=“urn:schemas-griddata:Change
Password>
<Status></Status>
</ChangePassword>

A failure message is returned if a message sent to the CIS fails for any reason such as being invalid, containing invalid formatting, containing invalid content, or causing a security infraction. The reason code provides a text description of why the message failed. Table 44 gives message field definitions.

<MessageFailure RequestID=“”xmlns=“urn:schemas-griddata:
MessageFailure’>
<Reason></Reason>
</MessageFailure>

Mapping application support includes use of a generic request and save function. When the mapping application needs to execute a request, it may use the GetMapParameters request function. This function has one element, the function type. All generic map functions return a standard response, which is the GetMapParameters response. This response contains one element, the status, which reflects the success or failure of the operation.

The GetMapParameters allows for a mapping application to receive persistent data stored in the gateway database. Table 45 contains the list of functions. The map parameter function request message format is:

<GetMapParameters RequestID=“” xmlns=‘urn:schemas-griddata:
GetMapParameters”>
<Functian></Function>
</GetMapParameters>

Whenever map parameters are saved, a SaveMapParameters response message is received. If the result is not successful, the reason code is filled in with the cause for the failure. Table 46 shows message field definitions. The response message format is:

```
<SaveMapParameters RequestID=“”
xmlns=”urn:schemas-griddata:GetMapParamaters”>
  <Status></Status>
  <Reason></Reason>
</SaveMapParameters>
```

Map persistent data commands include county list response and save request messages, formatted as set forth below. This message enables the user to control the display with street level data for a particular county. This configuration will follow the user wherever he logs in.

Table 47 contains message field definitions. The response message format is:

```
<GetMapParameters RequestID=“”
xmlns=“urn:schemas-griddata:GetMapParameters”>
  <MapCountyList>
    <CountyItem>
      <Name></Name>
      <DisplayStatus></DisplayStatus>
    </CountyItem>
  </MapCountyList>
</GetMapParameters>
```

And the save request message format is:

```
<SaveMapParameters RequestID=“”
xmlns=“urn:schemas-griddata:SaveMapParameters”>
  <MapCountyList>
    <CountyItem>
      <Name></Name>
      <DisplayStatus></DisplayStatus>
    </CountyItem>
  </MapCountyList>
</SaveMapParameters>
```

Similar to county data, the map may have numerous layers (“layer” is the amount of detail displayed on the map) of detail information. The user can control which layers are displayed. The map persistent data commands also include layer list response and save request messages. Table 48 shows message field definitions. The response message format is:

```
<GetMapParameters RequestID=”″
xmlns=″urn:schemas-griddata:GetMapParameters”>
  <MapLayerList>
    <LayerItem>
      <Name></Name>
      <DisplayStatus></DisplayStatus>
    </LayerItem>
  </MapLayerList>
</GetMapParameters>
```

And the save request message format is:

```
<SaveMapParameters RequestID=“”
xmlns=”urn:schemas-griddata:SaveMapParameters″>
  <MapLayerList>
    <LayerItem>
      <Name></Name>
      DisplayStatus></DisplayStatus>
    </LayerItem>
  </MapLayerList>
</SaveMapParameters>
```

Map persistent data commands also include map defaults response message and save request message. This message controls the search tolerances for address finding, zoom increments and other features. Table 49 shows message field definitions. The response message format is:

```
<GetMapParameters RequestID=“”
xmlns=“urn:schemas-griddata:GetMapParameters”>
  <MapDefaults>
    <EditSearchTolerance></EditSearchTolerance>
    <RoutePlanSearchTolerance></RoutePlanSearchTolerance>
    <ZoomInScale></ZoomInScale>
    <ZoomOutScale></ZoomOutScale>
    <ZoomInWheel></ZoomInWheel>
    <ZoomOutWheel></ZoomOutWheel>
    <BufferDistMin></BufferDistMin>
    <BufferDistMax></BufferDistMax>
    <MaxTurnAngle></MaxTurnAngle>
    <AddrSearchTolerance></AddrSearchTolerance>
  </MapDefaults>
</GetMapParameters>
```

And the save request message format is:

```
<SaveMapParamaters RequestID=″”
xmlns=”urn:schemas-griddata:SaveMapParamaters″>
  <MapDefaults>
    <EditSearchTolerance></EditSearchTolerance>
    <RoutePlanSearchTolerance></RoutePlanSearchTolerance>
    <ZoomInScale></ZoomInScale>
    <ZoomOutScale></ZoomOutScale>
    <ZoomInWheel></ZoomInWheel>
    <ZoomOutWheel></ZoomOutWheel>
```

```
    <BufferDistMin></BufferDistMin>
    <BufferDistMax></BufferDistMax>
    <MaxTurnAngle></MaxTurnAngle>
    <AddrSearchTolerance></AddrSearchTolerance>
  </MapDefaults>
</SaveMapParameters>
```

Map persistent data commands also include worksite defaults. These control the size of automatically generated sites when an address is supplied from work order management applications, for example, and the smallest allowable site size. Table 50 contains message field definitions. The response message format is:

```
<GetMapParameters RequestID=“”
xmlns=“urn:schemas-griddata:GetMapParameters”>
  <WorksiteDefaults>
    <SiteSizeMin></SiteSizeMin>
    <SiteSizeMax></SiteSizeMax>
  </WorksiteDefaults>
</GetMapParameters>
```

And the save request message format is:

```
<SaveMapParameters RequestID=“”
xmlns=“urn:schemas-griddata:SaveMapParameters”>
  <WorksiteDefaults>
    <SiteSizeMin></SiteSizeMin>
    <SiteSizeMax></SiteSizeMax>
  </WorksiteDefaults>
</SaveMapParameters>
```

Tool tip is also among the map persistent data commands. The mouse pointer will cause data to be displayed near the tip when the mouse passes over various map features. For example, the street name is displayed when a street is pointed to on the map. Table 51 has message field definitions. The response message format is:

```
<GetMapParameters RequestID=“”
xmlns=“urn:schemas-griddata:GetMapParameters”>
  <ToolTip>
    <MapLayerName></MapLayerName>
    <MapFieldName></MapFieldName>
  </ToolTip>
</GetMapParameters>
```

And the save request message format is:

```
<SaveMapParameters RequestID=“ ”
xmlns=“urn:schemas-griddata:SaveMapParamaters”>
  <ToolTip>
    <MapLayerName></MapLayerName>
    <MapFieldName></MapFieldName>
  </ToolTip>
</SaveMapParameters>
```

Home Extent is also among the map persistent data commands. The user is allowed to select the initial and default map view, the Home Extent. Table 52 contains message field definitions. The response message format is:

```
<GetMapParameters RequestlD=“ ”
xmlns=“urn:schemas-griddata:GetMapParameters”>
  <HomeExtents>
    <SWLatitude></SWLatitude>
    <SWLongitude></SWLongitude>
    <NELatitude></NELatitude>
    <NELongitude></NELongitude>
  </HomeExtents>
</GetMapParameters>
```

And the save request message format is:

```
<SaveMapParameters RequestID=“ ”
xmlns=“urn:schemas-griddata:SaveMapParameters”>
  <HomeExtents>
    <SWLatitude></SWLatitude>
    <SWLongitude></SWLongitude>
    <NELatitude></NELatitude>
    <NELongitude></NELongitude>
  </Home Extents>
</SaveMapParameters>
```

Map persistent data commands also include Asset Display. The user can select the icons and colors to denote each asset or vehicle on the map. A label or name can also be selected. Table 53 contains message field definitions. The Response Message format is:

```
<GetMapParameters RequestID=“ ”
xmlns=”urn:schemas-griddata:GetMapParameters”>
  <AssetList>
    <Asset ID=“ ”>
      <SymbolID></SymbolID>
      <Color></Color>
      <DisplayStatus></DisplayStatus>
      <LabelAttrib></LabelAttrib>
      <AssetName></AssetName>
    </Asset>
  </AssetList>
</GetMapParameters>
```

And the save request message format is:

```
<SaveMapParameters RequestID=“ ”
xmlns=“urn:schemas-griddata:SaveMapParameters”>
  <AssetList>
    <Asset ID=“ ”>
      <SymbolID></SymbollD>
      <Color></Color>
      <DisplayStatus></DisplayStatus>
      <LabelAttrib></LabelAttrib>
    </Asset>
  </AssetList>
</SaveMapParameters>
```

The user can control which assets are shown on the map. Assets or vehicles can be turned off to de-clutter the screen. Asset Display Management includes Change Asset Display, with a Request Message format as follows. Table 54 contains message field definitions.

```
<ChangeAssetDisplay RequestID=“ ”
xmlns=“urn:schemas-griddata:ChangeAssetDisplay”>
<AssetList>
    <Asset ID=””>
      <EnabledStatus></EnabledStatus>
    </Asset>
    <Asset ID=””>
      <EnabledStatus></EnabledStatus>
    </Asset>
  </AssetList>
</ChangeAssetDisplay>
```

The Response Message (Table 55 shows message field definitions) format is:

<ChangeAssetDisplay RequestID=“ ”
xmlns=“urn:schemas-griddata:ChangeAssetDisplay”>
<Status></Status>
</ChangeAssetDisplay>

Asset Display Management also includes Change Asset Icon, with Request Message format as follows. Table 56 contains message field definitions.

```
<ChangeAssetIcon RequestID=“ ”
xmlns=″urn:schemas-griddata:ChangeAssetIcon”>
<AssetList>
    <Asset ID=“ ”>
      <SymbolID></SymbolID>
      <Color></Color>
    </Asset>
  </AssetList>
</ChangeAssetIcon>
```

And the Response Message (Table 57 shows message field definitions) format is:

<ChangeAssetIcon RequestID=“ ”
xmlns=“urn:schemas-griddata:ChangeAssetIcon”>
<Status></Status>
</ChangeAssetIcon>

The user can request historical vehicle navigation data for display instead of the real-time data. This is primarily used to analyze vehicle trajectories to optimize routes, for example. History includes History Playback Request message format (Table 58 contains message field definitions):

```
<PlaybackHistory RequestID=“ ”
xmlns=“urn:schemas-griddata:PlaybackHistory”>
  <Asset ID=“ ”>
    <StartDateTime><StartDateTime>
    <EndDateTime><EndDateTime>
  </Asset>
</PlaybackHistory>
```

The CIS 29 will query the database for vehicle navigation data for which the user has access in the supplied time range and return that data in the History Playback Response message (Table 59 contains message field definitions), whose format is:

```
<AssetHistoryPostions RequestID=“”
xmlns=”urn:schemas-griddata:AssetHistoryPostions”>
  <Asset ID=“”>
    <Position>
      <Latitude></Latitude>
      <Longitude></Longitude>
      <Speed></Speed>
      <Heading></Heading>
      <DateTimeGMT></DateTimeGMT>
      <Status></Status>
    </Position> </Asset>
</AssetHistoryPostions>
```

General Purpose Messages include Application Support, Asset Functions, Work Site Functions, Messaging and Dispatch Functions, User Message Management, Sensor Message Management, Message Folder Management, and Lookup Table Functions.

The color of a status bar displayed with the vehicle icon based on status reports from the vehicle can be determined from the server.

Application Support includes Event Based Color Display Parameter Response message (Table 60 has message field definitions), formatted as follows:

```
<GetEventColors RequestID=“”
xmlns=”urn:schemas-griddata: GetEventColors”>
  <EventList>
    <Event ID=“”>
      <Color></Color>
    </Event>
  </EventList>
</GetEventColors>
```

Application Support also includes Application Module Parameters Response message (Table 61 has message field definitions), with the format:

```
<GetModuleList RequestID=””
xmlns=“urn:schemas-griddata:GetModuleList”>
  <ModuleList>
    <Module>
      <Name></Name>
      <Enabled></Enabled>
    </Module>
  </ModuleList>
</GetModuleList>
```

User accounts belong to a set of defined roles. As noted above, roles control access to gateway functions for each class of user. Role List is among Application Support, with a message as follows to indicate the capabilities of each role, and Request Message format:

<GetRoleList RequestID=””
xmlns=“urn:schemas-griddata:GetRoleList”>
</GetRoleList>

and a Response Message (Table 62 shows message field definitions) with the format:

```
<GetRoleList RequestID=“”
xmlns=”urn:schemas-griddata:GetRoleList”>
  <RoleList>
    <RoleItem>
      <Module></Module>
      <Function></Function>
      <Enabled></Enabled>
    </RoleItem>
  </RoleList>
</GetRoleList>
```

Asset Functions include a Query Asset List request message, the purpose of which is to provide the customer application with the ability to determine what assets are currently available to them. The Query Asset List response message is an abbreviated version of the mapping support function GetMapParamaters (type AssetList). Table 63 contains message field definitions. The request message format is:

<QueryAssetList RequestID=“”
xmlns=”urn:schemas-griddata:QueryAssetList”>
</QueryAssetList>

And the Query Asset List response message format is:

```
<QueryAssetList RequestID=“”
xmlns=“urn:schemas-griddata:QueryAssetList”>
  <AssetList>
    <Asset ID=“”>
      <LabelAttrib></LabelAttrib>
    </Asset>
  <AssetList>
</QueryAssetList>
```

The Asset Functions also include Asset List Status Request and Response messages. The request message, with the format shown immediately below, is used to retrieve historical information. It is similar to a real time message in information but represents only the last information actually stored in the database. An optional LongRequest parameter can be specified to request extended information.

```
<LastReportedAssetInfo RequestID=””
xmlns=”urn:schemas-griddata:LastReportedAssetlnfo”>
  <LongRequest></LongRequest>
  <AssetList>
    <Asset ID=””></Asset>
  <AssetList>
</LastReportedAssetInfo>
```

Two Response messages are possible: short and long, both shown below. Table 65 and Table 66, respectively, contain the message field definitions. The short position is:

```
<LastReportedAssetInfo RequestID=“”
xmlns=“urn:schemas-griddata:LastReportedAssetInfo”>
  <AssetList>
    <Asset ID=“”>
      <Latitude></Latitude>
      <Longitude></Longitude>
      <Speed></Speed>
      <Heading></Heading>
      <DateTimeGMT></DateTimeGMT>
      <Status></Status>
    </Asset>
  </AssetList>
</LastReportedAssetInfo>
```

And the long position is:

```
<LastReportedAssetlnfo RequestID=“”
xmlns=”urn:schemas-griddata:LastReportedAssetInfo”>
  <AssetList>
    <Asset ID=“”>
      <Latitude></Latitude>
      <Longitude></Longitude>
      <Speed></Speed>
      <Heading></Heading>
      <DateTimeGMT></DateTimeGMT>
      <Status></Status>
      <PersonName></PersonName>
      <LastMessageSent></LastMessageSent>
      <LastMessageSentDateTime></LastMessageSentDateTime>
      <LastMessageRcvd></LastMessageRcvd>
      <LastMessageRcvdDateTime></LastMessageRcvdDateTime>
    </Asset>
  </AssetList>
</LastReportedAssetInfo>
```

The Asset Functions also include a Real Time Asset Information message. While a customer application is connected to the CIS 29, it will receive real-time tracking data for assets associated with the customer's account. The CIS sends these tracking data to the customer application in a Real Time Asset Information message. This message may contain messages of several different types, including the asset's position, the user data received from the asset, message acknowledgments/responses, and site status information.

Real Time Asset Information messages are sent to the client application as they are received. Tracking data messages for assets with continuous tracking service are received at the rate specified by the asset's associated active reporting rate. Tracking data messages for assets without periodic reporting intervals are only received as a result of a request. The customer application may make such a request with a Tracking Request message.

The Real Time Asset Information message is an unsolicited message received from an asset, and used to provide any or all of the pieces of information noted above regarding the asset. Each asset block contains one or more of the data formats listed below. Table 67 has message field definitions.

```
<RealTimeAssetInfo
xmlns=“urn:schemas-griddata:RealTimeAssetlnfo”>
  <PacketDateTimeGMT></PacketDateTimeGMT>
  <LowPowerMode></LowPowerMode>
  <MessageType></MessageType>
  <Asset ID=“”>
```

(One or more of the data types/formats listed below)<

</Asset>
</RealTimeAssetInfo>

Position:

<Latitude></Latitude>
<Longitude></Longitude>
<Speed></Speed>
<Heading></Heading>
<RespDateTimeGMT></RespDateTimeGMT>
<Status></Status>

Site Status:

<WorkSite SiteID=“”></WorkSite>
<SiteType></SiteType>
<SiteStatus></SiteStatus>
<StatusSource></StatusSource>
<RespDateTimeGMT></RespDateTimeGMT>

Message Response:

<Alarm></Alarm>
<MessageResponseType></MessageResponseType>
<SequenceID></SequenceID>
<MessageText></MessageText>
<RespDateTimeGMT></RespDateTimeGMT>

User Data:

<UserData></UserData>
<WorkSite SiteID=“></WorkSite>
<Latitude></Latitude>
<Longitude></Longitude>
<Mileage></Mileage>
<RespDateTimeGMT></RespDateTimeGMT>

Pre-Defined Message:

<Alarm></Alarm>
<MessageText></MessageText>
<WorkSite SiteID=“”></WorkSite>
<Latitude></Latitude>
<Longitude></Longitude>
<Mileage></Mileage>
<RespDateTimeGMT></RespDateTimeGMT>

Sensor Message (Event types are listed in Table 68):

<AlarmInfo EventType=“”></AlarmInfo>
<WorkSite SiteID=“”></WorkSite>
<Latitude></Latitude>
<Longitude></Longitude>
<Mileage></Mileage>
<RespDateTimeGMT></RespDateTimeGMT>

The Asset Functions also include a Real Time Asset Location Request message to solicit a response (an indication of location, or position) from an asset that provides an unsolicited Real Time Asset Information message. Table 69 contains message field definitions.

<UpdateRealTimeLocation
xmlns=”urn:schemas-griddata:UpdateRealTimeLocation”>
<Asset ID=“”></Asset>
</UpdateRealTimeLocation>

A Tracking Request Message is another of the Asset Functions. Assets that do not have periodic reporting intervals only transmit their tracking information upon request. The Tracking Request Message allows an application to request tracking information from a specific asset. If an asset successfully receives a tracking request, it will transmit the requested tracking information in a Real Time Asset Information Message to the requesting application. The request message (Table 70 shows message field definitions) format is:

```
<TrackingRequest RequestID=“”
xmlns=“urn:schemas-griddata:TrackingRequest”>
  <AssetList>
    <Asset ID=“”></Asset>
  </AssetList>
</TrackingRequest>
```

And the response message (Table 71 contains message field definitions) format is:

```
<TrackingRequest RequestID=-“ ”
xmlns=“urn:schemas-griddata:TrackingRequest”>
  <AssetList>
    <Asset ID=“ ”>
      <Status></Status>
    </Asset>
</AssetList>
</TrackingRequest>
```

Yet another of the Asset Functions is the Modify Asset Service message, which is used when an application needs to update an asset's service reporting intervals. This message allows the application to change the primary and secondary sample rates used for sending real time tracking information. The request message (Table 72 has message field definitions) format is (the secondary rate in the message is used when the vehicle ignition is off):

```
<ModifyAssetService RequestID=“ ”
xmlns=“urn:schemas-griddata:ModifyAssetService”>
<AssetList>
    <Asset ID=“ ”>
      <SampleRatePrimary></SampleRatePrimary>
      <UpdateRatePrimary></UpdateRatePrimary>
      <SampleRateSecondary></SampleRateSecondary>
      <UpdateRateSecondary></UpdateRateSecondary>
    </Asset>
  </AssetList>
</ModifyAssetService>
```

And the response message (Table 73 has message field definitions) format is:

```
<ModifyAssetService RequestID=“ ”
xmlns=″urn:schemas-griddata:ModifyAssetService”>
<AssetList>
    <Asset ID=“ ”>
      <Status></Status>
    </Asset>
  </AssetList>
</ModifyAssetService>
```

Another of the Asset Functions is the Asset Attributes Message. The gateway maintains an information profile for each asset, which contains information to identify the asset. This information includes the asset's update rate (primary and secondary) and its sample rate (primary and secondary). The Asset Attributes Message retrieves a list of asset profiles associated with a customer account, and the returned list is limited by the list of asset ID's requested. The request message (Table 74 contains message field definitions) format is:

```
<GetAssetAttributes RequestID=“ ”
xmlns=“urn:schemas-griddata:GetAssetAttributes”>
<AssetList>
    <Asset ID=“ ”></Asset>
  </AssetList>
</GetAssetAttributes>
```

And the response message (Table 75 has message field definitions) format is:

```
<GetAssetAttributes RequestID=“ ”
xmlns=“urn:schemas-griddata:GetAssetAttributes”>
<AssetList>
    <Asset ID=“ ”>
      <SampleRatePrimary></SampleRatePrimary>
      <UpdateRatePrimary></UpdateRatePrimary>
      <SampleRateSecondary></SampleRateSecondary>
      <UpdateRateSecondary></UpdateRateSecondary>
      <Status></Status>
    </Asset>
  </AssetList>
</GetAssetAttributes>
```

Yet another of the Asset Functions is an Asset Name List. The gateway maintains a text name for each asset. A GetAssetNames message retrieves a list of asset names associated with a customer account. The list returned is limited by the list of asset ID's requested. The request message (Table 76 shows message field definitions) format is:

```
<GetAssetNames RequestID=″”
xmlns=“urn:schemas-griddata:GetAssetNames”>
  <AssetList>
    <Asset ID=“ ”>
    </Asset>
  </AssetList>
</GetAssetNames>
```

And the response message (Table 77 has message field definitions) format is:

```
<GetAssetNames RequestID=“ ”
xmlns=“urn:schemas-griddata:GetAssetNames”>
<AssetList>
    <Asset ID=“ ”>
      <Name></Name>
    </Asset>
  </AssetList>
</GetAssetNames>
```

Work Site. Functions, another of the Asset Functions, provide the capability to allow an application to create, change or delete work sites. Three types of work sites exist in this embodiment: home sites, job sites, and persistent job sites. Vehicles are normally stationed at the home site (for example a plant site), and are dispatched to job sites.

A GetWorkSiteList command retrieves a list of work sites based upon the parameter specified by “function.” If the parameter specified for “function” is “All”, then the response is the list of all home sites, and all job sites assigned to an active project or work order. If the “function” parameter is specified as “Home,” then only a customer's home sites are listed in the response message. The request message (Table 78 has message field definitions) format is:

```
<GetWorkSiteList RequestID=“ ”
xmlns=“urn:schemas-griddata:GetWorkSiteList”>
    <Function></Function>
    <WorkSite SiteID=“ ”></WorkSite>
</GetWorkSiteList>
```

And the response message, which returns a list of sites with their coordinates, type, address and other associated data, has the following format (Table 79 has message field definitions):

```
<GetWorkSiteList RequestID=“ ”
xmlns=″urn:schemas-griddata:GetWorkSiteList”>
  <WorkSiteList>
    <WorkSite SiteID=“ ”>
      <SWLatitude></SWLatitude>
      <SWLongitude></SWLongitude>
      <NELatitude></NELatitude>
      <NELongitude></NELongitude>
      <Color></Color>
      <DispStatus></DispStatus>
      <SiteType></SiteType>
      <SiteName></SiteName>
      <Address1></Address1>
      <Address2></Address2>
      <City></City>
      <County></County>
      <State></State>
      <Zip></Zip>
      <Timeout></Timeout>
      <Status></Status>
    </WorkSite>
  </WorkSiteList>
</GetWorkSiteList>
```

A SaveWorkSiteList command, another of the Work Site Functions, stores a single work site or list of work sites, and is used to save color and display status of the site(s). This function is used primarily by a graphical application such as a mapping application. The request message (Table 80 has message field definitions) format is:

```
<SaveWorkSiteDetails RequestID=“ ”
xmlns=″urn:schemas-griddata:SaveWorkSiteDetails”>
  <WorkSiteList>
    <WorkSite SiteID=“ ”>
      <Color></Color>
      <DispStatus></DispStatus>
    </WorkSite>
  </WorkSiteList>
</SaveWorkSiteDetails>
```

And the Response Message (Table 81 has message field definitions) format is:

```
<SaveWorkSiteDetails RequestID=“”
xmlns=”urn:schemas-griddata:SaveWorkSiteDetails”>
  <WorkSiteList>
    <WorkSite SiteID=“”>
      <Status></Status>
    </WorkSite>
  </WorkSiteList>
</SaveWorkSiteDetails>
```

A Create Work Site command is another of the Work Site Functions. The user can create a worksite on the map by drawing a rectangle and entering a name. The map application automatically associates an address with the designated site. The request message stores the site data in the system database (Table 82 has message field definitions), and has the following format:

```
<CreateWorkSite RequestID=“”
xmlns=“urn:schemas-griddata:CreateWorkSite”>
  <SiteType></SiteType>
  <SiteName></SiteName>
  <Address1></Address1>
  <Address2></Address2>
  <City></City>
  <County></County>
  <State></State>
  <Zip></Zip>
  <SWLongitude></SWLongitude>
  <SWLatitude></SWLatitude>
  <NELongitude></NELongitude>
  <NELatitude></NELatitude>
  <Timeout></Timeout>
</CreateWorkSite>
```

And the response message (Table 83 has message field definitions) format is:

```
<CreateWorkSite RequestID=””
xmlns=“urn:schemas-griddata:CreateWorkSite”>
  <WorkSite SiteID=“”></WorkSite>
  <Status></Status>
</CreateWorkSite>
```

Yet another of the Work Site Functions is a Modify Work Site command. When modifying a work site, the requesting application has the ability to do any of the following: change the address of a work site; change the coordinates of the work site, not affecting the address (just size of the area); and change the name of the work site (the work site name must be unique for each customer). The request message (Table 84 has message field definitions) format is:

```
<ModifyWorkSite RequestID=“”
xmlns=“urn:schemas-griddata:ModifyWorkSite”>
  <WorkSite SiteID=“”></WorkSite>
  <SiteType></SiteType>
  <SiteName></SiteName>
  <Address1></Address1>
  <Address2></Address2>
  <City></City>
  <County></County>
  <State></State>
  <Zip></Zip>
  <SWLongitude></SWLongitude>
  <SWLatitude></SWLatitude>
  <NELongitude></NELongitude>
  <NELatitude></NELatitude>
  <Timeout></Timeout>
</ModifyWorkSite>
```

And the response message (Table 85 has message field definitions) format is:

```
<ModifyWorkSite RequestID=“”
xmlns=“urn:schemas-griddata:ModifyWorkSite”>
  <WorkSite SiteID=“”></WorkSite>
  <Status></Status>
</ModifyWorkSite>
```

A Remove Work Site command, among the work site functions, allows a work site to be removed from the system if it is drawn in error or has never been used. The request message (Table 86 has message field definitions) has the following format:

<RemoveWorkSite RequestID=“”
xmlns=“urn:schemas-griddata:RemoveWorkSite”>
<WorkSite SiteID=“”></WorkSite>
</RemoveWorkSite>

And the Response Message (Table 87 has message field definitions) format is:

<RemoveWorkSite RequestID=“”
xmlns=“urn:schemas-griddata:RemoveWorkSite”>
<Status></Status>
</RemoveWorkSite>

An Assign Work Site to Asset command, yet another of the Work Site Functions, has a request message (Table 88 has message field definitions) format:

```
<AssignWorkSite RequestID=“”
xmlns=“urn:schemas-griddata:AssignWorkSite”>
  <WorkSite SiteID=“”></WorkSite>
<AssetList>
    <Asset ID=“”></Asset>
  </AssetList>
</AssignWorkSite>
```

And the Response Message (Table 89 has message field definitions) format is:

```
<AssignWorkSite RequestID=“”
xmlns=“urn:schemas-griddata:AssignWorkSite”>
  <WorkSite SitelD=“”></WorkSite>
  <AssetList>
    <Asset ID=“”>
      <Status></Status>
      <SequenceID></SequenceID>
    </Asset>
  </AssetList>
</AssignWorkSite>
```

A Purge Work Site message, among the Work Site Functions, provides the ability to send a site purge communication to an Asset. An application may send this message to one or many Assets to force the Asset to remove from its memory a specific work site. The request message (Table 90 has message field definitions) format is:

```
<PurgeWorkSite RequestID=“”
xmlns=”urn:schemas-griddata:PurgeWorkSite”>
  <WorkSite SiteID=“”></WorkSite>
  <AssetList>
    <Asset ID=“”></Asset>
  </AssetList>
</PurgeWorkSite>
```

And the response message (Table 91 has message field definitions) format is:

```
<PurgeWorkSite RequestID=″”
xmlns=“urn:schemas-griddata:PurgeWorkSite”>
  <DateTimeGMT></DateTimeGMT>
  <SequenceID></SequenceID>
    <AssetList>
      <Asset ID=“ ”>
      <Status></Status>
    </Asset>
  </AssetList>
</PurgeWorkSite>
```

Applications can send messages to vehicles using the Messaging & Dispatch Functions, which include a Message Failure Message, Pre-defined Message Response Sets, Send Text Message, Send Pre-defined Message, Send User Defined Message and Site Dispatch Message.

When messages (Text, Predefined, Site Dispatch, etc.) are sent to Asset modules, a timeout value may be specified. If a message is not acknowledged before its timeout value or the system maximum number of retry attempts occurs, the gateway sends a Message Failure message to indicate that the message was not acknowledged. The Message Failure message indicates that the gateway will no longer attempt to send the associated message. It is still possible that the Asset received the message, but has been unsuccessful providing the acknowledgment. The Message (Table 92 has message field definitions) format is:

```
<MessageFailure>
  <SequenceID></SequenceID>
  <AssetList>
    <Asset ID=“ ”>
      <FailureCode></FailureCode>
    </Asset>
  </AssetList>
</MessageFailure>
```

Pre-defined Message Response Sets are defined by their ID. A Response Set ID of zero indicates that no pre-defined response is required. Dynamic response sets, which constitute four values delimited by a “|” (vertical bar) character, are also defined using a Response Set ID of “0.” The responses follow the text of the messages in this case; for example: text1|text2|text3|text4. Examples of response sets are shown in Table 93.

Send Text Messages are among the Messaging & Dispatch Functions of the asset monitoring system. Text messages may be sent to assets with a mobile display terminal (MDT), or other display device like that on a cellular telephone. A Send Text Message commands the gateway to send a text message to a list of individual assets identified by their asset ID's. If the gateway successfully queues a message to be sent, the Send Text Message response message will indicate a Message Sequence ID associated with the message being sent. If the message is successfully acknowledged and/or responded to by an asset, the application will receive a Real Time Asset Information Message of type “Message Response.” This response will also include the original Message Sequence ID returned in the Send Pre-defined Message response message. The Send Text Message request message (Table 94 has message field definitions) format is:

```
<SendTextMessage RequestID=″”
xmlns=“urn:schemas-griddata:SendTextMessage”>
  <AssetList>
    <Asset ID=“ ”></Asset>
  </AssetList>
  <Message></Message>
  <ResponseSetID></ResponseSetID>
  <CustomResponse></CustomResponse>
  <Timeout></Timeout>
</SendTextMessage>
```

And the response message (Table 95 has message field definitions) format is:

```
<SendTextMessage RequestID=“ ”
xmins=“urn:schemas-griddata:SendTextMessage”>
  <SequencelD></SequenceID>
  <DateTimeGMT></DateTimeGMT>
    <AssetList>
      <Asset ID=“ ”>
        <Status></Status>
      </Asset>
  </AssetList>
</SendTextMessage>
```

Pre-defined text messages may be sent to assets with an MDT or other display device. As with the Send Text Message described above, a Send Pre-defined Message commands the gateway to send a pre-defined message to a list of individual assets identified by their asset ID's. If the gateway successfully queues a message to be sent, the Send Pre-defined Message response message will indicate a Message Sequence ID associated with the message being sent. If the message is successfully acknowledged and/or responded to by an asset, the application will receive a Real Time Asset Information Message of type “Message Response,” which will also include the original Message Sequence ID returned in the Send Pre-defined Message response message. The Send Pre-defined Message request message (Table 96 has message field definitions) format is:

```
<SendPreDefinedmessage RequestID=“ ”
xmlns=“urn:schemas-griddata:SendPreDefinedMessage”>
    <AssetList>
  <Asset ID=“ ”></Asset>
  </AssetList>
  <MessageID></MessageID>
  <ResponseSetID></ResponseSetID>
  <CustomResponse></CustomResponse>
  <Timeout></Timeout>
</SendPreDefinedMessage>
```

And the Response Message (Table 97 has message field definitions) format is:

```
<SendPreDefinedMessage RequestID=“”
xmlns=”urn:schemas-griddata:SendPreDefinedMessage”>
  <SequenceID></SequenceID>
  <DateTimeGMT></DateTimeGMT>
  <AssetList>
    <Asset ID=“”>
      <Status></Status>
    </Asset>
  </AssetList>
</SendPreDefinedMessage>
```

User defined data can be specific to applications integrated with the gateway. They can be used to control functions of the tracker or sensors connected to the vehicle. User Defined messages may be sent to assets with the optional service to receive such messages. As with the Text and Pre-defined messages described immediately above, a Send User Defined Message commands the gateway to send a User Defined message to a list of individual assets identified by their asset ID's. If the gateway successfully queues a message to be sent, the Send User Defined Response Message will indicate a Message Sequence ID associated with the message being sent. If the message is successfully acknowledged and/or responded to by an asset, the application will receive a Real Time Asset Information Message of type “Message Response,” which will also include the original Message Sequence ID returned in the Send Pre-defined Message response message. The Send User Defined Message request message (Table 98 has message field definitions) format is:

```
<SendUserDefinedMessage RequestID=“ ”
xmlns=″urn:schemas-griddata:SendUserDefinedMessage”>
  <AssetList>
    <Asset ID=“’></Asset>
  </AssetList>
  <UserData></UserData>
  <Timeout></Timeout>
</SendUserDefinedMessage>
```

And the response message (Table 99 has message field definitions) format is:

```
<SendUserDefinedMessage RequestID=“ ”
xmlns=“urn:schemas-griddata:SendUserDefinedMessage”>
  <SequenceID></SequenceID>
  <DateTimeGMT></DateTimeGMT>
  <AssetList>
    <Asset ID=“ ”>
      <Status></Status>
    </Asset>
  </AssetList>
</SendUserDefinedMessage>
```

In the current embodiment, job sites are created, automatically or manually, by an Order Entry Clerk or the Dispatcher, based on the address where the work is to be performed. These sites are displayed on a map on the dispatcher's display terminal. The coordinates of the job site are sent to the vehicle(s) assigned to do work at the site, whether it is dispensing concrete from a ready-mix vehicle, delivering lumber or other building materials from a truck, offloading trees and plants from a landscaper's flatbed, clearing the site with a bulldozer, or any other task. The message is sent at the time the vehicle is dispatched, and the process is referred to herein as the Site Dispatch™ process. A Site Dispatch™ Request Message (Table 100 has message field definitions) has the format:

```
<SiteDispatch RequestID=″”
xmlns=“urn:schemas-griddata:SiteDispatch”>
  <AssetList>
    <Asset ID=“ ”></Asset>
  </AssetList>
  <WorkSite SiteID=“ ”></WorkSite>
  <Message></Message>
  <ResponseSetID></ResponseSetID>
  <CustomResponse></CustomResponse>
  <Timeout></Timeout>
</SiteDispatch>
```

And the Response Message (Table 101 has message field definitions) format is:

```
<SiteDispatch RequestID=“ ”
xmlns=“urn:schemas-griddata:SiteDispatch”>
  <SequenceID></SequenceID>
  <DateTimeGMT></DateTimeGMT>
  <AssetList>
    <Asset ID=“ ”>
      <Status></Status>
    </Asset>
  </AssetList>
</SiteDispatch>
```

User Message Management involves a number of commands or messages as follows: Create User Messages, Find User Messages, Get Customer Messages, Get User Message Types, Modify User Messages, and Remove User Messages. These messages support creation, modification and display of special messages to be sent to vehicles for control of the tracker or display device by applications integrated with the gateway.

A Create User Message request message (Table 102 has message field definitions) has the following format:

```
<CreateUserMessage RequestID=“ ”
xmlns=“urn:schemas-griddata:CreateUserMessage”>
<MessageText></MessageText>
  <EffectiveDateGMT></EffectiveDateGMT>
  <ExpirationDateGMT></ExpirationDateGMT>
<MessageType></MessageType>
  <Sequence></Sequence>
  <SortOrder></SortOrder>
</CreateUserMessage>
```

And the Response Message (Table 103 has message field definitions) format is:

```
<CreateUserMessage RequestID=“”
xmlns=”urn:schemas-griddata:CreateUserMessage”>
  <Status></Status>
  <MessageID></MessageID>
</CreateUserMessage>
```

Find User Messages have the following Request Message format (Table 104 has message field definitions):

<FindUserMessage RequestID=“”
xmlns=“urn:schemas-griddata:FindUserMessage”>
<MessageID></MessageID>
</FindUserMessage>

And the Response Message (Table 105 has message field definitions) format is:

```
<FindUserMessage RequestID=“”
xmlns=“urn:schemas-griddata:FindUserMessage”>
  <MessageText></MessageText>
  <EffectiveDateGMT></EffectiveDateGMT>
  <ExpirationDateGMT></ExpirationDateGMT>
<MessageType></MessageType>
  <Sequence></Sequence>
  <SortOrder></SortOrder>
  <AssetTypeList>
    <AssetType ID=””></AssetType>
    <AssetTypeName></AssetTypeName>
      <AssetTypeEffectiveDate></AssetTypeEffectiveDate>
    </AssetType>
  </AssetTypeList>
</FindUserMessage>
```

The Get Customer Messages request message (Table 106 has message field definitions) format is:

```
<GetCustomerMessages RequestID=””
xmlns=“urn:schemas-griddata:GetCustomerMessages”>
  <Filter>
    <AssetType></AssetType>
    <MessageType></MessageType>
    <Status Type=“”></Status>
    <Origin Type=””></Origin>
  </Filter>
</GetCustomerMessages>
```

And the response message (Table 107 has message field definitions) format is:

```
<GetCustomerMessages RequestID=“”
xmlns=“urn:schema-griddata:GetCustomerMessages”>
  <AssetMessageList>
    <AssetMessage ID=“”>
      <MessageText></MessageText>
      <EffectiveDateGMT></EffectiveDateGMT>
      <ExpirationDateGMT></ExpirationDateGMT>
      <MessageType></MessageType>
      <Sequence></Sequence>
      <SortOrder></SortOrder>
      <AssetTypeList>
        <AssetType></AssetType>
      </AssetTypeList>
      <Status></Status>
    </AssetMessage>
  </AssetMessageList>
  <UserMessageList>
    <UserMessage ID=“”>
      <MessageText></MessageText>
      <EffectiveDateGMT></EffectiveDateGMT>
      <ExpirationDateGMT></ExpirationDateGMT>
      <MessageType></MessageType>
      <Sequence></Sequence>
      <SortOrder></SortOrder>
      <AssetTypeList>
        <AssetType></AssetType>
      </AssetTypeList>
    <ResponseSet></ResponseSet>
    </UserMessage>
  </UserMessageList>
</GetCustomerMessages>
```

The Get User Message Types request message format is:

<GetUserMessageTypes RequestID=“”
xmlns=“urn:schemas-griddata:GetUserMessageTypes”>
</GetUserMessageTypes>

And the Response Message (Table 108 has message field definitions) format is:

```
<GetUserMessageTypes RequestID=“ ”
xmlns=“urn:schemas-griddata:GetUserMessageTypes”>
  <MessageTypeList>
    <MessageType ID=“ ”>
      <Desc></Desc>
      <EffectiveDateGMT></EffectiveDateGMT>
      <ExpirationDateGMT></ExpirationDateGMT>
      <SortOrder></SortOrder>
    </MessageType>
  </MessageTypeList>
</GetUserMessageTypes>
```

The Modify User Message request message (Table 109 has message field definitions) format is:

```
<ModifyUserMessage RequestID=“”
xmlns=”urn:schemas-griddata:ModifyUserMessage’>
  <MessageID></MessagelD>
  <MessageText></MessageText>
  <EffectiveDateGMT></EffectiveDateGMT>
  <ExpirationDateGMT></ExpirationDateGMT>
<MessageType></MessageType>
  <Sequence></Sequence>
  <SortOrder></SortOrder>
</ModifyUserMessage>
```

And the Response Message (Table 110 has message field definitions) format is:

```
<ModifyUserMessage RequestID=“”
xmlns=“urn:schemas-griddata:ModifyUserMessage”>
  <Status></Status>
  <MessageID></MessageID>
</ModifyUserMessage>
```

The Remove User Message request message (Table 111 has message field definitions) format is:

<RemoveUserMessage RequestID=“”
xmlns=”urn:schemas-griddata:RemoveUserMessage”>
<MessageID></MessageID>
</RemoveUserMessage>

And the Response Message (Table 112 has message field definitions) format is:

<RemoveUserMessage RequestID=“”
xmlns=”urn:schemas-griddata:RemoveUserMessage”>
<Status></Status>
</RemoveUserMessage>

Sensor Message Management includes the commands View Sensor Message List, View Sensor Installation List, and Maintain Sensor Installation. Sensor messages are the text shown to the user when the sensor is activated and the severity (whether the message should assert an audible alarm, be simply displayed, or completely ignored) of the sensor output. In the case of the request message for each of the first two commands, all values are optional, and if no values are specified, the latest 20 Active Sensor Installations for the Customer are retrieved in sequence by SensorID within AssetID.

The View Sensor Message List request message (Table 113 has message field definitions) format is:

```
<SensorMessageList RequestID=“”
xmlns=‘urn:schemas-griddata: SensorMessageList”>
  <Function> </Function>
  <PreviousNumber></PreviousNumber>
  <NumberRequested></NumberRequested>
  <Alert></Alert>
  <SensorList>
    <SensorID></SensorID>
  </SensorList>
</SensorMessageList>
```

And the response message (Table 114 has message field definitions) format is:

```
<SensorMessageList RequestID=“
xmlns=“urn:schemas-griddata: SensorMessageList”>
  <Count></Count>
  <ListCount></ListCount>
  <RemainingCount></RemainingCount>
  <MessageList>
    <Message>
      <SensorlD></SensorID>
      <Discretelnput></DiscreteInput>
      <OnDescription></OnDescription>
      <OffDescription></OffDescription>
      <Alert></Alert>
    </Message>
  </MessageList>
</SensorMessageList>
```

A View Sensor Installation message shows which sensors are installed in a vehicle. The View Sensor Installation List request message (Table 115 has message field definitions) format is:

```
<SensorInstallationList RequestID=“”
xmlns=“urn:schemas-griddata: SensorInstallationList”>
  <Function></Function>
  <PreviousNumber></PreviousNumber>
  <NumberRequested></NumberRequested>
  <Status></Status>
  <Alert></Alert>
  <AssetTypeList>
    <AssetTypeID></AssetTypeID>
  </AssetTypeList>
  <AssetList>
    <Asset ID=“”></Asset>
  </AssetList>
  <SensorList>
    <SensorID></SensorID>
  </SensorList>
  <TechList>
    <PersonID></PersonlD>
  </TechList>
  <FromInstallDateGMT></FromInstallDateGMT>
<ToInstallDateGMT></ToInstallDateGMT>
<FromRemovalDateGMT></FromRemovalDateGMT>
<ToRemovalDateGMT></ToRemovalDateGMT>
</SensorInstallationList >
```

And the response message (Table 116 has message field definitions) format is:

```
<SensorInstallationList RequestID=“”
xmlns=“urn:schemas-griddata: SensorInstallationList”>
  <Count></Count>
  <ListCount></ListCount>
  <RemainingCount></RemainingCount>
  <InstallationList>
    <Installation>
      <Asset ID=“”></Asset>
      <SensorID></SensorlD>
      <DiscreteInput></DiscreteInput>
      <Enabled></Enabled>
      <InstallationDateTimeGMT></InstallationDateTimeGMT>
      <InstallerID></InstallerID>
      <RemovalDateTimeGMT></RemovalDateTimeGMT>
      <RemoverID></RemoverID>
      <OnDescription></OnDescription>
      <OffDescription></OffDescription>
      <Alert></Alert>
      <EffectiveDateGMT></EffectiveDateGMT>
      <ExpirationDateGMT></ExpirationDateGMT>
    </Installation>
  </InstallationList>
</SensorInstallationList>
```

The Maintain Sensor Installation request message (Table 117 has message field definitions) format is:

```
<Sensorlnstallation RequestID=“”
xmlns=“urn:schemas-griddata: Sensorlnstallation”>
  <Installation>
    <Asset ID=“”></Asset>
    <SensorID></SensorlD>
    <DiscreteInput></Discretelnput>
    <Enabled></Enabled>
    <InstallationDateTimeGMT></InstallationDateTimeGMT>
    <InstallerID></InstallerID>
    <RemovalDateTimeGMT></RemovalDateTimeGMT>
    <RemoverID></RemoverID>
    <OnDescription></OnDescription>
    <OffDescription></OffDescription>
    <Alert></Alert>
    <EffectiveDateGMT></EffectiveDateGMT>
    <ExpirationDateGMT></ExpirationDateGMT>
  </Installation>
</SensorInstallationList>
```

And the response message (Table 118 has message field definitions) format is:

<SensorInstallation RequestID=“”
xmlns=“urn:schemas-griddata: SensorInstallation”>
<Status></Status>
</SensorlnstallationList>

Message Folder Management includes the commands Message Folder Incoming Message, Message Folder Outgoing State Message, and Message Folder Outgoing Event Message. These messages implement the inbox and outbox functions of the messaging system. The folders show a record of messages sent to and received from trackers. All values are optional, and if no values are specified, the latest 20 Incoming messages, State messages, or Event messages, respectively, for the Customer are retrieved.

The Message Folder Incoming Message request message (Table 119 has message field definitions) format is:

```
<InMessageList RequestID=“”
xmlns=“urn:schemas-griddata: InmessageList”>
  <Function></Function>
  <PreviousNumber></PreviousNumber>
  <NumberRequested></NumberRequested>
  <SenderIDList>
    <SenderID></SenderID>
  </SenderIDList>
  <TypeIDList>
    <TypeID></TypeID>
  </TypeID>
  <AssetList>
    <Asset ID=“></Asset>
  </AssetList>
  <FromDateTimeGMT></FromDateTimeGMT
  <ToDateTimeGMT></ToDateTimeGMT>
</InMessageList>
```

And the response message (Table 120 has message field definitions) format is:

```
<InMessageList RequestID=“”
xmlns=“urn:schemas-griddata: InMessageList”>
  <Count></Count>
  <ListCount></ListCount>
  <RemainingCount></RemainingCount>
  <MessageList>
    <Message SequenceID=“”>
  <DateTimeGMT></DateTimeGMT>
  <SenderID></SenderID>
  <DefinedMsgID></DefinedMsgID>
  <MsgText></MsgText>
  <UserData></UserData>
  <TypeID></TypeID>
  <LocationID></LocationID>
  <ResponseSetlD></ResponseSetID>
  <AssetList>
    <Asset ID=“”>
      <AckFailure></AckFailure>
      <AckGMT></AckGMT>
      <AckPacketGMT></AckPacketGMT>
      <ResponseGMT></ResponseGMT>
      <ResponsePacketGMT></ResponsePacketGMT>
      <ResponseText></ResponseText>
      <RtnReceiptGMT></RtnReceiptGMT>
      <RtnReceiptPacketGMT></RtnReceiptPacketGMT>
    </Asset>
      </AssetList>
    </Message>
  </MessageList>
</InMessageList>
```

The Message Folder Outgoing State Message request message (Table 121 has message field definitions) format is:

```
<StateMessageList RequestID=“”
xmlns=“urn:schemas-griddata:StateMessageList”>
  <Function></Function>
  <PreviousNumber></PreviousNumber>
  <NumberRequested></NumberRequested>
  <AssetList>
    <Asset ID=“”></Asset>
  </AssetList>
  <FromDateTimeGMT></FromDateTimeGMT>
  <ToDateTimeGMT></ToDateTimeGMT>
</StateMessageList>
```

And the Response Message (Table 122 has message field definitions) format is:

```
<StateMessageList RequestID=“”
xmlns=“urn:schemas-griddata:StateMessageList”>
  <Count></Count>
  <ListCount></ListCount>
  <RemainingCount></RemainingCount>
  <MessageList>
    <Message>
      <Asset ID=“”></Asset>
      <DateTimeGMT></DateTimeGMT>
      <Latitude></Latitude>
      <Longitude></Longitude>
      <DefinedMsgID></DefinedMsgID>
      <UserData></UserData>
      <Heading></Heading>
      <Speed></Speed>
    </Message>
  </MessageList>
</StateMessageList>
```

The Message Folder Outgoing Event Message request message (Table 123 has message field definitions) format is:

```
<EventMessageList RequestID=“”
xmlns=“urn:schemas-griddata:EventMessageList”>
  <Function>Count</Function>
  <PreviousNumber></PreviousNumber>
  <NumberRequested></NumberRequested>
  <AssetList>
    <Asset ID=“”></Asset>
  </AssetList>
  <MsgTypeList>
    <MsgType></MsgType>
  </MsgTypeList>
  <FromDateTimeGMT></FromDateTimeGMT>
  <ToDateTimeGMT></ToDateTimeGMT>
</EventMessageList>
```

And the Response Message (Table 124 has message field definitions) format is:

```
<EventMessageList RequestID=“”
xmlns=“urn:schemas-griddata:EventMessageList”>
  <Count></Count>
  <RemainingCount></RemainingCount>
  <MessageList>
    <Message>
  <Asset ID=“”></Asset>
  <DateTimeGMT></DateTimeGMT>
  <EventID></EventID>
  <EventPacketGMT></EventPacketGMT>
  <Latitude></Latitude>
  <Longitude></Longitude>
  <MsgType></MsgType>
  <LocationID></LocationID>
  <DefinedMsgID></DefinedMsgID>
  <Mileage></Mileage>
  <Heading></Heading>
  <Speed></Speed>
  <DataValue></DataValue>
  <SiteType></SiteType>
  <StatusDirection></StatusDirection>
  <StatusSource></StatusSource>
  <UserData></UserData>
    </Message>
  </MessageList>
</EventMessageList>
```

Many of the items in the database are generally retrieved in the form of a lookup table, which are of two types, simple and complex. Simple tables contain an identifier and a value, and may also be qualified by effective start and end dates. Complex tables generally contain an identifier and a series of values. The Lookup Table Functions allow a means to access the database and retrieve a list which the application may either display or use for its own purpose. Table 125 contains a list of all available lookup table names and their respective descriptions. The Lookup Table Functions follow.

A Get Simple Lookup Table Message retrieves the entries in a simple lookup table, i.e., a list containing two data columns, where typically the first column is distinct and is interpreted by the second column. Typically these lists are used to populate selection criteria such as combo boxes, list boxes, scrolling lists, and so forth. The entries in these lookup tables may have a limited date range for applicability, so the response can optionally include “EffectiveDateTimeGMT” and “ExpirationDateTimeGMT”. The Get Simple Lookup Table Message request message (Table 126 has message field definitions) format is as follows. All values are optional except “Table.” If no other values are supplied, the first 255 rows are retrieved from the lookup table, restricted by customer, if appropriate.

```
<LookupTable RequestID=“”
xmlns=“urn:schemas-griddata:LookupTable”>
  <Function></Function>
  <PreviousNumber></PreviousNumber>
  <NumberRequested></NumberRequested>
  <Table></Table>
  <Sort>
    <Column></Column>
    <Direction></Direction>
  </Sort>
  <Search>
    <Column></Column>
    <Constraint></Constraint >
    <BeginningValue></BeginningValue>
    <ContainsValue></containsValue>
  </Search>
</LookupTable>
```

And the Response Message (Table 127 has message field definitions) format is:

```
<LookupTable RequestID=“”
xmlns=“urn:schemas-griddata:LookupTable”>
  <Count></Count>
  <ListCount></ListCount>
  <RemainingCount></RemainingCount>
  <ValueList>
    <Value>
      <Code></Code>
      <Description></Description>
      <EffectiveDateTimeGMT></EffectiveDateTimeGMT>
      <ExpirationDateTimeGMT></ExpirationDateTimeGMT>
    </Value>
  </ValueList>
</LookupTable>
```

The Get Lookup Table Entries Message retrieves a defined set of entries in a simple lookup table. This is used, for example, where a historical list of information contains redundant information. Rather than retrieve redundant information, this message can, if desired, retrieve only one instance of each unique identifier. The Get Lookup Table Entries Message request message (Table 128 has message field definitions) format follows. “Table” and at least one “Code” are required. All other entries are optional.

```
<LookupTableEntries RequestID=“”
xmlns=“urn:schemas-griddata:LookupTableEntries”>
  <Table></Table>
  <CodeList>
    <Code></Code>
  </CodeList>
  <Sort>
    <Column></Column>
    <Direction></Direction>
  </Sort>
  <Search>
    <Column></Column>
    <Constraint></Constraint>
    <BeginningValue></BeginningValue>
    <ContainsValue></ContainsValue>
  </Search>
</LookupTableEntries>
```

The Response Message contains only those entries which were found in the specified table, which may be filtered by Customer. The return list may be shorter than the request list and may be in a different sequence. No information is provided or implied about missing entries. The response message (Table 129 has message field definitions) format is:

```
<LookupTableEntries RequestID=“”
xmlns=“urn:schemas-griddata:LookupTableEntries”>
  <ListCount></ListCount>
  <ValueList>
    <Value>
      <Code></Code>
      <Description></Description>
      <EffectiveDateTimeGMT></EffectiveDateTimeGMT>
      <ExpirationDateTimeGMT></ExpirationDateTimeGMT>
    </Value>
  </ValueList>
</LookupTableEntries>
```

Complex records should have dedicated message types. However, situations may exist where a view or procedure is being developed and subject to change. In the current embodiment, the Get Complex List message is used on an interim basis until the format of the record is settled and a custom message is developed. In the present use, the rows returned contain an indeterminate number of columns. Columns are not named, but are separated by “|” (Vertical Bar). The application (customer, client, or other) is responsible for interpreting the columns. These lists may be used to populate selection criteria, similar to the simple lookup, or may represent a results set and populate a listview, and so forth. The Get Complex List request message (Table 130 has message field definitions) is formatted as follows. All values are optional except “Table.” If no other values are supplied, the first 255 rows are retrieved from the lookup table, restricted by customer, if appropriate.

```
<ComplexLookupTable RequestID=“”
xmlns=“urn:schemas-griddata: ComplexLookupTable”>
  <Function></Function>
  <PreviousNumber></PreviousNumber>
  <NumberRequested></NumberRequested>
  <Table></Table>
  <SortOptions>
    <SortColumn>
      <Column></Column>
      <Direction></Direction>
    </SortColumn>
  </SortOptions>
  <Search>
    <Column></Column>
    <constraint></Constraint>
    <BeginningValue></BeginningValue>
    <ContainsValue></ContainsValue>
  </Search>
</ComplexLookupTable>
```

And the Response Message (Table 131 has message field definitions) format is:

```
<ComplexList RequestID=“”
xmlns=”urn:schemas-griddata: ComplexList″>
  <Count></Count>
  <ListCount></ListCount>
  <RemainingCount></RemainingCount>
  <RowList>
    <Row></Row>
  </RowList>
</ComplexList>
```

Coherency Messages are intended to avoid incoherencies of shared assets or resources attributable to changes in the system. Unsolicited System Coherency Messages may be sent on occasion by the CIS to customers, to reflect changes that another user has made to assets or resources. Messages of this type are only sent to connected customers that share assets or resources that would become incoherent based upon changes that have occurred in the system.

One such message is an Unsolicited Work Site Message (Table 132 has message field definitions), formatted as follows:

```
<WorkSite xmlns=“urn:schemas-griddata:WorkSite”>
  <WorkSite SiteID=“”></WorkSite>
  <SiteType></SiteType>
  <SiteName></SiteName>
  <Action></Action>
  <Address></Address>
  <City></City>
  <State></State>
  <Zip></Zip>
  <SWLongitude></SWLongitude>
  <SWLatitude></SWLatitude>
  <NELongitude></NELongitude>
  <NELatitude></NELatitude>
  <Timeout></Timeout>
  <ErrorMessage></ErrorMessage>
</WorkSite>
```

Another unsolicited system coherency message is a System Shutdown message (Table 133 has message field definitions), with the following format:

<Shutdown xmlns=“urn:schemas-griddata:Shutdown”>
<Reason></Reason>
</Shutdown>

G. Map Interface

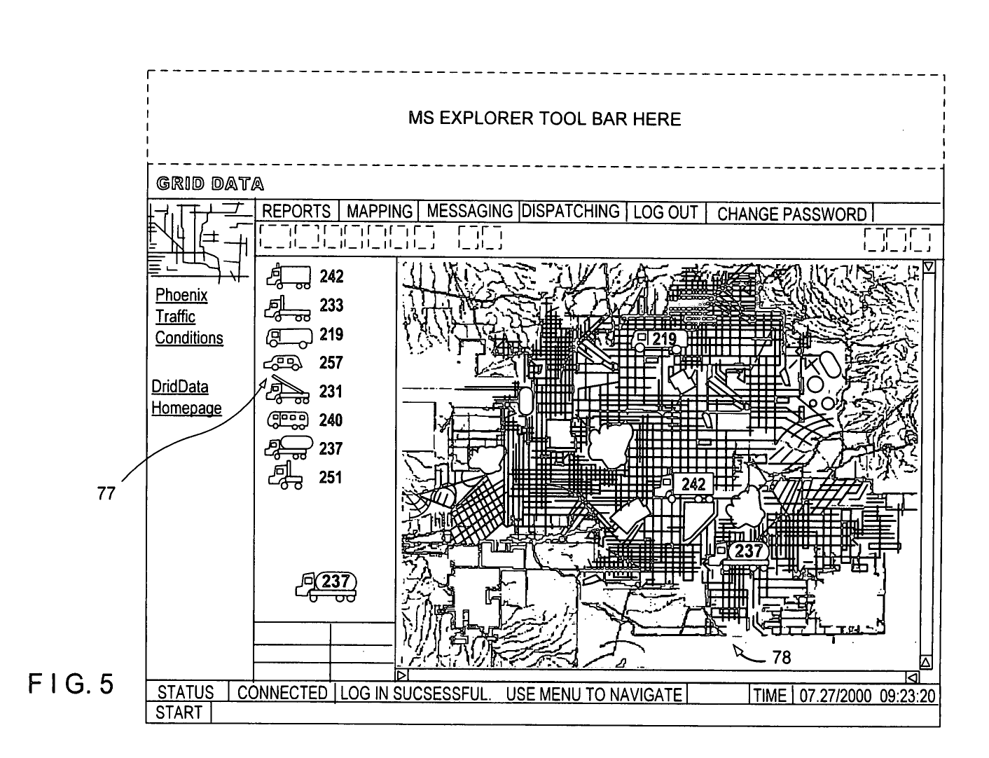

Typical web served mapping applications are based on image delivery as a method to display locations of vehicle on a map to a user. The map display is periodically refreshed by having the browser request a reload of the page containing the image. In response, the web server looks up the last reported positions of vehicles from a data base, generates an image file with the locations on the map, and downloads it to the browser. The same process occurs when the map view is changed. Typically, it takes several seconds to update the display, which is unusable for all but the most casual interaction with the map. This type of implementation is advantageous in that code and data only reside on the server, which makes for easy maintenance of the system. FIG. 5 is an exemplary screen of the web browser mapping user interface, described more fully below.

In contrast, client server or stand alone map applications reside entirely on the user's machine with local or LAN (Local Area Network) based map data. These applications can change and redraw the map display in sub-second times, receiving location information in real time and capable of moving the vehicle location on the screen without redrawing the entire map. They also allow interaction with the vehicle icons on the map by clicking on them to obtain additional data or send messages. However, a significant disadvantage of this implementation is the greater difficulty to maintain code and data since it all resides on every user machine instead of a central server.

The architecture of the mapping application is designed to combine the performance advantages of a local application and database with the supportability advantages of a web served application. The user interface is made to be fast and flexible by having the map database local to the client machine running the application, using a map control application that is running in the context of a web browser, and providing real time data through a second data channel (XML). The application is supported by providing automatic updates to the control through ActiveX download and registration facilities supported in the browser and operating system of the client machine. Updates to the maps are also downloaded to the client machine; updates are kept to a minimum size by partitioning the data by county. A typical metropolitan area user only needs one or two counties of street level data.

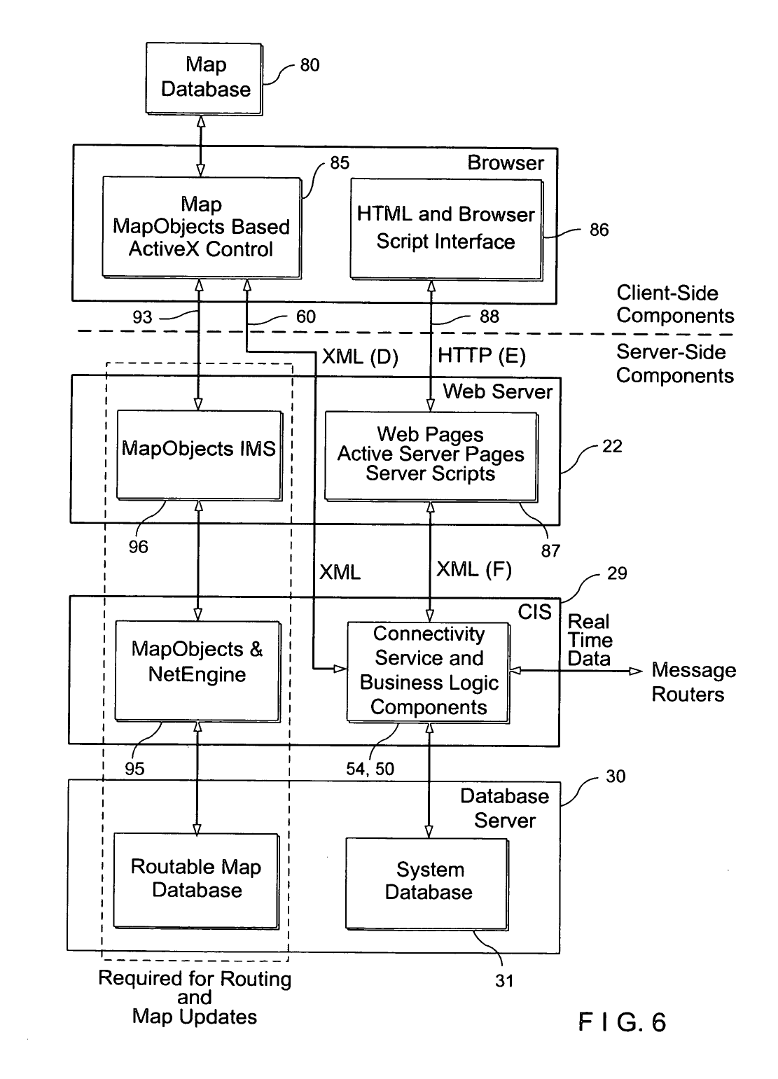

FIG. 6 is a block diagram of the web based mapping application architecture, illustrating the technique of integrating the mapping application into the system. The mapping system is based on a set of software tools and map objects made by ESRI (Environmental Systems Research Institute, Inc., a developer of Geographic Information System (GIS) applications designed to combine maps with other data to show information geographically). A MapObjects component 85 is used as the basis for an ActiveX control that runs the map interface 86. The browser controls communications with other portions of the user interface and web pages 87. Two main channels of communication are provided from the servers to the browser, an HTTP (Hypertext Transfer Protocol) interface 88 to the web server 22 and an XML interface 60 to the CIS connectivity service 54. Real time data, control, and status information is exchanged between the CIS 29 and the map application using this interface.

A third interface 93 is used for mapping when map data require updating and routing is performed. The data base server maintains a full copy of the entire map data. On login, following any updates of any of the counties used by a particular customer, the customer is able to download the new map data. The server side street level map data also has network information that enables routing. Routing is performed using an ESRI NetEngine routing product 95 along with additional code and the MapObjectsIMS (Internet Map Server) 96 software. To reduce cost, routing is performed only on the server; speed is not a concern with routing because the data returned from the server is a short text description and a sequence of points for display on the map.

The user interface of the mapping application (FIG. 5) consists of a command area 77 and a map area 78. The menu bar at the top and interface on the left are made up of HTTP data and scripts. The map 78 occupies most of the display area and is controlled by executable code that is downloaded to the local PC from the server. The map database 80 and application running on the local machine to control the map has a number of advantages over image served mapping solutions, including fast map redrawing, ability to push location data to the map application using a second data channel (the XML channel in this case) which allows seamless updating of vehicle locations in real time, interaction with vehicles by selecting their icons with a mouse, and entry of work sites by drawing them directly on the map.

The XML interface 60 provides for real time location data and other status information to be pushed from the server to the map application. The HTTP interface 88 always requires the client to request, or pull, data.

H. Remote Asset Computer

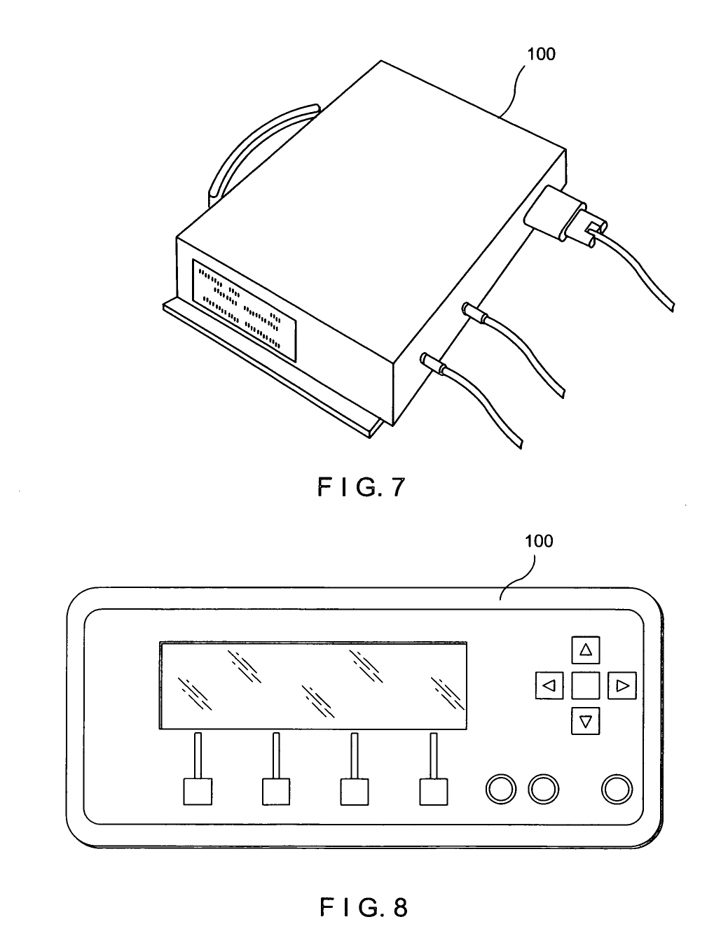

The wireless device, or remote asset computer (e.g., in a vehicle, the tracking computer, or tracker; for individuals, a hand-held computer; for other remote assets, another suitable type of computer), is a critical component in the location aware business logic. The device is responsible for reporting location and other navigational state data as well as managing work site information and reporting status. Vehicle mounted devices, such as the fixed vehicle mounted wireless tracking device (data computer) 100 shown in FIG. 7 and the vehicle mounted display terminal 101 of FIG. 8 for devices using the GRID DATA™ network, also report data sensors used to measure asset utilization and generate automated inputs to work order management applications.

In general, the wireless device of a vehicle includes a display and data entry terminal 101, an example of which is shown in FIG. 8, conveniently located in the cab, for example, for the driver of the vehicle or field person to receive text messages, dispatches, and other information and to allow that person to provide data back to the customer (enterprise owner). The tracking computer 100 and display terminal 101 have industry specific or customer specific user interfaces or business logic on top of the core messaging and location functions.

Different industries have different requirements for their mobile workforce, therefore necessitating a variety of wireless devices to meet each industry's needs. Three types of such devices which are useful in conjunction with the present invention are discussed below: a completely vehicle mounted solution for industrial users, a hybrid device with the location and sensor component in the vehicle and a handheld wireless display device, and a completely handheld unit for the commercial service industry that does not have vehicle sensor requirements. Each of these devices has different capabilities, but all have the same core messaging, location, and work site management functionality.

Over time, it is expected that most location aware devices will be handheld. The light duty, field service business is the largest market for location services, and handheld devices are preferred in this market. The environment is not severe, and the business is interested in communicating with the field representative (FR) when the FR is away from the vehicle. Practical handheld devices with robust navigation capabilities, wireless data communications, and convenient displays and keyboards are not currently available, but it is anticipated that they will be at some point in the future. A hybrid device provides a solution to this need until such a device is available.

1. Vehicle Fixed Mounted Device

A number of industries or industry segments have harsh operating environments, sophisticated vehicle system monitoring requirements, unmanned equipment, or operating characteristics that require use of multiple wireless networks. Examples of industries that have one or more of these requirements include ready mix concrete and other construction materials transportation, heavy duty utility vehicles, and construction equipment rental. In these applications, a wireless device and display fixed to the vehicle or asset is the optimal solution. The wireless device, or tracking computer, is made rugged and environment resistant, and may have numerous sensor connections to the vehicle systems.

Vehicles that operate in remote areas typically need to operate on two wireless networks, a low air time cost metropolitan network and a higher air time cost network with rural coverage, a combination such as CDPD and Orbcomm. The large size of the box needed to accommodate the circuitry for multiple networks and the variety of antennas required makes a portable unit impractical. In cases where the remote equipment is not usually manned or where the equipment, not the operator, is the object of interest, fixed mounted units are desirable.

In the fixed mounted case, the wireless device 100 (FIG. 7) is a tracking computer housed in a box with navigation sensors (e.g., GPS) and one or more wireless communication boards integrated with a power supply and inputs for vehicle sensors. The display terminal 101 (FIG. 8) is a stand alone device that connects to the wireless computer with a serial interface cable. The wireless computer is typically mounted in the cab of the vehicle behind a seat or other location and the display terminal is typically mounted near the dashboard.

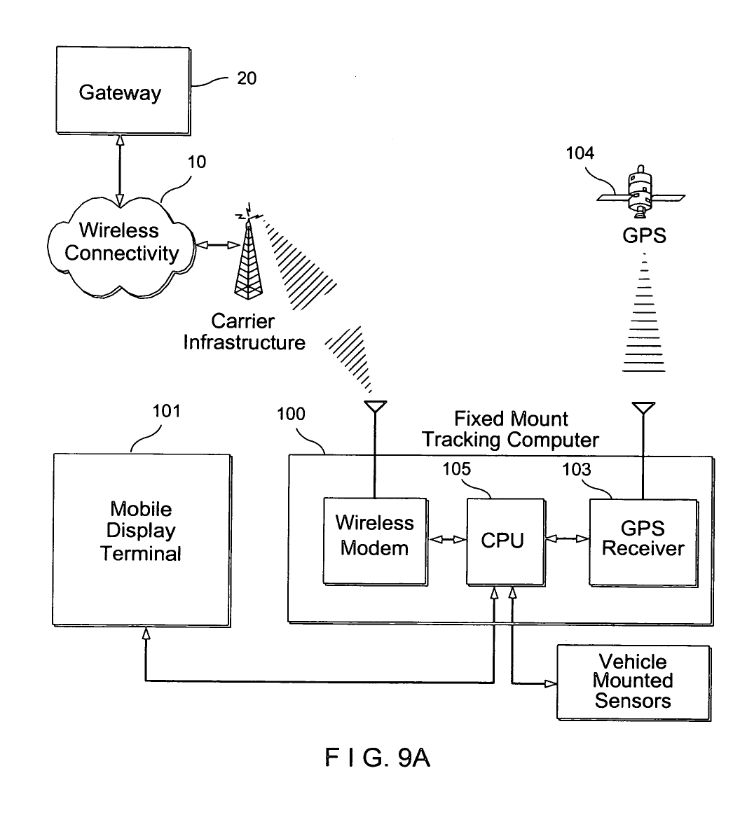

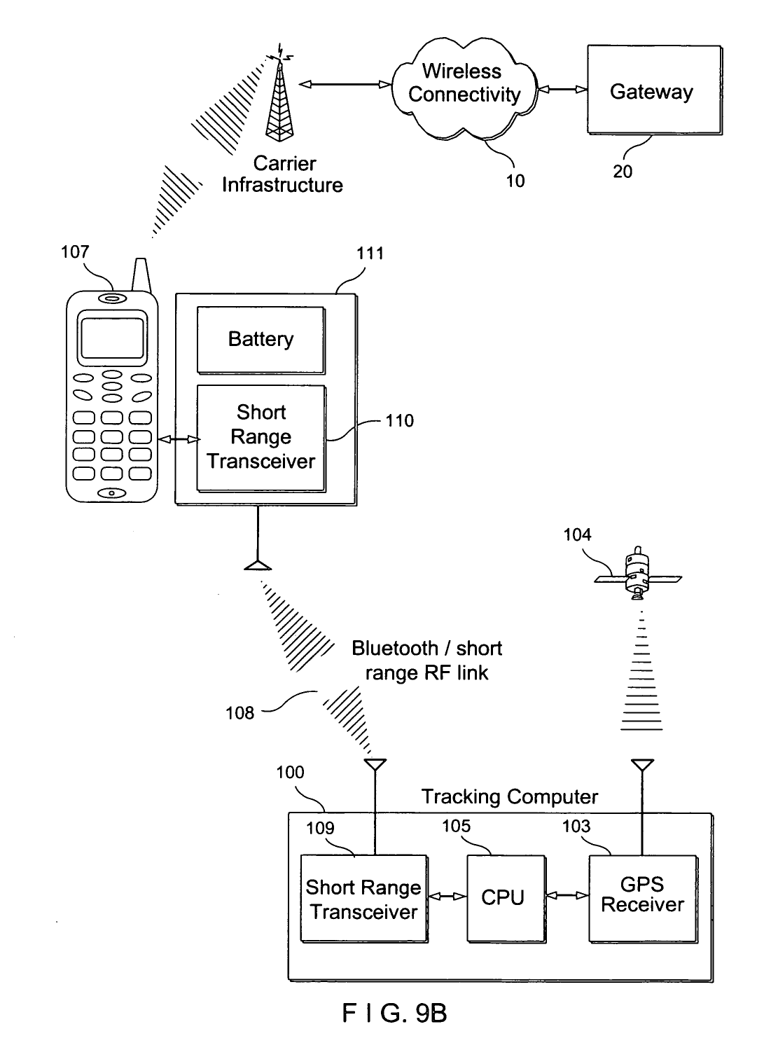

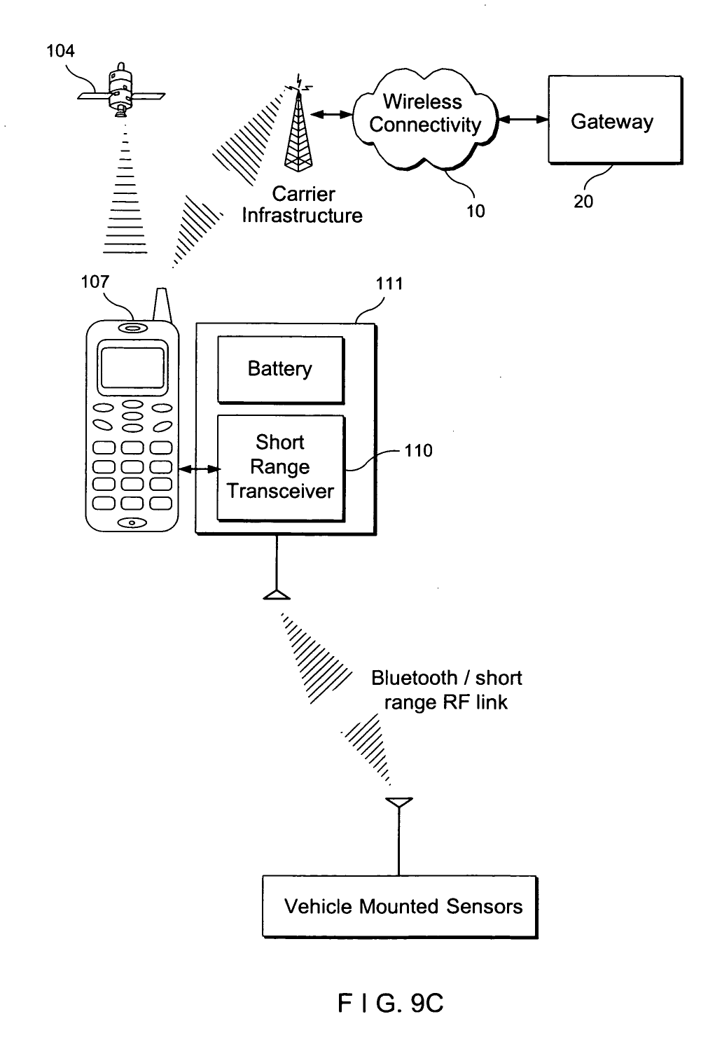

FIG. 9A is a simplified block diagram of a fixed mounted tracking device as it interacts with the gateway 20, display 101, and vehicle mounted sensors (×2). The tracker contains three major functional areas, a CPU 105, a GPS receiver 103, and a wireless modem (×1). The CPU is responsible for running location aware business logic, processing sites for dispatch functions, storing and relaying messages between the gateway and the display, receiving navigation data from the GPS receiver, and receiving data from vehicle sensors. The GPS receiver receives signals from GPS satellites 104 and computes a navigation solution. The CPU uses GPS data and information from speed and heading sensors, if installed on the vehicle, to enhance the navigation solution and forwards the solution at periodic intervals to the wireless modem. Modems, such as the Expedite from Novatel Wireless, communicate on a single wireless network, CDPD in the case of the Expedite. Other modems, such as the Orion from Stellar Satellite Communications, communicate on multiple networks, Orbcomm and Aeris in the case of the Orion. The modem communicates with the wireless carrier infrastructure and, when connected, sends data to and receives data from the gateway.

Sensors mounted on the vehicle (×2) are used to enhance navigation performance and measure other items of interest to the enterprise user. For navigation, these include connections to the vehicle speed sensor so that accurate speed and distance can be determined, particularly when GPS is not available. Heading sensors can also be mounted to the vehicle to provide a full dead reckoning capability to navigate with only intermittent GPS availability, frequently encountered in dense city or urban canyon environments. Other sensors measure equipment utilization, such as ready mix drum rotation and water usage, bed up/down determination for dump trucks, sirens on/off for ambulances, and so on.

2. Hybrid Handheld Device

In the field service industry, which includes plumbing, pest control, HVAC, telecommunication services, and so forth, the technician performing service leaves the vehicle while doing his required tasks. While he is working, he needs data communications with the enterprise, but the vehicle remains at the location where he left it. While he is driving between jobs, the enterprise needs to know his location and also needs to communicate with him. The enterprise may also need automatic information about usage of equipment on the service vehicle, such as the amount of pesticide used.

The hybrid handheld/fixed mounted device provides customers with a handheld wireless messaging device and a vehicle mounted location and sensor data device. FIG. 9B is a block diagram of the of the hybrid handheld/fixed mounted wireless device architecture. The vehicle fixed mounted portion of the hybrid system is a tracking computer 100 that contains the navigation hardware (including GPS receiver 103 that receives signals from GPS satellites such as 104, and CPU 105) and interfaces to the vehicle sensors of interest (not shown in this Figure). A handheld phone 107, or wireless capable PDA (Personal Data Assistant), is the display terminal and provides the wireless connectivity to the gateway. To allow maximum flexibility and usability for the field technician or driver, a short range wireless link 108 between the handheld device 107 and the fixed mounted device 100 is used to communicate data between the gateway and the fixed mounted device.

To that end, the short range wireless link 108 enables the tracking computer 100, via short range transceiver 109, to relay location and sensor data from the vehicle to the gateway through the handheld device 107 via short range transceiver 110 in battery module 111 of the handheld device. This also avoids a need for the driver to connect wires between the devices each time he enters the vehicle. When the driver is away from the vehicle the fixed device 100 stores data, for transmission when the handheld device 107 is within range. The wireless link 108 may use Bluetooth short range spread spectrum transceivers 109, 110 or other low power (e.g., 0.75 milliwatt) frequency or amplitude modulated systems which are very low in cost and use technology similar to that used in garage door openers. These technologies are well suited to this application because only a small amount of data is transferred over this link, and in short bursts. The link is only required to work within the cab or in close proximity to the vehicle, and the low power extends battery life in the handheld device.

A key aspect to making the handheld device inexpensive and relatively simple lies in an unmodified cellular phone hardware or software, which would otherwise require re-certification of the phone with the wireless carrier. Therefore, the short range wireless interface circuitry is added to the battery pack 111 rather than the phone 107 itself. Mobile phones can be completely controlled through their data ports, and batteries connect to those data ports. The battery/radio module 111 buffers work site data and other commands for the fixed device 100, and location, status, and sensor data from the fixed device. The module commands the phone to send data when not in use for voice or other data communications.

In practice, then, the tracking computer 100 provides location of the vehicle and sensor data, and hosts location logic for site dispatch and related functions. The wireless phone 107 provides the wireless link (via 108) between the tracking computer and the gateway, and is the display terminal for messages (in place of unit 101 of FIG. 8). And the gateway can receive data from the tracker when the phone 107 is inside the cab of the vehicle or within about 30 feet of the vehicle with present technology.

Telephone software is left unchanged by using a WAP (Wireless Application Protocol) enabled phone to support the text messaging required by the customer. WAP also provides for more sophisticated user interfaces by providing a web interface on the handheld device. A drawback of WAP for user interfaces is the requirement of substantial wireless bandwidth and/or air time. Greater efficiency is achieved with a local user interface, and sending only the minimum data required over the wireless link. For sophisticated user interfaces, PDAs with add-on wireless modems are desirable because their displays are larger and software can be changed without requiring carrier certification.

3. Location Enabled Handheld Device

Ultimately, an entirely handheld device will provide location aware services to the enterprise in the field service industry, whose primary need is to know the location of and to be able to communicate with the employee. Businesses or industries in which information from vehicles or equipment is the primary concern will continue to require fixed mounted devices. When location enabled wireless phones become widely available, expected in the near future, all of the location aware software that resides in the fixed portion such as tracker 100 of the hybrid device of FIG. 9B can be moved to the handheld device 107.

This arrangement is shown in FIG. 9C. The processor in the cellular telephone or other handheld device will perform all of the functions performed by the CPU in the fixed mounted tracker. In situations where vehicle mounted sensors are required, but a handheld device is also needed, vehicle mounted sensors must have the short range wireless interface built in. The Bluetooth wireless technology is expected to be widely available in the near future as a standard interface on many types of devices to replace cables. Wireless telephones with Bluetooth interfaces are also anticipated to be available soon, an example being the R320 cellular telephone from Ericsson.

II. User Functionality

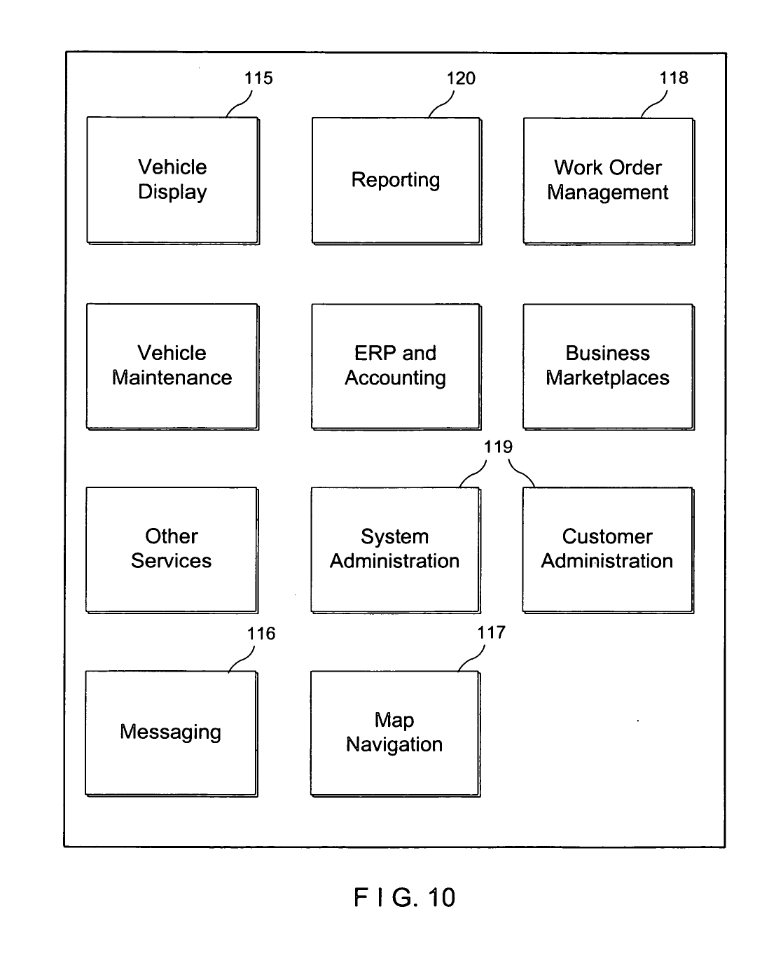

The functions of some of the possible applications available to users will now be considered. The overall software system structure is divided into subsystems as shown in FIG. 10. Each subsystem is composed of one or more functions. Vehicle Display, Messaging, Map Navigation, Dispatching, Administration, and Reporting are considered in detail below.

In addition to managing the processes for the above subsystems, the core business logic 14 (FIG. 1) of the wireless gateway 20 performs the functions of administering user login, user roles, and customer data sets, using a security component. The system is designed to support thousands of customers, each with up to several hundred assets or employees to be tracked and tens of enterprise users, for example. The enterprise users have defined roles that allow different levels of access to the web applications (FIG. 1) and data. As noted earlier herein, defined roles include posts such as Order Entry Clerk, Dispatcher, Manager, and Administrator. Many businesses with mobile or remote assets lease them to their clients. (As also noted previously herein and as generally used in this specification, the term “customers” refers to businesses that use the gateway services. Customers supply their “clients” with services, often using their fleet vehicles that are managed through the gateway. Occasionally, clients themselves are gateway customers.) The business logic allows customers to transfer access to data from assets for defined periods of time so that enterprise users at clients of a customer can get vehicle data and dispatch vehicles. Data in the database are managed by data sets that are partitioned by time periods so that only authorized users have access to the appropriate data for the appropriate time periods. Each time a request is made through the web for data or to use a particular function, the system data base is checked to ascertain that the user has the proper authority before the requested data or function is furnished or permitted.

The gateway provides applications and data to enterprise users via web browsers. To the user, the experience of using the applications must be the same regardless of the computer from which he connects to the gateway. Therefore, “cookies,” a common technique used by web servers to store user specific information on the user's machine cannot be used; all user specific information must be maintained in the system database in the gateway. This User Configuration contains data that is set up by the user or by a user in the customer's enterprise with administration privileges. The configuration contains data including default map view (home extents), vehicles to be included and excluded from display, message types from vehicles to be flagged for alerts when received, the time zone to be used to display times of sent and received data, and map icon shapes and colors for vehicle representation. A user can change his configuration in the context of certain use cases such as Manage Vehicle Display described below, where the vehicles to be displayed on the map can be selected.

A. Vehicle Display

The Vehicle Display Function 115 of the overall software system structure of FIG. 10 enables the user to monitor vehicles on a map display. To monitor vehicles, real time vehicle location data is received and used to update the vehicle icon on the map, thereby displaying the vehicle's new location. Other capabilities of this function, for example, include allowing the user to select which vehicles are to be displayed (or not displayed) on the map, to track a particular vehicle, to playback the vehicle's route history, as well as enabling general map navigation such as viewing various layers of detail (state, city, street, etc.).

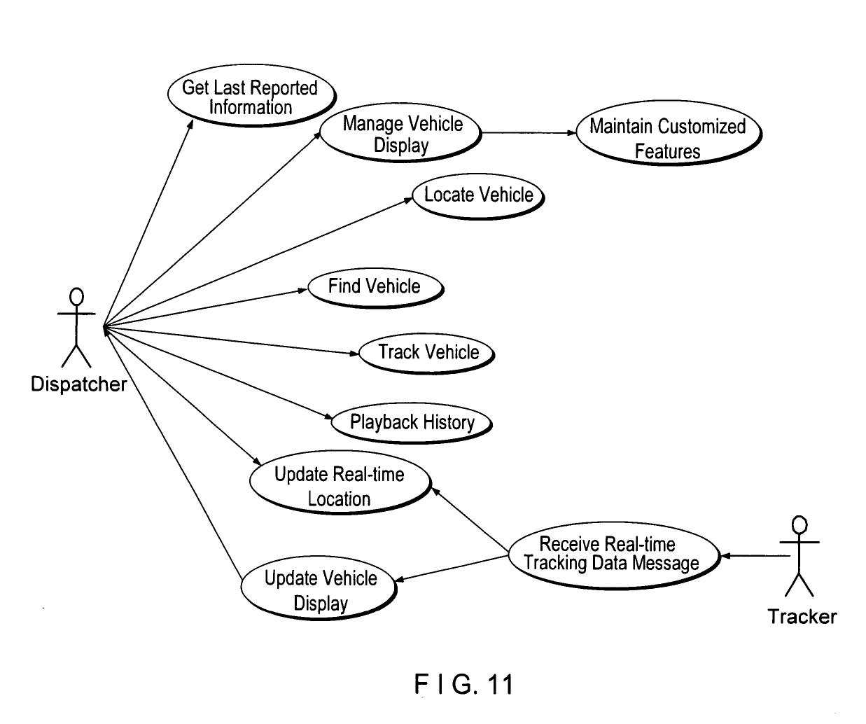

Summary descriptions of the function use cases will now be presented, with reference to the more detailed structure of the Vehicle Display Function illustrated in the functional diagram of FIG. 11. It will be understood that the user (shown in the Figure as a dispatcher as an exemplary user role) may initiate many of the actions shown in FIG. 11 from use cases other than those indicated there, such as from View Vehicle List or View Project/Work Order List (in the Dispatching Function structure, to be described presently). These other use cases are omitted from this Figure to avoid a cluttered diagram, for the sake of simplicity and clarity.

1. Get Last Reported Information

The “get last reported information” case is used when the user wants to view what is currently the last reported information for a vehicle. This information is not real-time data, but rather the last information received from the tracker and recorded in the data base as to the location of the vehicle, and various attributes about the vehicle at the time the last message was received from the vehicle's installed tracker. It may typically include, for example, the vehicle name (or other ID), location given by nearest cross streets or address, speed, direction, last message (text or dispatch) sent to the tracker with time sent and read and longitude and latitude. The response to the last message and time sent may also be displayed (if available). The name of the vehicle in the message may be different from the name originally assigned to the vehicle. For example, some industries create an alias vehicle name based on a particular work order. If the vehicle has an alias name associated with an active work order, that name will be displayed.

In any event, the response to the request “get last reported information” is displayed when the user selects a vehicle and makes the request. It may be displayed while directly in the map (in which case the text is displayed on the map) or wherever a vehicle is displayed (e.g., from a vehicle list or work order list). In the presently preferred embodiment, only one vehicle can be selected at a time. Once the last reported information is displayed, another vehicle can be selected. The user is allowed to view only the last reported information for which the user has authorization to view. For example, if the vehicle was leased to a different customer during the time the latest location message constituting the last reported information was recorded, the system will only allow the leasing customer and lessor to view the last reported info. If the vehicle selected is not enabled for display on the map, the vehicle becomes enabled.

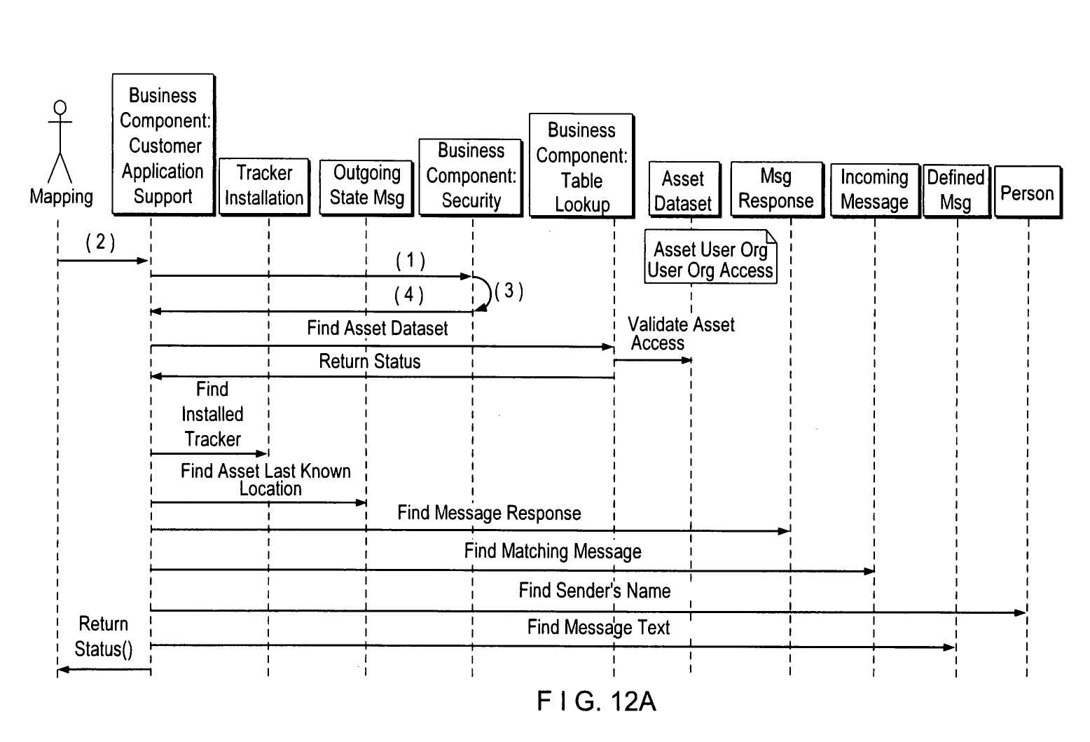

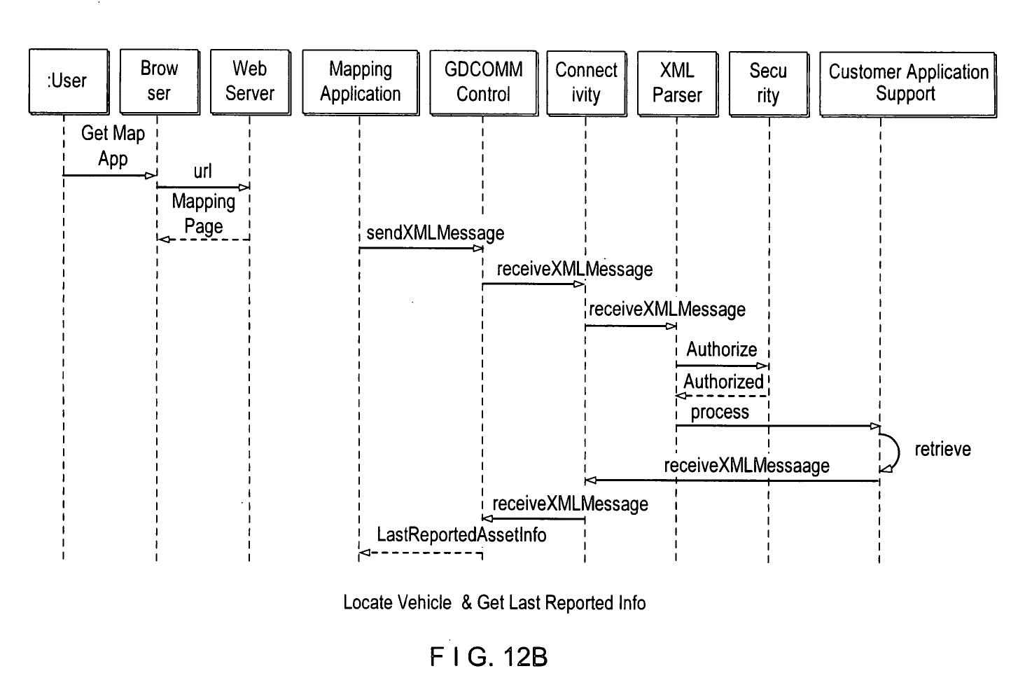

The sequence of operations performed for the Get Last Reported Information function is shown in FIG. 12A. This figure shows the software components and services used to execute the function. The normal sequence is:

(1) Validate Security Access: The Security Component is called to verify security access for the assets being requested. Security caches the results of this so that a subsequent call to the server is not required.

(2) Get Last Reported Information: The mapping application sends a request through the XML interface to get the last reported information for a specific asset.

(3) Determine Asset Authority: Asset authority is verified for the specific time frame the last location message was received to verify the user had authority at the time the message was received.

(4) Details Returned: The details related to the asset are returned to the mapping application. The database is queried to determine the last recorded location and any messages sent to the tracker and any corresponding responses received from the tracker. If the user does not have authority to access the most recent data from the desired tracker, an error message is returned and no data is supplied.

The detailed design of the function sequence is shown in FIG. 12B. The browser opens the mapping application page when requested by the user. The mapping application makes a request for last reported information via the GDCOMM ActiveX control which generates an XML message to the connectivity service 54 in the CIS 29. The message is parsed, and if it passes the security tests, the customer application support component 70 processes the request for data from the database. The results are returned to the mapping application through the connectivity service.

2. Manage Vehicle Display

This use case enables the user to add or remove a vehicle from the map display. Through selecting this function, the user is able to identify which vehicle(s) he is able to see displayed on the map. The function is available only within the mapping application. The user can only “turn on” vehicles for display which he is authorized to view, and only during periods for which such authorization exists. Once the vehicle is selected and displayed on the map, the user can “turn off” any vehicle, which allows him to view a subset of the vehicles authorized to be seen. When the user selects a vehicle to display, the icon is displayed according to the attributes defined for the vehicle, which include icon shape and color. The attributes are assigned in the maintain vehicle function of the administration subsystem discussed below. The system allows the icon/symbol for a selected vehicle to be changed from a default icon/symbol at any time by the user. In the current preferred embodiment, if a vehicle selected for display is located outside the current default map area, the map will not automatically scale to allow the selected vehicle to be seen. Rather, the user must issue a Find Vehicle request (discussed below) in order to display the vehicle's location on the map or change the view by panning or zooming the map display. The user can select multiple vehicles at any given time to be added to the display. It is emphasized again that the term “vehicle” may refer to any asset equipped with location services, not merely cars and trucks; it can be a person, a fixed asset, or other piece of equipment.

When a vehicle (or any remote asset) is selected to be turned on or off from display on the map, this change can be saved to the user's configuration in the system database to be persistent for future logins. The user has the option to save his configuration at any time, or, if the configuration has not been previously saved, the user has the opportunity to save it on logout.

When the user selects a vehicle for display, it is displayed at its last known location. This is the location last reported by the vehicle and stored in the system database. This location is retrieved from the database in a manner analogous to the Get Last Reported Information described above. A request is not sent to the tracker to immediately report its location in the manner of Update Real-time Location described below.

The Manage Vehicle Display function can (i) add or remove a vehicle from map display; or (ii) change the displayed name (label) of a vehicle (asset) icon, icon shape, or icon color. The sequences of operations to perform these functions are outlined below:

The normal sequence for enabling or disabling an asset for display on the map is:

(1) Validate Security Access: The Security Component is called to verify security access for the assets being requested. Security caches the user's parameters so that a subsequent call to the server is not required.

(2) Change Asset Display: The Mapping Application sends a request to enable or disable an asset from the map display through the XML interface.

(3) Asset Details Updated: The database tables are updated to reflect the change.

(4) Notify Message Filter: The message filter is notified the asset has been enabled/disabled so that it can start or stop sending messages to the mapping application.

(5) Get Asset Location: The Mapping Application sends a request to get the last known location for the asset(s) enabled.

(6) Last Known Location Retrieved: The database tables are accessed to retrieve the last known location for the asset(s) requested.

(7) Details Returned: The last known location data is returned to the mapping application.

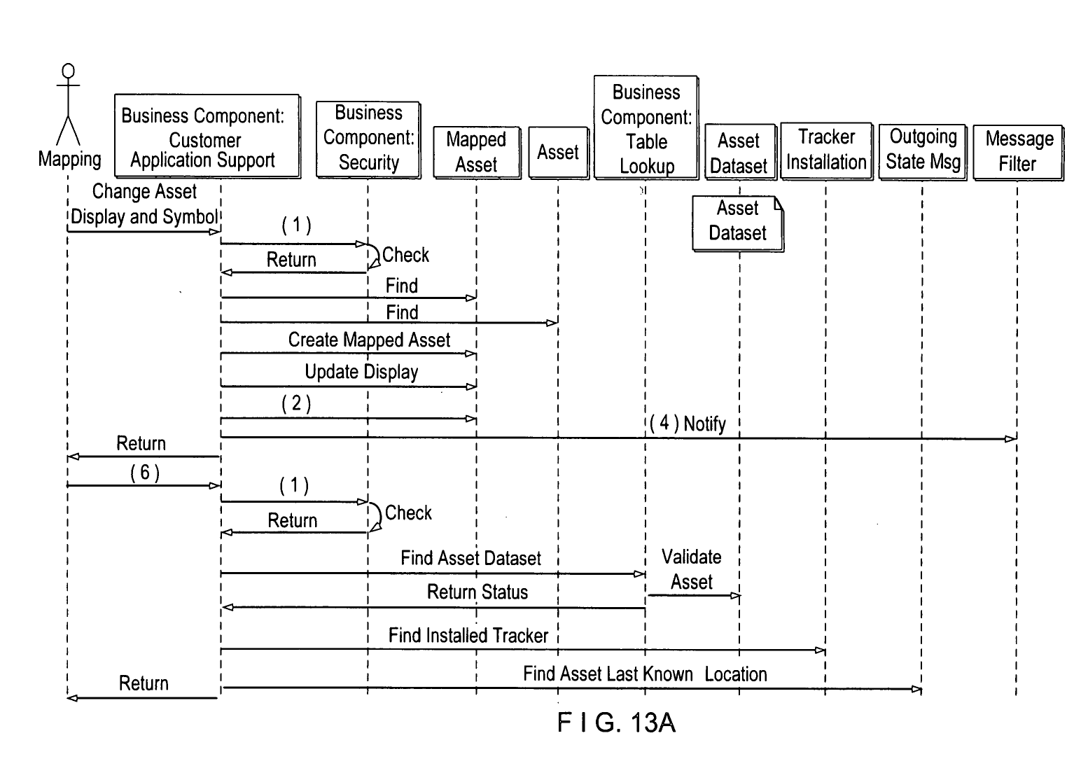

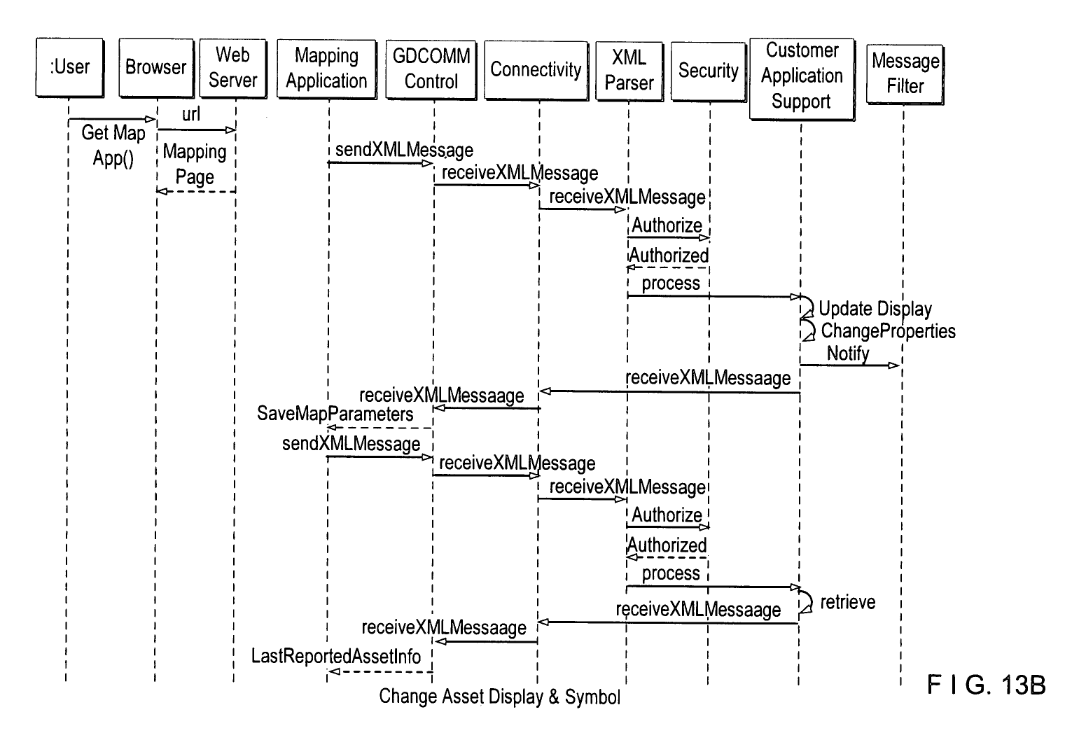

The normal sequence of events when the user enables an asset and changes the symbol, color, name and/or label attribute of the asset in the mapping application is shown below. This sequence is shown, by way of example for the other functions of this use case in FIG. 13A. This Figure shows the software components and services used to execute the function, including:

(1) Validate Security Access: The Security Component is called to verify security access for the assets being requested. Security caches the user's parameters so that a subsequent call to the server is not required.

(2) Update Symbol: The Mapping Applications sends a request to change the icon, label, or color of one or more assets.

(3) Asset Details Updated: The database tables are updated to reflect the asset is enabled.

(4) Notify Message Filter: The message filter is notified the asset has been enabled/disabled so that it can start or stop sending messages to the mapping application.

(5) Symbol Updated: The database tables are updated to reflect the change.

(6) Get Asset Location: The Mapping Application sends a request to get the last known location for the asset(s) enabled.

(7) Validate Security Access: The Security Component is called to verify security access for the assets being requested. Security caches the user's parameters so that a subsequent call to the server is not required.

(8) Last Known Location Retrieved: The database tables are accessed to retrieve the last known location for the asset(s) requested.

(9) Details Returned: The last known location data is returned to the mapping application.

If the user is not allowed to change the display parameters or does not have access to the vehicle, an error message is returned and no action is taken.

The detailed design of the Change Asset Display and Symbol function sequence is shown in FIG. 13B. The browser opens the mapping application page when requested by the user. The mapping application makes a request to save (saving the change to) mapping parameters, which here include the display of the vehicle icon, icon shape, color, and label, via the GDCOMM ActiveX control which generates an XML message to the Connectivity Service in the CIS. The message is parsed, and if it passes the security tests, the Customer Application Support component processes the request to update the user's configuration in the database. The message filter is notified if there is a change in which assets are to be displayed so that subsequent real time updates from the vehicle are not sent to the user's map application. If the vehicle has been turned on for display, Get Last Reported Information is executed on behalf of the user so that the last known location of the vehicle can be displayed on the map. The results are returned to the Mapping Application through the Connectivity Service.

3. Locate Vehicle

This case is utilized when the user is seeking the location of a vehicle not visible in the current display area of the map and does not wish to attempt to find it manually by panning and zooming the map display (which would be a hit and miss task if the display is cluttered with vehicles or the particular vehicle is disabled for display). By virtue of a capability existing within the mapping and dispatching applications, the icon of the requested vehicle is displayed at its current location on the map. If the request is made for a vehicle that is currently not enabled for display on the map, the vehicle becomes enabled (or selected) but only if the user is authorized to view the vehicle. If the location request is made for multiple vehicles, the map will scale appropriately to display the location of all requested vehicles.

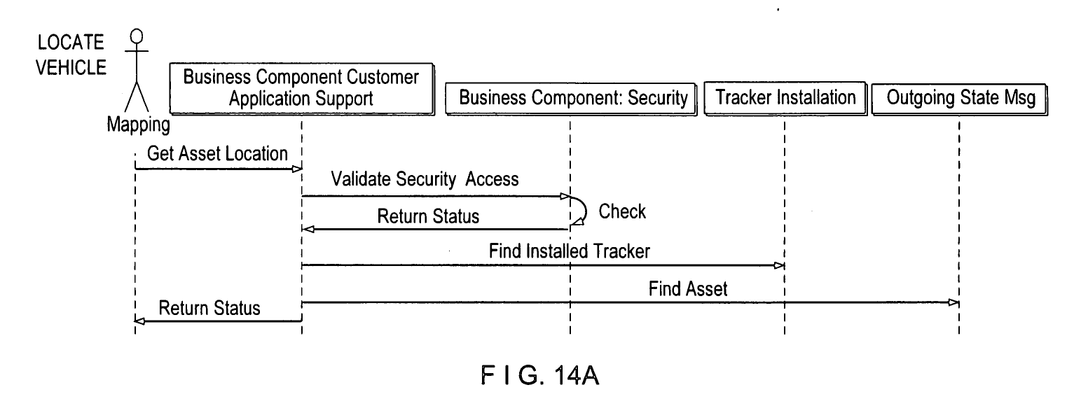

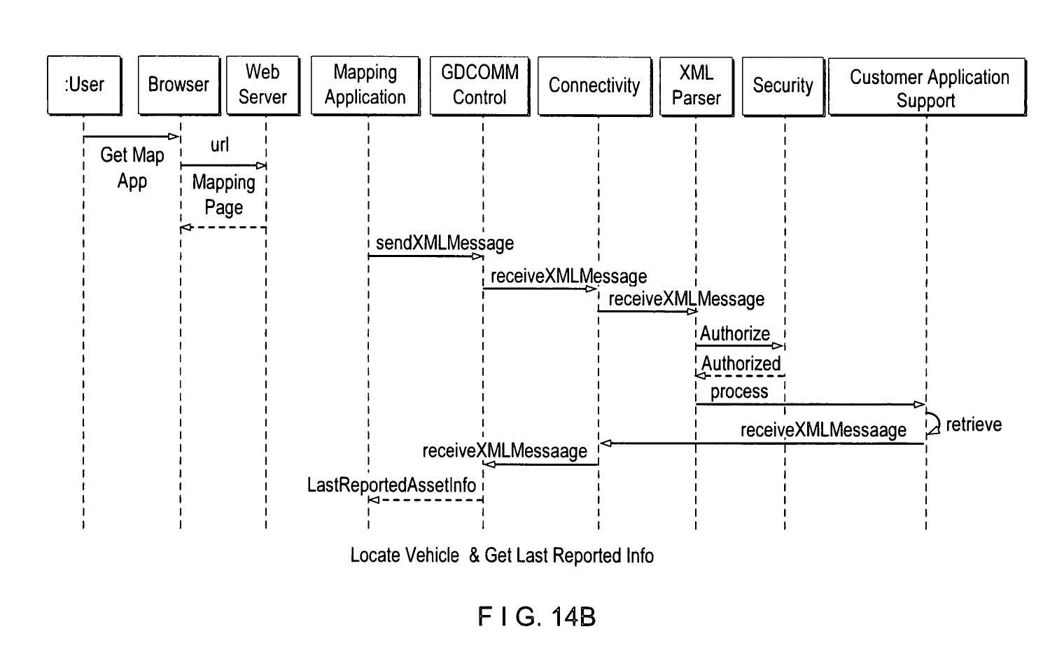

The normal sequence for locating a vehicle is for the user to select the locate vehicle command and select the name of a vehicle or asset to locate. The mapping application then issues a request to the CIS. Then the following actions occur as shown in FIG. 14A.

(1) Validate Security Access: The Security Component is called to verify security access for the assets being requested. Security caches the results of this so that a subsequent call to the server is not required.

(2) Get Asset Location: The database tables are accessed to retrieve the last known information for the asset(s) requested.

(3) Details Returned: The last known location data is returned to the mapping application. If the user does not have access or there is no data available, an error message is returned.

The detailed design of the Locate Vehicle function sequence is shown in FIG. 14B. The browser opens the mapping application page when requested by the user. The mapping application makes a request to locate vehicle via the GDCOMM ActiveX control which generates an XML message to the Connectivity Service in the CIS. The message is parsed, and if it passes the security tests, the Customer Application Support component retrieves the last reported asset information. The results are returned to the Mapping Application through the Connectivity Service so that the location can be displayed. The map view then automatically centers around the located vehicle.

4. Find Vehicle

This function use case is employed when the user is seeking the location of a vehicle based on some search criteria. This is initiated from the Dispatching application only, and complements the capabilities listed above under the “Locate Vehicle” function use case. The requested vehicles are found based on various selection criteria, such as project/work orders, vehicle IDs, resources, and so forth. Once the user defines the search criteria and submits the Find Vehicle request, the Locate Vehicle capability is initiated as described above. If the request is made for a vehicle that does not exist, the user is so notified by an appropriate posting on the display.

When the user selects the Find Vehicle function from the dispatching application, he is presented with search options. The user can select vehicles associated with a specific work order, vehicles that are available for assignments, vehicles that are late to jobs, and so forth. When the search criteria are selected, the dispatching application makes a request to the CIS for a list of vehicles that match the criteria If the request passes security tests, the database is queried and a list of vehicles that match the query is returned. The find vehicle function then successively calls the Locate vehicle function for each vehicle.

5. Track Vehicle

This function, which is available only within the mapping application, is used by the user to monitor a vehicle's activity, enabling a real-time trail of the vehicle to be initiated in response to the request. The user may select either of two options for the tracking: (1) Tracking only, in which the requested vehicle is kept on the map by re-centering as often as necessary to prevent the vehicle from running off the edge of the map display; or (2) Tracing, in which a “bread crumb” trail of the requested vehicle's path is displayed. The user may initiate the Track Vehicle request with the tracking/tracing option, and designate an optional interval for which the tracking/tracing is to continue. The function continues until stopped by the user, or the designated time interval expires, or the user logs out or closes the browser, or the user is no longer authorized to view the vehicle. The user is permitted to extend or reduce the time from that originally designated when tracking/tracing function was initiated. When the function is initiated, the first point created is the latest known location of the vehicle retrieved from the data base. That is, the tracker is not requested to provide a location update at the start of the track vehicle function; it starts with the last location provided by the tracker.

At each point of the trail when the tracing option is selected, the user can obtain text detail of the vehicle status, including speed, direction and time information. The frequency at which these points are displayed is dependent upon the sampling rate of the tracker. While the Track Vehicle request is turned on, real-time tracking data messages are being received, and each time a message is received, a point (or “bread crumb”) is displayed on the map, which the user may select to get the requested vehicle's last reported information. When the trail reaches a defined (by the user) number of points to be displayed at one time, the oldest point on the trail is dropped as the next point is displayed. In the current preferred embodiment, only one vehicle at a time can be selected for tracking/tracing, and ifthe selected vehicle is not currently enabled for display on the map, the vehicle will become enabled. Here again, the user must have both authorization to view and be within a period that such authorization is current, in order to initiate a Track Vehicle request, and the “bread crumb” trail will cease or the vehicle icon will cease being updated (depending on option selected) if the authorization expires before completion of the selected tracking/tracing duration.

The Track Vehicle function begins by using the Change Asset Display function as outlined below:

(1) Validate Security Access: The Security Component is called to verify security access for the asset being requested. Security caches the results of this so that a subsequent call to the server is not required.

(2) Change Asset Display: The Mapping Application sends a request to enable the asset in the map display.

(3) Asset Details Updated: The database tables are updated to reflect the change.

(4) Get Asset Location: The database tables are accessed to retrieve the last known location for the asset requested.

(5) Details Returned: The last known location data is returned to the mapping application.

Once the start position is returned, the map display will center on the location. Subsequent received real time location data will be shown on the map and the map display will be centered around the newly received location. In trace mode, the old location of the vehicle is not erased until the maximum number of points is received since the start of tracing. The mechanics of tracking or tracing a vehicle are handled entirely within the mapping application so that no further interaction with the CIS is required other than to receive real time data.

6. Playback History

The Playback History case, which is available from various applications, is used when the user desires a playback of a selected vehicle route history. The user is allowed to view a selected vehicle's history by playing back its route for a selected period of time, project/work order or assigned resources. The user can select one vehicle at a time for playback, and, when requesting playback, designates the number of “points” to be returned. Each point represents the location of the selected vehicle at a specific point in time. If the number of points requested is greater than 100, for example, only the last 100 points are returned. The vehicle's route is played back on the map by leaving a “bread crumb” trail of points along the vehicle's path. At each point of the trail, the user can display the vehicle's last reported information, recorded at the time represented by that point. Vehicle route history is only viewable by the user to the extent authorized for the selected vehicle and for the specific time period of the authorization. The trail exists only during periods of authorization, and ceases at times when authorization is no longer valid.

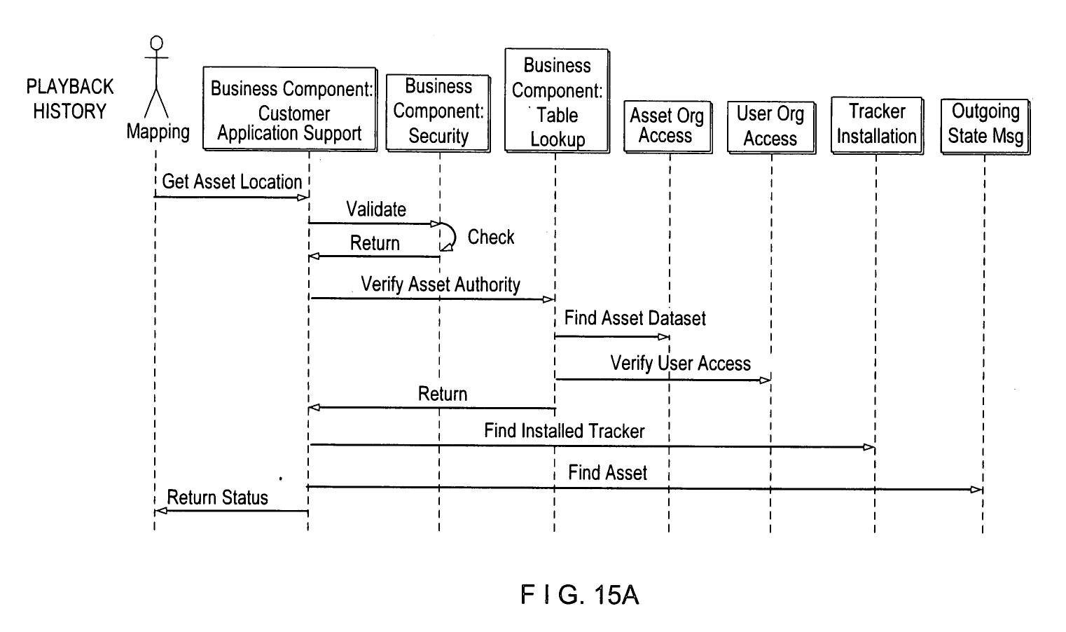

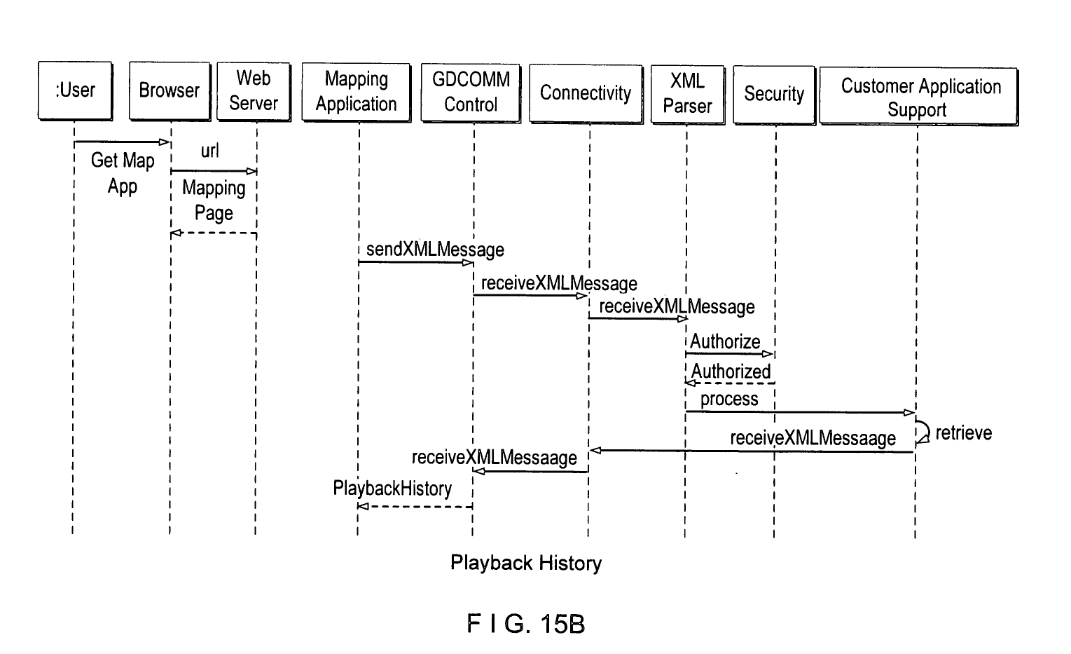

The normal sequence for performing a playback of vehicle location history is shown in FIG. 15A. After a vehicle is selected for playback, the mapping application requests the location. Subsequently, the following actions are performed:

(1) Validate Security Access: The Security Component is called to verify security access (current access) for the asset being requested. Security caches the results of this so that a subsequent call to the server is not required.

(2) Verify Asset Authority: The Table Lookup Component is called to verify the user had access to the asset for the time frame requested. This call will return the time frame(s) the user did or does have access to the asset.

(3) Get Asset Location: The database tables are accessed to retrieve the last known information for the asset requested for the time frame requested. The most recent 100 messages are retrieved (fewer if less than 100 exist).

(4) Details Returned: The last known location data are returned to the mapping application.

The detailed design of the Playback History function sequence is shown in FIG. 15B. The browser opens the mapping application page when requested by the user. The mapping application makes a request to playback history via the GDCOMM ActiveX control which generates an XML message to the Connectivity Service in the CIS. The message is parsed, and if it passes the security tests, the Customer Application Support component retrieves the desired playback history for the vehicle from the system database. The results are returned to the Mapping Application through the Connectivity Service so that the location history can be displayed. Only data for which the user has access is returned for display.

7. Update Real-Time Location

The Update Real-Time Location use case, which is only performed within the mapping application, provides the user with a capability to request immediate updates of a selected vehicle's position. The request initiates a communication to the tracker asking for an updated position. When the tracker responds, the vehicle icon on the map is updated with its new position (described below in the Update Vehicle Display use case). In the current embodiment, while an update request is in progress, the ability to request another update for the same vehicle is disabled to avoid burdening the system with repetitive requests for the same information. When the request times out, a new request for an updated real-time location of that vehicle (or any other) may be made. Multiple requests are permitted, but each must pertain to a different vehicle from that for which a request remains extant. Requests prompt the tracker for an immediate response from the selected vehicle. If a response is not received before the request times out, the respective vehicle location may be updated at least once thereafter from normal periodic reports from the tracker. If the vehicle selected for update of real-time location is not currently enabled for display on the map, the vehicle will become enabled, but here again, the user must have authorization to view and the authorization must not have expired.

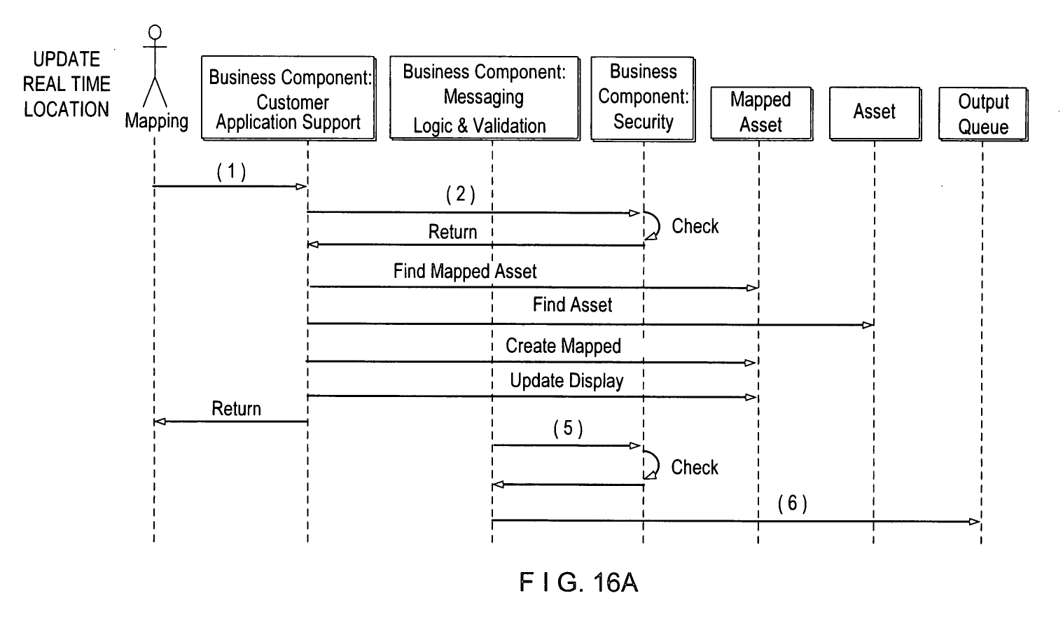

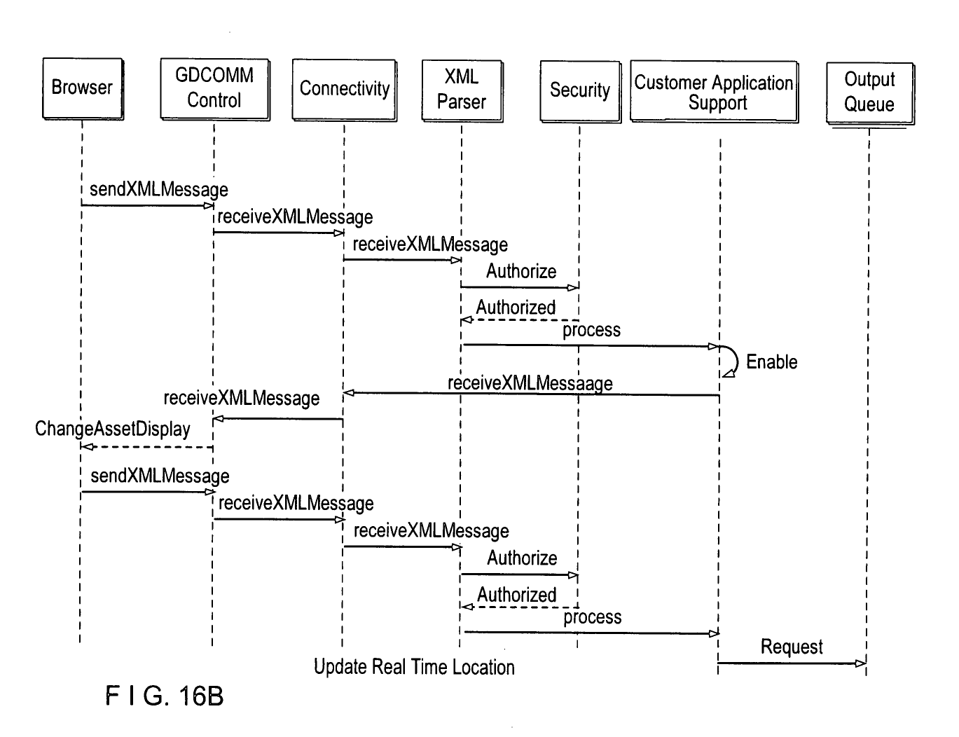

The normal sequence for performing an Update Real Time Location request is shown in FIG. 16A. The function uses Change Asset Display to ensure the vehicle is enabled for display and then requests the tracker for an Update. The sequence is as follows:

(1) Change Asset Display: If the asset is not currently enabled, the mapping application makes a call to enable the asset.

(2) Validate Security Access: The Security Component is called to verify security access for the assets being requested. Security caches the user's parameters so that a subsequent call to the server is not required.

(3) Asset Details Updated: The database tables are updated to reflect the change.

(4) Real Time Location Request: The mapping application makes a call to request the latest location message for an asset.

(5) Validate Security Access: The Security Component is called to verify security access for the assets being requested. Security caches the user's parameters so that a subsequent call to the server is not required.

(6) Send Real Time Location Request: The Messaging Logic & Validation Component sends the request to the output queue.

A real time tracking data message will subsequently be received by the mapping application through the gateway from the tracker.

The detailed design of the Update Real Time Location function sequence is shown in FIG. 16B. The browser first uses the Change Asset Display function sequence to ensure the vehicle is enabled for display on the map and that the user has access to data for the requested vehicle. Then the browser makes a request to update the real time location of the tracker via the GDCOMM ActiveX control which generates an XML message to the Connectivity Service in the CIS. The message is parsed, and if it passes the security tests, the Customer Application Support component sends the command to the wireless network management system.

The CMR then routes the request to the appropriate wireless network and the request is sent to the tracker through the corresponding base packet server. When the tracker responds by sending a position report, the gateway treates that as any other real time location report. The report is forwarded back to the customer's connected mapping applications from the CIS through the XML interface. When the mapping application receives the message, it is processed and displayed (as required) using the Update Vehicle Display function described below.

8. Update Vehicle Display

The Update Vehicle Display use case enables an updated display of the vehicle on the map whenever a real-time message is received from that vehicle. The updated display includes the vehicle's location as well as any sensor or event data that will cause a change in a vehicle's display. This function is performed only within the mapping application, and is performed automatically for all vehicles regardless of whether they are displayed in the current map view or not. Each vehicle is represented by a colored icon on the map. The user can select the color/shape of the icon and a label. The icon also has an associated status bar that can change color based on events or status reported by the vehicle. If the vehicle is displayed on the map, then the icon is updated to reflect its new position or status. Authorization for the vehicle is imperative; without it, the vehicle is not displayed on the map and therefore, updates will not be displayed. The data are still recorded, but just not displayed to those users who lack authorization. The customer has the ability to define events on the display by color. When the vehicle location is updated, the color of the status bar on the map may also change depending upon the defaults established by the customer or user.

9. Receive Real-Time Tracking Data Message

This function is used to provide the communication that receives messages from the tracker when the tracker sends real-time data. Based on business logic in the tracker or user entry, the gateway may receive unsolicited messages such as location information that is passed to the user applications. Messages received from the tracker may be any of the following types: text messages (pre-defined messages); sensor messages; message acknowledgments, return receipts, and responses; site status information (events); or tracker information such as tracker's speed, location and heading The message is deciphered to determine what type of message is within the communication.

Message data received from trackers by the gateway are processed using the following steps:

(1) Messages are received by the Tracker Packet Server on the appropriate wireless network.

(2) The message, along with others are bundled and sent through the queuing system to a Customer Message Router

(3) The CMR parses the message to determine: (i) the tracker ID and thus the customer that owns and/or has authorization to access the data; and (ii) the contents of the message.

(4) The CMR then stores the message into the system database and forwards the message to the CIS which, in turn, sends the message to any connected customer applications that have access to the data via the XML interface.

(5) Location reports are displayed on map applications, messages are shown in the real time input windows of messaging applications, and so on.

B. Messaging

The Messaging Function 116 of the overall software system structure of FIG. 10 provides the capability to the enterprise user to send various types of text messages. Messages can be: from a predefined pick list, or created in free form text; sent to one tracker, all trackers or selected trackers; sent with required responses or as information only, without a required response. All messages are stored and can be viewed by using the View Message Folder. Messages are always listed with the corresponding response; if any exists.

Messages can also be received from the tracker. These messages may be explicitly initiated by the driver of a vehicle or the user of a location aware phone, such as a pre-defined message or response to an enterprise user initiated message; or they may be automatically generated by the tracker, such as acknowledgments and return receipts. Event messages based on sensor data are also sent automatically from the tracker (discussed further below in the section on Sensor Classification).

The messaging application is a standalone application; however it can be initiated from other applications served from the gateway (e.g., the griddata.com™ web site of the assignee of this invention) through the core business logic. Capabilities may include the ability to send e-mail messages to pagers or other enterprise users or broadcast messages to groups of individual trackers or e-mail addresses, and the ability to forward messages to an e-mail system (e.g., vehicle@customer.griddata.com).

Trackers on vehicles may have sensors attached to vehicle systems to report on any number of vehicle parameters. When a sensor input changes, the tracker sends a sensor message. Sensor Classification is a part of the messaging functionality. It provides the capability for the customer to identify sensor messages it wants logged and the associated priority. Sensor messages are prioritized at the customer level, not at the individual user level, but the user is able to view sensor messages in the Message Folder. The customer also has the ability to define exception classification messaging. Some examples of exceptions that the customer may want to be notified of are: a vehicle exceeding a specified speed limit, a work order taking too long or an event that occurs out of a predetermined sequence. Sensor data include such things as the amount of product left on the vehicle and/or engine performance information. Sensors are installed on the vehicle, similar to trackers. The maintenance of sensors is performed within the core business logic.

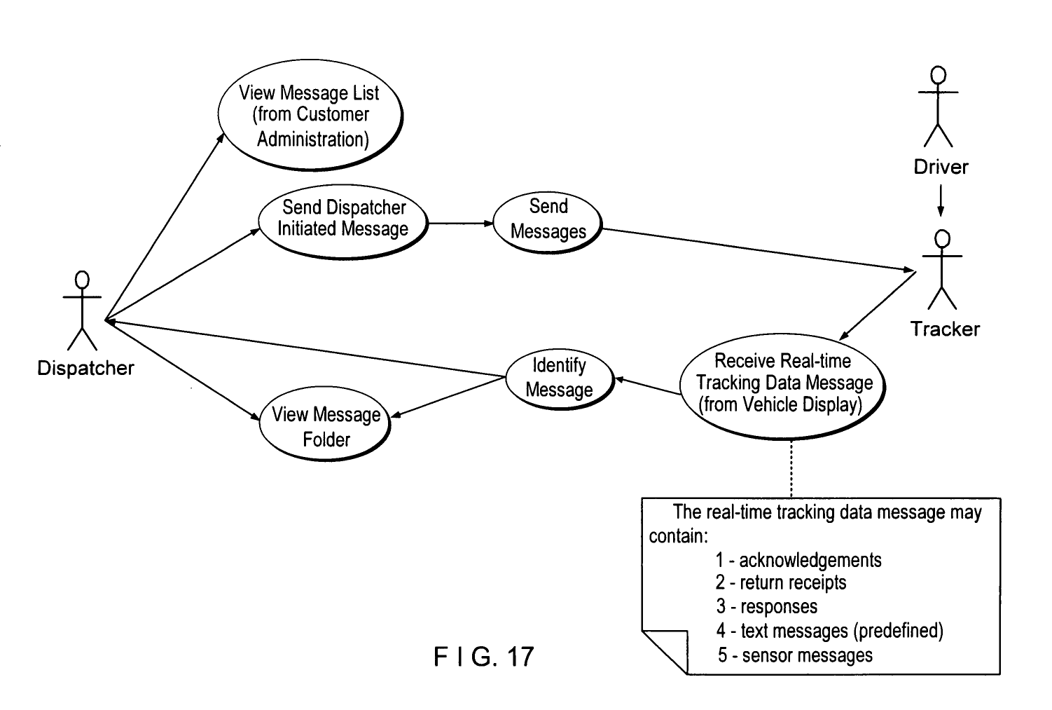

Use cases of the messaging function are described below. The structures of the Messaging Function are illustrated in the functional diagram in FIG. 17. Sensor management functions are discussed in the Administration section.

1. Send Dispatcher Initiated Messages

This function exists as a standalone application, which can be initiated from both the mapping and dispatching applications, as well as other applications integrated with the gateway. It allows the enterprise user, most often a user acting in the dispatcher role, to send messages to a vehicle when the user wants to communicate with the driver(s). Capabilities are:
The ability to send the message to one or many vehicles. The message can be selected from a list of pre-defined messages.
The message can be a free form text message. The free form text message is not added to the message list for future reference. If a message needs to be added to the message list, it must be done within Customer Administration since all messages are defined at a customer level and the typical dispatcher does not have the ability to define new messages. This ability is usually reserved for a user with administrator privileges.
The ability to define a response set or use pre-defined response sets. The message can be route planning directions.

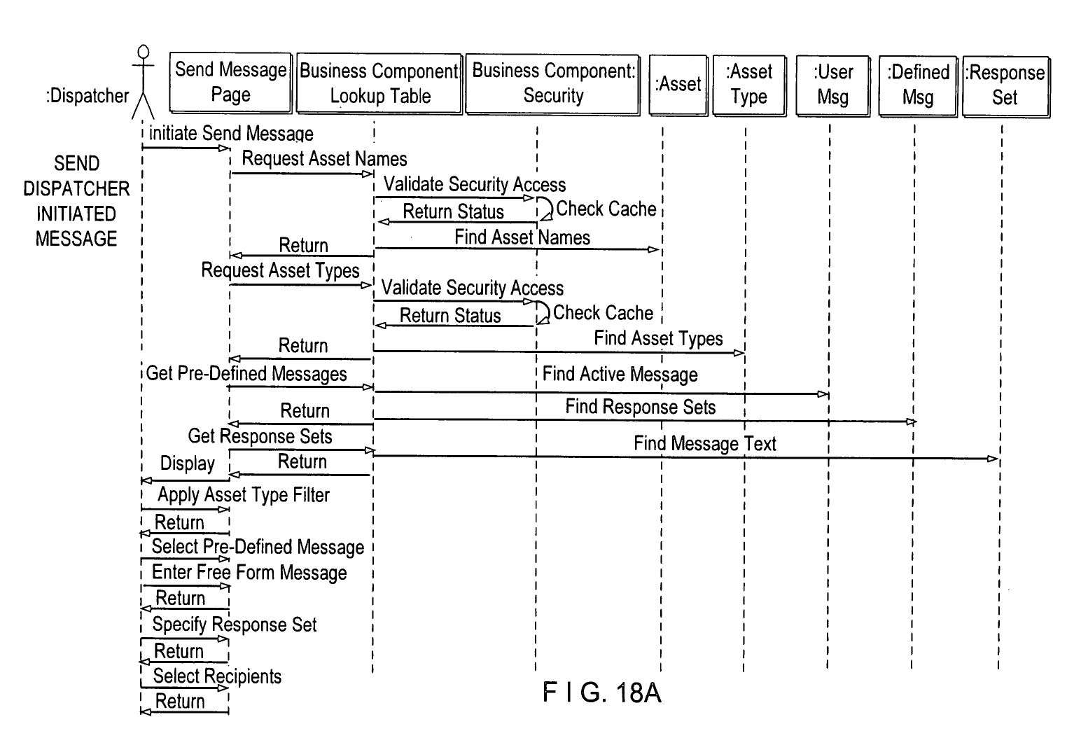

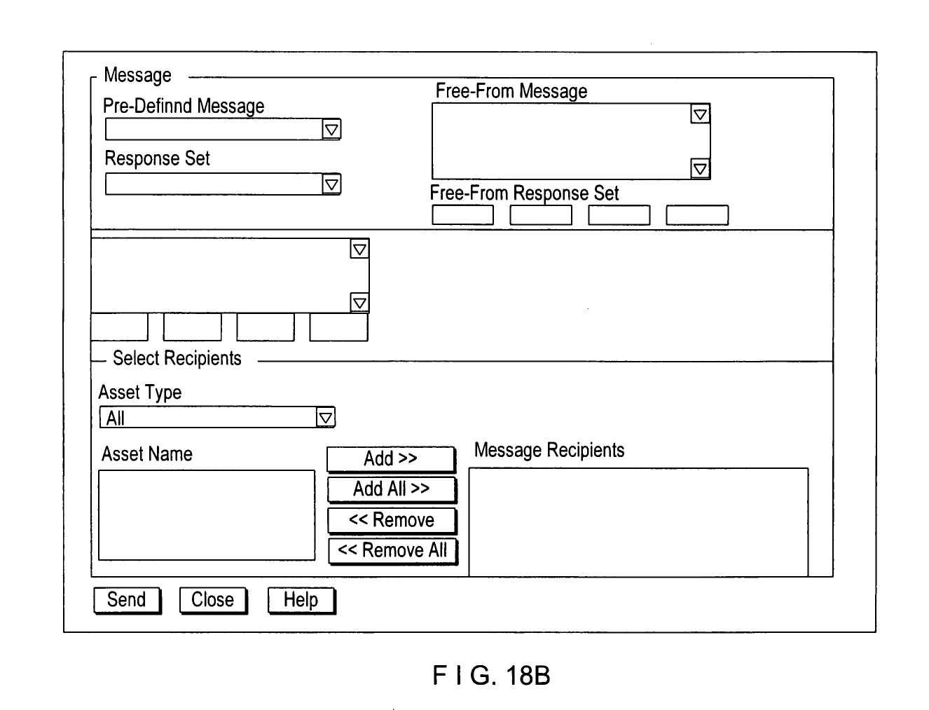

Two types of text messages may be sent to the tracker Pre-defined and Free-form. The functional steps are shown in FIG. 18A and outlined below. The send message step is outlined in more detail in the description of that function.

The following sequence is executed for Pre-defined Messages:

(1) Initiate Send Message: The user chooses the send message option from the View Message Folder and the Send Message page is displayed.

(2) Apply Asset Type Filter: The user may choose to display only the asset names associated with a asset type in the Asset Name list box.

(3) Select Pre-Defined Message: The user selects a pre-defined message from the Pre-Defined Message Text drop down combo box. When a pre-defined message is selected the response that was used with that message is displayed as the default.

(4) Specify Response Set: The user chooses either to use the default response set, select a response set from the Response Set drop down combo box, or enter a free form response set into the Free Form Response Set entry boxes.

(5) Select Recipients: The user selects the message recipients by either selecting the Add All push button, or highlighting individual asset names and selecting the Add push button. These push buttons move asset names from the Asset Name list box to the Message Recipient list box.

(6) Send Message: The user sends the message by selecting the Send push button. A response is sent back from the Messaging Logic & Validation component, which is interpreted and an icon is listed next to the corresponding asset name in the Message Recipient list box.

The following sequence is executed when a free-form text message is sent:

(1) Initiate Send Message: The user chooses the send message option from the View Message Folder and the Send Message page is displayed.

(2) Apply Asset Type Filter: The user may choose to display only the asset names associated with a asset type in the Asset Name list box.

(3) Enter Free Form Message: The user enters a free form message into the Free Form Message entry box.

(4) Specify Response Set: The user chooses either to select a response set from the Response Set drop down combo box or enter a free form response set into the Free Form Response Set entry boxes.

(5) Select Recipients: The user selects the message recipients by either selecting the Add All push button, or highlighting individual asset names and selecting the Add push button. These push buttons move asset names from the Asset Name list box to the Message Recipient list box.

(6) Send Message: The user sends the message by selecting the Send push button. A response is sent back from the Messaging Logic & Validation component, which is interpreted and an icon is listed next to the corresponding asset name in the Message Recipient list box.

FIG. 18A shows the interaction between the browser application and the gateway when the send message interface is initiated. The messaging application must retrieve from the gateway the list of pre-defined messages and response sets assigned to the customer. It must also retrieve and display the available list of vehicies (assets) that can receive the message. The user may restrict this list by selecting vehicles of certain asset types.

The user interface for sending dispatcher initiated messages is shown in FIG. 18B. The user either selects a pre-defined message from the drop down list in the upper left or types in a message in the window in the upper right. The user selects a pre-defined set of response choices, or enters them manually. There can be up to four responses which appear over the four buttons on the MDT display when the message is received by the tracker. The user in the vehicle then selects one response of the choices presented, and the selection is transmitted back to the enterprise user through the gateway. Attaching a response to the message is optional. Once the message and responses are selected or typed in, the message shows on the middle section of the display as it would appear to the driver. The user is allowed to format the message, if needed.

The User then selects the recipients for the message. The available options for selecting recipients are:

Add>>—Moves a highlighted asset name from the Asset Name list box to the Message Recipients list box.

Add All >>—Moves all asset names in the Asset Name list box to the Message Recipients list box.

<<Remove—Moves a highlighted asset name from the Message Recipients list box back to the Asset Name list box.

<<Remove All—Moves all asset names in the Message Recipients list box back to the Asset Name list box.

After the recipients are selected, the message may be sent by hitting the send button at the bottom. The function buttons at the bottom of the interface are:

Send—Submits message.

Close—Closes the Send Message Page.

Help—Displays associated Help Page.

The send command is disabled until sufficient information is supplied, that is, (i) a message is entered, (ii) a recipient tracker (vehicle) is selected. Once the message is sent, the Send Messages function takes over.

2. Send Messages

This case is used when the user initiates sending a message; it is the communication that sends a message to the tracker. The function commands the gateway to send a text message to all trackers that are intended to receive the message identified by their asset IDs.

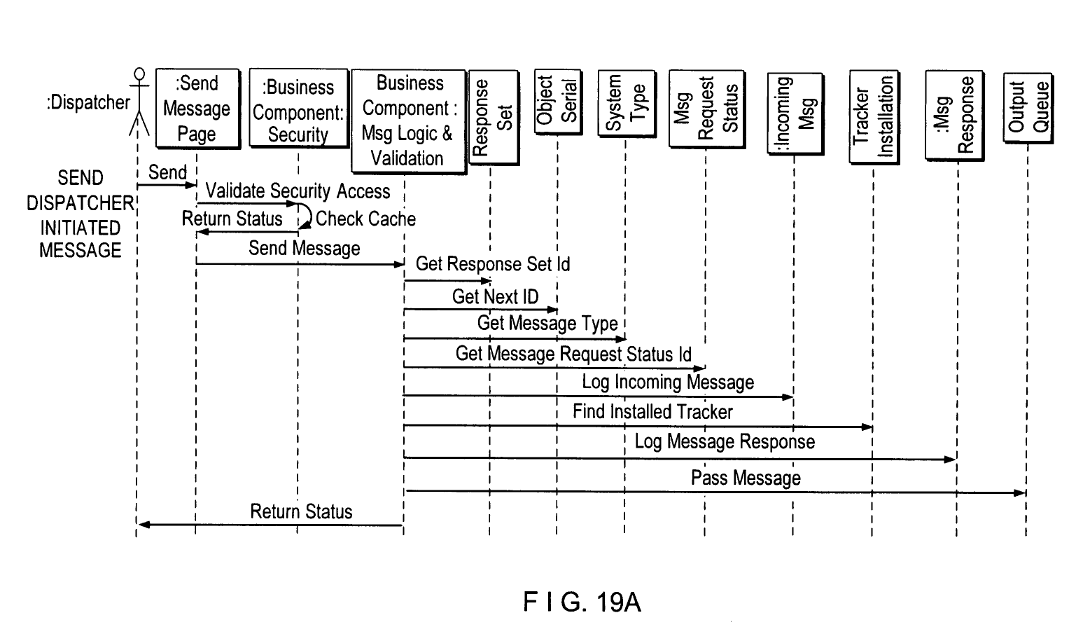

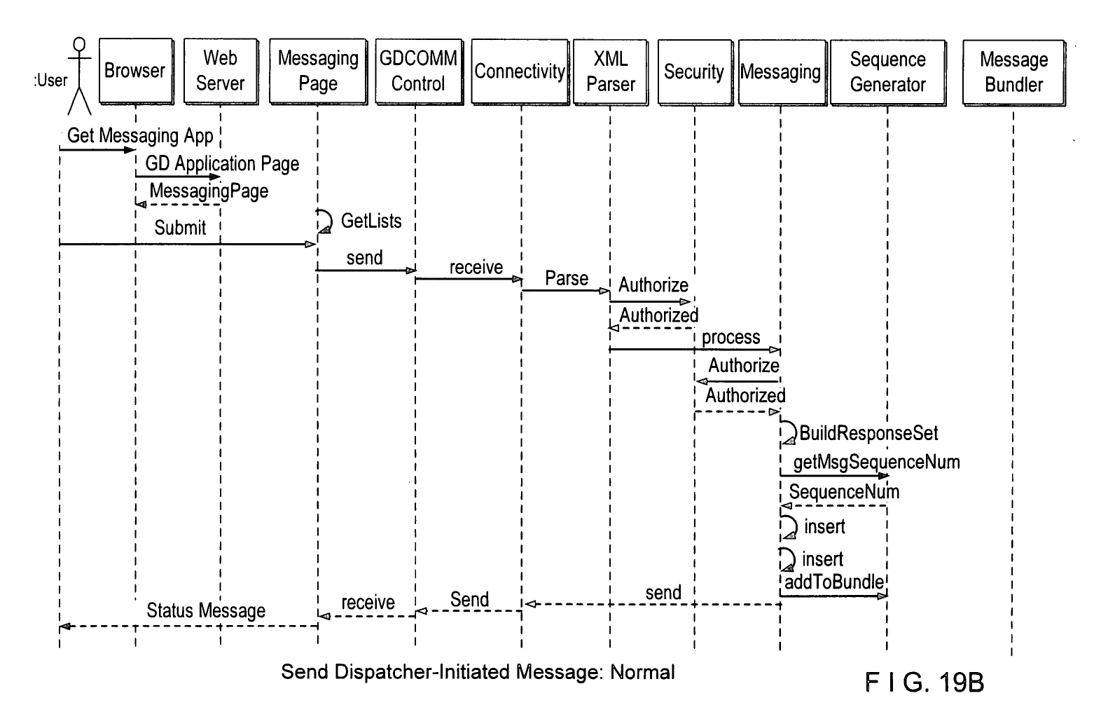

The functional steps performed by Send Messages are shown in FIG. 19A. The user selects the send message command from the user interface and the message is sent to the CIS. Security is checked, and if it passes, the response set ID is determined and a sequence ID is attached to the message. The message is logged in the system database and a record is created to receive the response when one is received from the tracker. The message is then queued to the CMR for transmission to the tracker through the appropriate wireless network. Status is returned to the messaging application when the message is queued or an error is generated.

The detailed design of the Send Message function sequence is shown in FIG. 19B. The browser first activates the messaging application and lists of pre-defined messages and assets are returned from the system database via the CIS and XML interface. When the message is entered and submitted to be sent, it is sent to the connectivity service in the CIS using the XML interface. If security passes by verifying that the user as authority to send messages to the desired vehicles, the message is formatted and a sequence number is assigned. It is logged to the system database and bundled with any other messages to be sent via the CMR. A success or failure status is sent back to the messaging application.

Up to three response can be returned for a message sent to a tracker. When the tracker receives the message, it acknowledges the receipt to the Tracker Packet Server. The acknowledgment is logged in the database and forwarded to the messaging application. This acknowledgment is used by the RMR (Reliable Message Router) to know that the message had been successfully delivered so that retries are not necessary and to inform the messaging application of the same status. When the driver reads the message, and “return receipt” is sent through to the messaging application to indicate that the driver viewed the message. Finally, if a response was specified, when the driver selects the appropriate response, that is sent to the messaging application. The return receipt and response are also logged in the database.

3. View Message Folder

This use case provides the user with the ability to view the message folder, which contains any messages sent to or received by the enterprise users. If more than one user sends messages to the same vehicles, all users that have access see their own messages and those sent by others. The core business logic enables messages and responses to be associated and tracks times and locations of all message events. All text and some sensor messages that the customer has chosen to see will be in the message folder. Each customer has one and only one message folder. All messages sent by all dispatchers are kept in one message folder. A predetermined number, e.g., 20, of the most recent messages are displayed as the system default. However, the user has the capability to filter messages. For example, the user may request to view all messages for a given day and time period, user, or priority. Once the first 20 messages are displayed, the user has the ability to view next and subsequently previous messages. The Message Folder is presented in an in/out box format, and contains information such as: the message itself (either dispatcher or tracker initiated, including sensor messages); the sender; time sent; corresponding response, acknowledgment and/or return receipt (if applicable), and time thereof; message priority. The Message Folder can be sorted by any of the above mentioned items. A real time box is provided in addition to the in and out boxes. The real time box shows messages sent by trackers as they come in without the need for manually refreshing the inbox display periodically.

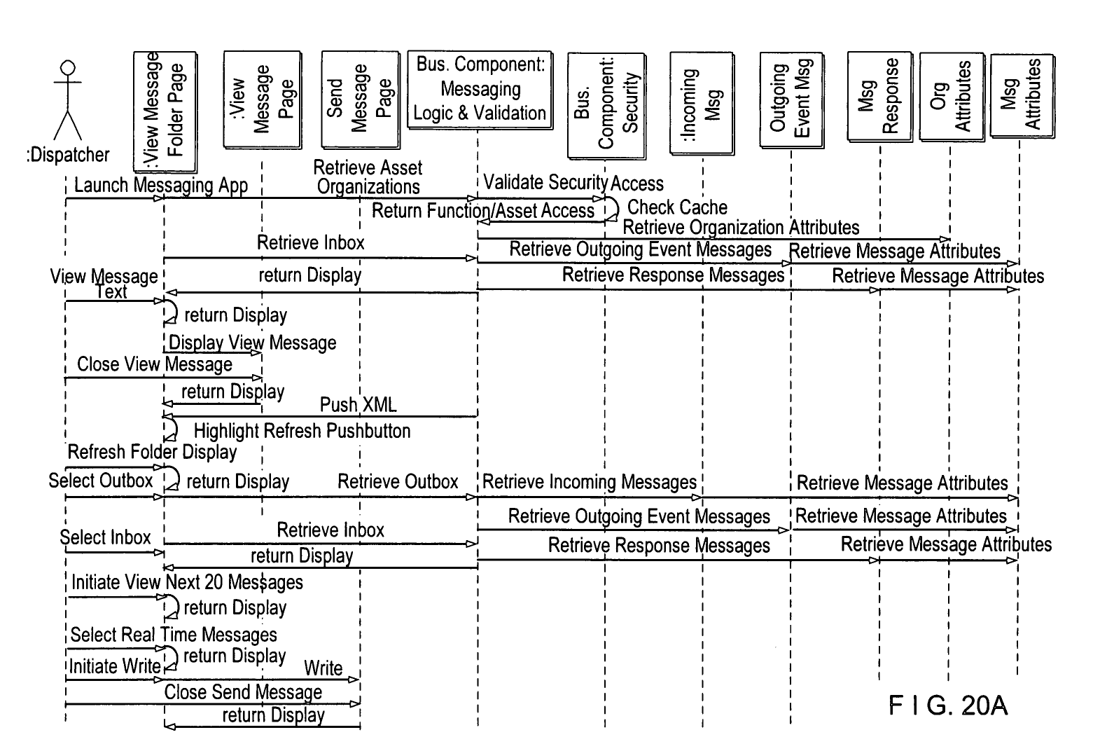

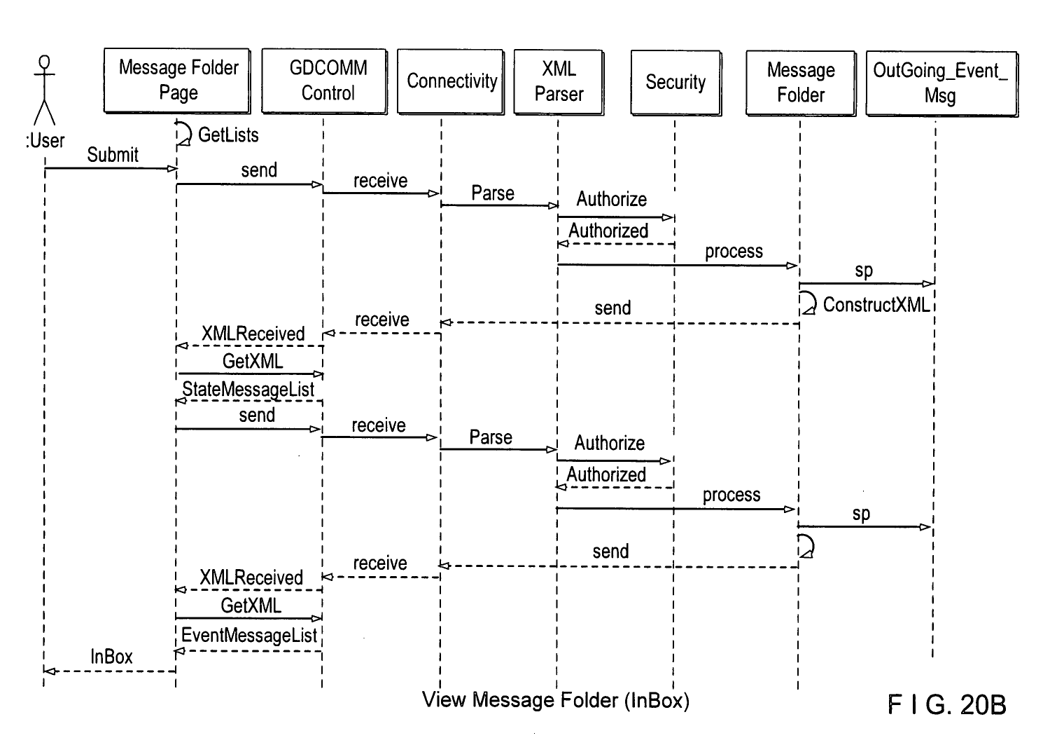

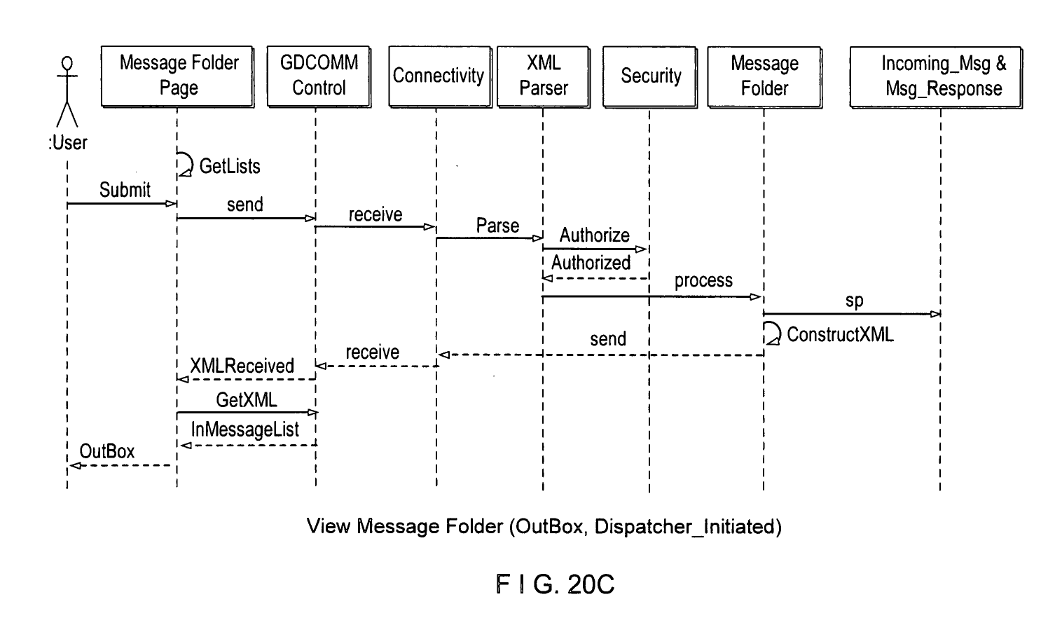

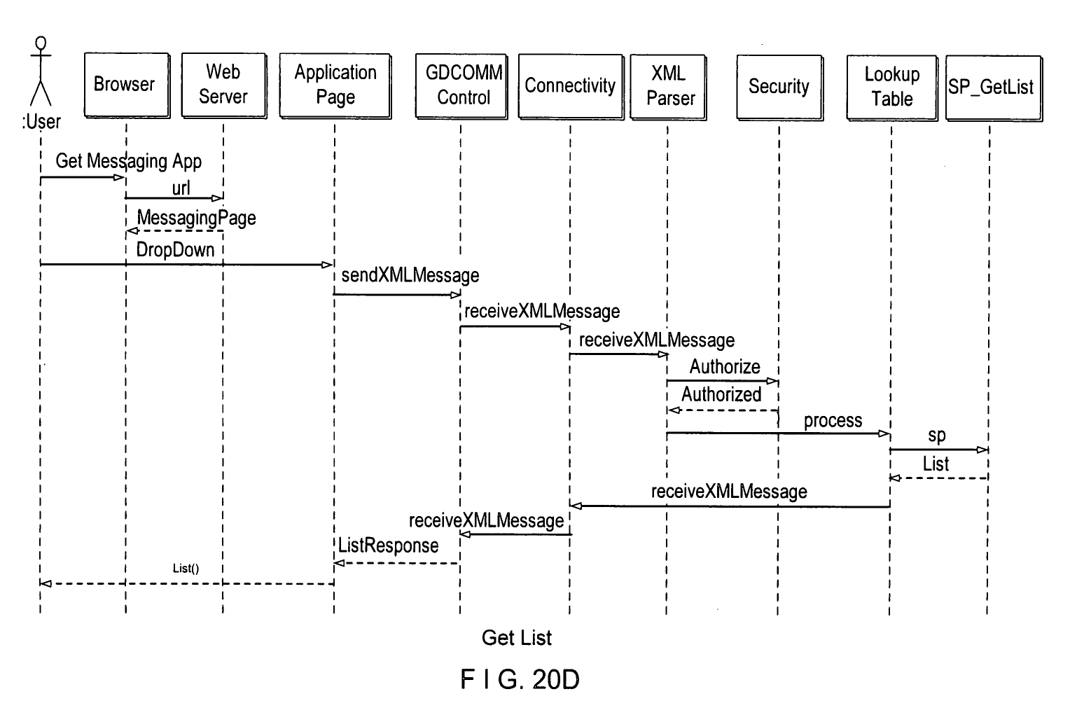

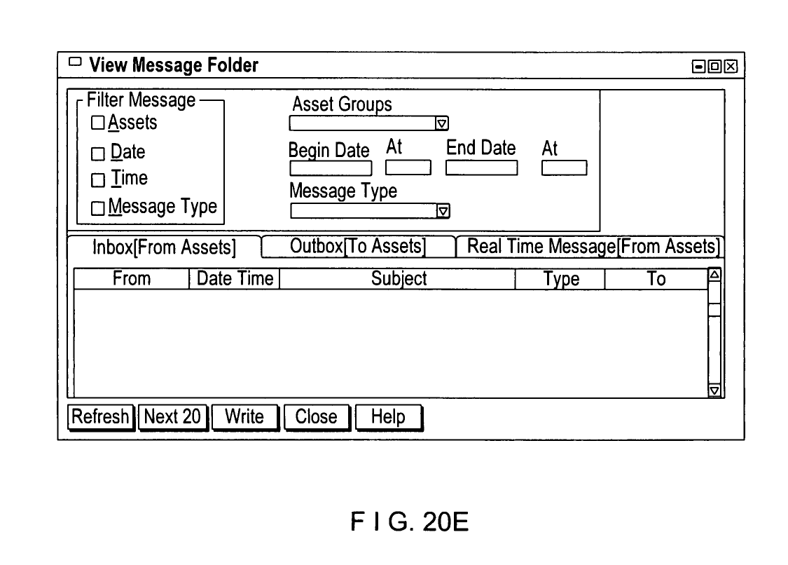

With reference to FIG. 20E which shows the View Message Folder user interface display and FIG. 20A which shows the functional steps performed by View Message Folder, the user can complete the following tasks:

(1) Initiate View Message Folder
(a) Launch Messaging Application: The User successfully completes Login procedures, launches the Messaging Application from the main application toolbar, and selects the View Message Folder from the Messaging toolbar sub-menu. The View Message Folder Inbox is displayed according to session filter parameters previously set by the User when viewing the Message Folder Inbox (or Outbox). The Inbox contains all messages sent by Trackers for a Customer Organization, including only those messages from Trackers (Assets) that the User has access to.

(2) View Message Text
(a) Select Message: Double-click on the row in the folder list box pertaining to the message to be viewed in full. The View Message Page is displayed with a multi-line entry field formatted with the corresponding list box columns containing the information for the message, along with the full message description text. On the View Message page, all pushbuttons are enabled, all fields are protected, and the scroll bar will be enabled for the user to scroll through the actual text of the message. The View Message Folder window will remain open in the background but inactive.
(b) Close: Click on the Close pushbutton (or hotkey). The View Message Page will be closed and the View Message Folder is displayed in the foreground and active. The user must return to the View Message Folder from the View Message window.

(3) Refresh Folder Display
(a) Refresh Inbox or Outbox: Click on the Refresh pushbutton (or use hotkey). Any filter or sort parameter specified in the window at the time of the refresh will be applied for populating the list box (for the folder tab highlighted).
(b) Respond to Refresh: The Refresh pushbutton will be highlighted BLUE when new messages are received by the View Message Folder Page real-time via the Messaging Logic & Validation CS Component. Either:
   (i) Select the Inbox Tab. Any filter or sort parameter specified in the window at the time of the refresh will be applied for populating the list box. Therefore, ONLY the real-time messages that meet the conditions of the filters will be populated in the list box. [or]
   (ii) Select the Real Time Messages Tab. No filter parameters will apply to this folder. All real time messages will be displayed in the multi-line entry field for this folder.

(4) ViewNext 20 Messages
(a) Initiate ViewNext 20 Messages: Click on the Next 20 pushbutton (or use hotkey). The next 20 messages will be displayed in the list box, up to 20 messages, if 20 messages exist, according to the current filter parameters.

(5) Select Folder
(a) Select Outbox: Highlight Outbox Folder Tab, or if already highlighted, click on the Refresh pushbuffon (or hotkey). The View Message Folder Outbox list box is displayed according to the same filter and sort parameters set by the User when viewing the Inbox UNLESS the user changed the filter parameters prior to highlighting the Outbox Tab. The Outbox contains all messages sent by the User (Dispatcher), including only those messages sent to Trackers (Assets) that the User has access to.
(b) Select Inbox: Highlight Inbox Folder Tab, or if already highlighted, click on the Refresh pushbutton (or hotkey). The View Message Folder Inbox list box is displayed according to the same filter and sort parameters set by the User when viewing the Outbox UNLESS the user changed the filter parameters prior to highlighting the Inbox Tab. The Inbox contains all messages sent by Trackers for a Customer Organization, including only those messages from Trackers (Assets) that the User has access to.
(c) Select Real Time Messages: Highlight Real Time Messages Folder Tab. The Real Time Message Folder multi-line entry field is displayed and protected. Filters can't be specified by the user for this folder, and any filters specified for the Inbox or Outbox do not apply. This folder displays only the messages sent by tracker(s) that the user as access to by asset organization (i.e., asset group). These messages will arrive to the real time folder by being appended to the bottom of the existing text, and the field will automatically adjust to scroll down to the recently arrived message(s). The user can scroll up and down at any time.

(6) Write
(a) Initiate Write: Click on the Write pushbutton (or hotkey). The Send Dispatcher Initiated Messages Page is displayed (this functionality is not part of this Use Case Specification).
(b) Close Send Dispatcher Initiated Messages: Click on the Close pushbutton (or hotkey) from this page to return to the View Message Folder.

The detailed design for the View Message Folder sequence of operations is shown in FIGS. 20B, 20C and 20D. The diagrams all use list requests of different types to populate the Inbox, Outbox, and data to identify message response codes and pre-defined message codes for display. In general, the application requests a specific list of data from the CIS. Once security is checked for access to the data, the database is queried for the data and a message is formatted and sent back to the application through the XML interface. FIGS. 20B and 20C show the sequence of populating the inbox and outbox respectively, and FIG. 20D shows the detailed design of the View Message Folder lists function. The inbox can show location data (though normally location information is graphically represented on the map) as well as unsolicited tracker event messages that correspond to responses to messages or sensor outputs. Inbox and Outbox data returned corresponds to any filtering selected by the user based on time range, asset type, and so forth.

On initialization of the message folder, it must request a significant amount of information in order to display the message data in a meaningful way to the user. It does this by requesting several lists of data which include the asset (vehicle) names and types and the definitions of pre-defined messages and responses. The CIS retrieves the appropriate information from the database and returns it to the messaging application.

The user interface for View Message Folder is shown in FIG. 20E. The various available commands are:

Inbox Folder Tab: allows the User to view the Inbox folder list box.

Outbox Folder Tab: allows the User to view the Outbox folder list box.

Real Time Messages Folder Tab: allows the User to view the Real Time Messages folder multi-line entry field.

Refresh: allows the User to submit request to view an updated version of the Inbox and Outbox folder list box. Also prompts the user to select the Real Time Messages folder tab.

Next 20: allows the User to view the next most recent 20 messages in the folder list box according to existing filter parameters set on the page. This function only applies to the Inbox and Outbox.

View Message Text: double clicking on a row in the folder list box will allow the user to view the full message text along with the associated information from the list box, in the View Message Page.

Write: allows the User to access the Send Dispatcher Initiated Messages Page (not part of this Use Case) in order to create a new message to be sent to the Tracker(s).

Close: allows the User to close the View Message Folder page.

Help: allows the User the ability to view overview help related to the page.

Calendar: selecting Enter Date Range in the Date Drop Down List Box will display a calendar to allow the user to change the dates visually.

4. Identify Message

The Identify Message use case is used to provide the ability to identify messages being received from a tracker and send them to the appropriate user interface, the map or real time message folder for example. Other capabilities of this use case are to: (i) Notify the user when a new message is received; (ii) Identify alert conditions and notify the user appropriately (alert conditions may cause a different display of the original message notification); and (iii) If the message is a sensor message, identify if there are any exception conditions that may also cause an alert notification.

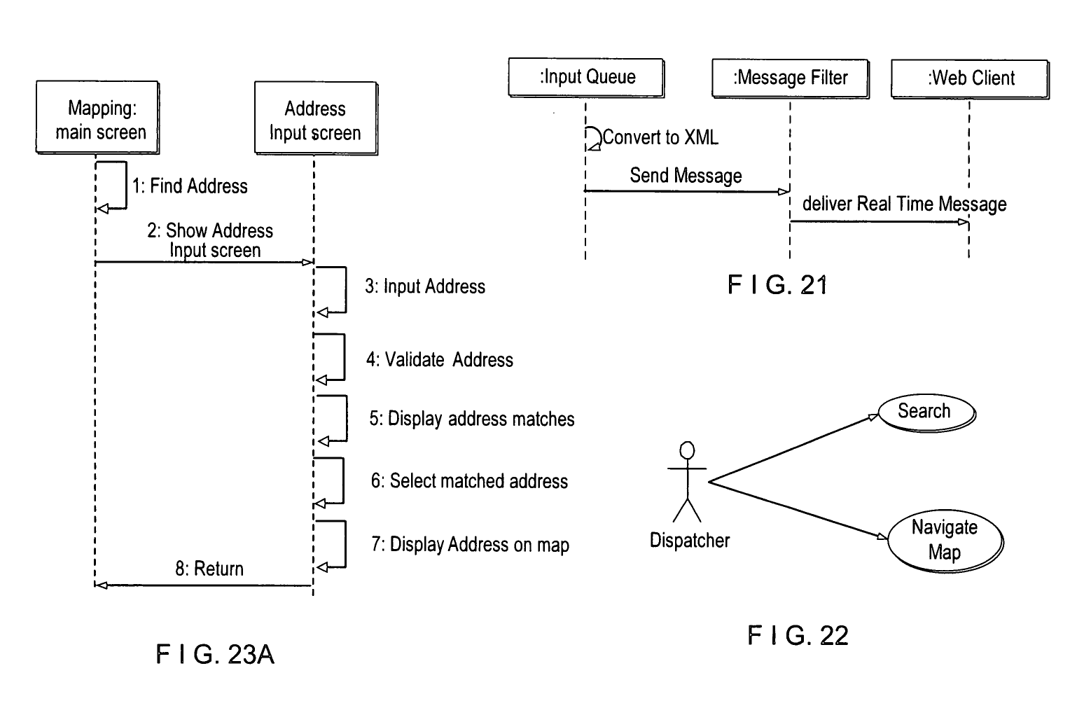

The processing flow is shown in FIG. 21. The flow is very simple:
(1) An outgoing message in the input queue generates an XML message. The message type is compared to the settings stored for the customer or user configuration in the database to determine if alert flags should be set for the message. Logged in users are checked to ensure they have authority to receive data from the particular vehicle and messages are queued to the appropriate connected users or applications.
(2) The XML message Real Time Asset Information is sent.
(3) A real time message is delivered to the Web interface application.

C. Map Navigation

The Map Navigation Function 117 of the overall software system structure of FIG. 10 provides a user with the capability to perform basic map view manipulation functions. These include panning to a new area of the map, reducing or increasing map details through the use of zooming in and out as well as searching for areas on the map.

An important aspect of map navigation in a business environment is the responsiveness of the user interface. To allow the user to interact with the map and fluidly pan and zoom, the application controlling the interface and the map data is located on and runs on the machine being used. If the data reside on a slow interface, interaction with the map becomes too slow and frustrating to be useful. The map application is a core piece of the griddata.com web site functionality. The architecture of the site that includes local map data and a second XML data channel makes the map application usable and enables it to be integrated with other applications. A significant portion of the map functionality is described in the Vehicle Display section.

This section describes functions for interacting with the map display itself.

Function use cases of the Map Navigation Function are described below. The structure of the Map Navigation Function is illustrated in the functional diagram of FIG. 22.

The map interface is shown in FIG. 5, previously described herein but referred to again for some additional description at this point in the specification. The display shows a list of vehicles (assets) on the left side, and the main view is a graphical representation of a geographical area with icons representing vehicles at their corresponding locations. The map has a tool bar across the top of the map window that has buttons for performing the following functions from left to right:

Zoom In: Magnifying Glass (+) Icon

Zoom Out: Magnifying Glass (−) Icon

Pan: Hand Icon

Re-center: Line segment Icon

Select: Pointer

Address Search: Mailbox Icon

Thumbnail Tool: Map Icon

Help: Question Mark

Launch Messaging Application: Envelope Icon

Refresh Display: Circular Arrow Icon

Save Extents: Disk Icon

Zoom to World: Globe Icon

Zoom to Home Extents: House Icon

These functions can also be selected by using a mouse to right click on the map and choosing them from a menu. Address Search and the Map Navigation functions (panning and zooming) are discussed in more detail below.

1. Search

The Search function is used when the user wants to see a specific area on the map. It provides the ability to find an area on the map based on address selection criteria (e.g., related to street address and city/state or street address and zip code) as well as defining the magnification level. These functions are not dependent upon a vehicle being displayed on the map.

The process flow for the Search function is shown in FIG. 23A. The user selects the Mailbox Icon and enters an address to be found and selects the Find option. The application will search the street level map database on the user's computer to provides matching addresses. The user selects the match he desires, and the map then highlights that location in the map display and automatically zooms to that location. An example of the user interface and a highlighted address is shown in FIG. 23B. This shows the state of the interface after the selected address has been displayed on the map.

2. Navigate Map

This use case provides basic map navigation features such as Zoom In/Zoom Out and Panning, for use when the user wants to see more or fewer details of the map or wants to see a different area of the map not currently visible. Zoom hi/Zoom Out allows the user to select an area on the map to either increase or decrease magnification level. The level of magnification is based on point increases or decreases, which is a pre-set parameter, without user ability to change the points. Panning allows the user to grab the map and re-center a new area on the screen. But if the user selects an area of the map for which street level data are unavailable (e.g., the county data is not available), he will only see interstate highways without a capability for the user to see any further detail. It is not necessary for a vehicle to be displayed on the map in order to perform any of these functions.

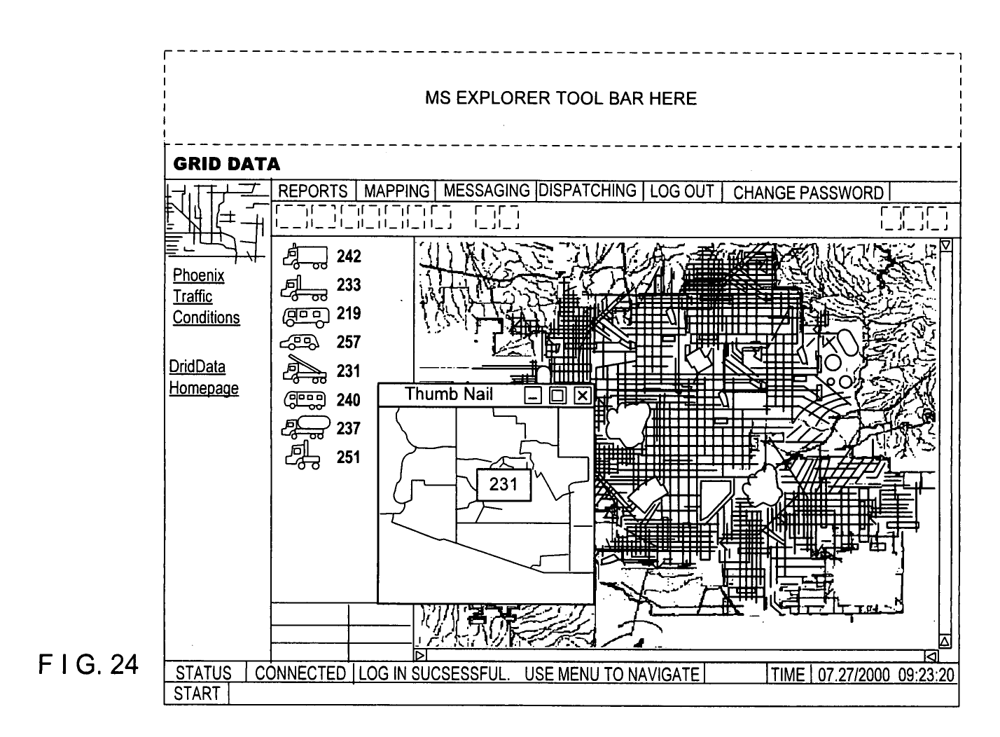

The Map Navigation functions have simple sequences. Each is described below:
(a) Zoom In: Zooming in is performed by selecting Zoom In tool from the tool bar. The user can then simply single-click on the map display with the mouse. The map application will then increase the magnification of the map by one level and re-center the display on the location that was clicked. Zoom to specific extents can be accomplished by using the Zoom In tool to draw a rectangle on the map display. The mapping application will then change the screen extents to show the selected map region.
(b) Zoom Out: Zooming out is performed by selecting the Zoom Out tool from the tool bar. The user can then simply single-click on the map display with the mouse. The map application will then decrease the magnification of the map by one level and re-center the display on the location that was clicked.
(c) Pan: Panning is performed by selecting the Pan tool from the tool bar. The user can then click on the map display and, while holding down the mouse button, drag the map view in the desired direction. Upon release of the mouse button, the map display is redrawn show the new area. The display can be moved a maximum of one window width or height at a time. For example, to pan the display to show an area to the west of the current view, the map is grabbed and dragged to the right (east) to move an area to the west into the window view.
(d) Re-center: Re-centering is performed by selecting the Re-center tool from the tool bar. This is a quick pan feature that allows the user to simply click a location on the map display. The display is then re-centered around that location without changing scale. To pan to the southeast, the user simply clicks in the lower right corner of the map display.
(e) Thumbnail: The Thumbnail tool provides another method for panning the map display. When the user selects the Thumbnail, a small map window appears as shown in FIG. 24. The Thumbnail view has the extents of the user's default home extent and shows a small box on the display that is the outline of the main display window. The user can pan the main map display by selecting the box in the Thumbnail window and moving it to the desired location in the Thumbnail window. This will cause the map application to change the main map view to the location selected on the Thumbnail.
(f) Refresh Display: The Refresh Display tool enables the user to clean up the map display by removing transient information like address labels from searches, vehicle trails from tracing, and the like. Selecting the Refresh Display button causes the map application to redraw the map display with only the current, real-time or last know vehicle location information.
(g) Save Extents: The Save Extents saves the current map window view as the default home extents for the user. The home extent is the initial map display boundary when the application is started and is used for the Thumbnail display. Saving the home extents causes the map application to send the new data to the CIS via the XML interface. The CIS will then store the new extents to the database so that it is available the next time the user logs in.
(h) Zoom to World: This tool allows the user to zoom out to the maximum extent of the available map. Selecting Zoom to World causes the application in its present embodiment to change the map view to the entire United States.
(i) Zoom to Home Extents: This tool allows the user to zoom in or out to his default home extents. Selecting Zoom to Home Extents causes the map application to redraw the map with the default home extents shown in the map window.

Other map interface tools do not perform map navigation. The Select Pointer tool is the default map interface tool. It allows selection of vehicles on the map for further action, such as sending a message. The help tool brings up a help screen to aid the user with the map application interface. The Envelope Icon launches the messaging application directly from the map without having to select it from the menu bar.

D. Dispatching

The Dispatching Function subsystem 118 of the overall software system structure of FIG. 10 provides a computer aided dispatching capability that enables the user to schedule vehicles, assign resources, perform route optimization and automated work order status updates. The dispatching concept centers on work orders, vehicle, job site and time frame. The capabilities of the dispatching function and its business rules are specific by industry. The gateway has the ability to plug and play dispatching applications that are geared toward various business models. The dispatching application outlined below is tailored to the on-demand service call management business, by way of example and not of limitation.

The Dispatching subsystem, as described here, consists of two primary functions: Work Order Management and transmission of work orders to vehicles. Both of these functions together are called Dispatching. Management of work orders encompasses entry of service requests, scheduling of work, and resource planning. Dispatching also provides a user interface to work site management that is performed by the gateway.

Applications integrated with the gateway communicate with the gateway through the XML interface (data channel D). Integrated applications typically maintain their own database of parameters used in their operation. The integrated application may be hosted on the same computers that run the gateway (run on the internally hosted application servers 35 in FIG. 2) or at a remote location and connected to the gateway through the Internet or other wide area network (externally hosted applications 34 in FIG. 2). If the application is hosted at the gateway, then the application's database is managed by the same database servers 31 that run the gateway's system database 30. The Dispatching application described below is assumed to be an internally hosted application, but could easily be externally hosted with little change except for the addition of its own database and database server.

An important part of Dispatching is how the core location aware business rules relate Work Order Management and Work Site Management. Any stand alone or integrated dispatching application manages work orders, their scheduling, and usually resources assigned to them. The location aware business logic applies the concept of work sites across all business types, allows work sites to be associated with work orders, and allows the management of the sites. The Dispatching function is normally performed by a user with a dispatcher role.

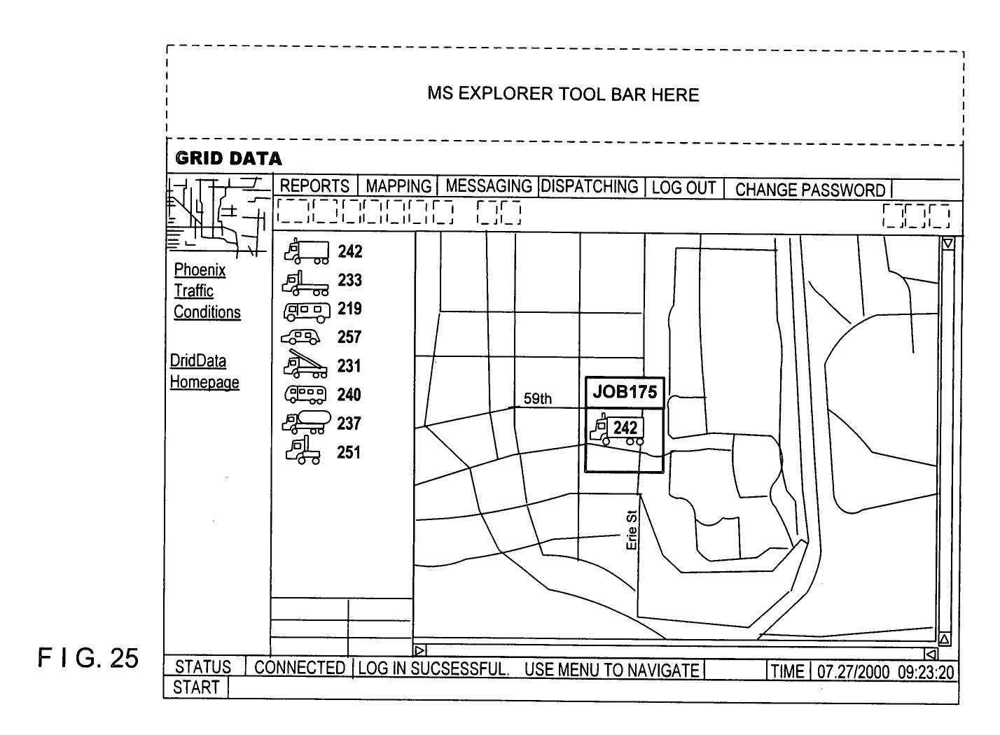

Work sites are areas defined by rectangles of latitude and longitude. They are either places where work is to be performed, “job sites,” or places where vehicles are usually stationed or load material, “home sites.” Job sites are automatically or manually created by the Order Entry Clerk or Dispatcher from the address at which the work is to be performed. A typical job site is shown in FIG. 25. Sites are displayed on the map, and the coordinates are sent to the vehicle(s) assigned to participate in performing the work at the time of its (their) dispatch. This process is referred to from time to time herein by SITE DISPATCH (a trademark of Grid Data, Inc. The mobile computer, or tracker, knows its position and continually checks to see if it has entered or left any work site that it has in memory. When such an event occurs, the tracker automatically reports back to the gateway the arrive/leave status and the ID of the site. Arrival at a site is often used to change the status of a work order from a pending state to an in progress state. In sophisticated dispatching and work order management products, the work order is automatically tracked in detail by using the arrive/leave status from the tracker.

Home sites and job sites are treated differently by the tracker. Home sites are permanent until deleted so that every arrive/leave is reported. Job sites are either used one time and discarded or are time persistent. If they are time persistent, every arrive/leave within a time period, such as 24 hours, is reported, and, after the time limit expires, the site is discarded. The purpose of the Work Site Management Function is to provide the capability to allow the Dispatcher to create, change or delete work sites.

The end-to-end work site dispatch functionality can be supported by any mobile computer that is location enabled. As described earlier in this specification, this device can be a vehicle or fixed asset mounted computer or a handheld PDA or mobile telephone. The device requires a wireless interface and a location determining mechanism such as ones based on GPS, inertial, dead reckoning, radio ranging or Doppler, or any combination of these techniques. Radio navigation systems include those that use the signals of the wireless communication networks themselves, such as some E911 services, that use triangulation, trilateration, or Doppler from the cellular telephone infrastructure to determine position.

The SITE DISPATCH™ process can also be performed entirely at the gateway by comparing position reports from the devices to the site locations to generate the arrive/leave event information. This opens the possibility of using location techniques which do not require position determination in the wireless device. However, use of such location techniques would be accompanied by several drawbacks, including: accuracy of event times dependent on the frequency of location determinations, requiring frequent updates and more wireless bandwidth; requirement of more central computing throughput because all device positions would require comparison to the sites appropriate to each device in one central location instead of distributing processing across all devices.

A Project & Work Order Function provides the ability to define the project order and its individual work orders under the project order. A project order is the master description of the work a client has requested. It may encompass one or many work orders. Each work order defines the “task” necessary to complete the master order. Thus, a work order cannot exist on its own, but exists as part of a whole project order. This function also provides the capability to view details of a Project & Work Order, and a list of existing project & work orders and their statuses. The details of Project & Work Orders will vary by industry, defined at least in part by industry specific work orders (or tickets). The particular use cases which follow describe the functionality needed for small field service companies with an on-demand dispatching model. Other dispatch functions tailored to other business models, such as fixed routes and periodic service, could be provided as well.

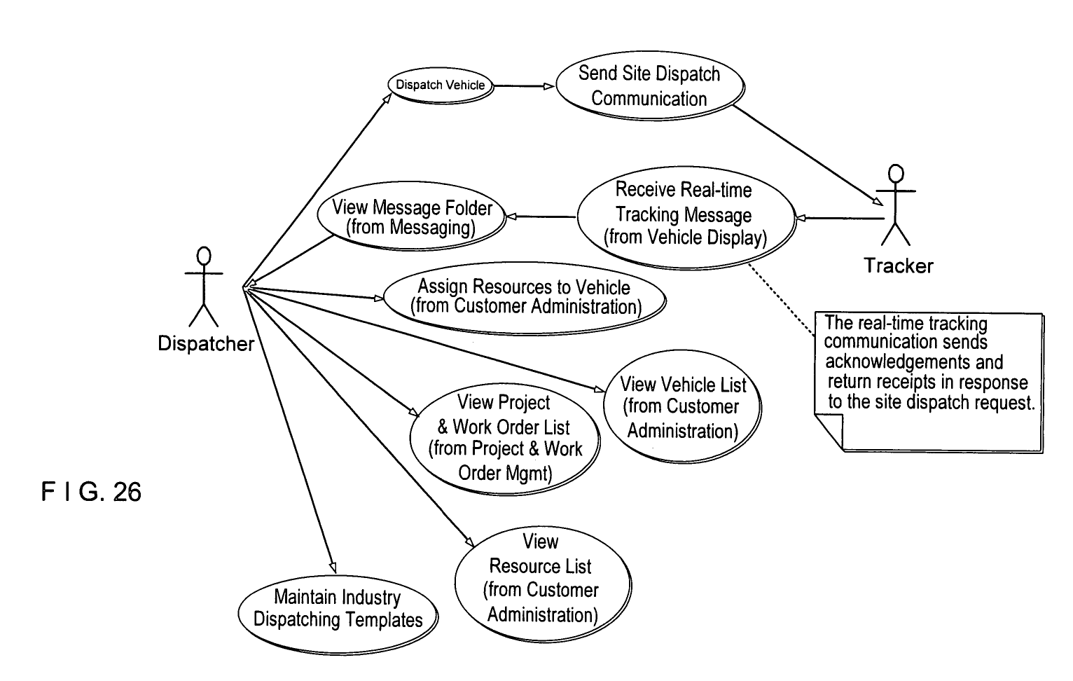

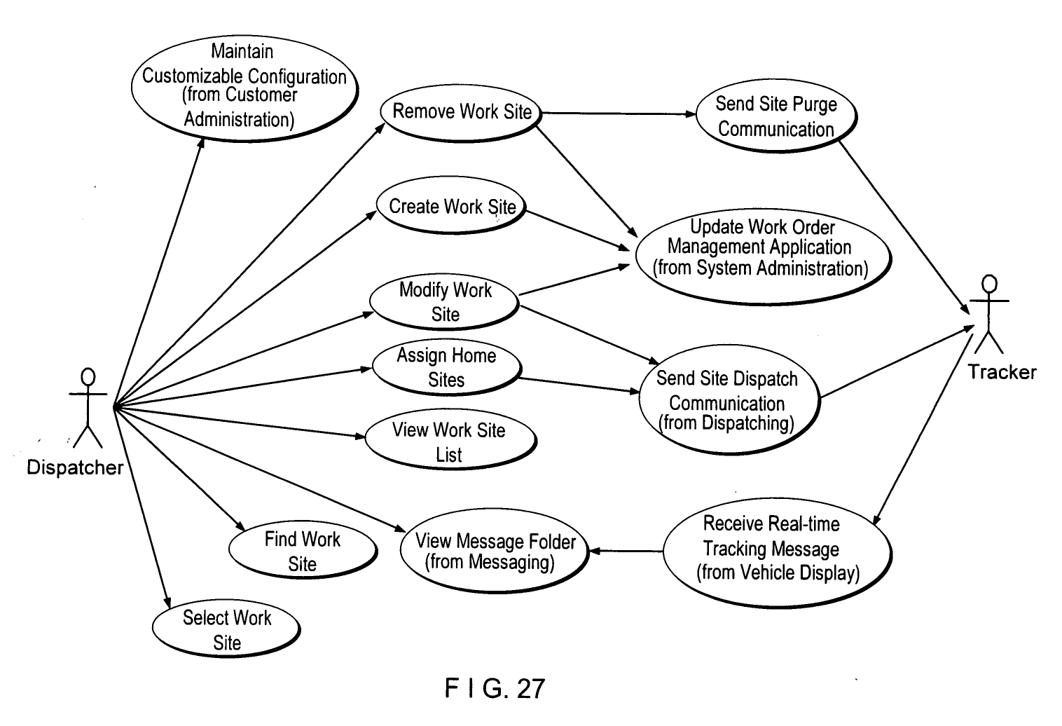

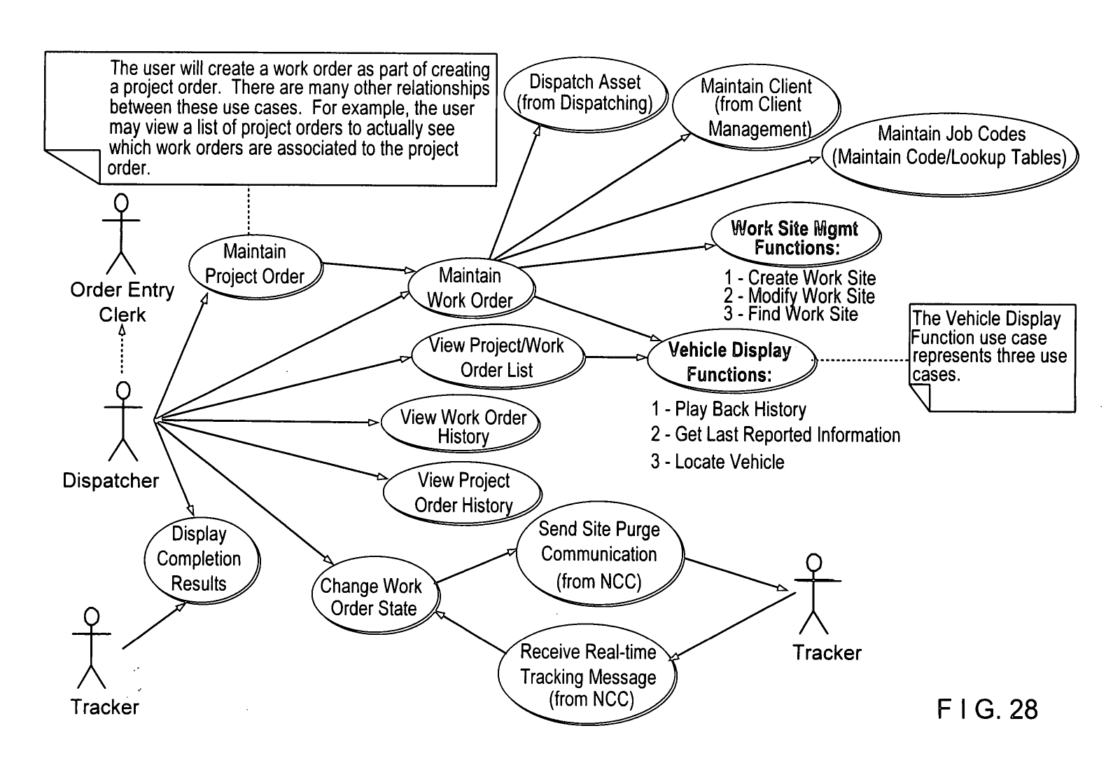

Pertinent use cases of the Dispatching and related functions are described below. The structures of the Dispatching Function, Work Site Management Function, and Project & Work Order Management Function, are illustrated in the functional diagrams of FIGS. 26, 27 and 28, respectively.

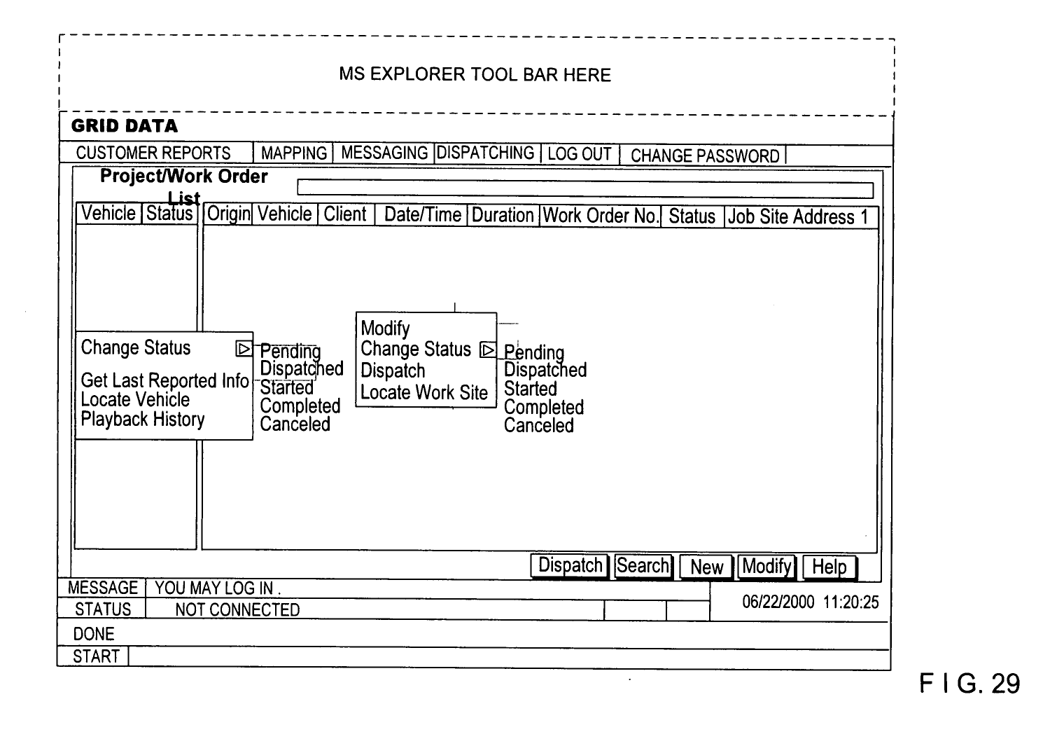

FIG. 29 shows the main user interface for dispatching and work order management. When populated with data, this interface shows vehicles and their work order status, such as “On Job” or “Available,” on the left side and a list of work orders on the right side. Vehicles may be selected for dispatch, and work orders may be selected for dispatch, manual status change, or to determine the work site location on the map. Work sites can be dispatched, created, or modified using the buttons in the lower right.

1. Dispatch Vehicle

This use case provides the ability to dispatch a vehicle(s) to a job site in order to fulfill a work order. The Dispatcher has the ability to set up an “auto dispatch” or to manually dispatch a vehicle. The dispatch may also be set up with a status of Holding, in which case the dispatch is suspended until the Dispatcher manually dispatches the order or sets it to an auto dispatch. A work order is assigned to one vehicle only. If multiple vehicles are needed to fulfill a work order, multiple work orders are created and each vehicle will be dispatched to fulfill its respective work order. This will result in multiple dispatch messages being sent.

When manually dispatching a vehicle, the Dispatcher selects a vehicle that will meet the work order's specific needs. Depending upon the industry, the Dispatcher may also need to view attributes of a driver and/or crew that has been assigned to the vehicle to ensure that each possesses the necessary and sufficient skills to complete the work order. When a vehicle is assigned to a work order, the resources and vehicle cannot be assigned to another work order for the expected duration of the current work order. If the Dispatcher has selected the auto dispatch function, the work order will be dispatched automatically based on analysis of the following circumstances: (1) vehicle location (the vehicle closest to the work site with the proper requirements); (2) special skills necessary (any driver or vehicle special skills); and lastly, (3) the least busy vehicle (based on the current work load assigned to the vehicle).

At the time of dispatch of a vehicle to ajob site, the Dispatcher is able to determine if the job site is one that may last for one hour, one day or many days. The appointment time and/or duration is used to identify the length of stay at the job site, which in turn determines the job site's persistence. The order entry clerk may have entered the appointment time and duration, but the Dispatcher has the capability to change it, as well as to change the address and work site. At the time of the dispatch, the Dispatcher has the capability to send a text message along with the dispatch request, which may be a message from a pick list, a customized message, or the address of the job site (which may be set as the default message). The Dispatcher also has the ability to define a response set to a message sent. The response set may be just an acknowledgment from the driver or it may be an accept or decline. When the dispatch has been made (either manual or automatic), the send site dispatch communication is sent. This message notifies the designated tracker to retain this job site (persistence) in its memory for the length of time stated in the appointment duration.

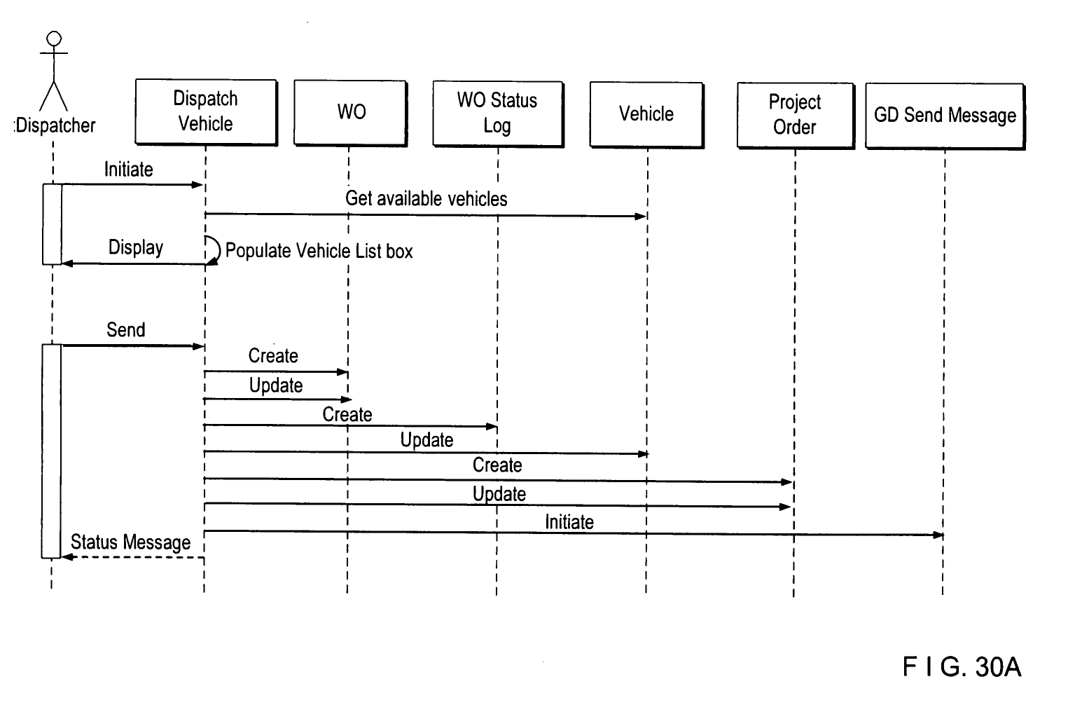

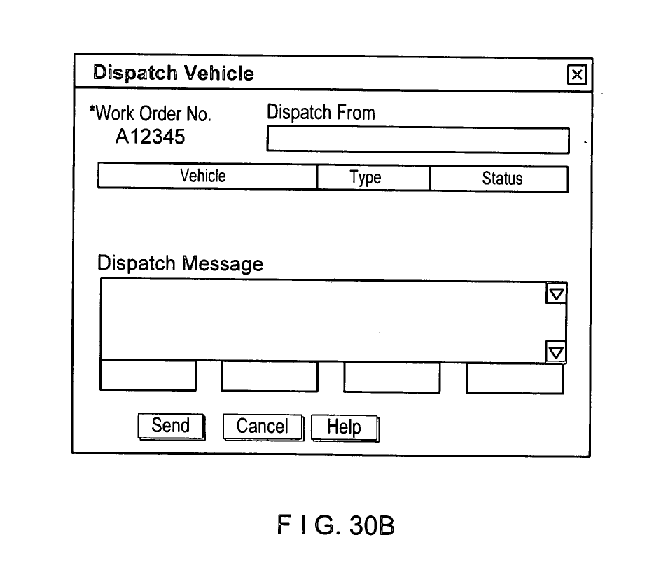

The Work Order Management Application performs the steps shown in FIG. 30A to dispatch a vehicle if a work order is selected for dispatch. The user interface in FIG. 30B is used to send the dispatch message. First the list of vehicles is created to populate the vehicle list in FIG. 30B. The user selects the desired vehicle(s). The default message to the vehicle(s) contains the date and time, work order number, the client name, and work order address. The default responses are “Accept” and “Decline.” The user may edit the message; then the user selects send.

At this point the work order status is updated to “Dispatched.” If multiple vehicles were selected, a parent Project Order is created and additional work orders are created. Then the dispatch message is sent to the gateway through the XML interface.

This triggers the Send Site Dispatch function in the gateway. The gateway processes this function in a manner similar to that for Send Messages shown in FIG. 19A. In this case, a site dispatch message is sent to the tracker(s) instead of a text message. The site dispatch message has a site attached to the text.

2. Maintain Industry Dispatch Templates

This function provides for configuration of the dispatching and work order management applications for different businesses. It allows specification of job codes, employee skill codes, and configuration of forms and reports.

3. Maintain Project Order and Work Order

These use cases provide the Dispatcher with the ability to create, modify, complete or cancel a project order or a work order, as well as providing the ability for the user to view details of existing project or work orders. Project orders are parents of work orders. A project order can be made up of one or more work orders. The dispatching application in this embodiment of the invention requires that one vehicle (or Field Service Representative) is dispatched to a work order. If a task or job requires multiple vehicles, three trucks of concrete for example, then three work orders must be created. These work orders can then be placed into a project order for easier management by the dispatcher. In the current embodiment, a work order cannot exist without a corresponding project order. To simplify the interface for the user, the application automatically creates a parent project order when the user creates a work order.

When creating a work order, the user identifies attributes such as the work site, job code, any special skills required (as identified by the type of job) and appointment date and time. Any special comments may also be entered. In order to take advantage of the gateway's SITE DISPATCH™ capability, a work order must have an associated work (job) site. Site association can be performed at the time a work/project order is created, modified, or at the time the dispatch occurs. If the work site has previously been created (for example when this is a subsequent dispatch to the same location), it can be selected from a list of sites. If one does not exist, it is created by the user. Work site creation and modification is described in detail below.

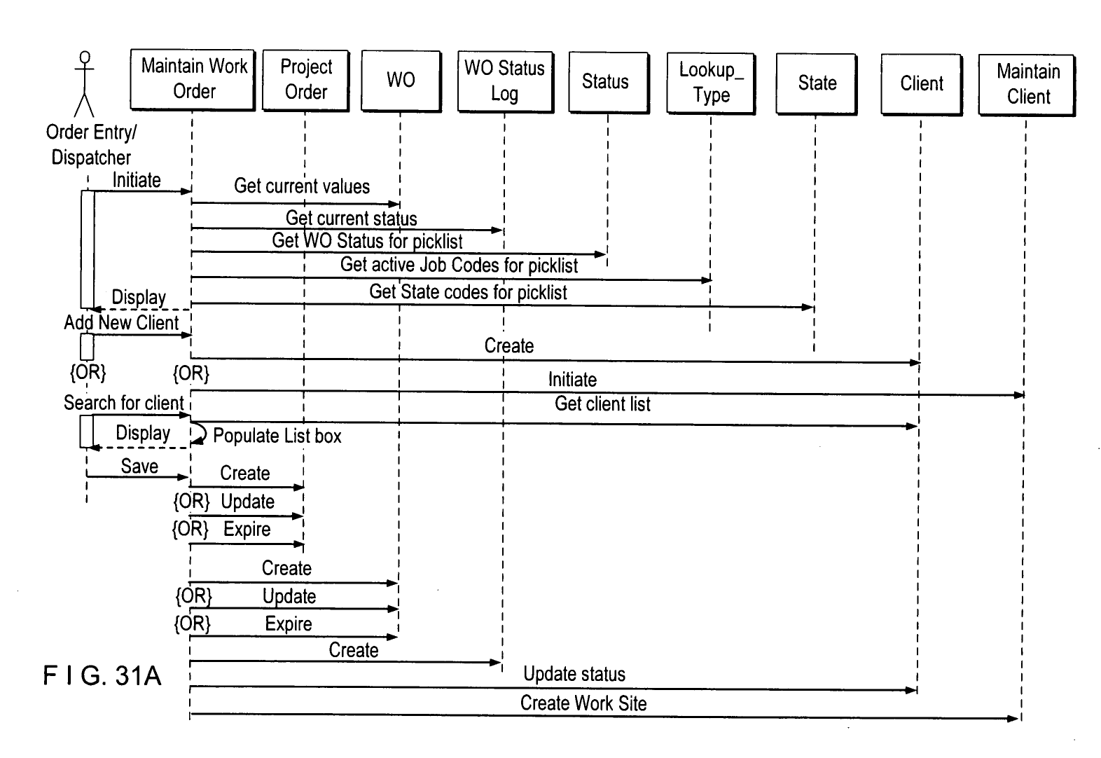

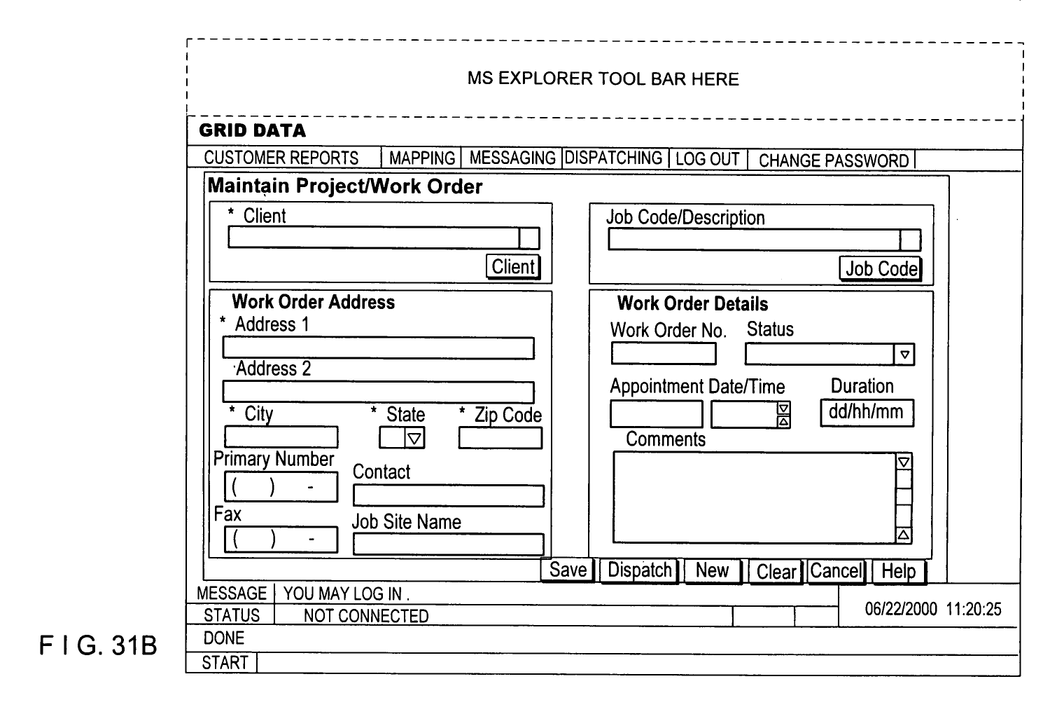

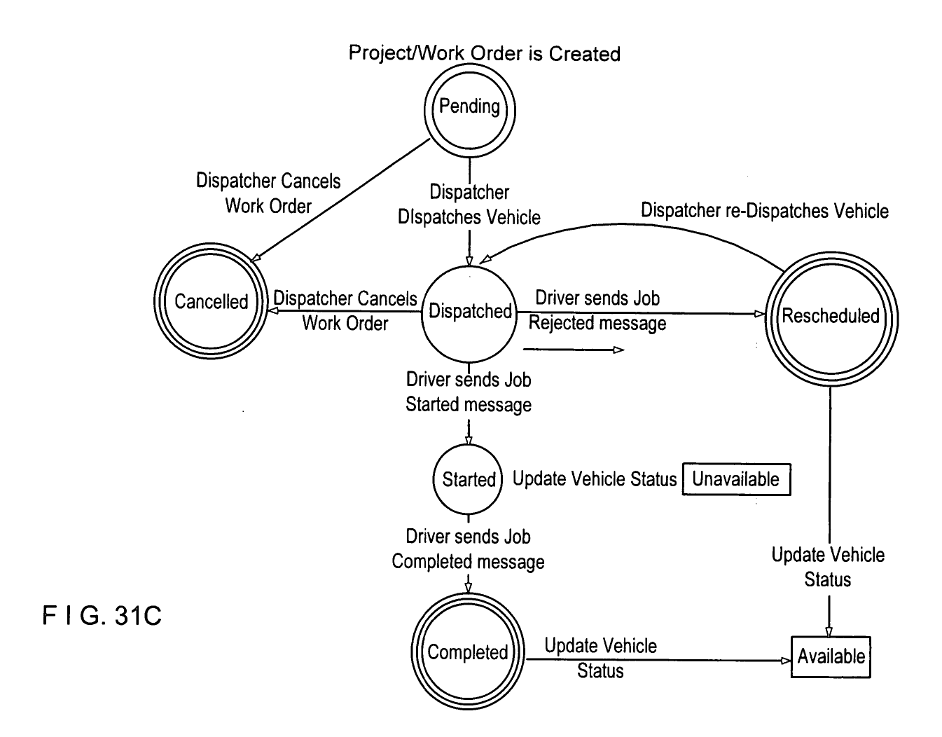

The functional steps performed by the Maintain Project Order and Work Order function are shown in FIG. 31A. The user interface for the function is shown in FIG. 31B. When the Maintain Order function is initiated the work order management application queries its database to fill the user interface with the appropriate data for open work orders, job codes, work order status and code definitions, and client list. The interface is either started from selecting a particular work order, which automatically populates the interface, or without one, which forces the user to select client and work order. The user takes the desired action to change work order details, address, site, status, etc., and then can save or dispatch the form. On save or dispatch, the application makes the appropriate changes to the work order and project order as required as shown in FIG. 31A.

A work order cannot be changed if its status is either completed or canceled, but may be canceled at any time if either of those two events has not already occurred, and, if created in error, can be deleted from the database. Deletion of the last or only work order for a project order results in automatic deletion of the project order, since a project order cannot exist without a work order.

The states of a work order are shown in FIG. 31C. When a work order is initially created it is pending. Once it is dispatched, it is in the dispatched status until canceled by the dispatcher, rejected or declined by the driver or started by the driver. If it is rejected, the dispatcher must dispatch the work order to another driver. If the driver does not reject the work order, then he must start it and complete it. When the work order is started, the vehicle is unavailable for further dispatches, and when the work order is complete, the vehicle becomes available again.

A project order may go through various states, but fewer in number than the states of a work order. Some states may be updated automatically, as where the final work order of a project order is completed, which automatically updates the project order state to completed. A project order can be canceled at any time, and if created in error, can be deleted from the database. Deleting a project order deletes all related work orders. Since a project order may have many work orders, it may have many job sites and vehicles assigned to it. A work order can be added to an active (i.e., not canceled or completed) project order at any time.

4. Change Work Order State

This function is used when a work order is being started, completed or canceled. It provides an ability for the driver, dispatcher or some event to change the state of a work order. A work order goes through various state transitions (FIG. 31C), some of which will occur based on the driver initiating the event. The driver may cancel a work order such as for lack of proper skills required to complete the work order, and the canceled work order may then be reassigned (dispatched) to another vehicle. When a work order is being closed, the Dispatcher may request that the work site be purged from the tracker but this does not remove the work site from the mapping application. Once the work site is selected for display on the map it will stay on the map until the next time the map is loaded or until the user “turns off” the selection of the work site. Status changes can be automated using the SITE DISPATCH™ system of the gateway. The vehicle will automatically report arrive/depart job. These can be used to change the work order status to started and completed, respectively.

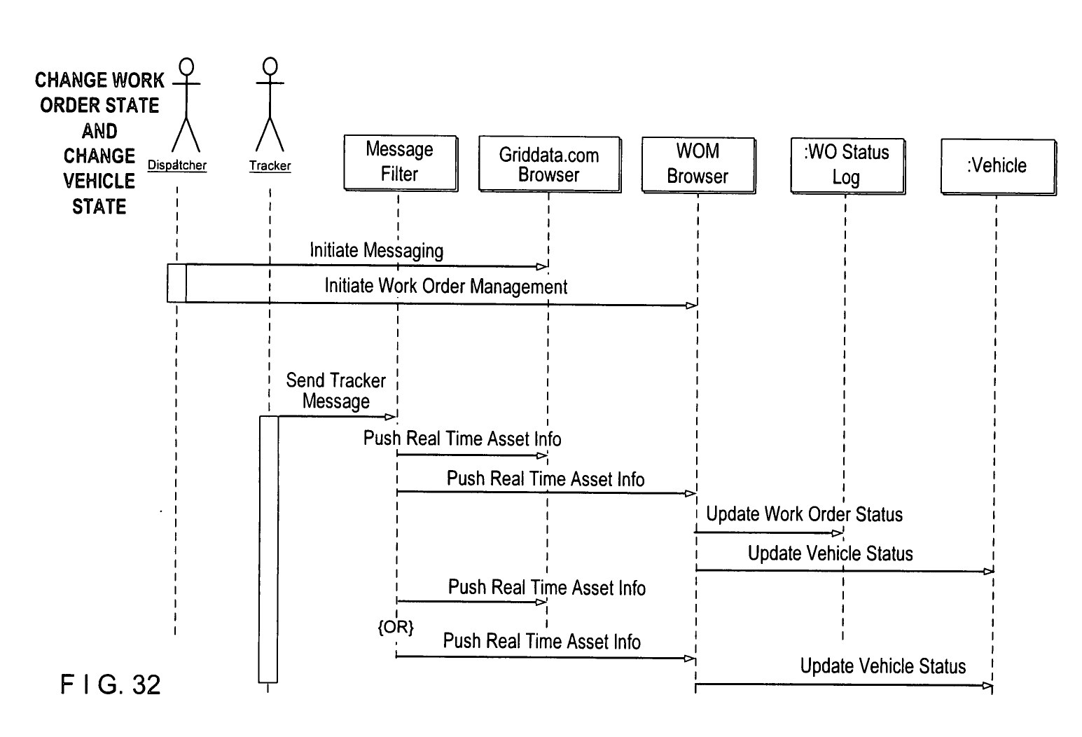

The functional steps for Change Work Order State are shown in FIG. 32. For the application to be able to change the state of a work order, either from enterprise user initiation or driver initiation, an enterprise user must be logged in to the gateway and the application must be running. The user may change work order status using the maintain work order function described above. When the work order management application is running, it accepts messages from the tracker (initiated by the driver) to change the state of a work order as indicated in FIG. 31C. Messages received by the gateway are passed through the message filter in the CIS to the appropriate customer and user, and the Work Order Management application updates the work order and vehicle state as shown in FIG. 32. The driver can start, complete, cancel, or reject a work order. Certain responses only make sense for certain work order states; for example, a driver can only complete a work order that has been started.

5. View Project/Work Order List

This function is used whenever the user wants an overview of all his project and work orders, or to view details of a project or work order, or to view the status of orders that have been dispatched. The application provides the capability of viewing all project and work orders that exist. Filtering capabilities on attributes such as status, client, location, vehicle and time frame (date) provide the user the ability to select subsets of the work order list for viewing. Once the list is displayed, the user has the ability to sort the list by either project order and work order, and then by status. This sorting allows the user to view all work orders that have been dispatched, started or are late, as well as by work order priority or by project order priority. If project order is selected, all work orders are grouped under their related project order. The list displays a meaningful subset of project/work order attributes. Selection of a project or work order on the list allows the user to view all details of that project or of an associated work order.

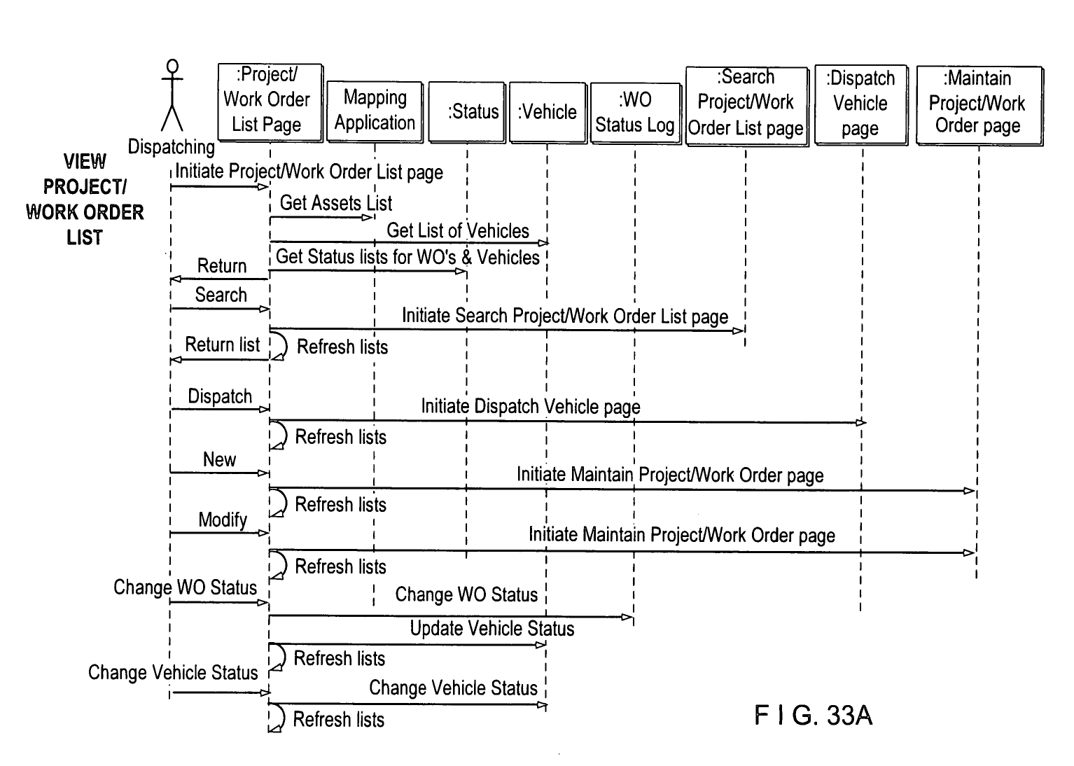

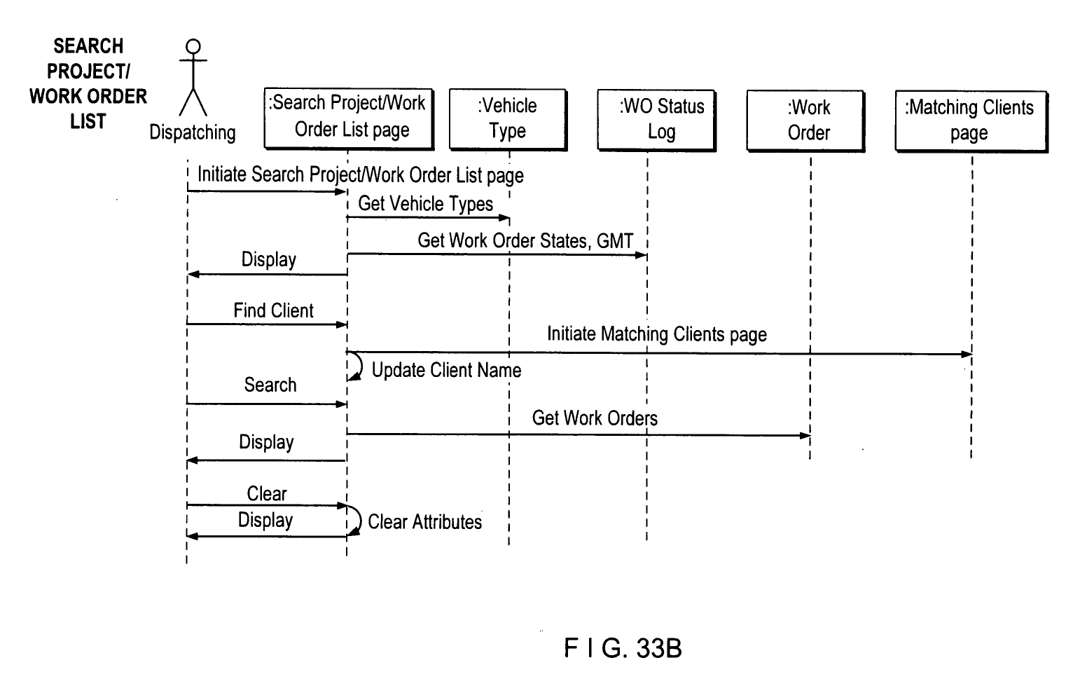

The steps performed by the View Project/Work Order List function and the Search Project/Work Order List functions are shown in FIGS. 33A and 33B. The user interface for the function is shown in FIG. 29 (the main interface screen for the application). When the user initiates the function, it requests from the application database, the vehicles (assets) and work orders that match the selection criteria provided by the user, time span or specific clients, for example. The user interface then displays these parameters with vehicles on the left side and work orders on the right side of the display.

The user interface provides the following options:
Dispatch: initiates the Dispatch Vehicle pop-up page, allowing the Dispatcher to send a Site Dispatch Message to the Vehicle(s) assigned to the selected work order.
Search: initiates the Search Project/Work Order List pop-up page, allowing the Dispatcher to enter criteria for work orders he/she wishes to see in the list. The Work Order list is refreshed when the pop-up page closes.
New: initiates the Maintain Project/Work Order page, allowing the Dispatcher to create a new work order.
Modify: initiates the Maintain Project/Work Order page, allowing the Dispatcher to make changes to the selected work order, including changing its status.
Help: allows the Dispatcher to view overview help related to the page.
Work Order Pop-up menu: initiated by right-mouse click on a selected work order, allows the dispatcher to quickly initiate Mapping application Locate Work Site function, and Work Order Management application functions (Modify, Change Status (WO), Dispatch).
Vehicle Pop-up menu: initiated by right-mouse click on a selected vehicle, allows the dispatcher to quickly initiate Mapping application functions (Locate Vehicle, Get Last Reported Info, Playback History) and Work Order Management application Change Status (Vehicle).

The actions performed by the application when these options are selected are shown in FIG. 33A. FIG. 33B shows additional detail for the Search option. First, a client is selected from a list the application provides from the work order management database. Then, the search criteria are selected which consist of any combination of date range, work order status such as open or closed, vehicle or driver name, and so forth. The application then queries the database to return the list of work orders that match the search criteria

6. View Project Order History

This use case provides the ability for the user to view the history of a particular project order. Although many of the attributes displayed in the project and work order list (above) are included, the history shows the each state the project order traversed, when the state changed, and who was responsible for changing the state. Additional details may be displayed in the history, including identity of the person who created the project order, date the project order was started and/or completed, and outstanding work orders (if any exist). It then provides the ability to view the history of any associated work orders as described in View Work Order History. History can be viewed by selecting the project order from the View Project/Work Order List display and requesting a history. The application then retrieves the desired data from the database and displays it.

7. View Work Order History

This use case provides the ability for the user to view the history of a particular work order. Although many of the attributes displayed in the project and work order list (above) are included, the history shows each state the work order traversed, when the state changed, and who was responsible for changing the state. Additional details may be displayed in the history, including identity of the person who created the work order, date the work order was started and/or completed, and any completion results as described in the Display Completion Results function below. History can be viewed by selecting the work order from the View Project/Work Order List display or from View Project Order History of a parent project order and requesting a history. The application then retrieves the desired data from the database and displays it.

8. Display Completion Results

This use case is used to report any statistical information pertaining to a project order or work order that is important to the user. It provides the capability to review any statistics related to a completed project or work order. Information is received via the Tracker (the driver having entered some statistics and a message containing same having been received). Examples of statistics include materials used and quantities thereof to complete the project. Completion results are shown when viewing work order history or by themselves. Summarized completion results are shown for project orders. These are the totals or averages of results from individual work orders. The user selects the desired project or work order from either the View Project/Work Order List interface or a work order from a Project Order History. The application then retrieves the desired data from the database and displays it.

9. Create Work Site

This function is used to create a work site (home or job) for the SITE DISPATCH™ system. Job sites are normally created in conjunction with a work order, but can be created independently. Work sites are created directly within the Mapping Application or initiated from the Dispatching application, either by drawing the area on the map or by entering a street address.

Work sites are created using the Mapping application. The user can either draw a rectangle on the map to represent the work site or enter an address. When the site is drawn manually, the application selects an address nearest the center of the rectangle as the work site address. The user can enter the correct address, and must also supply a site name for future identification of the site and a site type (home or job). When an address is entered to initiate the site creation, first possible matching addresses are provided to the user, who selects the desired address. The application then automatically draws a default size site, e.g., a 200×200 meter square, centered at the indicated address. The user is then allowed to modify the site by changing its size, shape, and location graphically on the map. As in the first case, the site name and type must be supplied.

Job site creation can be, and normally is, initiated from the Dispatching application. Once the address of the job site is supplied to the Dispatching application, the Mapping application can be initiated to create the corresponding site. The Mapping application uses the address to create the default site and assumes a job site for the type. The user is then allowed to modify the site by changing its size, shape, and location graphically on the map and must supply a site name.

When a work site is created, it is sent to the CIS, which stores it in the system database and assigns it a site identification. The CIS also identifies the site to any logged in users of that customer that the site exists for use.

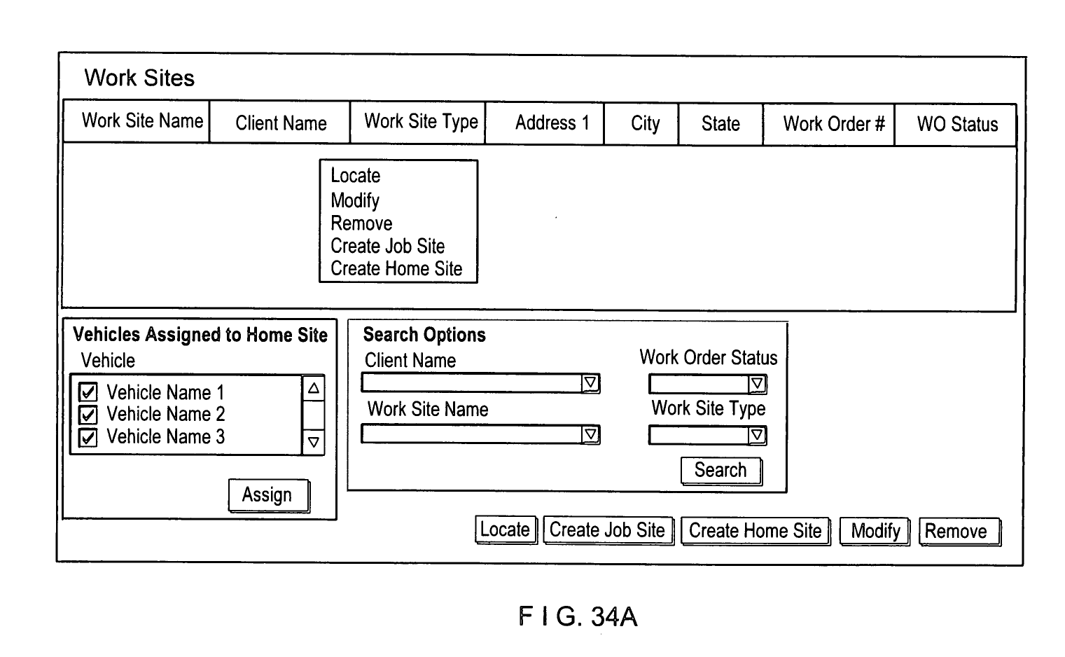

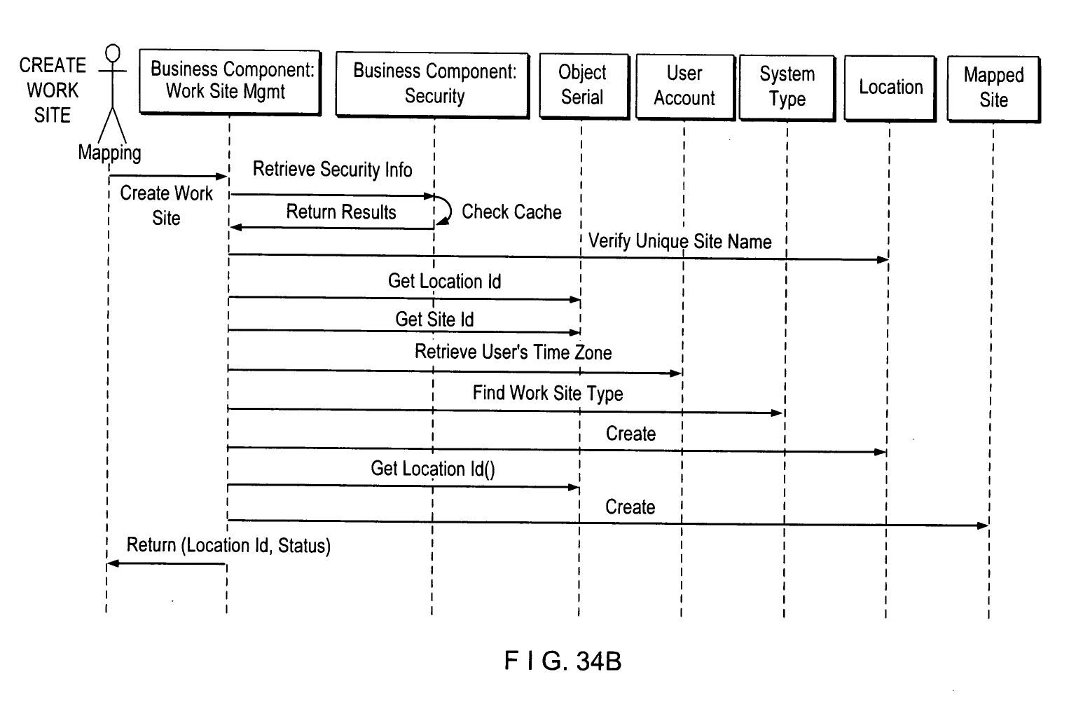

The user interface for work site creation and the modification, removal, and location functions described below is shown in FIG. 34A. The main part of the interface contains a list of existing sites, with name and address of the site. It also contains work order information if the interface is started from the Dispatching application. The bottom left shows which vehicles are assigned to a home site selected in the top display. The search criteria in the bottom middle part of the display allow for searching the database for sites based on different parameters such as home or job, or work order information if the interface is started from the Dispatching application. The search portion of the interface implements the Find Work Site function described below. This function is used to populate the list of sites for further action by the user for all of the work site related functions.

The steps performed by the Create Work Site function are shown in FIG. 34B. The steps shown are those after the site has been drawn by the user and the user has accepted the site.

(a) Create Work Site: The mapping application sends a create work site method to the customer server when the user has selected the accept push button on the Create Work Site page.

(b) Retrieve Security Info: The security component is called to retrieve security information related to the user such as which customer they belong to and their role and personal ID.

(c) Verify Unique Site Name: The site name is checked to ensure it is unique among all work sites. The same site name cannot exist for any site including active or expired sites as well as across the different site types.

(d) Get Location ID: The location ID for the location table is retrieved. The location ID is unique among all sites for all customers.

(e) Get Site ID: The site ID for the location table is retrieved. The site ID is unique among each customer.

(f) Retrieve User's Time Zone: The time zone the user is located in is retrieved. The time zone is associated with the site for potential use in time conversion related to reporting arrival and departure from the site.

(g) Find Work Site Type: The ID associated with the type of work site is retrieved.

(h) Create (Location): The new site is added to the location table.

(i) Get Location ID: The location ID for the mapped site table is retrieved. The location ID is unique among all mapped sites for all customers.

(j) Create (Mapped Site): The new site is added to the mapped site table, to reflect that the map is currently enabled, and displayed on the map.

(k) Return: The location ID and status is returned to the mapping application.

10. Modify Work Site

This use case is provides the ability for the user to change the characteristics of a work site. Both job sites or home sites can be modified. Modification of a work site can be initiated directly within the Mapping Application or from the Dispatching application. When modifying a work site, the user may do any of the following: change the address of the work site; change the coordinates of the work site, without affecting the address but only the size of the area; or change the name of the work site (but maintaining its uniqueness to the specific customer). Once a user accepts the changes to the site, a site dispatch message may be sent to trackers affected by the change. For home sites, a new dispatch (site assignment) message is sent to all vehicles assigned to the home site; for changes to a job site, the site dispatch message is sent to all vehicles that have been dispatched to the site, but are not currently located at the job site (vehicles already at the job site will not receive the site dispatch message uniless they are dispatched to thejob site another time). It is the responsibility of the work site management component of the gateway to resend the original site dispatch messages created by the customer to the appropriate trackers with the modified site data attached. If any vehicles are associated with the work site via a home assignment or dispatch, the user is warned that the changes will have an effect on those vehicles.

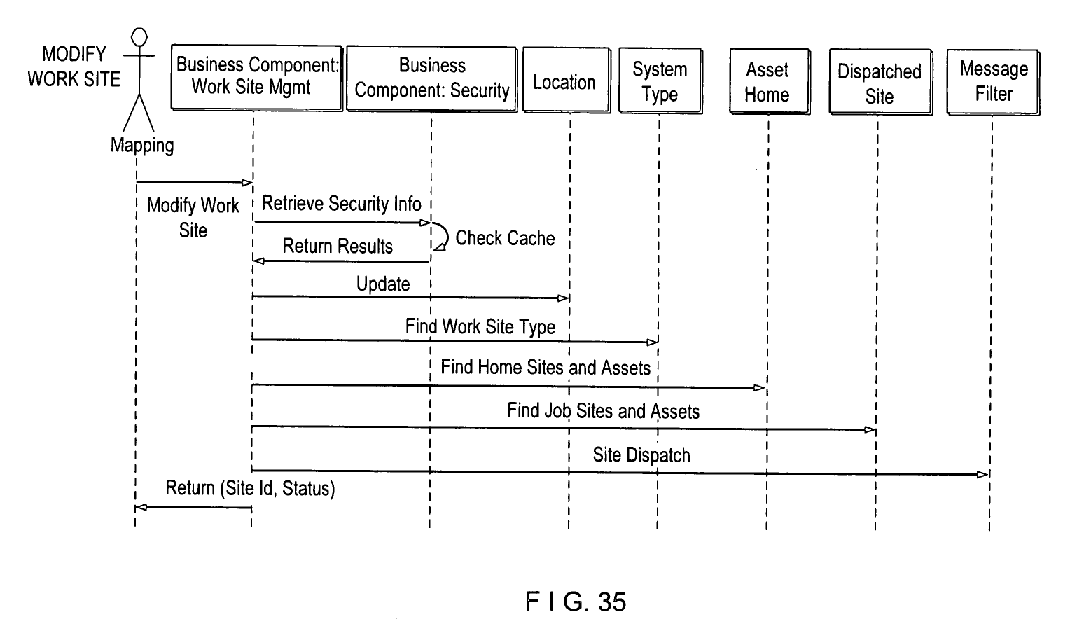

Modification is initiated by selecting a site using the interface in FIG. 34A and selecting the modify option. The steps performed by the Modify Work Site function are shown in FIG. 35. The steps shown are those after the site changes have been accepted by the user.
(a) Modify Work Site: The mapping application sends a modify work site method to the customer server when the user has selected the accept push button on the Modify Work Site page.
(b) Retrieve Security Info: The security component is called to retrieve security information related to the user such as which customer they belong to and their role and personal ID.
(c) Update (Location): The work site information is updated in the location table.
(d) Find Work Site Type: If the coordinates of the work site changed (latitude/longitude) the type of site is retrieved. This helps in determining which table to access to find the assets associated with the work site.
(e) Find Home Sites and Assets: If the site is a home site and the coordinates changed (latitude/longitude), assets associated with the home site are retrieved so a site dispatch message can be sent.
(f) Find Job Sites and Assets: If the site is a job site and the coordinates changed (latitude/longitude), any assets associated with that job site that have been dispatched to and not yet arrived at the site are retrieved so a site dispatch message can be sent.
(g) Site Dispatch: Any assets found in steps (e) or (f) are sent the original site dispatch messages corresponding to the site with the new site coordinates.

11. Remove Work Site

This use case provides the ability for the user to remove a work site. The site can be a home site or a job site. Removal of a work site can be initiated directly within the Mapping application or from the Dispatching application. When a work site is removed, it can be deleted from the database if it has never been used, that is a vehicle has never been dispatched to a job site or a vehicle has never been assigned to a home site. Otherwise, removing the work site will not remove it from the database but instead it is marked as expired so that it is only valid between the times it was created and removed. It will only be subsequently referenced in historical reporting. Removing a site will also cause a site purge message to be sent to any associated vehicles (trackers). If a vehicle dispatched to a job site that has been removed has not arrived, the site purge message is not sent until the vehicle leaves the site.

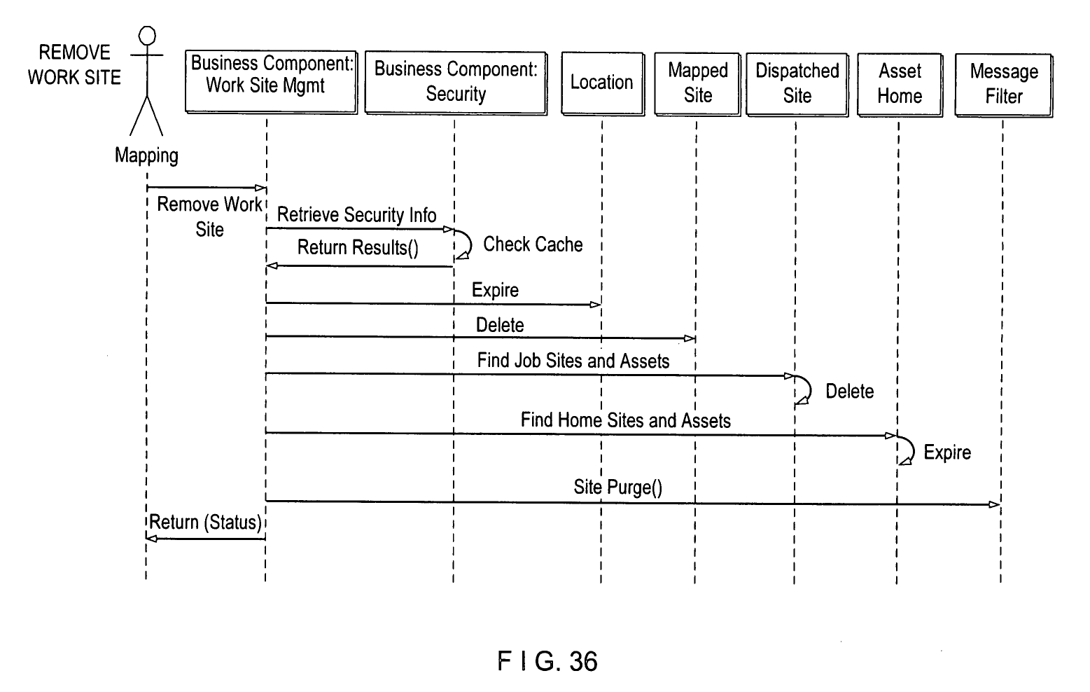

Removal is initiated by selecting a site using the interface in FIG. 34A and selecting the remove option. The steps performed by the Remove Work Site function are shown in FIG. 36. The steps shown are those after the site has been selected for removal.
(a) Remove Work Site: The mapping application sends a remove work site method to the customer server when the user has initiated the remove work site by selecting a work site in the list or on the map, right mouse click and selecting the remove option.
(b) Retrieve Security Info: The security component is called to retrieve security information related to the user such as which customer they belong to and their role and personal ID.
(c) Expire (Location): The work site is expired in the location table.
(d) Delete (Mapped Asset): The work site is deleted in the mapped asset table in the system database. This table controls what is displayed on the map for the particular user. Now it must be deleted for all users.
(e) Find Job Sites and Assets: If the site is a job site, the dispatched site table in the system database records which assets have been dispatched to a job site. The state of the dispatch is recorded so it can be determined if the asset has arrived, not yet arrived or left the job site. All assets associated with the job site that have a status of not yet arrived are retrieved.
(f) Delete (Dispatched Site): The association between the asset and the job site is deleted (for those assets that have not yet arrived at the site).
(g) Find Home Sites and Assets: If the site is a home site, the assigned home table in the system database records which assets have been assigned to the home site. All assets associated with the home site are retrieved.
(h) Expire (Asset Home): The association between the asset and the home site is expired.
(g) Site Purge: A site purge communication is sent to trackers associated with the home site or those not yet arrived at the job site. When the tracker receives the site purge message, it immediately removes the site from its internal tables.

12. Assign Home Site to Vehicle

This function is enables a user to assign a vehicle to a home site. A vehicle can only be assigned to a certain number of home sites, e.g., 20, due to memory constraints on the vehicle tracking computer or wireless phone. However, a home site can have an unlimited number of vehicles assigned to it. If a user attempts to assign a vehicle to more than the limit of home sites, the earliest assigned site will become de-assigned in the system database and in the memory of the tracker. The user has the ability to delete an assignment. Assignments are made to vehicles, not trackers, and the assignment may be made from either the Dispatching application or the Mapping application.

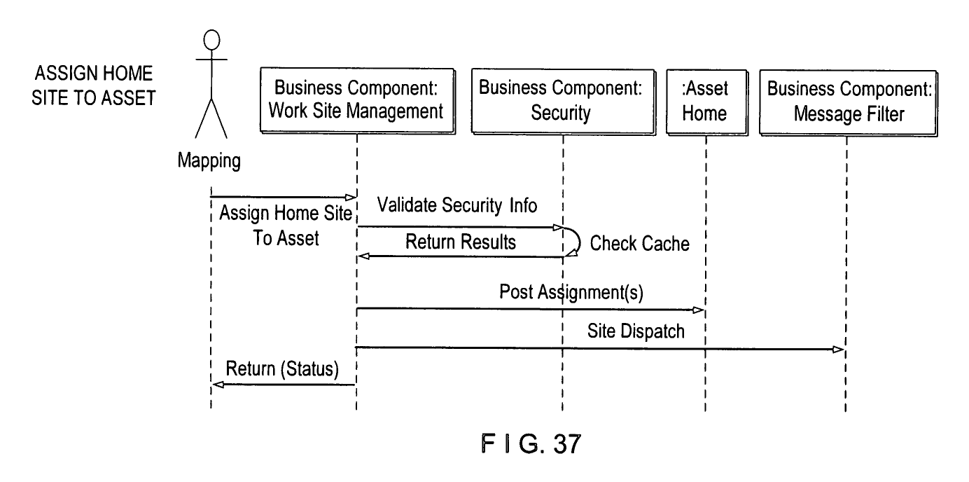

Home site assignment is initiated by selecting a home site using the interface in FIG. 34A, selecting a vehicle from the list and selecting the assign option. The steps performed by the Assign Home Site function are shown in FIG. 37.
(a) Assign Home Site To Asset: When the User selects the Assign pushbutton on the user interface, the Mapping application calls a server sub system interface method to update the database with the assignment of Home Site to Asset(s). A Site Dispatch message is also sent to the Asset(s). When the number of Home Sites assigned to a Vehicle exceeds 20 (for example), the oldest Home Site assignment is expired to allow for the new Home Site assignment.
(b) Retrieve Security Info: The Security Component is called to retrieve security information related to the user such as related customer, role and personal ID.

13. Find Work Site

This function is used when the user wants to find a work site in the database or locate a work site on the map. The process of finding a work site is controlled through the search criteria available on the work site interface shown in FIG. 34A. That interface can be started from the Mapping application or from the Dispatching application. Finding a work site can be a precursor to the other work site related functions so that the desired site can be more quickly located. It is also extended to enable to the user to find the site on the map by selecting the Locate option on the interface. This brings up the map display and centers the map on the site, similar to the view shown in FIG. 25.

As described above, the search portion of Find Work Site narrows the list of all available sites to those that fit the desired parameters. The user has the ability to search on site type and site name. Other search fields that are not shown, but are possible, are the city, state, zip, and street name associated with the site when it is created. When initiated from the Dispatching application, the additional search criteria of client and work order status are available.

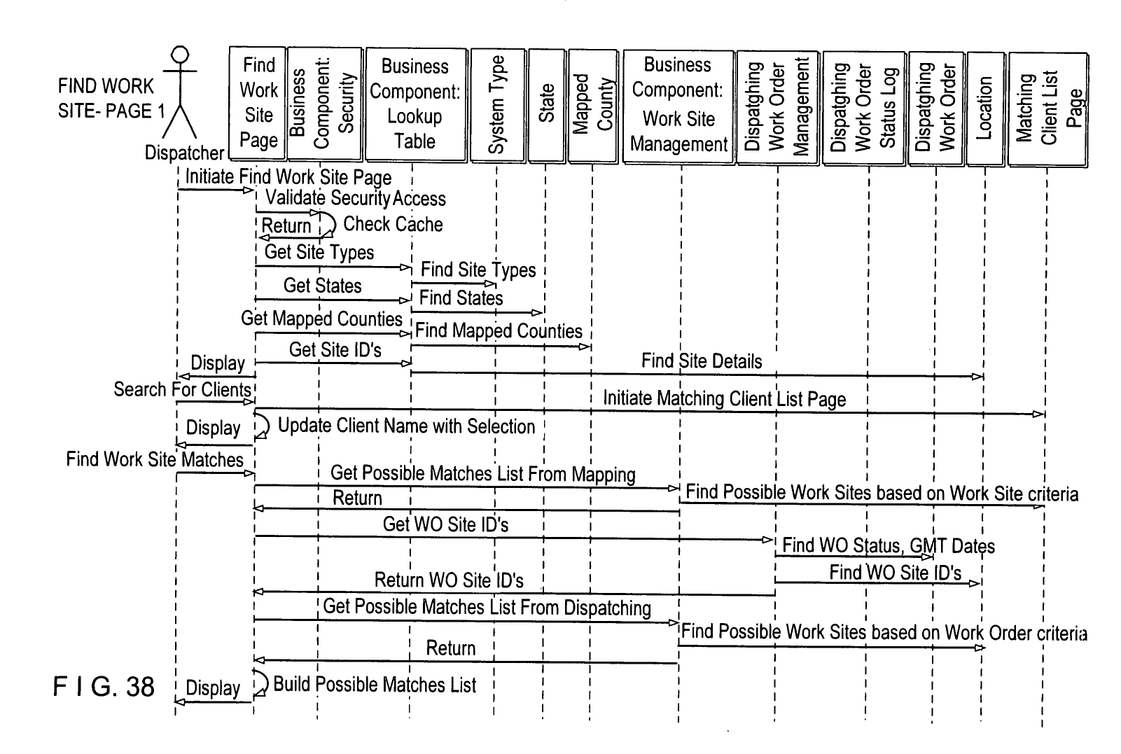

The steps performed by the Find Work Site function are shown in FIG. 38 and are outlined below.
(a) Initiate Find Work Site page: The user starts the work site interface shown in FIG. 34A. If initiated from the Dispatching application, work order related fields are made visible in the search criteria. If not already started, the Mapping application is started in a separate browser and the interface is displayed showing all entry fields empty. No cookies are maintained for search criteria previously used.
(b) Enter Search Criteria Details: The User enters selection criteria that will be used to locate possible matches when the Search pushbutton is selected. This can be any combination of Work Site details such as Site Type, Site Name or address and/or Work Order details such as Client Name, Work Order Status and status date range.
(c) Find Possible Matches: The user selects the Search pushbutton to find possible matches to existing work sites, based on the selection criteria entered. If Work Site related criteria is entered, a list of possible matches will be retrieved from the system database. If Work Order related criteria is entered, a list of possible matches will be retrieved from the Dispatching application's database. If more than 20 sites (for example) are returned, the first 20 are displayed; the user can scroll through the list by requesting 20 at a time.
(d) Refine Search: The page stays active to allow the user to refine the search by repeating steps (b) and (c) as many times as necessary until the subject work site is shown in the list box.
(e) Locate Work Site: The user selects the subject work site in the list box and selects the Locate pushbutton to go the map location where the selected work site exists. The Find Work Site page is closed, and the Mapping Application map is displayed showing the location of the selected work site.
(f) Cancel Find Work Site Request: The user may choose to cancel the Find Work Site request by closing the page. No search is initiated, the Find Work Site page is closed and the previous page is displayed (control returns to the Work Order Management application if the Find Work Site request was initiated there).

14. Select Work Site

This use case provides the ability of the user to identify which work site(s) are to be displayed (or not displayed) on the map. The user can only “turn on” or “turn off” work sites for display on the map; turning off a site does not remove the site from the system database. If a work site selected for display is outside the current default map area of the user, the map will not scale to make the new work site viewable; rather, the user should issue a Find Work Site request if he needs to see the location of the work site and does not know where it is. Turning on or off a work site for display is considered part of the user's configuration. Therefore, the user can save the configuration so that it will be displayed as defined on subsequent logins. Otherwise, the user is notified upon logout that the configuration changed and the ability exists to save the configuration at that time.

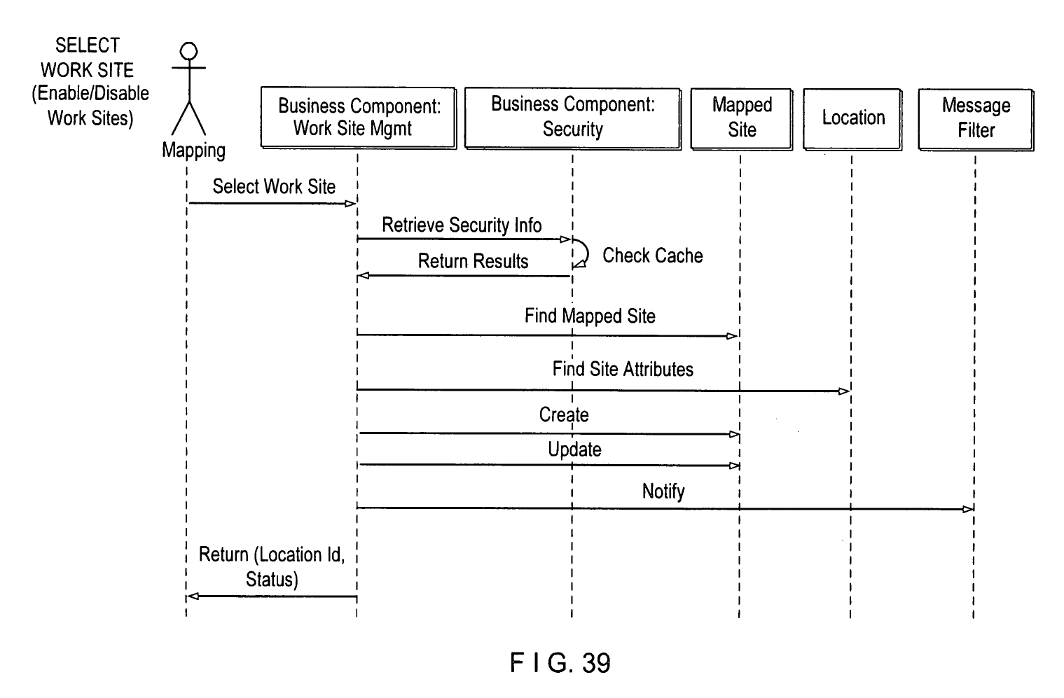

The functional steps performed by the Select Work Site function are shown in FIG. 39 and are outlined below.
(a) Select Work Site: The mapping application sends a select work site method to the customer server when the user has checked on/off a site from either the home or job site list.
(b) Retrieve Security Info: The security component is called to retrieve security information related to the user such as which customer they belong to and their role and personal ID.
(c) Find Mapped Site: Determine if the site exists in the mapped site table.
(d) Find Site Attributes: If the site did not exist in the mapped site table, the attributes of the site are retrieved from the location table.
(e) Create (Mapped Site): If the site did not exist in the mapped site table, a row is created. The display flag is set appropriately.
(f) Update (Mapped Site): If the site did exist in the mapped site table, the display flag for the site is updated appropriately.
(g) Notify Message Filter: The message filter is notified that a site is turned on/off for display so that it can begin or stop sending messages related to the work site.

15. Send Site Puree Communication

This use case is performed by the core business logic. It is triggered when the user has removed a work site and the work site has not already been purged from the tracker's memory, or a vehicle dispatched to the site has not yet arrived. It is also triggered when the user has completed or canceled a work order and requests the removal of a job site from the tracker. A message is sent to the affected tracker(s) through the wireless gateway.

The gateway sends site purge messages in the same manner that text messages are sent. The tracker acknowledges all received purge messages even if the identified site has already been purged from the tracker memory. When the gateway receives the acknowledge, it will stop repeating the purge message; otherwise, the RMR will continue to attempt to deliver the message.

E. Administration

The Administration Function subsystem 119 of the overall software system structure of FIG. 10 spans administration performed at the system and customer level. It encompasses setup of customer accounts, user accounts, user roles and data set access, login/logout, application download, access to data by clients of customers, and customer vehicles, sensors, messages, and resources.

The purpose of the Customer Asset Management Function is to provide the ability for the customer to define his resources (people), vehicles, and sensors. The Customer has the ability, once vehicles and resources are defined, to manage the relationship between a resource and vehicle. The Customer has the ability to define sensor message text, severity, sequence and exceptions that will cause alerts. The customer also has the ability to define exception classification regarding the sensor, examples of which have been cited earlier in this specification. The purpose of the Client Management Function is to provide the ability for the customer to define its clients and any leasing agreements they may have with other companies. The purpose of the Customized Feature Management Function is to provide the ability for the customer to define company defaults, which involves defining map defaults and structure (including the ability to add new roads) and other features such as password requirements and color usage.

The purpose of the Maintain Code/Lookup Tables is to provide the ability for the Customer to define such things as messages, asset types, job codes (or other system type codes), skills and events used. This allows the Customer to define messages and codes specific to itself and its industry. A set of standard messages, job codes, skills and events will be supplied by the gateway when a customer is activated and a user with administrator privilege has the ability to change, delete or add new ones that make sense for it.

The Customer Setup Function provides the ability to create a new customer in the web site, e.g., the griddata.com web site. It also allows the system administrator to provide support in the form of changing passwords for the customer.

The System Access Function provides the ability for a user of the web site to log in and log out of the web site. It also supports the ability to load the mapping application.

The Role Management Function provides the ability for a user with administrator privilege to maintain user accounts, roles and dataset authorization tied to the roles. User accounts define the user and role the user is assigned to. Roles are a collection of capabilities and configuration defaults that a User Account may exercise when accessing the web site. Datasets are a logical grouping of a customer's data that provides the ability for the customer to define which data they may want to partition and allow access to. In the current embodiment, datasets are only used to partition vehicles.

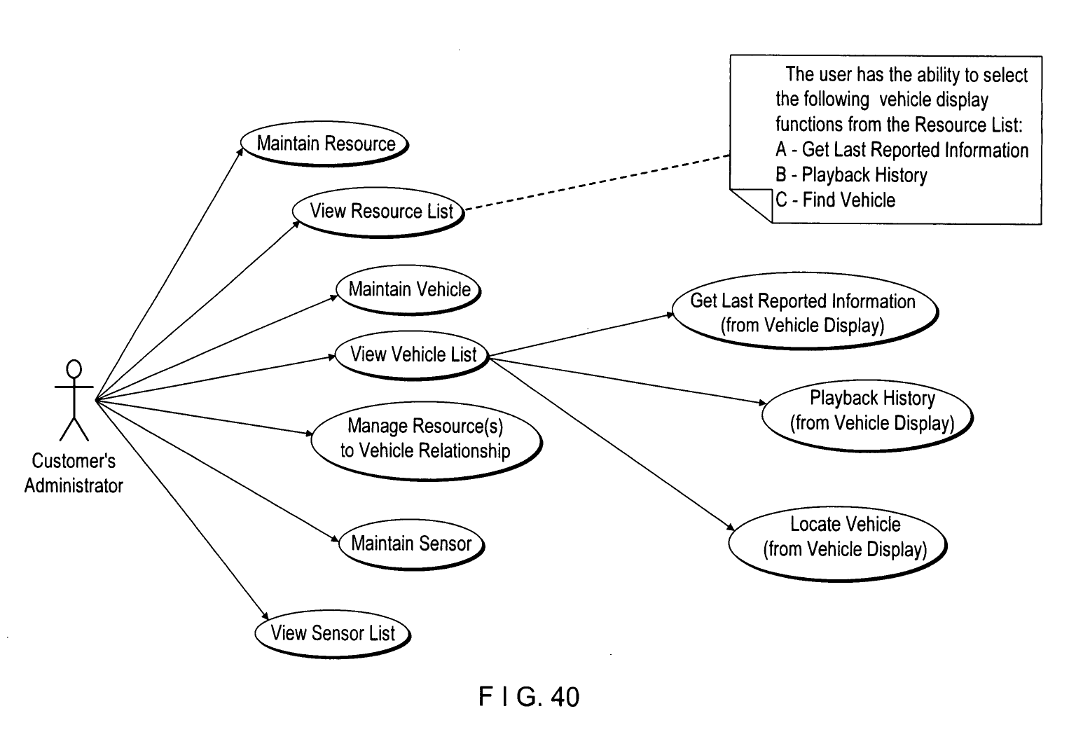

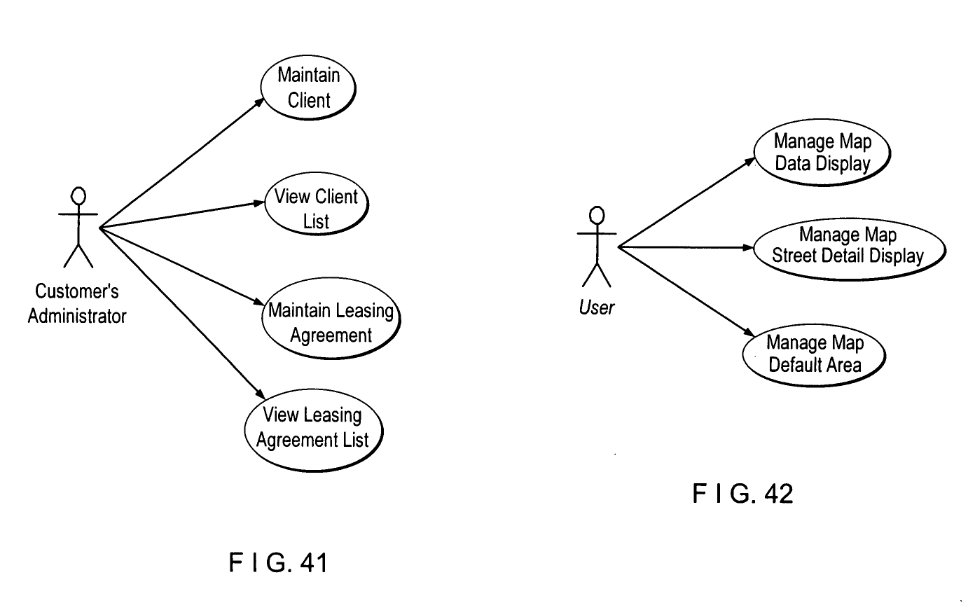

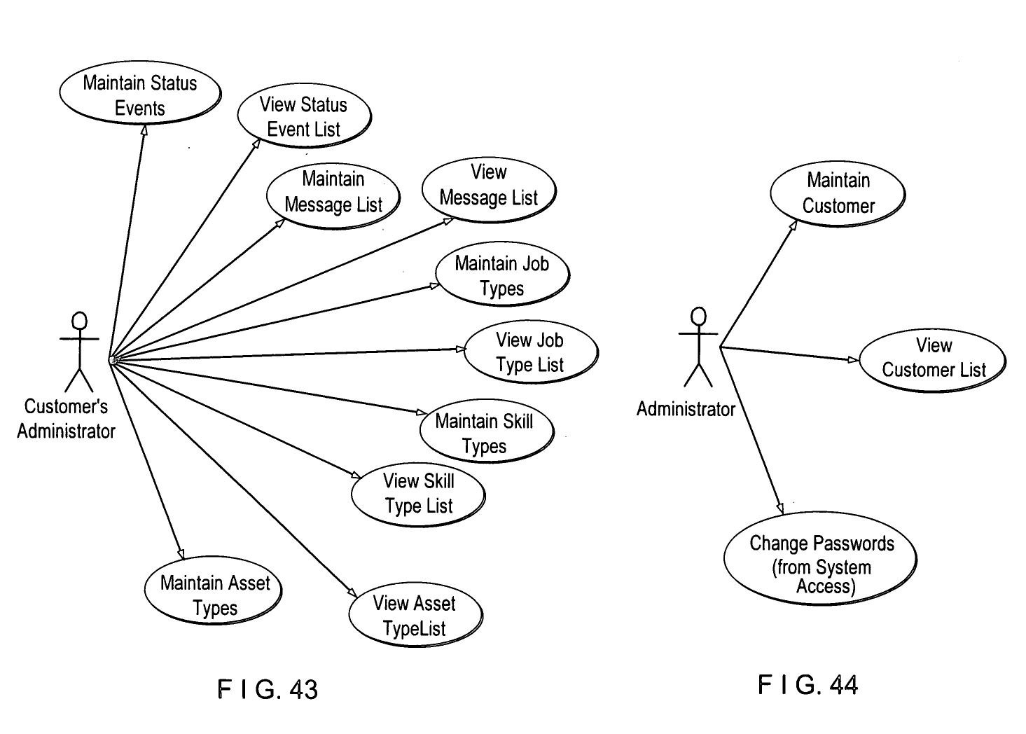

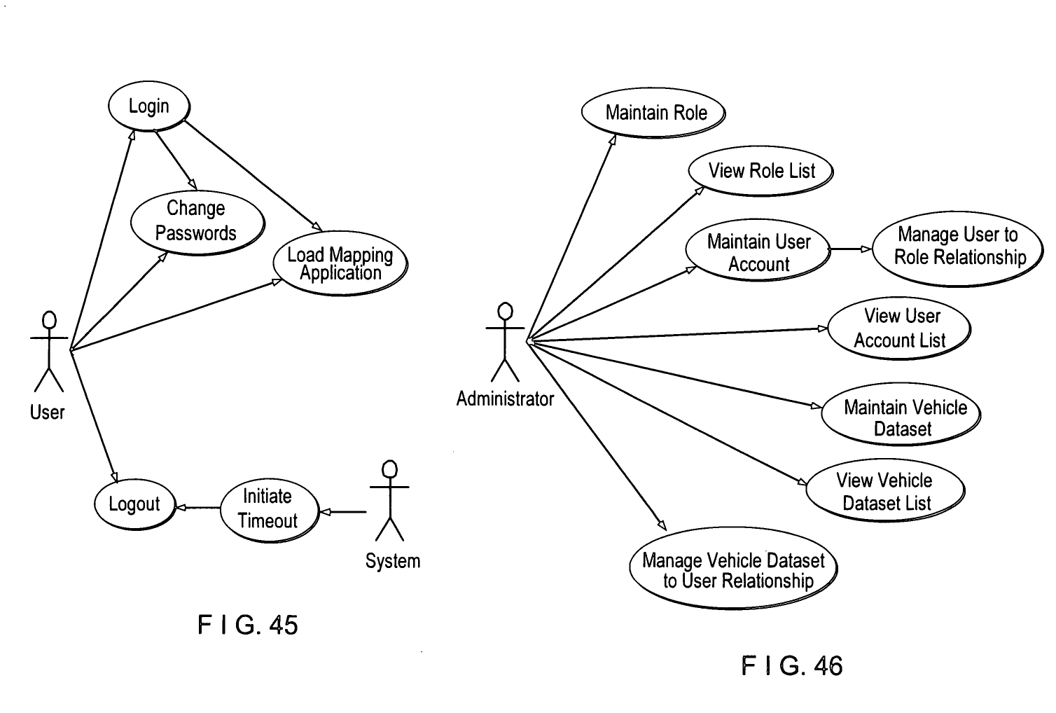

The functions of these use cases are described below. The structures of the Customer Asset Management, Client Management, Customized Feature Management, Maintain Code/Lookup Table, Customer Setup, System Access, and Role Management functions are illustrated in the functional diagrams of FIGS. 40 through 46, respectively.

1. View Resource List and Maintain Resource

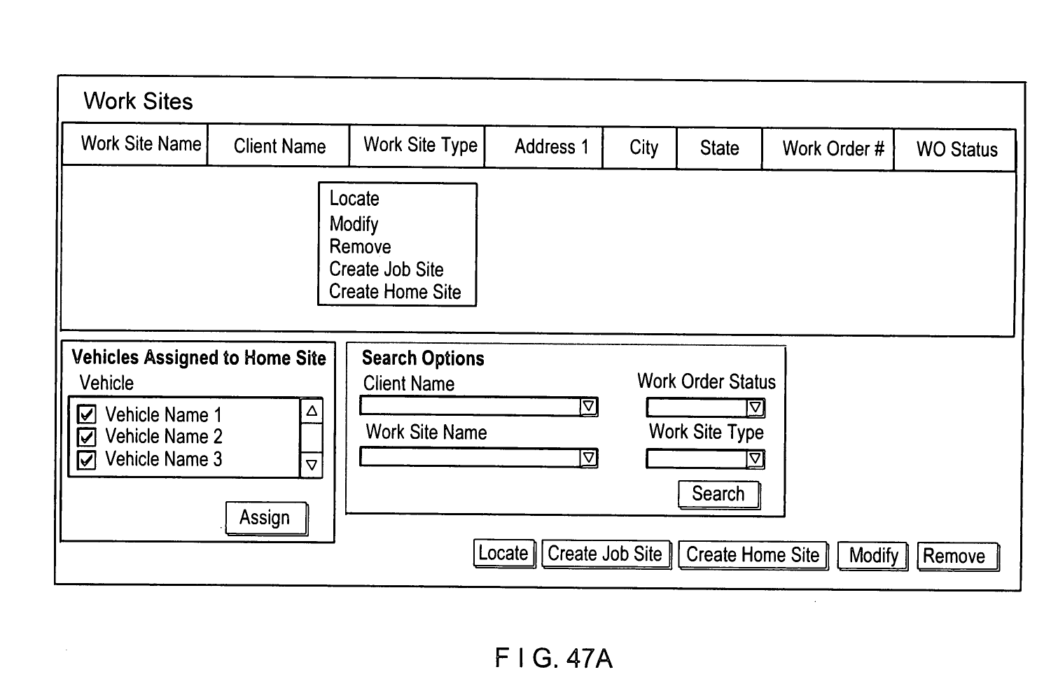

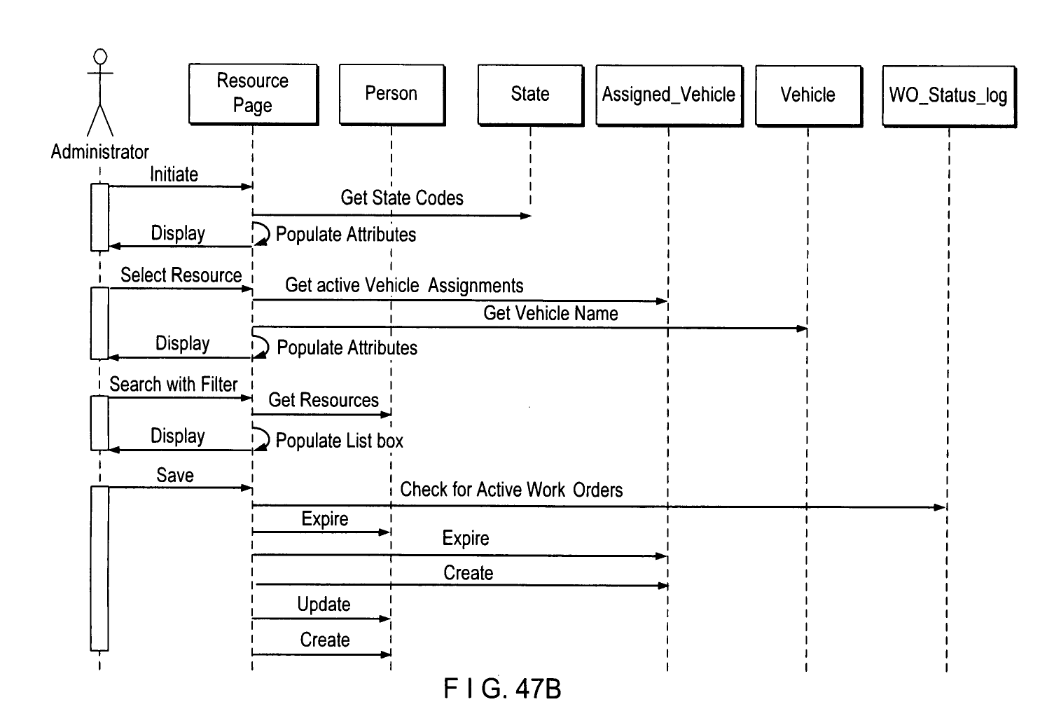

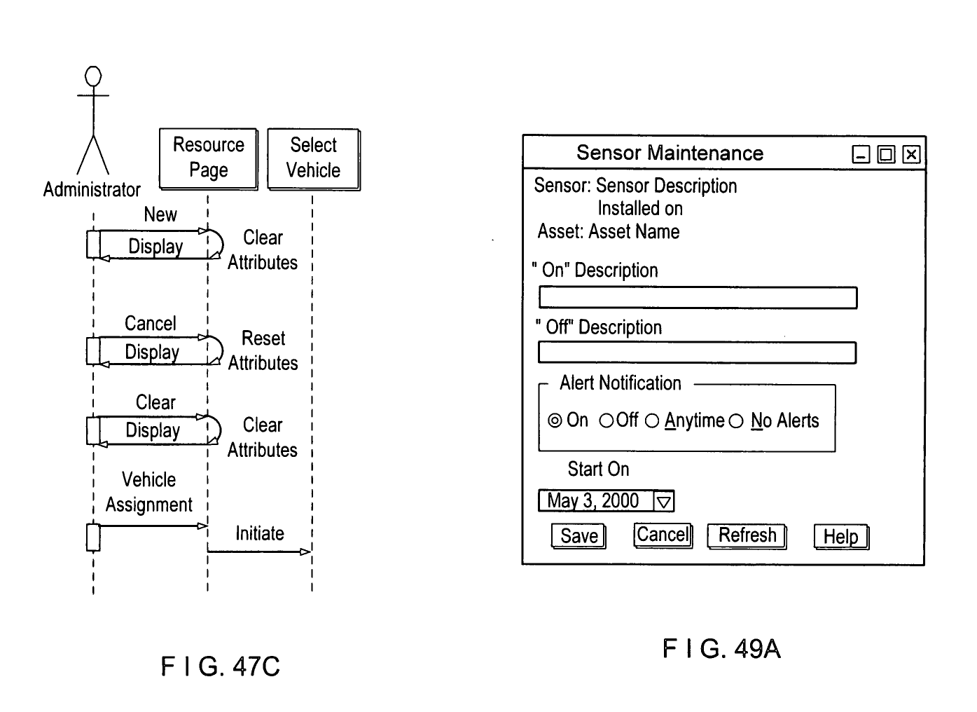

The View Resource List and Maintain Resource use cases are discussed together because they share the same user interface. Resources are assumed to be people: employees or contractors of the customer. View Resource List provides the ability for the user to see all of the customer's resources and their vehicle assignments. Once the list is displayed, a resource may be selected and its attributes modified. These functions are available from the dispatching application. The user interface for these functions is shown in FIG. 47A. It is simplified somewhat from that described below in that some of the search and sorting parameters are not shown in the Figure.

The resource list may be filtered on attributes such as skill sets, available (or active) resources, and assignments (vehicle and vehicle to work order) are provided. Once the list is displayed, the ability to sort the list based on the attributes mentioned above is provided. If the resource is assigned to a vehicle, the user has the ability to select the resource and ask for vehicle display functions such as Find Vehicle, Playback History and Get Last Reported Information. In those cases, the mapping application will be initiated.

The Maintain Resource function is used to initially set up a resource, or edit, expire, or delete an existing resource. It provides the ability for the user, usually with administrator privilege to create, update, or delete the resource profile for each employee and contractor. This information then forms the basis for assigning drivers and crews to vehicles (see Assign Resources to Vehicle). The information maintained is not intended to identify enterprise users of the system, it is intended for managing field service representatives or vehicle drivers that would be dispatched using the system. The interface provides the ability to identify attributes of a resource (some attributes may be required while others are optional), such as: name, employee ID, home address, title, telephone number, status (e.g., identifying the resource as an employee or contractor), special skills of the resource, effective dates, and comments or notes. A resource can be modified at any time, regardless of its current state, even resources that are expired (or no longer with the company). A resource that is created in error can be deleted. However, most resources cannot be deleted. Rather, an expiration date is used to indicate the resource is no longer available.

The functional steps performed by the Dispatching application when the Resource interface is activated are shown in FIG. 47B and continued in FIG. 47C. When the page is started, the database is queried for the customer's resource status codes, vehicle assignments, and vehicle names. Implicit in the operation of getting vehicle data is the verification with the CIS security component that the user has the authority to view the vehicles. If a vehicle is selected, home site assignments are retrieved from the gateway (e.g., griddata.com).

These allow the interface to be populated. Then the resources themselves are extracted from the database based on any search criteria that the user may have supplied. A resource may then be created, or an existing one may be selected and updated.

The user can enter data into the required fields of the interface and create a new resource by selecting the New button. Mistakes in a new entry can be completely removed by selecting Clear. Any changes to an existing resource or adding a new one and pressing Save causes the application to update the appropriate parameters in the database related to that person. If a resource was deactivated, the resource is expired as long as there were no active work orders assigned to the resource. Changing a vehicle assignment causes the previous vehicle assignment to be expired and the new one to be created.

2. View Vehicle List and Maintain Vehicle

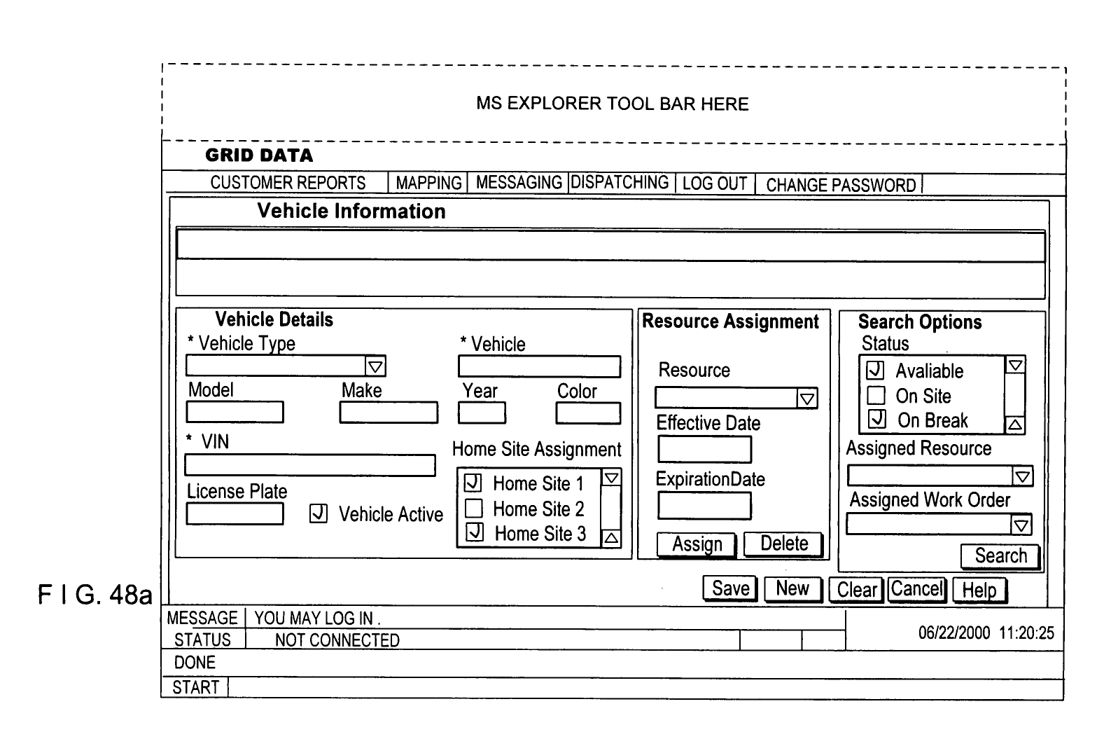

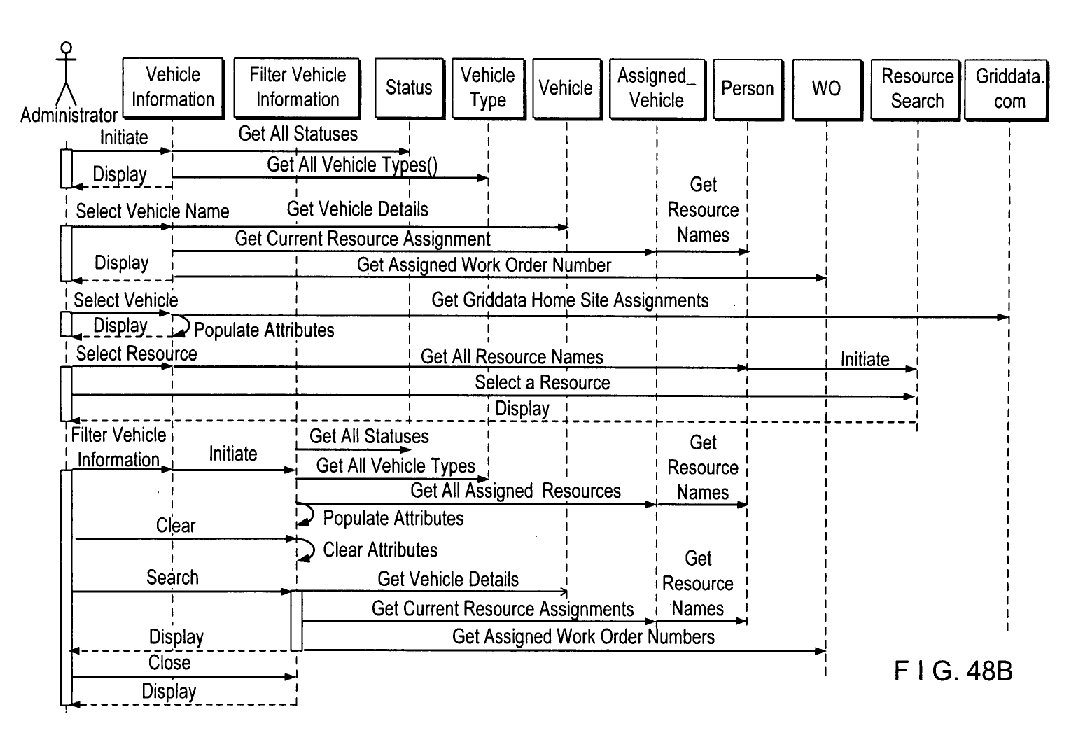

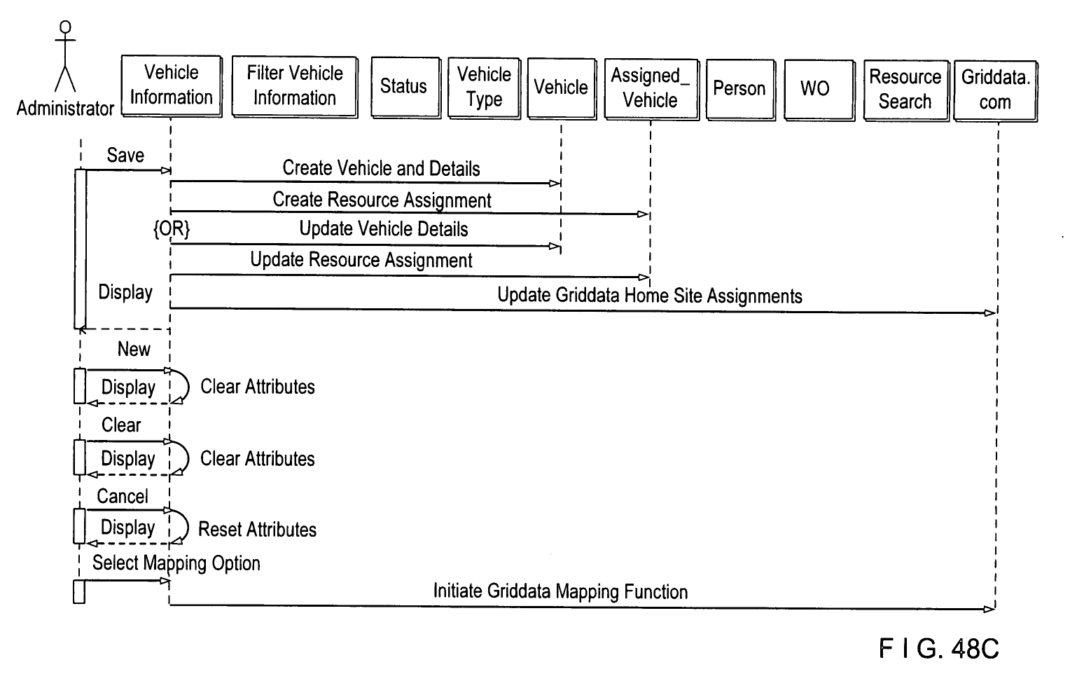

The View Vehicle List and Maintain Vehicle functions are discussed together because they share the same user interface. The user interface is shown in FIG. 48A. These functions provide the user with the ability to add, remove, or update parameters for fleet vehicles that are tracked by the gateway. This function is used when a new vehicle is obtained and the tracker has been installed, when a vehicle is taken out of service, or when information regarding a specific vehicle needs to be updated. Some attributes are required while others are optional, and some attributes may only be maintained by a gateway administrator (these attributes the customer may only view). Attributes include: vehicle ID number (VIN), make and model; name; vehicle type (as identified by the client); alias name associated with an active work order; “retirement” information or effective dates; map display symbol and color; special equipment or capabilities of the vehicle; whether the vehicle is leased (See Maintaining Leasing Agreement Information); home site assignments, tracker serial number and ID Number; and update rate. Tracker serial numbers and update rates are examples of parameters that the customer may only view but not change. The interface shown in FIG. 48A is a streamlined version of the customer interface and shows a subset of the possible parameters. A vehicle created in error can be deleted. However, most vehicles cannot be deleted. Rather, an expiration date is used to indicate the vehicle is no longer available.

Normally, a gateway administrator will create vehicles for customers as trackers are installed. However, a customer user may create a vehicle for which a tracker has not been installed. This vehicle cannot be communicated with until the tracker is installed (for example, no messages or vehicle location updates will occur).

The View Vehicle List function provides the user with a method for displaying and searching for vehicles belonging to the customer. The user will only see the list of vehicles that user is authorized to view, including both owned and leased vehicles. The list is available for display from either the Dispatching application or the Mapping application. However, when initiated from the Dispatching application, additional search parameters and status related to work orders are available. Searching capabilities on attributes such as name, assigned resources, assigned work orders, active vehicles, and on attributes such as make and model, or home site assignment are available; and, once the list is displayed, the list may be sorted by the attributes mentioned above.

The user interface shown in FIG. 48A has four areas: the top is the current list of vehicle based on specified search parameters; the lower left has vehicle details for the selected (or newly being entered) vehicle; the lower middle has resource (driver) assignments for the selected vehicle from the Dispatching application; and the lower right has additional work order information for the vehicle from the Dispatching application.

The functional steps performed by Maintain Vehicle and View Vehicle List are shown in FIG. 48B and continued in FIG. 48C. When the user interface display is initiated, the application first retrieves vehicle status codes and types from the system database. An initial list is displayed of the first 20 vehicles (for example) with resource assignments and work orders, if initiated from the dispatching application. Implicit in the operation of getting vehicle details is the verification with the CIS security component that the user has the authority to view the vehicles. If a vehicle is selected, home site assignments are retrieved from the gateway (e.g., griddata.com).

To reduce the size of the vehicle list, the list may be narrowed by searching (filtering). A value for any of the displayed parameters may be supplied, and a search command is issued to return vehicle details; resources and work order data are retrieved, and the reduced list, if there are matching vehicles, is displayed.

If changes are made to a vehicle's details such as make, model, or year, or to the assigned resource or home sites, the new data are saved to the database as shown in FIG. 48C. Data are stored by the application to the vehicle and assigned vehicle tables. Selecting New, Clear, or Cancel, will cause the attributes to be cleared or reset, respectively.

3. Manage Resource(s) to Vehicle Relationship

This function is used when a user is assigning a vehicle to a work order, or making one-time/permanent assignments of a vehicle to a driver (resource), or removing the assignment of resource(s) to a vehicle. It provides the ability to assign a driver (or crew) to a vehicle, as either a permanent or a temporary assignment. The ability to remove the assignment is also available. If necessary, the user has the capability of matching special skills of a driver/crew to the proper vehicle. This includes matching a driver/crew to the vehicle requirements (or capabilities) or matching driver/crew to skill sets required to fulfill a work order. The user has the ability to define an alias vehicle name based on the resource/crew assignment, which will be of interest only to specific industries. For example, a fire truck being dispatched with only fire personnel on board may be referred to as F10, whereas a fire truck with a paramedic on board may be referred to as FP10. Different industries will assign a vehicle to a driver once a day, once a week, once per project, at the time of the dispatch (work order), or the driver may always belong to a particular vehicle.

Resource to vehicle relationships are managed through the vehicle and resource interfaces already defined. These interfaces have meaning in the context of the Dispatching application. Whether performed in the resource interface or the vehicle interface, changes to the assignment of a resource to a vehicle cause the vehicle assignment table in the database to be updated by the application when the changes are saved. These sequences are shown respectively in FIG. 47B and FIG. 48B.

4. Maintain Sensor

This function is used when the user is establishing the sensors to be used on a vehicle or type of vehicle, or when the user is changing or deleting any sensor defaults. The use case provides the capability of creating, modifying and expiring sensor defaults. For each installation of a sensor to a vehicle (asset), the Customer can define message text, severity level and expected sequences of messages related to a sensor. This allows the customer to define specific sensor messages it wants to see, and to be notified of, configured on a per vehicle basis (or vehicle type). For each sensor, the customer can specify whether it wants to be alerted when the sensor triggers an ‘on’ state, ‘off’ state, or whenever the sensor changes from one state to the other. Specifying when the customer wants to be alerted helps to determine when to send an alert message to the user and how the message should be delivered and viewed in the Message Folder (alerts may be highlighted in red, for example). Changes for sensor parameters require a user with administrator privilege.

The user is not allowed to change all attributes related to the sensor installation, only those fields that are related to what the message text and alert notification will be. The user is not allowed to delete or expire a sensor installation; this capability is reserved for gateway administration personnel only. When the user changes the attributes it is allowed to change, a new sensor installation is created, automatically expiring the previous installation. Each customer has a defined set of sensor messages and their severity; these severities are used for all sensors for the customer, i.e., the individual user does not have the ability to define his own sensor messages/severity.

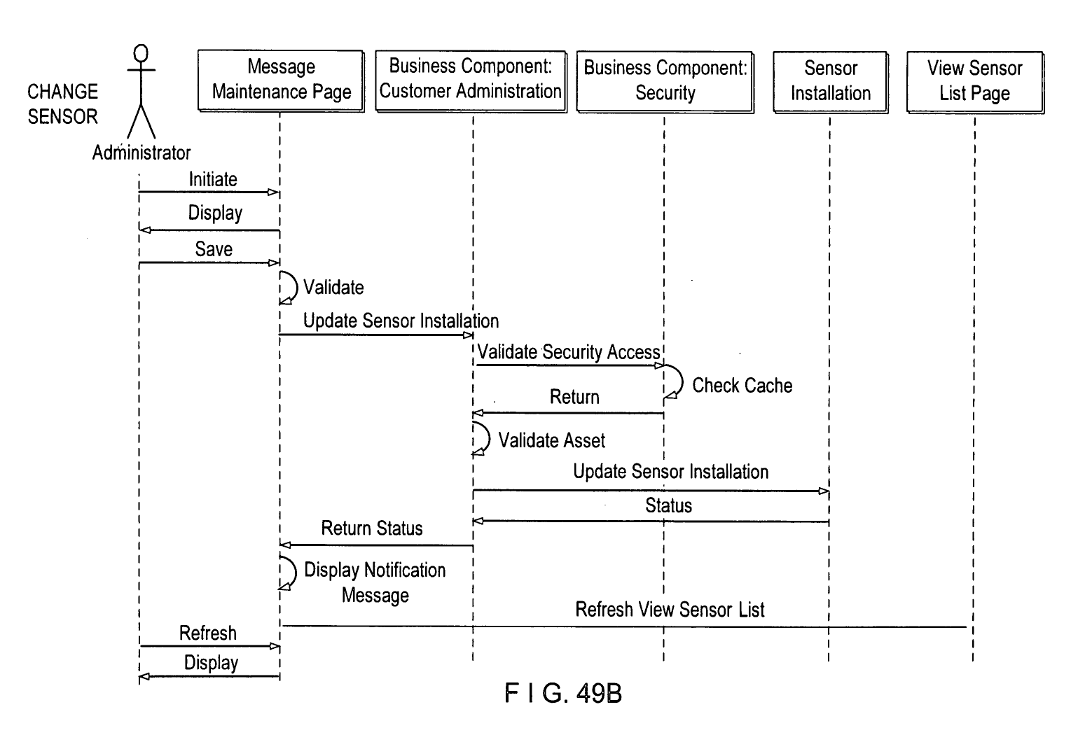

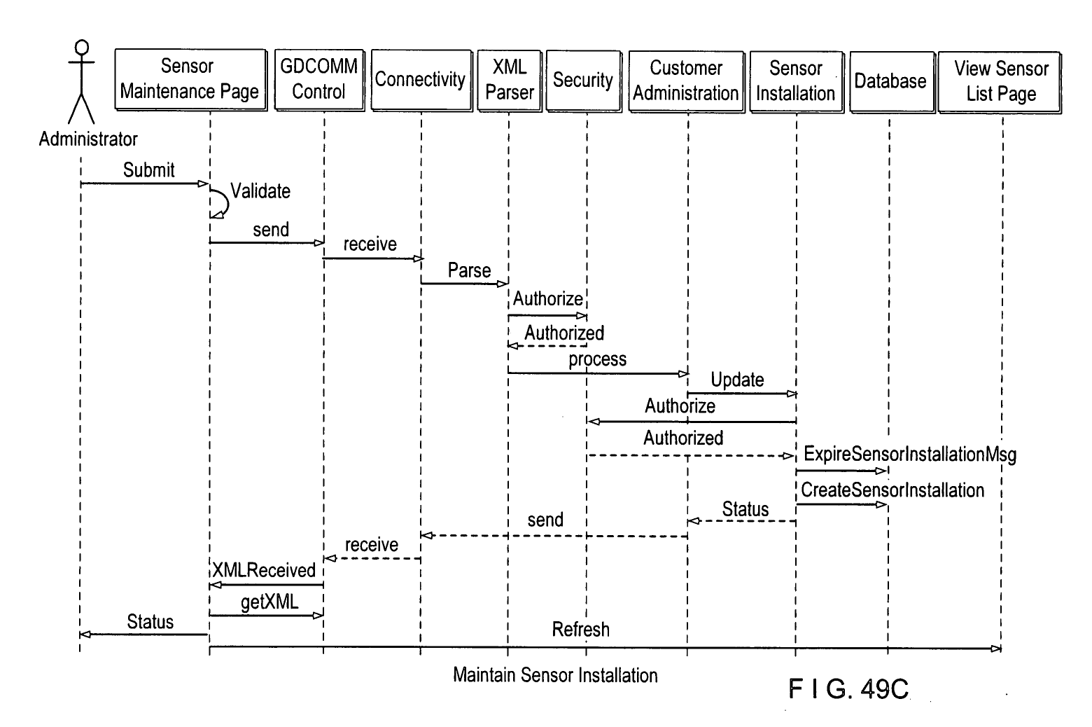

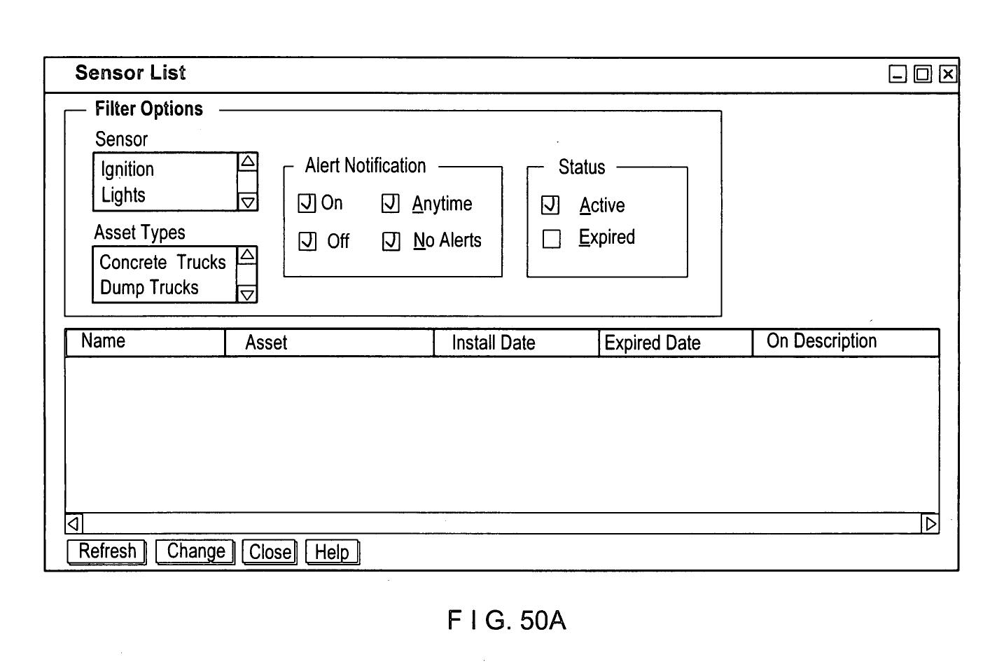

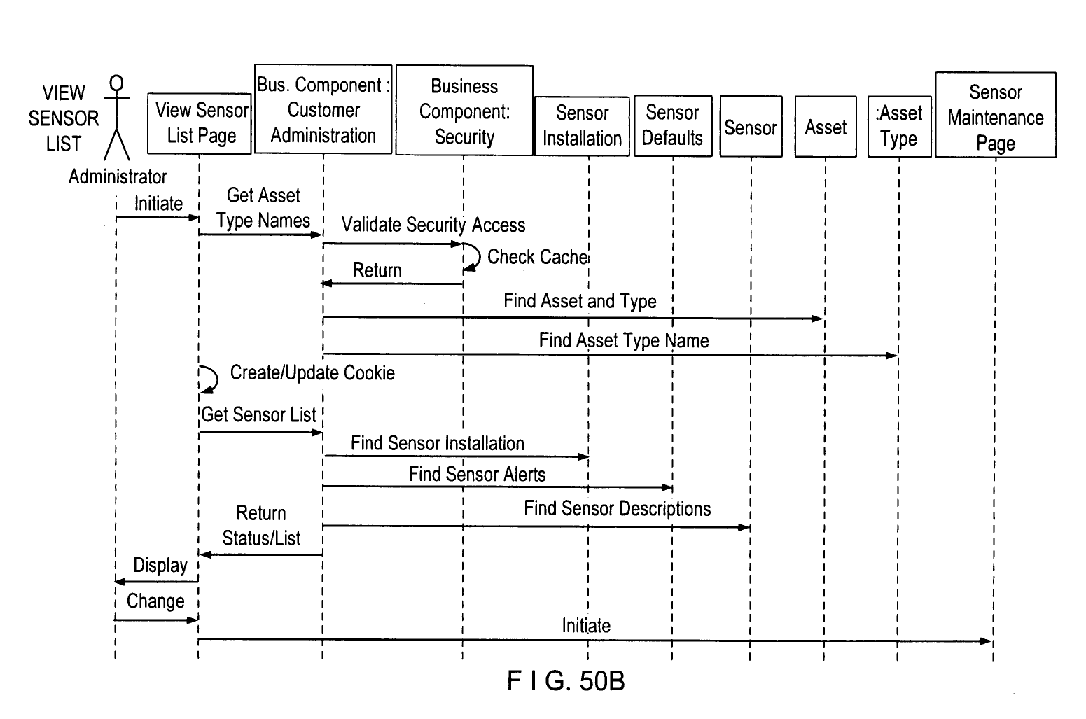

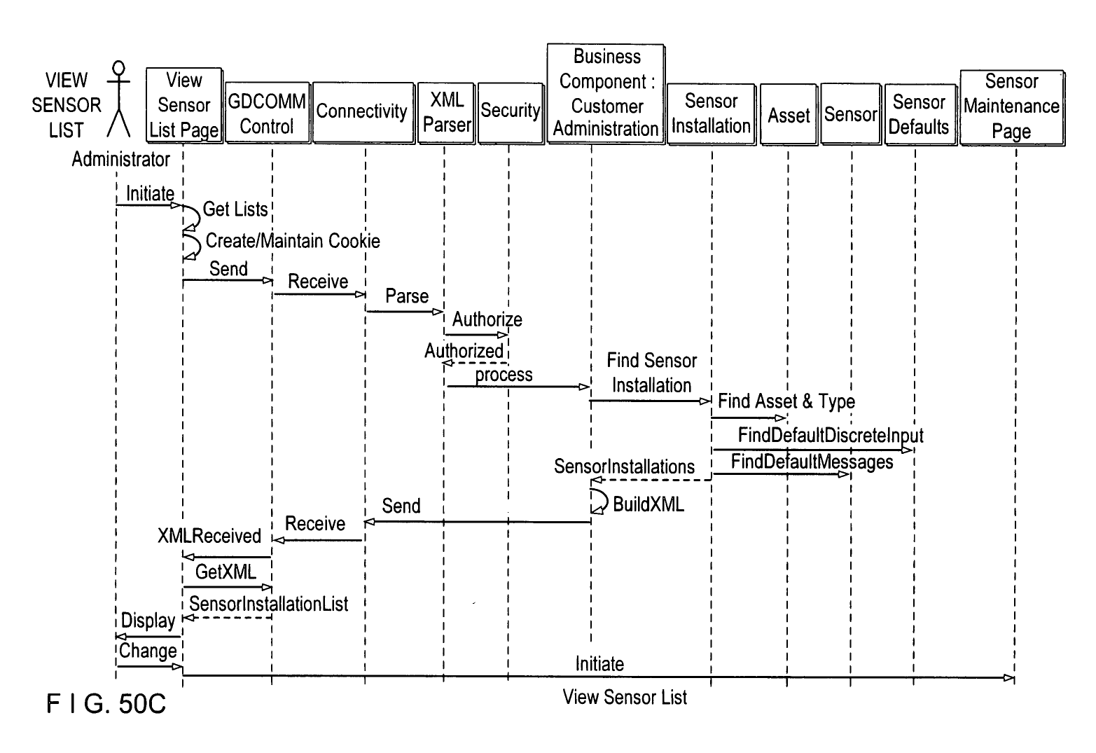

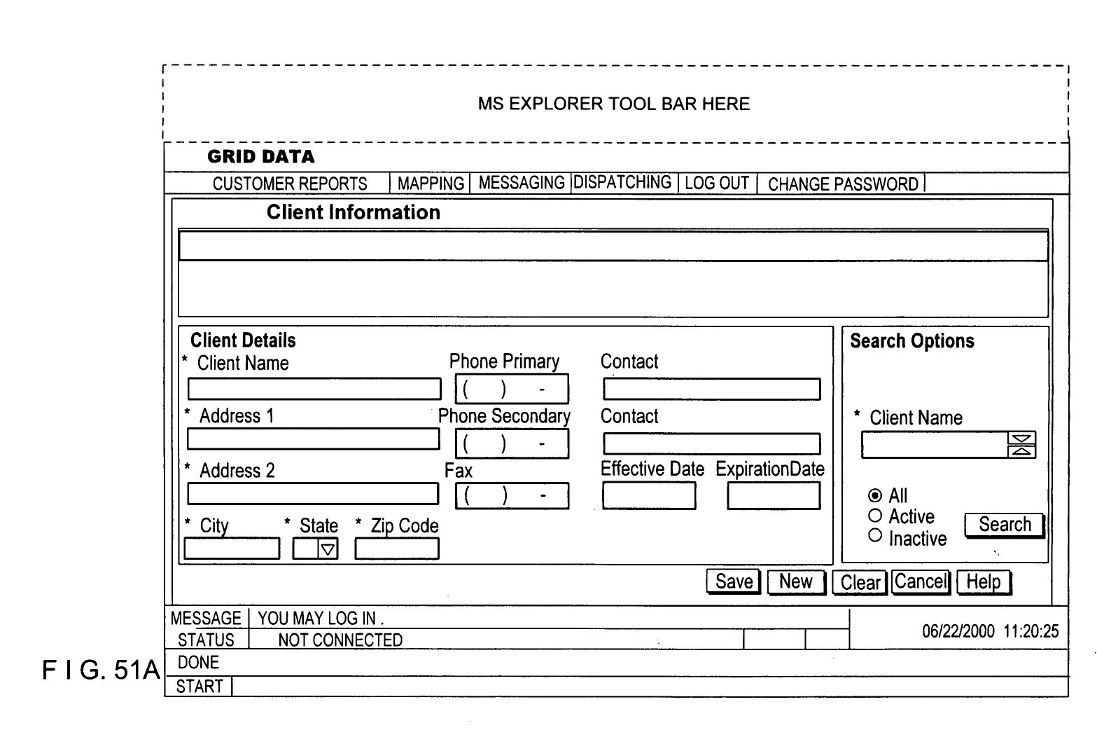

The Maintain Sensor user interface is shown in FIG. 49A. When the sensor is selected from the view sensor list user interface in FIG. 50A, the user is allowed to modify the message displayed when the sensor is turned on and off and whether the user should be alerted of either, neither, or both of the events. Typical on/off sensors are door open/closed, pump on/off, four wheel drive engaged/disengaged, and so forth.

The normal course of action for the user is:
(a) Initiate Change Sensor: The user can initiate changing a sensor from the following:
(b) From the View Sensor List, the user can double click on the sensor.
(c) From the View Sensor List, the user selects the message; right mouse clicks and selects the Change option from the fly-out menu.
(d) From the View Sensor List, the user selects a message and selects the Change push button.
(e) The Sensor Maintenance page is displayed with the attributes of the selected sensor installation.
(f) Enter Details: The user can change any attributes of the sensor listed on the Sensor Maintenance page except sensor description and asset name.
(g) Refresh: If the user wants to return to the original values, selecting the Refresh pushbutton redisplays the page.
(h) Save: The user submits the sensor installation for update to the database.

The functional steps performed by the application when a sensor parameter is changed and the user selects save are shown in FIG. 49B. The detailed sequence is shown in FIG. 49C. The change is submitted to the CIS via the XML interface. After security is checked, the Administration component of the CIS stores the change in the system database. After the change is successfully made, the Sensor List is refreshed with the new data.

5. View Sensor List

This function is for a user who wants to see all the sensors defined for the customer. It provides the capability to view a list of all such sensors. Filtering capabilities are available, such as the ability to select a list based on sensor name, asset assignment, alert notification (severity) and active or expired sensors.

The View Sensor List user interface is shown in FIG. 50A. The interface allows filtering the list of sensors based on type of sensor, type of vehicle (asset), or alert notification mode. Selecting Refresh after one of the filter parameters has been changed will cause the list to be redisplayed with the new filter in effect. The user interface as the following features:

(a) Initiate View Sensor: The user selects the Sensor List link from the System Administration application. The sensor list is displayed showing sensors based on the last filter options or all active sensors are displayed (if there are no previous filter options).

(b) Refresh List: The user can select various filter options and then the Refresh push button. The sensor list is displayed depending upon the filter options selected.

(c) Change Sensor: The user can choose to change a sensor, in which case they are transferred to the Sensor Maintenance page described above.

(d) Close List: When the user is finished viewing sensors, they select the Close push button.

The functional steps performed by the View Sensor List function are shown in FIG. 50B and the detailed sequence design is shown in FIG. 50C. When View Sensor List is initiated, the application requests the assets and their types. This is done through the XML interface to the CIS. After security checks are passed, the vehicles (assets) are returned from the system database. The same is performed for the sensor list where the sensor types and the vehicles in which they are installed must be retrieved from the database. The results are provided back to the sensor list page. Selecting Change, launches the maintain sensor interface described above.

6. View Client List and Maintain Client

These functions allow the user to view the list of clients the customer has and to modify client information. Clients use services of gateway customers, and clients of customers may themselves be gateway customers. Maintaining client information is primarily required for the Dispatching application; the gateway does not use client information for its business logic.

The function provides the ability to create, modify, or delete information about the customer's clients, as well as the ability for a user with administrator privilege to create the initial profile. The user may enter the name, address and other pertinent data such as contact information. A client created in error can be deleted. However, most clients cannot be deleted; rather, an expiration date is used to indicate the client is no longer active. The client list view can be filtered and searched based on client name and active or inactive client status. Once the list is displayed, it may be sorted according to the attributes mentioned above. The list displays a meaningful subset of client attributes. If the user wants to see all details of a client, it can select a client on the list and the client details become visible.

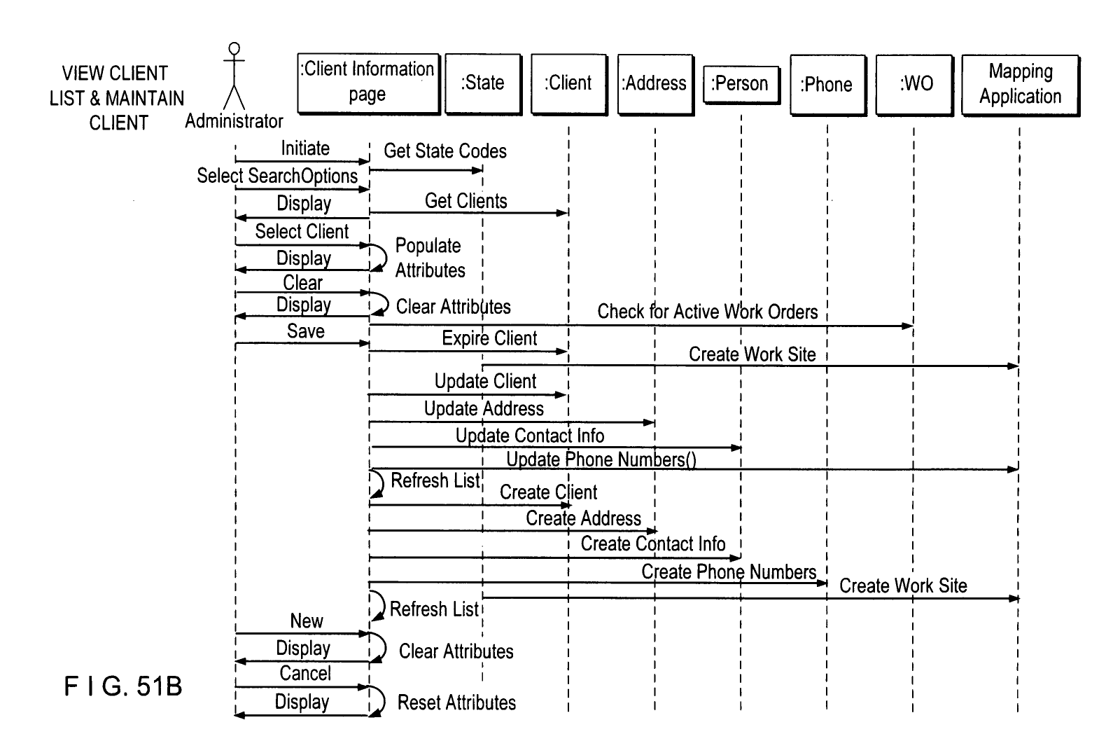

The View Client and Maintain Client user interface is shown in FIG. 51A. The top part of the display shows the list, the bottom left shows the details for a selected client or provides data entry fields for modifying data for an existing client or adding a new client. The bottom right shows the search criteria for searching and filtering the client list.

The functional steps performed by the View Client and Maintain Client functions are shown in FIG. 51B. When the page is opened, the Dispatching application database is queried for the client state codes. When Search is selected by the user, customer client information is extracted from the database to populate the list using the search criteria specified by the user. When a client in the list is selected, the details are shown in the lower left of the display. Selecting Clear, clears the attribute fields in the lower right of the display. If attributes for a new client are added or attributes are modified and Save is selected the following occurs:
(a) If an existing client is not associated with any existing work orders, it is expired.
(b) If the Use Client Address option is selected, the client's address will be used as a default for job sites related to work orders for that client. The Mapping application is activated to create a site for the client.
(c) The client address, contact information and other attributes are then stored in the database.
(d) The client list is refreshed.

7. View Leasing Agreement List and Maintain Leasing Agreement

Leasing agreements enable customers to share vehicles. This occurs when an owner of fleet vehicles provides tracker equipped vehicles to clients on a rental, for hire, or lease arrangement, and wants to provide the client with access to the gateway to monitor those vehicles. As long a the client is a customer, the owning customer can set up Administration Rights for the client to have access to the data for a specified period of time for a specified set of vehicles. These functions enable the customer user, typically a user with administration privileges, to create, modify, and cancel leasing agreements.

The View Leasing Agreements function is used when the user wants to view leasing agreements. Filtering capabilities on attributes such as client, start/end date, and active/inactive leases is provided. Once the list is displayed, it may be sorted by the attributes mentioned above. Once the initial list of leasing agreements has been identified, the user has the ability to see further details of a leasing agreement on the list by selecting that leasing agreement. Any comments associated with the leasing agreement may also be displayed.

The Maintain Leasing Agreement function enables the user create and change lease agreements and change the vehicles being leased. It also allows the user to enter the information specifying the client it is being leased to, effective dates, and a comment area (this free form text area allows the customer to enter any information it desires regarding the leasing agreement). A gateway administrator must support the initial leasing agreement between any two customers so that the name of the customer leasing the vehicles can be visible to the lessor customer.

The user interface for Leasing Agreements is similar to that of clients shown in FIG. 51A. The search options include the addition of lease agreement date range and vehicles leased. The detail section in the lower left contains the client name, the lease agreement date range and the vehicles assigned to the client. Only clients who are gateway customers and who allow their customer name to be visible, through gateway administration, to the customer viewing leasing agreements will be shown.

When the interface is initiated, the application requests the list of available leasing customers (clients) from the CIS, which verifies security and extracts the list from the system database. The user may create a new leasing agreement or modify and existing one. Vehicles may be added or removed, and the time frame may be changed. Once the changes are accepted, a new agreement with customer, vehicles and time range is sent to the CIS. A dataset is created in the system database that enables the leasing customer to have access to the data from the specified vehicles and to have administration rights to those vehicles for the specified time frame. The customer will have access to the data in real time during that period and will be able to generate historical reports on the data for times beyond the expiration of the agreement. For a changed agreement, the original agreement is expired and a new one is created.

8. Manage Map Data Display

This function is used when the user wants to change the county data displayed on his map. The use case provides the ability to change how the map data will be displayed on subsequent entries. The map data defines whether the user wants to see county level detail on the map. For example, for the map to know which streets exist in Maricopa county, Arizona, the user must have Maricopa county selected and it must exist on the user's machine. Street level data from any number ofcounties may be selected simultaneously. When the user changes the selection of county data, it changes his user configuration; these configuration changes can be saved at any time, and the user is notified on logout that the configuration changed and is asked whether the configuration change is to be saved at that time. The user initially receives defaults as defined by the customer, and can change these defaults at any time.

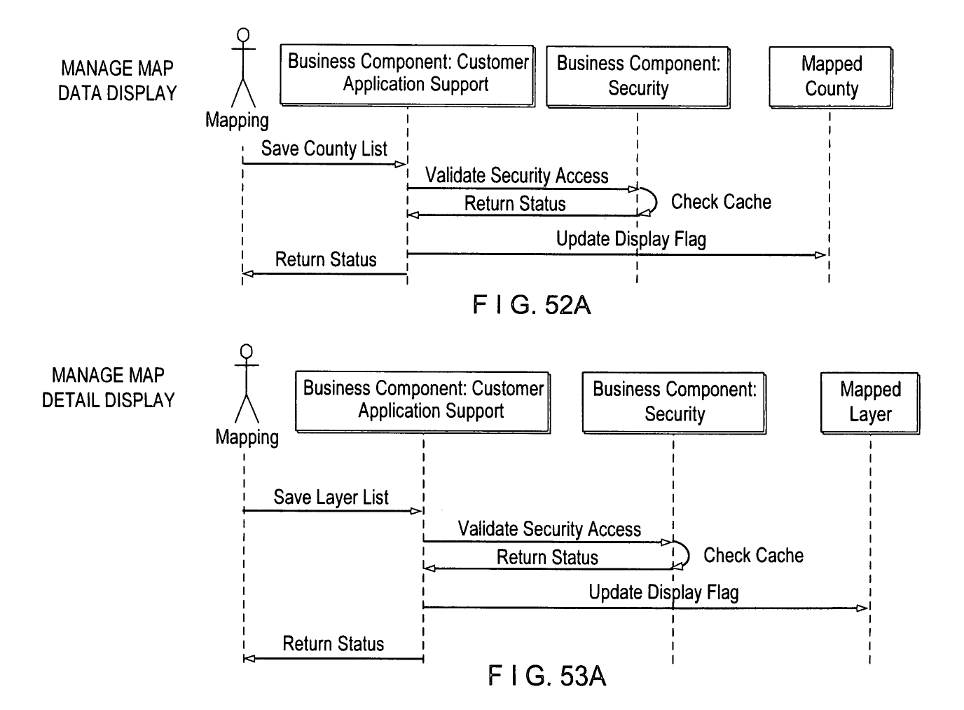

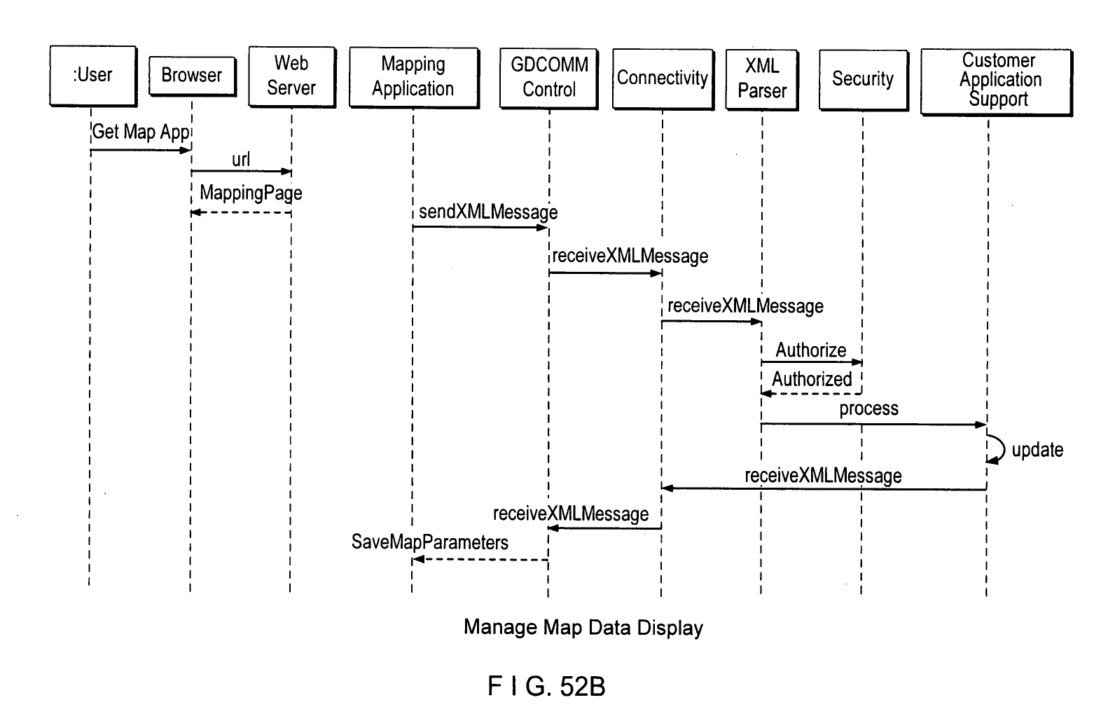

The functional steps performed by the Manage Map Data Display function are shown in FIG. 52A. When the user adds or removes counties from the street level data display, the Mapping application performs the following:

(a) Save County List: The Mapping Application sends a request to save the user's county configuration (county layers).

(b) Status Returned: A status is returned to indicate to mapping that the request was successful.

The detailed sequence is shown in FIG. 52B. The Mapping application sends an XML message to the CIS to store the new county list. If the request passes security, the change is stored in the system database by the customer application support component.

9. Manage Map Detail Display

This function is used when the user wants to change the map display. The use case provides the ability to change how the map detail will be displayed. The user has the ability to define how much detail is to be displayed on the map, commonly referred to as a layer. Examples of a layer the user can choose to see are parks, airports, water bodies, landmarks or zip code boundaries. Other examples could be cited. Changing the selection of layers changes the user configuration, which is handled in the manner described above for the Manage Map Data Display use case.

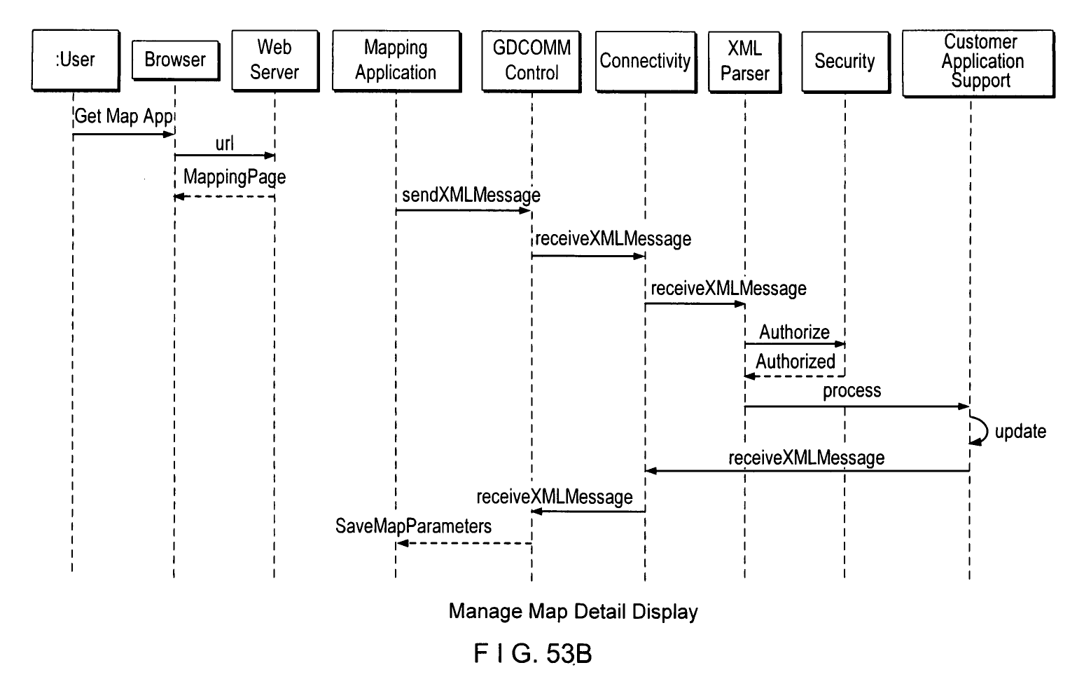

The functional steps performed by the Manage Map Detail Display function are shown in FIG. 53A. When the user changes the layers to be displayed, the Mapping application performs the following:

(a) Save Layer List: The Mapping Application sends a request to save the user's layer configuration (layers).

(b) Status Returned: A status is returned to indicate to mapping that the request was successful.

The detailed sequence is shown in FIG. 53B. The Mapping application sends an XML message to the CIS to store the new layer list. If the request passes security, the change is stored in the system database by the customer application support component.

10. Manage Map Default Area

This function is used when the user wants to change the home extent area of the map. The use case provides the ability for the user to change the default map area, commonly referred to as a home extent, displayed on subsequent entries. The home extent is the area the user wants to see in his map display, such as the Phoenix, Ariz. metropolitan area, each time he logs in. This is not to be confused with map data; this use case identifies the area the user wants to see, not the level of detail. When the user changes the home extent, it changes the user configuration, which is handled in the manner described above for the Manage Map Data Display use case.

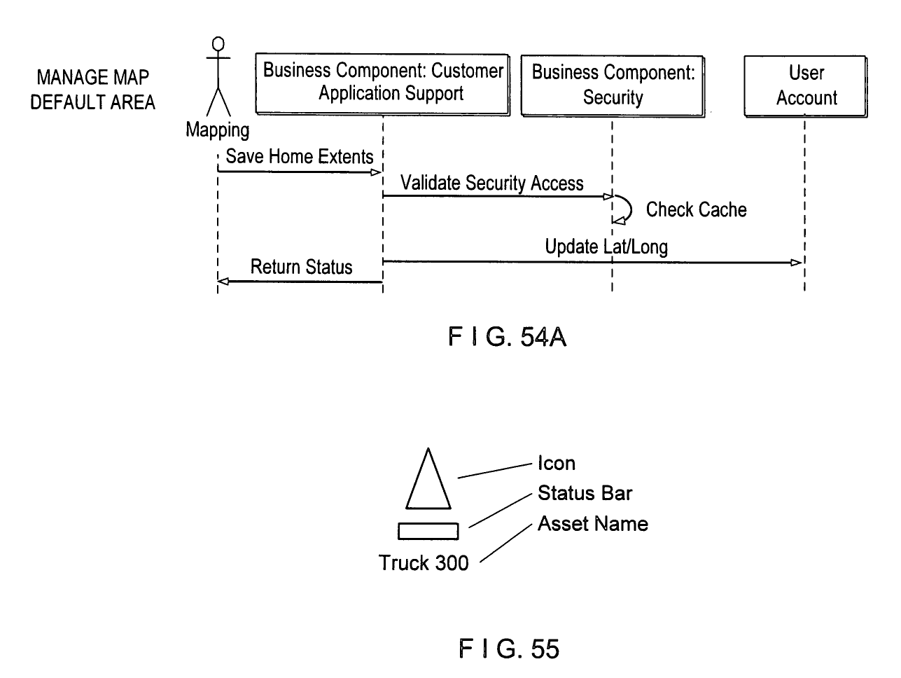

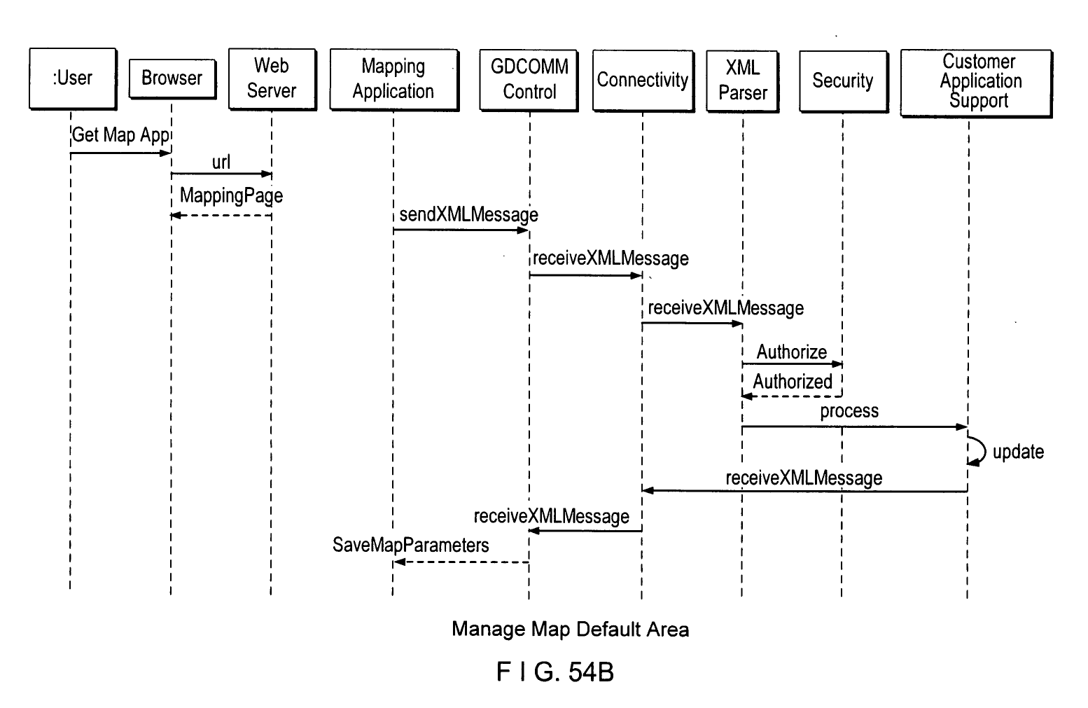

The functional steps performed by the Manage Map Default Area function are shown in FIG. 54A. When the user changes the default home extents of the map, the Mapping application performs the following:

(a) Save Home Extents: The Mapping Application sends a request to save the user's map default area (home extents).

(b) Status Returned: A status is returned to indicate to mapping that the request was successful.

The detailed sequence is shown in FIG. 54B. The Mapping application sends an XML message to the CIS to store the new home extents. If the request passes security, the change is stored in the system database by the customer application support component.

11. View Status Events and Maintain Status Events

The status of a vehicle is shown on the map display in a status bar in the vehicle symbol. A typical vehicle symbol is shown in FIG. 55. It consists of three parts: (i) an icon; (ii) a status bar; and (iii) a label. The icon is selected to represent a type of vehicle and has a shape and color definable by the user. The icon points in the direction of travel of the vehicle. The status bar shows status of a vehicle by changing color based on status received from the vehicle or other applications. The label is the vehicle name selected by the customer or an alternate name selected by the user. The types of status and the sources of status change events are managed by a customer user with administrator privilege.

The View Status Events function enables the user to view the events that have been identified and to help manage the addition of new events or changes to existing events. The use case provides the capability of viewing all status events that exist for a customer. Filtering capabilities on attributes such as type and status (expired versus active events) is necessary. Once the list is displayed the ability to sort the list by any of the attributes listed above is available.

The Maintain Status Events function allows the user to add, modify, or remove a status. The use case allows the Administrator the ability to define which events it wants to be present on the vehicle status bar (on the map display). The user has the ability to add new events, change the color associated with an event and delete events at any time. The map display will not reflect any changes made until the next time a real-time vehicle location message is received.

12. Maintain Messages

This function enables the user to create, change or remove a text message. The use case allows a user with administrator privilege to create, change or remove a message that is re-used by all users within the system. These messages are those used by the user to send to a driver (typically referred to as pre-defined messages) and for a driver to send to a dispatcher. When a message is changed, a new message is created and the original message is expired. Messages can be associated with a particular vehicle, group of vehicles or can apply to all vehicles. A message created in error can be deleted. However, most messages cannot be deleted. Rather, an expiration date is used to indicate the message is no longer available.

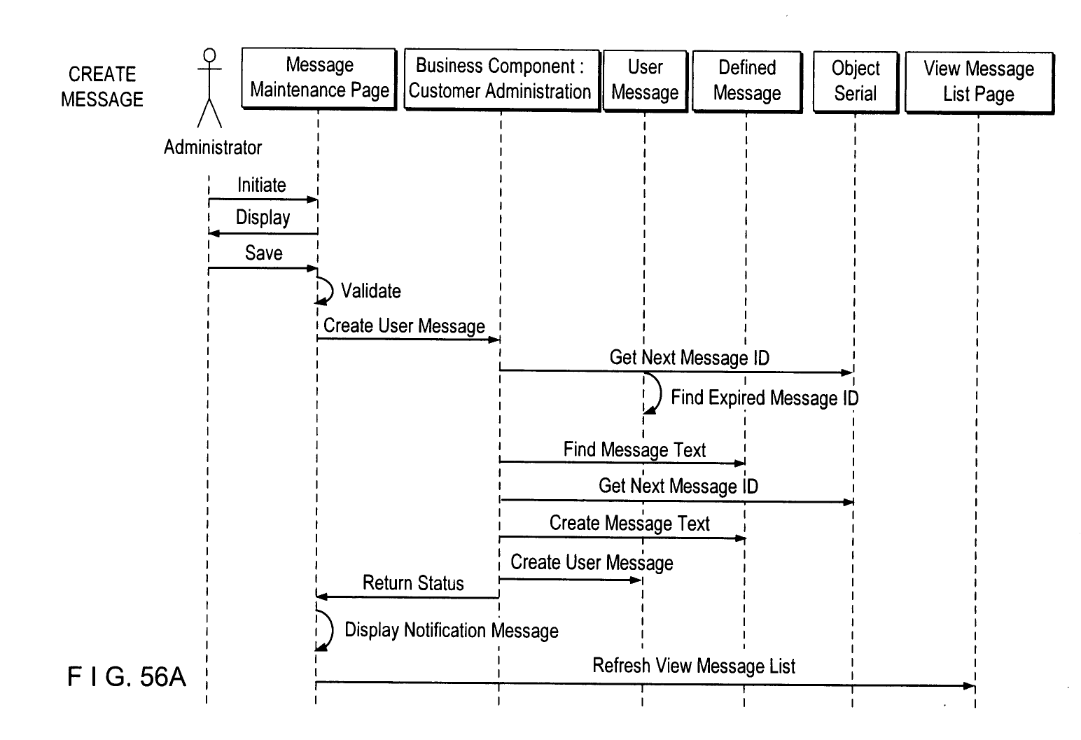

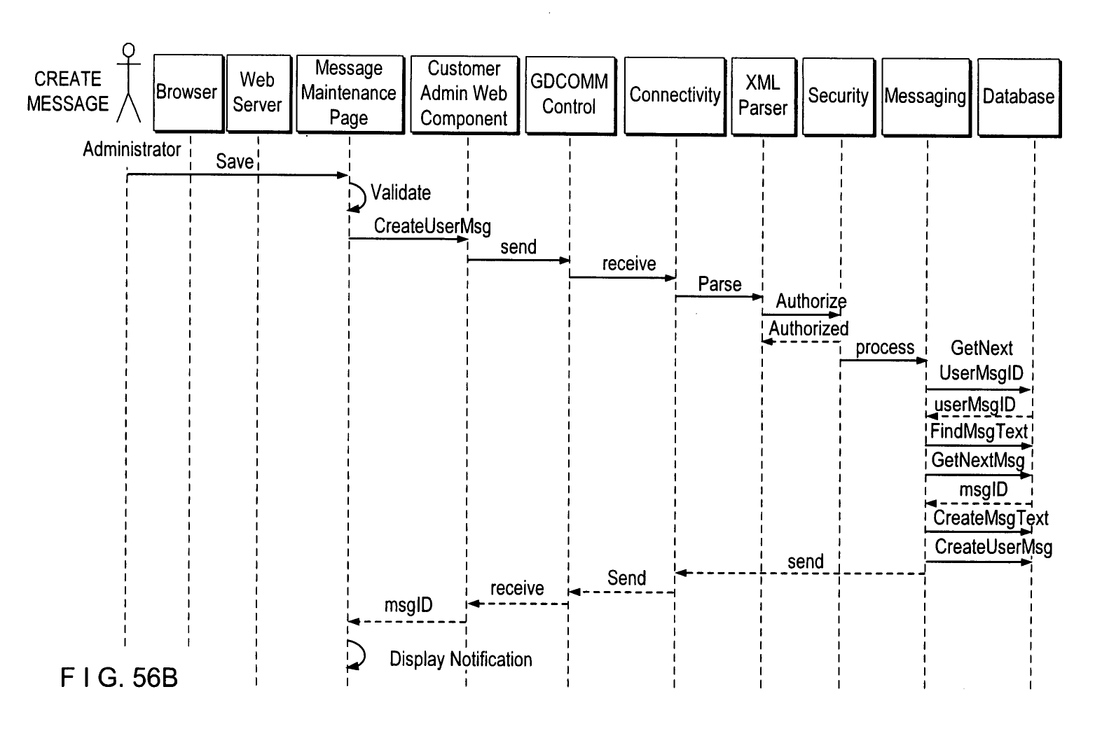

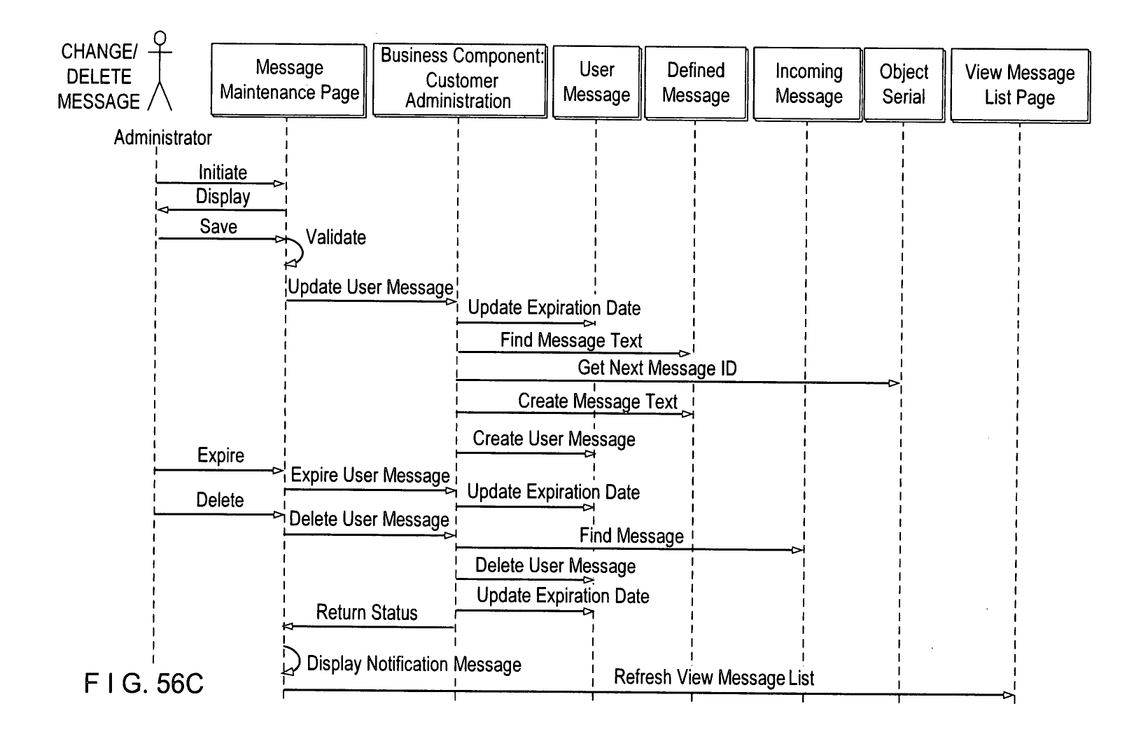

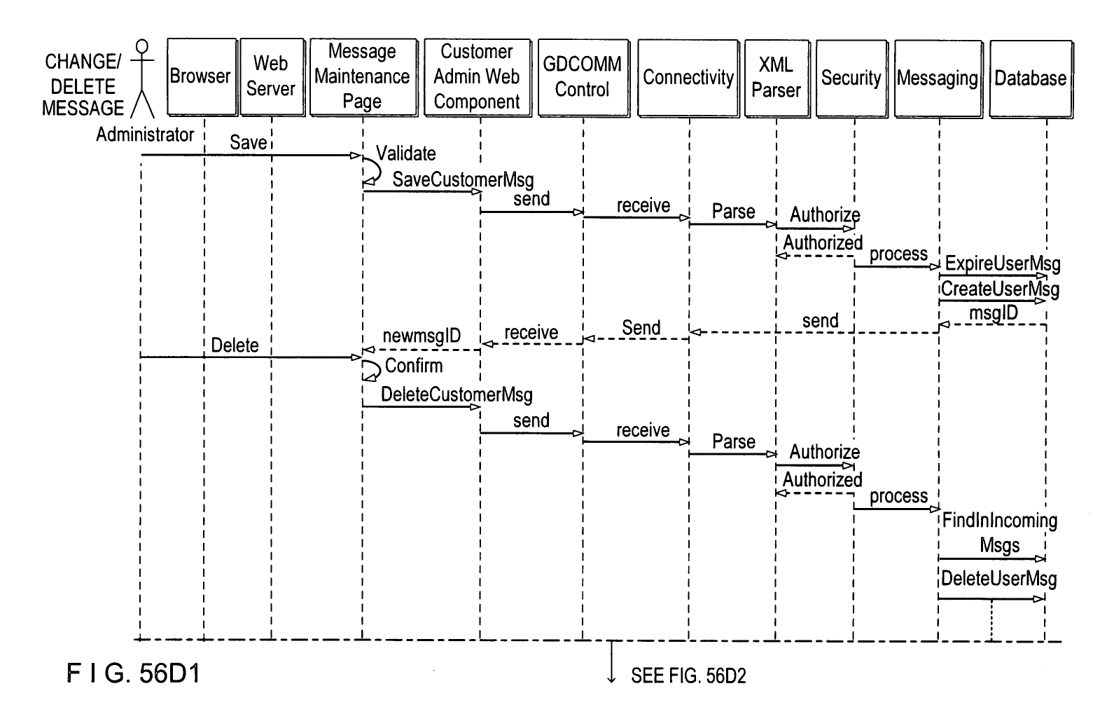

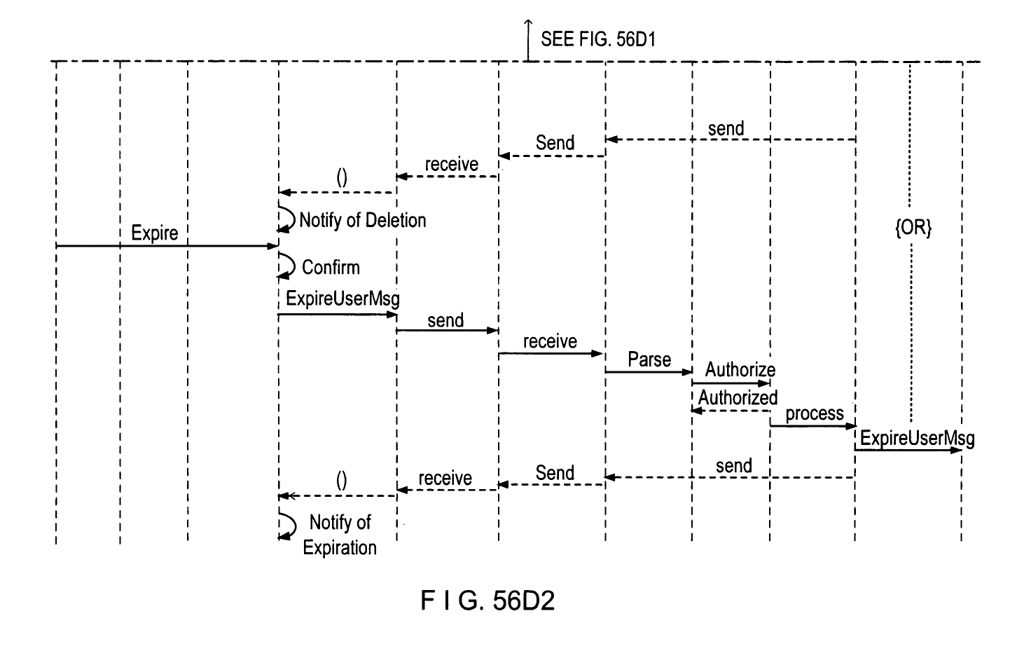

The functional steps performed when a message is created are shown in FIG. 56A. The steps are:
(a) Initiate Create Message: A user with administrator privilege selects the Create option from the View Message List page. The Message Maintenance form is displayed with the list of available message types.
(b) Enter Details: The user enters the text and selects a message type. The effective date must also be entered (default=current date).
(c) Save: The user submits the message for addition to the database.

The detailed sequence of message creation is shown in FIG. 56B. When the message is saved, the new message text is sent to the CIS through the XML interface. If the request passes security, the next available message ID is retrieved from the database and assigned to the message. The message text is then inserted in the database. The message list is updated and a status code is returned to the user interface.

The functional steps performed when a message is changed, deleted or expired are shown in FIG. 56C. The steps for changing a message are:
(a) Initiate Change Message: A user with administrator privilege can initiate changing a message from the following:
   (i) From the View Message List, the user can double click on the message.
   (ii) From the View Message List, the user selects the message; right mouse clicks and selects the Change option from the fly-out menu.
   (iii) From the View Message List, the user selects a message and selects the Change push button.
(b) The Message Maintenance page is displayed with the attributes of the selected message.
(c) Enter Details: The user can change any attributes of the message except message id.
(d) Save: The user submits the message for update to the database.

The steps for deleting a message are:
(a) Initiate Remove Message: A user with administrator privilege can initiate deleting a message from the following:
   (i) From the View Message List, the user can double click on the message.
   (ii) From the View Message List, the user selects the message; right mouse clicks and selects the Change option from the fly-out menu.
   (iii) From the View Message List, the user selects a message and selects the Change push button.
      It should be noted that the user can specifically ask for a delete from within the View Message List.
(b) The Message Maintenance form is displayed with the attributes of the selected message.
(c) Delete: The user submits the message for deletion from the database.
   The steps for expiring a message are:
(a) Initiate Expire Message: A user with administrator privilege can initiate expiring a message from the following:
   (i) From the View Message List, the user can double click on the message.
   (ii) From the View Message List, the user selects the message; right mouse clicks and selects the Change option from the fly-out menu.
   (iii) From the View Message List, the user selects a message and selects the Change push button.
      It should be noted that the user can specifically ask for expiration within the View Message List.
(b) The Message Maintenance page is displayed with the attributes of the selected message.
(c) Expire: The user submits the message for expiration in the database.

The detailed sequence of message modification, deletion, and expiration is shown in FIG. 56D. When a changed message is saved, the new message text is sent to the CIS using the XML interface. If the request passes security, the old message is located and replaced with the new text in the system database. Expiring and deleting a message have the essentially the same sequence. The difference is that if a message had never been used (sent) delete will remove it from the system database; otherwise the effects of expire and delete are identical. When the user selects expire/delete for a message the request is sent through the XML interface to the CIS. the CIS locates the message in the database and sets the expire date to the current date.

13. View Message List

This function enables the user to view the pre-defined text messages of the customer to help manage the addition of new messages. When a user is ready to send a message to the driver, the user will select a message to send from the message list. The use case provides the capability of viewing all messages that exist for a customer. Filtering capabilities on attributes such as type, severity and status (expired versus active messages) is available. Once the list is displayed, the ability to sort the list by any of the attributes listed above is available.

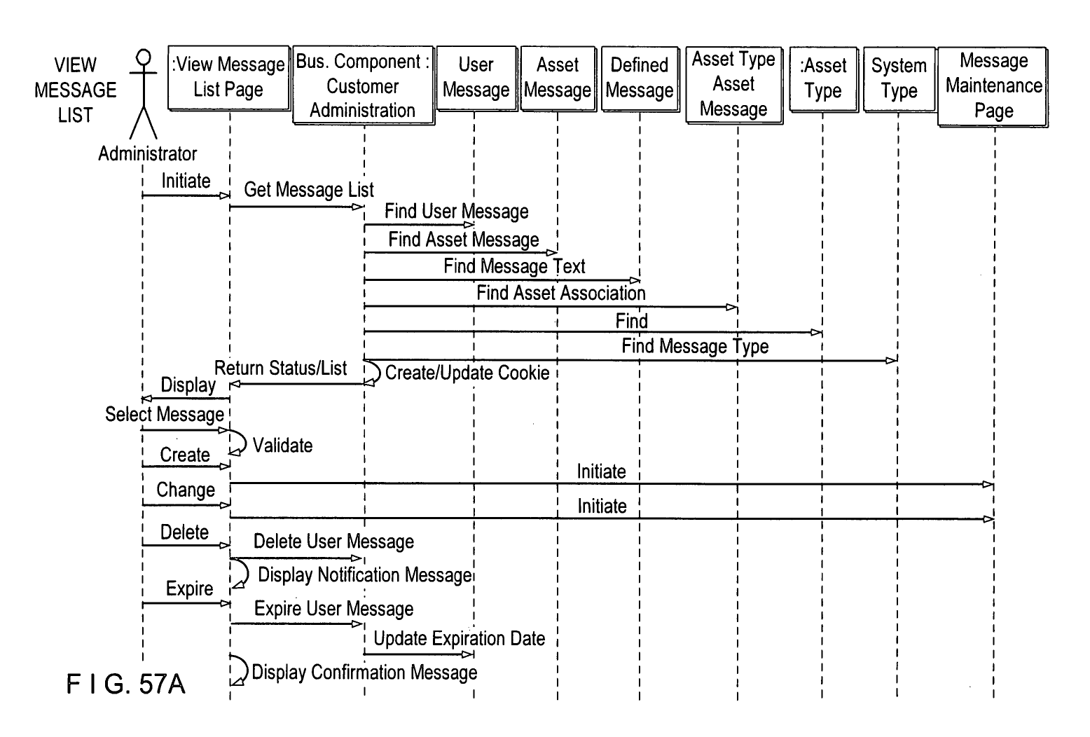

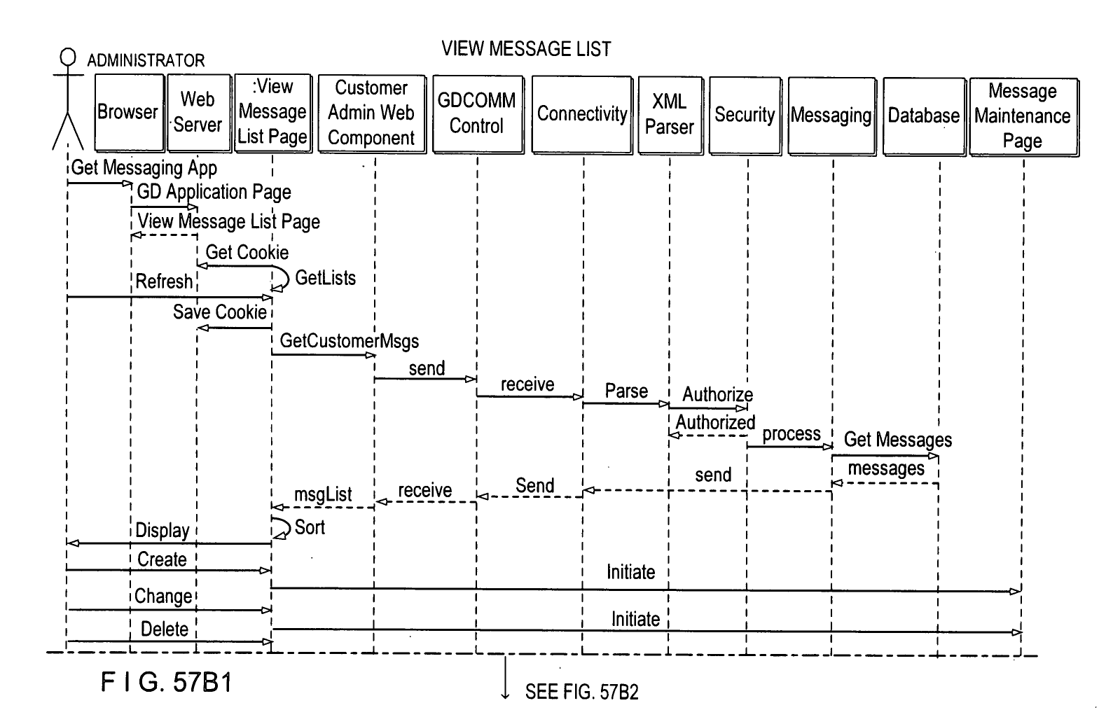

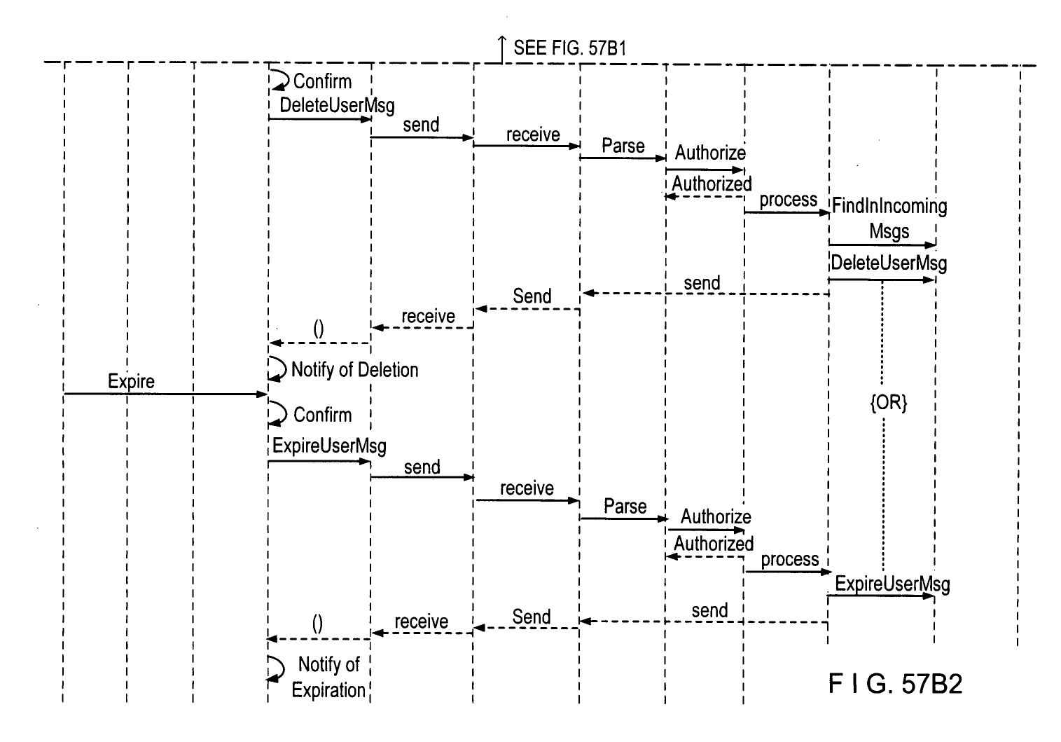

The functional steps for View Message List are shown in FIG. 57A. They are:
(a) Initiate View Message: The user selects the Message List link from the System Administration Application. The message list is displayed showing messages based on the last filter options or all messages are displayed (if there are no previous filter options).
(b) Refresh List: The user can select various filter options and then the Refresh push button. The message list is displayed depending upon the filter options selected.
(c) Select Message: The user can select one message and perform many functions on that selected message. These functions are: Change Message, Delete Message, Expire Message
(d) Create Message: The user can choose to create a new message.
(e) Close List: When the user is finished viewing messages, they select the Close push button.

The detailed sequence of the View Message List Function is shown in FIG. 57B. When the interface is initiated, the list is retrieved from the CIS using a request through the XML interface. If the request passes security, the system database is queried for the message list. The request is determined from the filter/search parameters specified by the user. The CIS then returns the message list to the user interface. If actions are initiated by the user for a selected message, the processing flow for each of those actions is shown in FIGS. 57A and 57B.

14. View Job Type List and Maintain Job Types

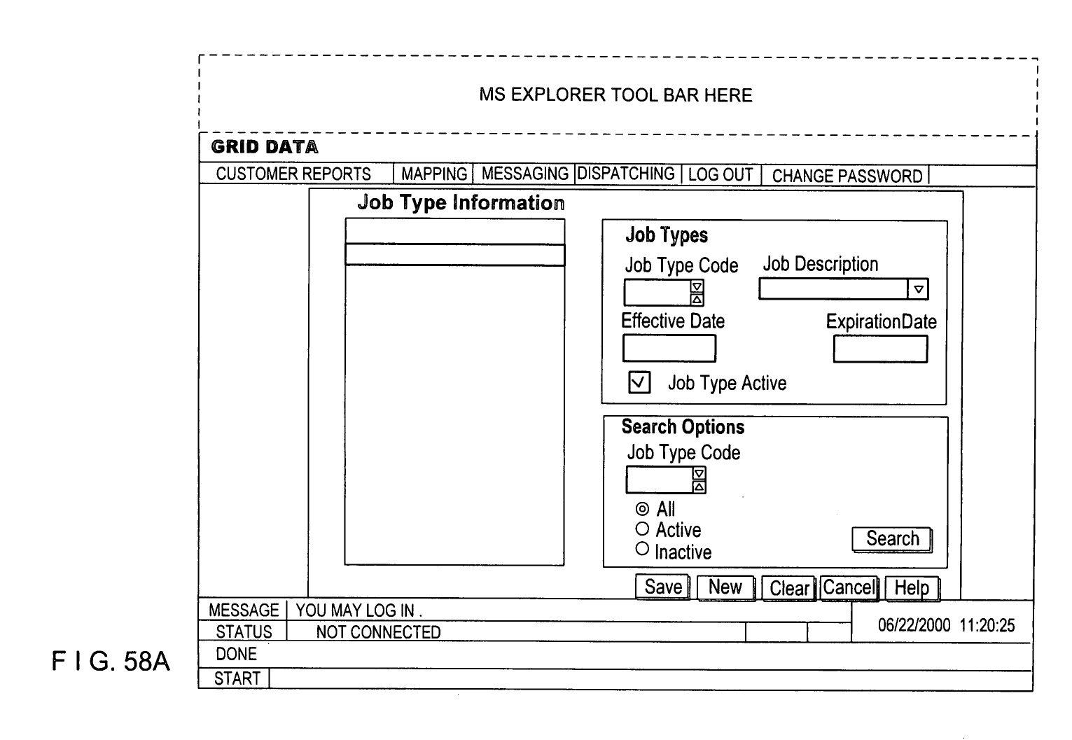

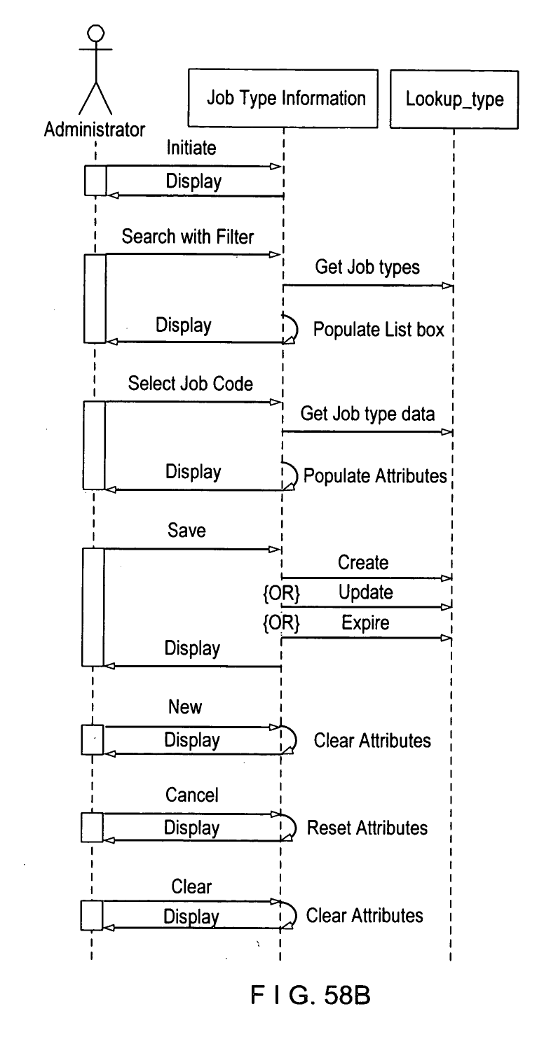

The View Job Type List and Maintain Job Types functions share the same user interface shown in FIG. 58A. Job types are codes used in conjunction with the Dispatching application to identify the type of work to be performed for a particular work order.

These functions enable a user with administrator privilege to view job codes and create, modify, or delete a job code. Job codes can be created at any time, and are immediately available to be used to identify a work order. When a job code is modified, the old job code is expired and a new job code is created with the effective date being the current date. A job type that is created in error can be deleted. However, most job types are not deleted. Rather, an expiration date is used to indicate the job type is no longer available. The job type list can be filtered on attributes such as status (expired versus active job types). Once the list is displayed the ability to sort the list by the attribute listed above is available.

The functional steps of View Job Type List and Maintain Job Types are shown in FIG. 58B. When the Job Type interface is initiated, the Dispatching application extracts from the database the job types and displays them on the left side of the interface. As with most list retrieval, codes are presented in groups of twenty so that the user does not have to wait for long data transfers. The user can then narrow the list by searching for a particular job type among active or inactive job types. When a search request is made, the Dispatching application queries the database with the search parameters, and the results are returned, refreshing the list display.

The user may select a job type and change its description, effective dates, and make the job type active or inactive. Inactive or expired job types are not available to other users. Saving a change causes the Dispatching application to update the job type parameters in the database. On a change, the old parameters are expired, and the new parameters replace the old job type. When new job types are saved, the Dispatching application inserts the new job type into the database. The new job type then becomes available for other users.

15. View Skill Type List and Maintain Skill Types

The Dispatching application must ensure that resources dispatched to a job have the skills necessary to complete the job. Skill types are used to define three things: (i) on the work order to identify the type of skills required for the job; (ii) on the vehicle to identify the capabilities the vehicle can perform; (iii) on the person to identify specific skills a person may have. Skill types can be created at any time, and are immediately available to be used to identify a work order, vehicle or person.

The View Skill Type List enables the user with administrative privilege to view the skill types held by the customer to help manage the addition of new skill types or changes to existing skill types. The list may be filtered on attributes such as type and status (expired versus active skill types). Once the list is displayed the ability to sort the list by any of the attributes listed above is available.

The Maintain Skill Types function allows the user to ability to create, modify or delete skill types related to his or her specific business. When a skill type is modified, the old skill type is expired and a new skill type is created with the effective date being the current date. A skill type that is created in error can be deleted, but most skill types are not deleted. Instead, an expiration date is used to indicate the skill type is no longer available

When the Skill Type interface is initiated, the Dispatching application extracts from the database the job types and displays them on the left side of the interface. As with most list retrieval, codes are presented in groups of twenty (for example) to avoid having the user wait for long data transfers. The user then narrows the list, if desired, by searching for a particular skill type among active or inactive skill types. When a search request is made, the Dispatching application queries the database with the search parameters, and the results are returned, refreshing the list display.

The user may select a skill type and change its description, effective dates, and make the skill type active or inactive. Inactive or expired skill types are not available to other users. Saving a change causes the Dispatching application to update the skill type parameters in the database. On a change, the old parameters are expired, and the new parameters replace the old skill type. When new skill types are saved, the Dispatching application inserts the new skill type into the database. The new skill type then becomes available for other users.

16. View Asset Type List and Maintain Asset Types

The Gateway allows customers to classify vehicles or assets into types for assignment of icons on the map display and to support other applications. Dispatching applications require knowledge of vehicle types to determine which vehicles can be assigned to certain jobs. A user with administrative privilege can create, modify, or remove vehicle types for a customer.

The View Asset Type List function enables a user to view the asset types held by the customer to help manage the addition of new asset type codes or changes to existing asset type codes. The list may be filtered and sorted based on attributes of the asset. The Maintain Asset Types function enables the user to add a new asset type, or modify or remove an asset type. Asset types allow the customer to define the different types of assets it has such as fire trucks, dump trucks, and so on. No expiration date is associated with a type of asset and once deleted it is gone. In the current exemplary embodiment, only one type of asset category exists, viz., a vehicle. As other asset categories are added, the user associates an asset type with a particular category.

When the Asset Type interface is initiated, the application extracts from the system database the asset types and displays them on the left side of the interface. As with most list retrieval, codes are presented in groups of twenty (for example) so that the user is not required to wait for long data transfers. The user may then narrow the list by searching for a particular asset type among active or inactive skill types. When a search request is made, the application queries the database with the search parameters, and the results are returned, refreshing the list display.

The user may select an asset type and change its description and make the asset type active or inactive. Inactive asset types are not available to other users. Saving a change causes the application to update the asset type parameters in the database. On a change, the old parameters are deleted, and the new parameters replace the old asset type. When new asset types are saved, the application inserts the new asset type into the database. The new asset type then becomes available for other users.

17. View Customer List and Maintain Customer

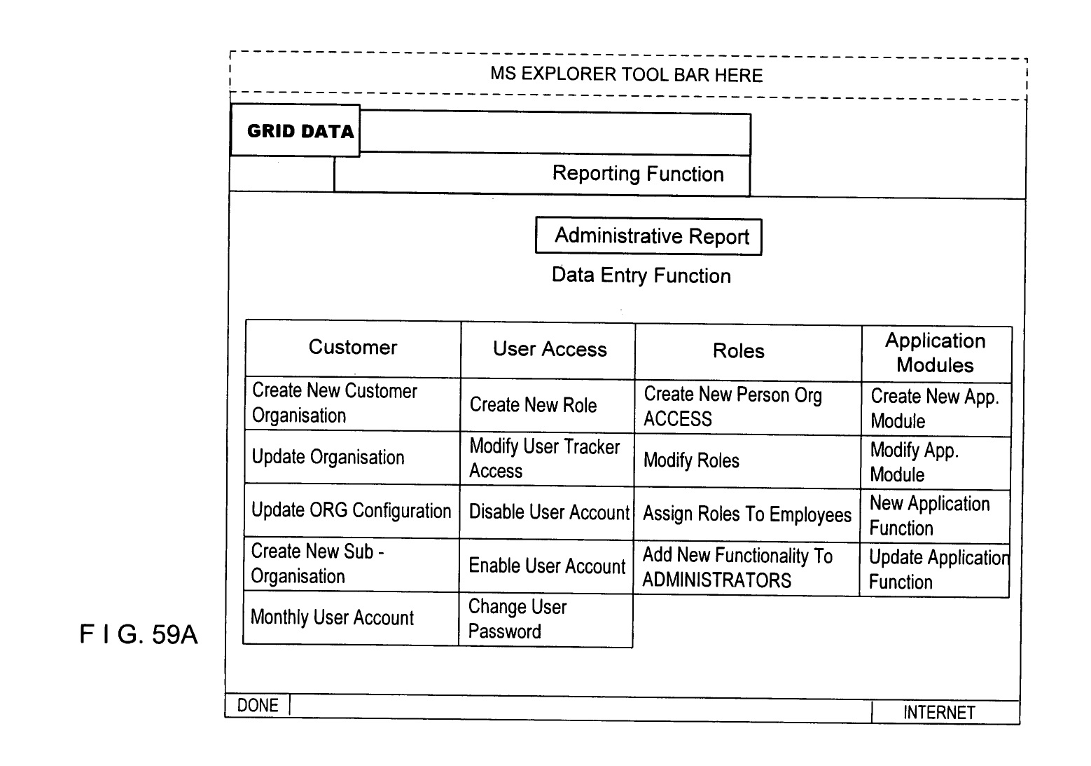

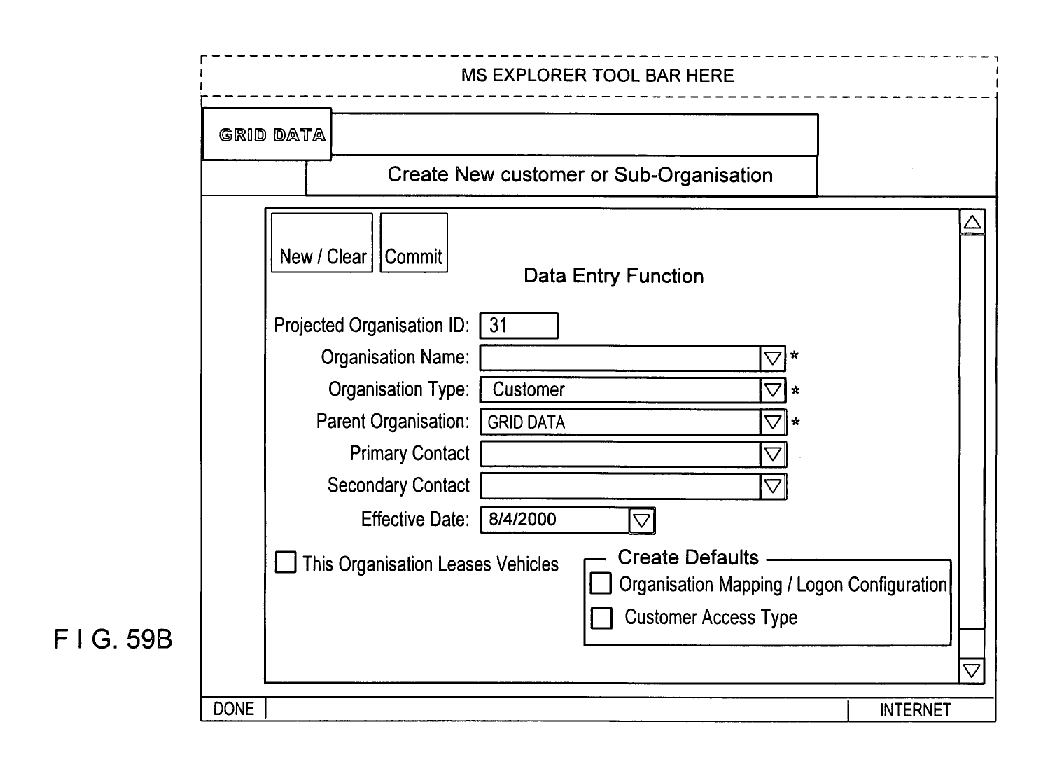

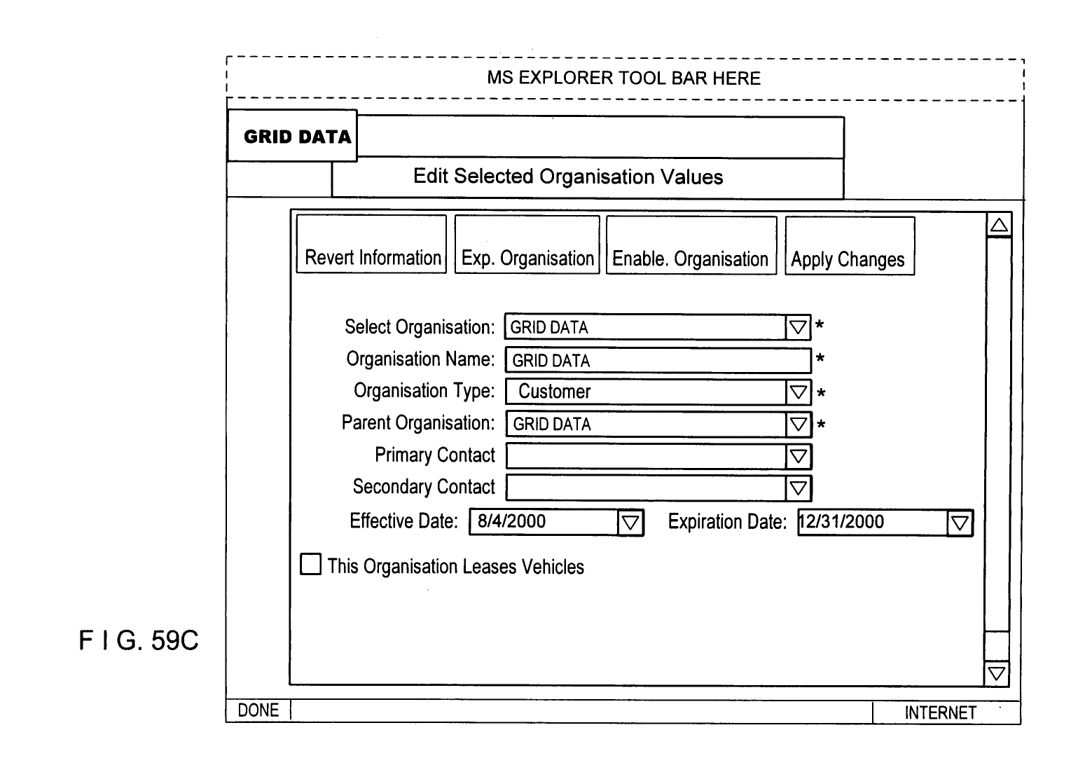

Gateway administrators create and maintain customer accounts, including managing user accounts and passwords when customer users or administrators have need for such assistance. This also includes setting up the basic account information to support the gateway business logic for user roles and initial vehicle datasets and vehicle and tracker associations for new installations and repairs. The main user interface for gateway administration is shown in FIG. 59. The interface is a set of web pages that interact with the system database, and presents a menu of functions for maintaining customers, users, roles, and applications.

The Maintain Customer function enables the administrator to create a customer, update information about the customer, and delete a customer. The gateway administrator is the only person who can perform this function. This provides the basis for all other functions related to a customer—allowing users, vehicles, resources, work sites, work orders, and so forth to be associated with a specific customer. The customer's profile includes: customer name; customer address; and customer contact. Another very important aspect of defining a customer is defining whether the customer ever leases vehicles to other customers. If it does, the gateway administrator will identify the customer as such, thereby allowing this customer to be selected for a leasing arrangement with another customer. The gateway administrator has the ability to “lock out” a customer from using the gateway operator's web site for reasons such as a delinquent bill. The View Customer List function enables the gateway administrator to view a list of all customers to allow modification to the respective customer's account information.

The user interface for creating a new customer is shown in FIG. 59B. When the interface is initiated, the system database is queried for the next available customer ID number, shown in the Projected Organization ID field. The user must supply a customer name, contact information, an effective date for the customer account to become active, and set the leasing flag, if required. Selecting Commit will cause the application to write the data to the system database. At that time the customer ID is confirmed, and the customer is created.

The customer account may be modified using the Update Organization interface shown in FIG. 59C. Available customer accounts are shown in the Select Organization drop down box. When selected, the customer list is retrieved from the system database, and the user is able to select the desired customer account. Customer name and contact information can be changed, and the account expiration data may be set. The user can immediately expire the account or re-enable the account. Applying changes causes the application to update the system database with the new information.

18. Login

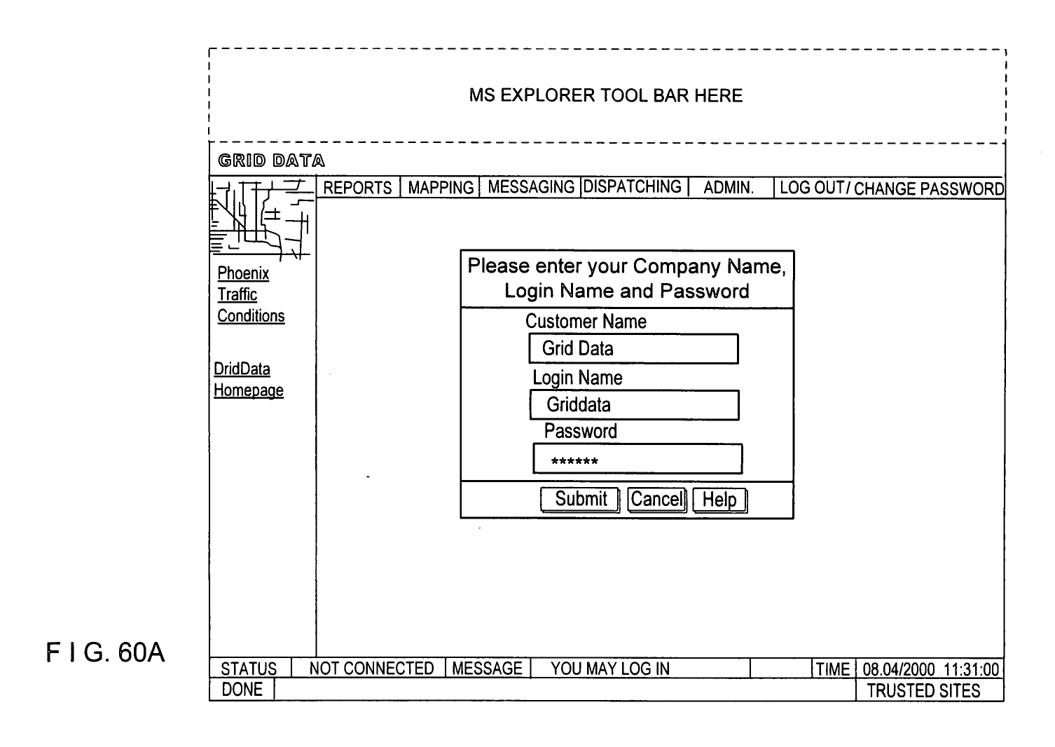

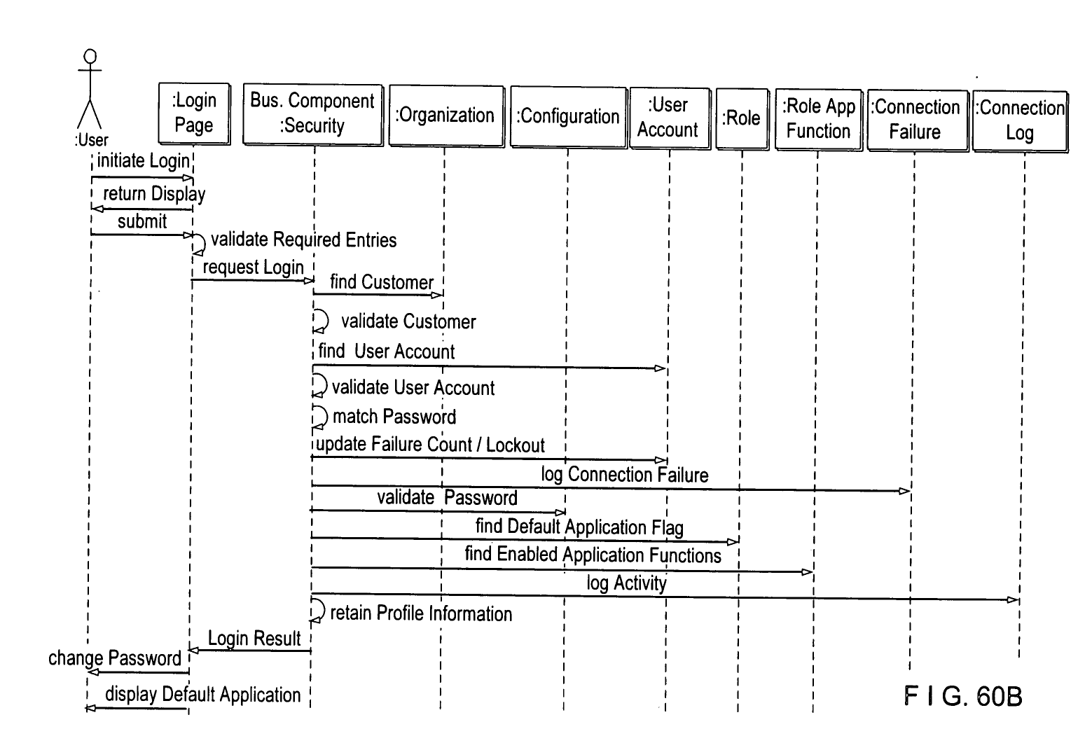

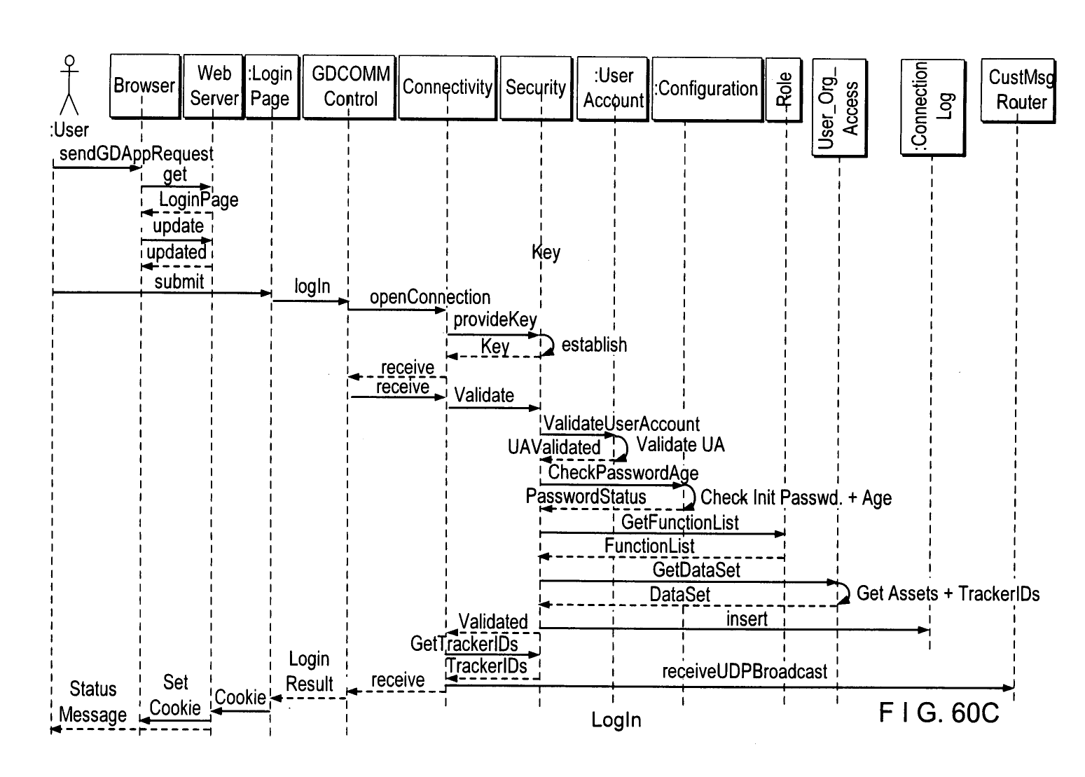

This function allows a user to login to the gateway. The login user interface is shown in FIG. 60A. The function has two other capabilities:

(a) Password Expiration Notification: This follows a protocol that, based on the customer's password expiration rules, the user may be prompted to change its password.

(b) Customer Machine. Updates/Notification: After the user's login is confirmed, the user may be notified of any updates that are needed on the customer machine such as application code and/or mapping data (mapping data include all layer data such as street markers, landmarks, roads and city limits); i.e., the login process will determine if the customer machine requires updating. If the user logs in from a machine that has already been updated, it will not receive the notification. The web site prioritizes each update; for example, application code changes that are mandatory are required to be immediately downloaded, while other updates, such as display parameters, are not mandated for immediate download. Some users stay logged in for long periods of time. Therefore, for updates that are mandatory, these users will receive notification that they are required to logout and may go through an orderly logout process in order to force the updates onto their machine.

The functional steps performed by the Login function are shown in FIG. 60B. A detailed sequence for the function is shown in FIG. 60C. The user must enter the customer name, his user name and a password; the password characters are obscured so that they cannot be read. An example is shown in FIG. 60A. The user then selects Submit.

The submitted login parameters are encrypted and the login request is sent to the CIS security component through the XML interface. The CIS validates the customer and user account. If the login fails, the security failure is logged, user lockout counters are updated and the user is notified. If the login is successful, the connection is logged and the application retrieves the user's configuration information from the database, determines application access based on the user's role, and retrieves data such as vehicle lists and last known location information based on the user's dataset access. All of these data are returned to the user. The CMR is notified that a customer user is logged in so that the user can receive real time data from vehicles.

19. Logout

The Logout function enables the user to logout from the gateway. Logout occurs in one of four ways: (a) the user initiates the logout by selecting the option in the main interface menu; (b) the user closes the last browser window that is logged into the gateway; (c) the user navigates away from the web page containing an application; or (d) the gateway logs the user out due to inactivity or a lost connection. In the first three cases, the user is prompted to ensure he intends to logout. If the user changed its default configurations without saving them, it will be notified that a change is acknowledged and be given the ability to save its configuration.

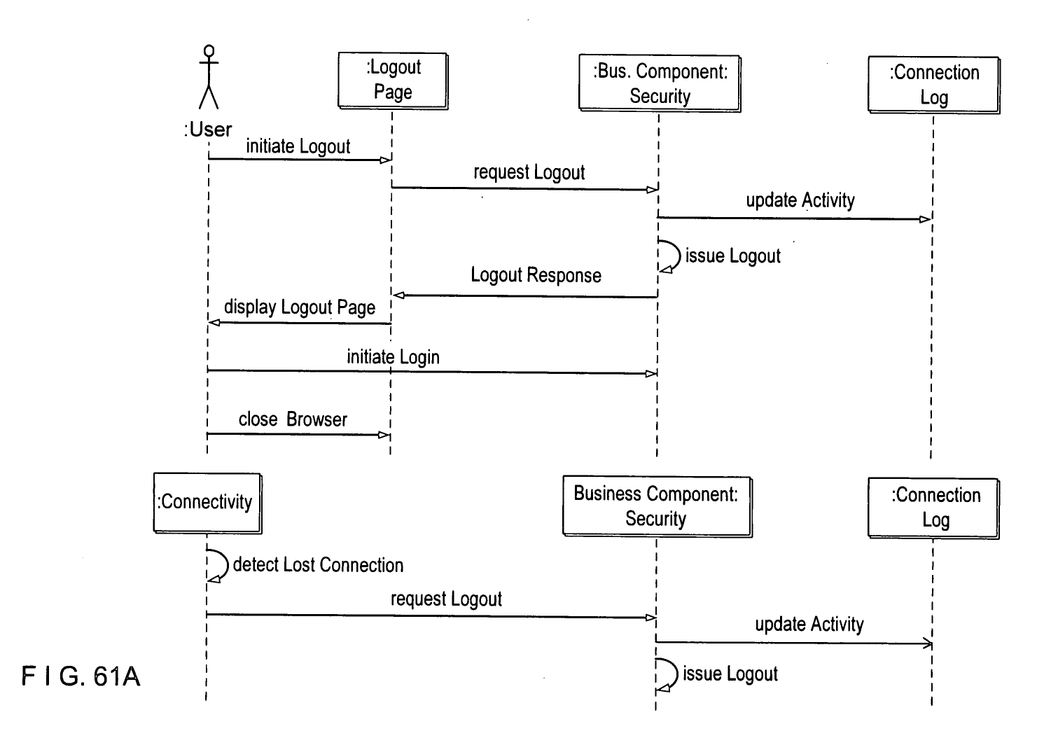

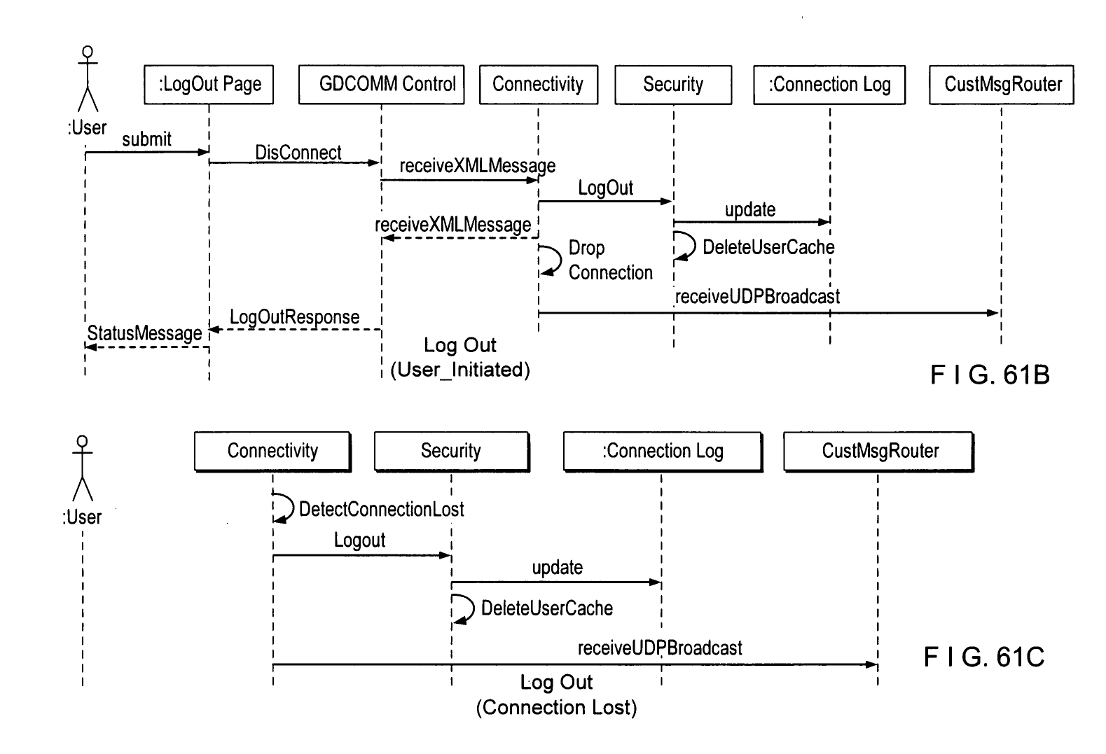

The functional steps performed by the Logout function are shown in FIG. 61A. A detailed sequence of the Logout function is shown in FIGS. 61B and 61C, for the cases in which the user initiates the logout, and in which the connection is lost, respectively. When the user selects Logout from the menu, the logout request is sent to the CIS security component through the XML interface. The logout request causes the gateway to send a response back to the user and drop the connection to the user. The CMR is notified that the customer user is no longer connected.

If the user is idle for a certain timeout period or the connection to the user's browser is lost, the gateway will automatically logout the user. In this case, the CIS connectivity service will issue the logout request to the security service. The user connection will be dropped. The CMR will also be notified that the customer is no longer connected.

20. Change Passwords

Passwords can be changed by the normal user or by the gateway administrator. This function enables the password to be changed when the user forgets its password, when the password expires, or when the user chooses to change its password. The user may change its password at any time. When a password is forgotten, a user with gateway administrator privilege can reset the user's password. Based on the customer's configuration, the user may be prompted to change its password at login based on some expiration rules. Password configuration is customized for each customer. Therefore, parameters such as length and format may be different for each customer.

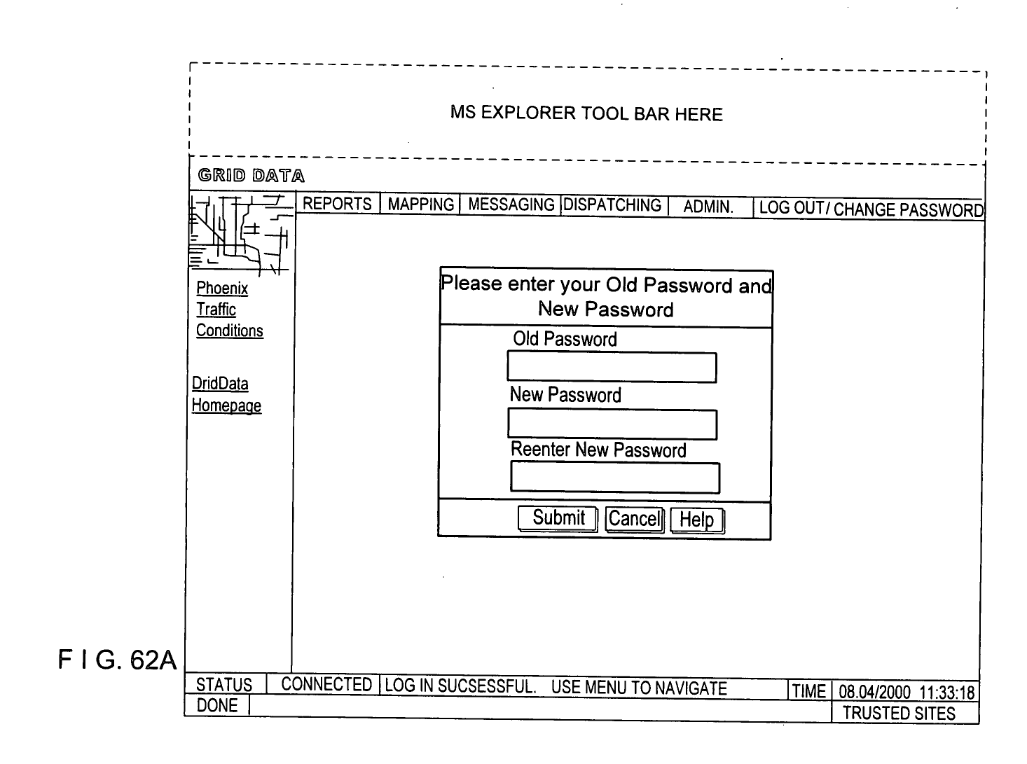

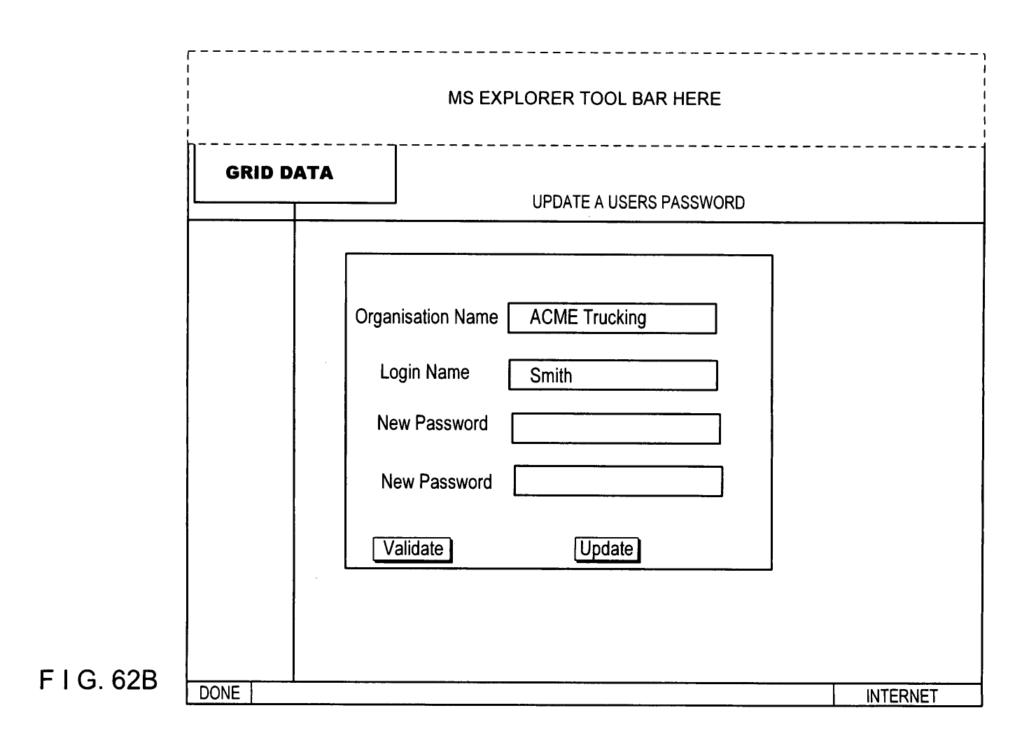

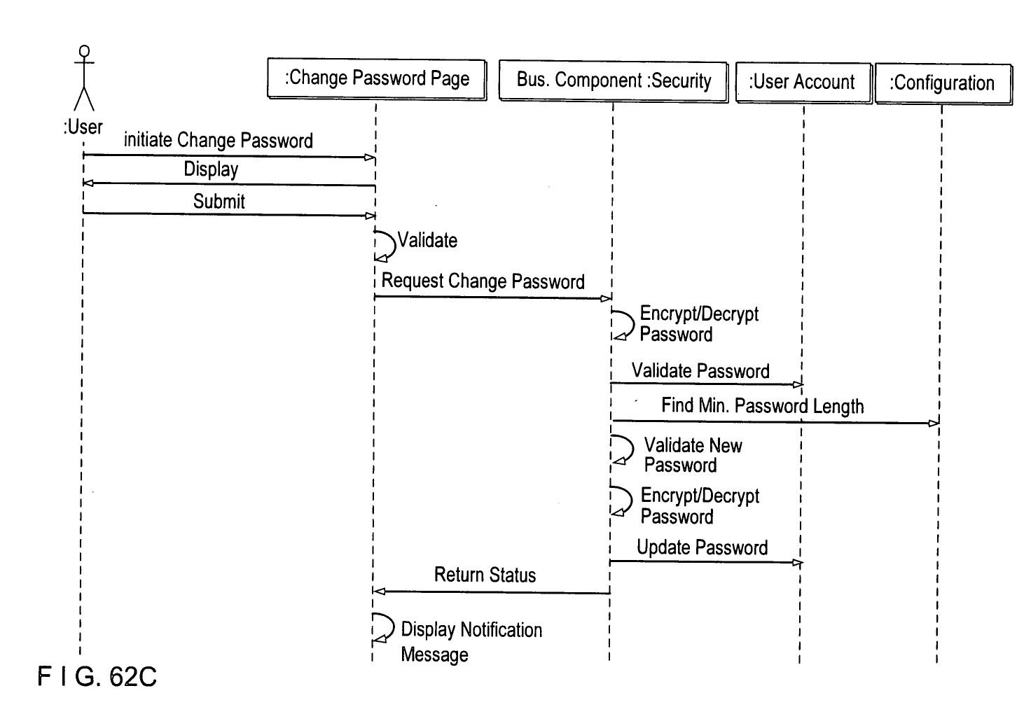

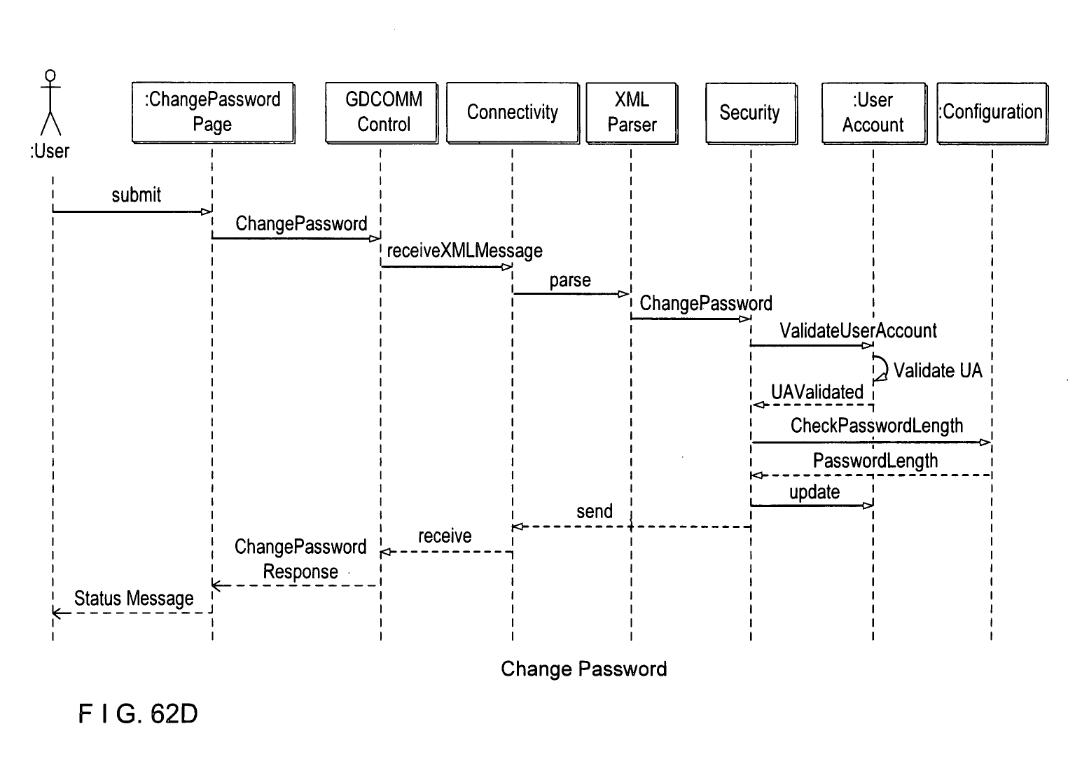

The user Change Password interface is shown in FIG. 62A, and the gateway administrator Change Password interface is shown in FIG. 62B. When the user changes its password it must enter its original password, and the new password twice to ensure there is no typographical error. The user then submits the request. The Change Password functional steps for the user initiated change are shown in FIG. 62C, and the sequence detail design is shown in FIG. 62D. The encrypted password information is sent to the CIS security component via the XML interface. The user account is verified and the password is checked for validity relative to minimum length. If acceptable, the password is stored in the system database and the user is notified that the password was changed successfully.

The gateway administrator has the authority to change the password of any customer's user. The old password is not required, but the new password must be entered twice as above. The CIS updates the user's password in the same manner as described above.

21. Initiate Timeout

The Initiate Timeout function is used when the system remains idle for a user for a specified period of time. It provides the ability for the system to logout the user automatically. Customers may define the timeout necessary to force a user logout. Depending upon the Customer, the user may be notified that it will be logged out at a specified time before the actual log out occurs. This function is noted above in the Logout functional description. The connectivity service maintains an activity monitor. Each request from the user's connection resets the timeout counter in the activity monitor. If no activity occurs for the timeout period, the security service is notified and the user is logged out.

22. Load Mapping Application and Unload Mapping Application

These functions control the start and end processing by the Mapping Application and configuration data retrieval and storage from and to the system database. The Mapping application relies on a great deal of user configuration data for its operation. When the Mapping application starts, it must properly initialize default settings set by the user. When it closes, it must store changed settings back to the system database. The parameters the Mapping application requires include:

(a) the vehicles to display and their location (for first time users, the initial display will include all vehicles assigned to the user, subsequent displays are based on which vehicles the user has turned on/off);

(b) the layers the user has selected;

(c) the job sites associated with any active or pending work orders, or job sites that have work orders dispatched to them;

(d) the job sites that have been recently created;

(e) all home sites;

(f) the counties the user has selected;

(g) system parameters such as: search tolerance, magnification scale (zoom), work site parameters (min/max), and tool tip.

These functions are performed only at login.

The Load Mapping Application requests certain data items from the CIS using the XML interface. On each request, security is validated and the CIS queries the system database user configuration table or other tables for the desired data, which are then returned to the Mapping application. The data items requested by the Mapping application are in the order listed below.

(a) Get Layer List: The Mapping Application sends a request to get the layer list available to the user. The layers returned also indicate whether the user has the layer turned on or off for display on the map. The first time a user accesses the map, the layers displayed are defaulted to the customer's preference. Status Returned: A status is returned to indicate to mapping that the request was successful, along with the layer name and display flags.

(b) Get Home Extents: The Mapping Application sends a request to get the user's map default area (home extents). Status Returned: A status is returned to indicate to mapping that the request was successful, along with the longitude and latitude parameters.

(c) Get County List: The Mapping Application sends a request to get the county list available to the user. The counties returned also indicate whether the user has the county turned on or off for display on the map. The first time a user accesses the map, the counties displayed are defaulted to the customer's preference, i.e., only those counties that the customer wants to bring down are brought down. Status Returned: A status is returned to indicate to mapping that the request was successful, along with the county name and display flags.

(d) Get Map Defaults: The Mapping Application sends a request to get all the map defaults, such as zoom scale, search tolerances and buffers, for the customer. Status Returned: A status is returned to indicate to mapping that the request was successful, along with the map parameters.

(e) Get Tool Tip: The Mapping Application sends a request to get the tool tip parameters for the customer. Status Returned: A status is returned to indicate to mapping that the request was successful, along with the tool tip parameters.

(f) Asset Display: The Mapping Application sends a request to get the assets available to the user. The assets returned indicate whether the user has the asset turned on or off for display on the map, the display name of the asset as well as the icon and color associated with it. The first time a user accesses the map, all assets default to a display of “off.” Status Returned: A status is returned to indicate to mapping that the request was successful, along with the asset attributes and display flags.

(g) Query Asset List: The Mapping Application sends a request to get the last known location for all those assets that are turned on for display on the map. Status Returned: A status is returned to indicate to mapping that the request was successful, along with the asset's last known location.

(h) Find Home Sites: The Mapping Application sends a request to get all the home sites for a customer. Status Returned: A status is returned to indicate to mapping that the request was successful, along with the details of the home sites.

(i) Find Job Sites: The Mapping Application sends a request to job sites for a customer. These are job sites that have pending or active work orders associated with them (or with a display flag of “on”). All other job sites are ignored. Status Returned: A status is returned to indicate to mapping that the request was successful, along with the details of the job sites.

When the Mapping application is closed, the Unload Map function is executed. It saves configuration changes to the system database in the manner of the Maintain Map Data Display and related functions. The Unload Map function will save the following information (if not already saved) in the order listed below:

(a) Save Layer List: The Mapping Application sends a request to save layers turned on/off for display by the user. Status Returned: A status is returned to indicate to mapping that the request was successful.

(b) Save Home Extents: The Mapping Application sends a request to save the user's map default area (home extents). Status Returned: A status is returned to indicate to mapping that the request was successful.

(c) Save County List: The Mapping Application sends a request to save counties turned on/off for display by the user. Status Returned: A status is returned to indicate to mapping that the request was successful.

(d) Asset Display: The Mapping Application sends a request to save any assets that were turned on/off for display by the user. Status Returned: A status is returned to indicate to mapping that the request was successful.

23. View User Account List and Maintain User Account

Each person that accesses the gateway is required to have a unique user account. The Maintain User Account function enables a gateway administrator to create, modify and expire user accounts. Items maintained on a user account basis include user name, user ID, password, effective date, and expiration date, as well as the user's configuration information.

When a user is added, a role is assigned. Therefore, in order to complete this use case, all the functionality as described in the use case Manage Role to User Relationship must be executed. Initially, when a user account is created, the configuration parameters are inherited based on defaults for the assigned Role. Configuration parameters are items such as default application and icons used. The user has the ability to override these configuration parameters. When a user's access is being removed, the user account is expired. The user will no longer have access to the gateway web site.

The View User Account List function enables the gateway administrator to view a list of user accounts for a customer to facilitate modification of account parameters. Filtering capabilities are available such as the ability to select user accounts based on effective date, role, or customer. Once the list is displayed, the ability to sort the list by the above mentioned attributes is available.

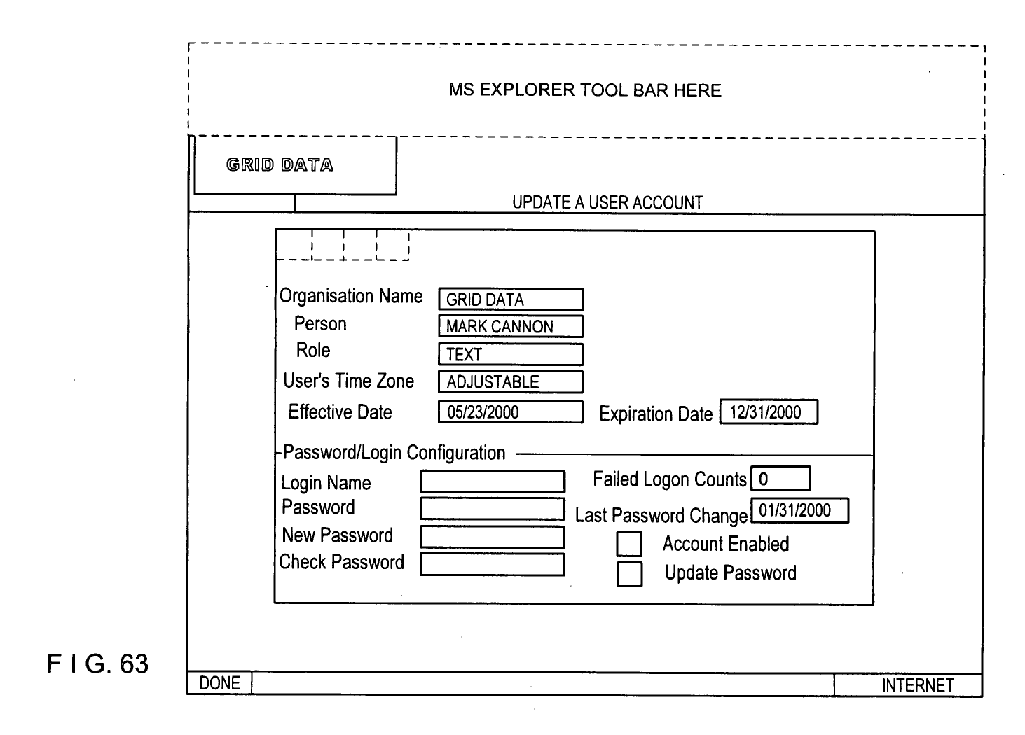

By way of example, the user interface for changing or expiring a user account is shown in FIG. 63. The gateway administrator has the ability to select from a list of customers, then users. Once a user is selected, user account parameters can be changed, including role, time zone, password, and initial map default extents. The user account can also be expired or reactivated. When the administrator Commits the changes, the updates are written to the system database.

24. View Role List and Maintain Roles and User-Role Relationships

The gateway security model is based on roles which create classes of users. Each class has access to certain levels of functionality, applications, or data. Examples of roles are Dispatcher, Order Entry Clerk, and Administrator. Each user of the gateway has a defined role. For example, a user with a Dispatcher role may be able to run the Dispatching, Messaging, and Mapping applications, while an Order Entry Clerk is only allowed to run the Dispatching and Mapping application. The steps performed to view and maintain Roles are substantially similar to that of viewing and maintaining customer accounts.

The Maintain Role function enables the gateway or customer administrator to create a new role, add or remove capabilities of an existing role, or remove or expire an existing role. Customers have their own set of roles. Therefore, roles are not shared between customers. New roles can be added at any time. When creating a new role, the administrator can base it on an existing role, thereby pre-selecting many of the capabilities. Changes to an existing role include changing the name as well as adding or removing any capabilities. These changes can occur at any time. However, users currently logged in and associated with the changed role do not know about the update until the time of their next login. Roles can be deleted at any time. There is no expiration date associated with the role. Once a role is removed, it is deleted and therefore not available for reuse or any reporting. When deleting a role, if there are any associations with the role, the associations must first be deleted. This means that the administrator will not be able to delete a role until all users with that assigned role have their roles changed. The gateway provides the customer with a set of standard roles, which the customer can choose to use or modify.

The View Role List function enables the administrator to view a list of roles for the customer's organization. If the administrator is the customer's administrator, he can only see those roles defined for their company. However, the gateway administrator can see all roles for all customers. This function is intended to enable selection of a role for modification in the Maintain Role function. Filtering capabilities are available such as the ability to select roles based on effective date, users or customer. Once the list is displayed, the ability to sort the list by the above mentioned attributes is available.

2. View Vehicle Dataset List and Maintain Vehicle Datasets and User-Dataset Relationships

A vehicle dataset is a group of vehicles defined for a certain time period. The gateway security component verifies customer and user access to vehicle datasets before real-time and historical data access is granted to the user. The dataset mechanism makes vehicle leasing arrangements possible and also enables a customer to partition access of vehicle data between internal users. For example, a Dispatcher may have one group of vehicles for which he is responsible and other Dispatchers have their vehicle groups, and the customer wants to prevent access to the vehicles between dispatchers. The Maintain Vehicle Datasets function enables a customer administrator to partition a group of the customer's vehicles, make changes to a vehicle grouping, or remove a vehicle grouping. Vehicle datasets created in error can be deleted. Deletion of a vehicle dataset can only take place when all associations with that vehicle grouping are removed. If any users are associated with the vehicle grouping, an error message is displayed alerting the user that they must remove the associations before the deletion can occur. Vehicles can be added or removed from the vehicle dataset at any time.

The View Vehicle Dataset List enables the administrator to view a list of vehicle datasets for a customer. If the administrator is a gateway administrator, he or she has ability to see all vehicle datasets. The dataset list facilitates the selection of a list for maintenance or modification. Filtering capabilities are available such as the ability to select vehicle datasets based on customer or user. Once the list is displayed, the ability to sort the list by the above mentioned attributes is available. The steps performed to view and maintain datasets are substantially similar to those of viewing and maintaining customer accounts.

The Manage User-Dataset Relationship function enables the user to change dataset assignments to users. Once the vehicle dataset has been created, the Administrator will assign this dataset to a user. This gives the user access to any vehicles within the vehicle dataset. A user can have access to multiple vehicle datasets. A vehicle dataset assignment can be removed at any time. This removal of a vehicle dataset takes effect immediately. Applications displaying data will remove data from a vehicle for which the user no longer has dataset access the next time the data are refreshed.

F. Reporting

The Reporting Function subsystem 119 of the overall software system structure of FIG. 10 provides features that encompass a wide variety of queries and views into the database of vehicle activity. Reports include vehicle location information such as unscheduled stops, speeding events, and historical location information. More complex reporting features include reporting on vehicle usage, driver productivity, and vehicle maintenance information. These reports are enhanced by location related information such as vehicle mileage and trip times. The customer is able to filter the reports by selecting events or groups of events he wants to see and also select the frequency of how often the report should be generated. The customer is also provided the flexibility to choose the reports that he wants to see on a regular basis, through the Report Setup function.

The Reporting Function queries the system database for events and location related data reported by assets or vehicles and displays a web page with the results. Events are site status reports such as arrive or leave job, sensor reports such as ignition on, door open or begin pour, exception reports such as driving too fast or stopped for too long, or messages reported by the driver. Positions and sites associated with the event allow the user to determine where the event occurred, if desired.

Event reporting is based of the occurrence of events. An unfiltered report provides all of the events generated by the vehicle over the time range selected. The user can filter out desired events by selecting for display any of the events supported by the vehicle device. The event selection interface is shown in FIG. 64. The date, time and description, and optionally, the location, will appear on the report for every occurrence of the selected events for the selected time duration.

Grouping of events is an important and powerful reporting feature to help a manager evaluate the information in the event reports. Groups are created by selecting a start event and an end event. The reporting subsystem then determines time and, if desired, distance, between events. These group times can then be rolled up into vehicle and fleet summaries, and trends in reported data such as cycle times can be analyzed.

Different types of reporting are: time between events; total time for the group; mileage between events; total mileage for the group, definition of a slice on a pie chart; calculation of customer costs/profits.

An example of a group start/end event pair is a start event of “Begin Pour” and an end event of “End Pour” for the group “Pour Time.” Groups can be further customized by selecting the first event in a date/time range and the last event in a date/time range, or the first group in a date/time range and the last group in a date/time range. For example, the group “Time Worked” would have a start event of “First Ignition On” and an end event of “Last Ignition Off.” Offsets can be applied to groups to modify the group total time. Using the above example, the customer may want to pay its drivers for “Time worked” plus 15 minutes. He would enter in a group offset of 15 minutes to accomplish this.

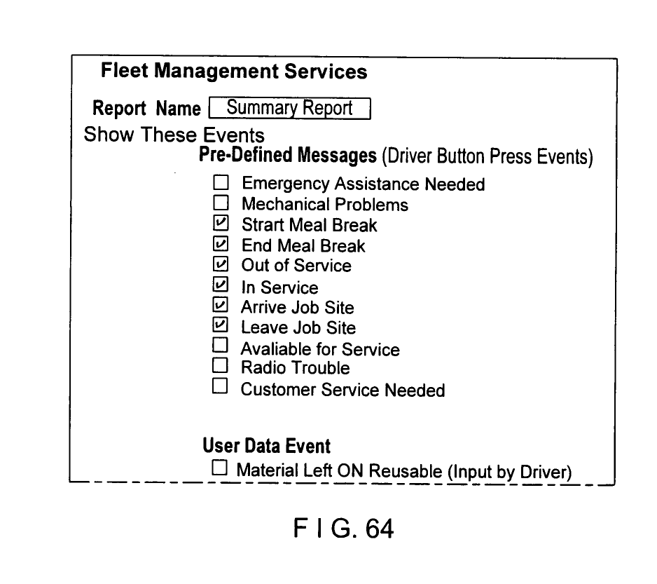

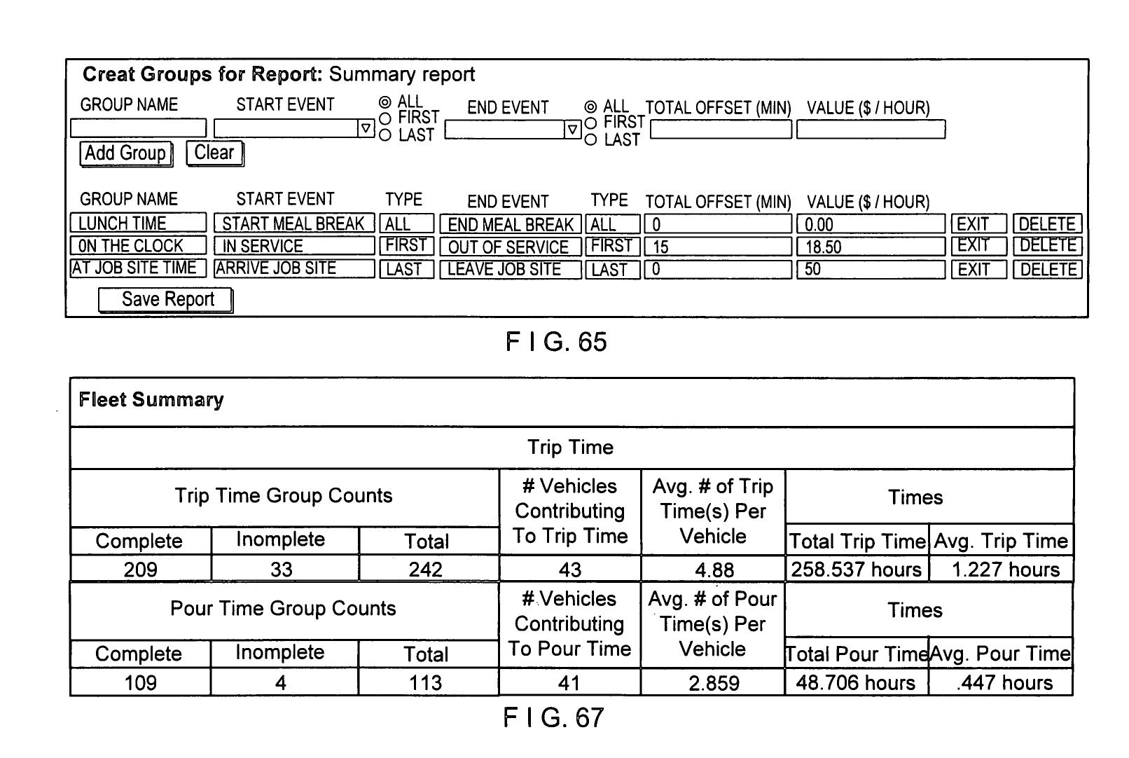

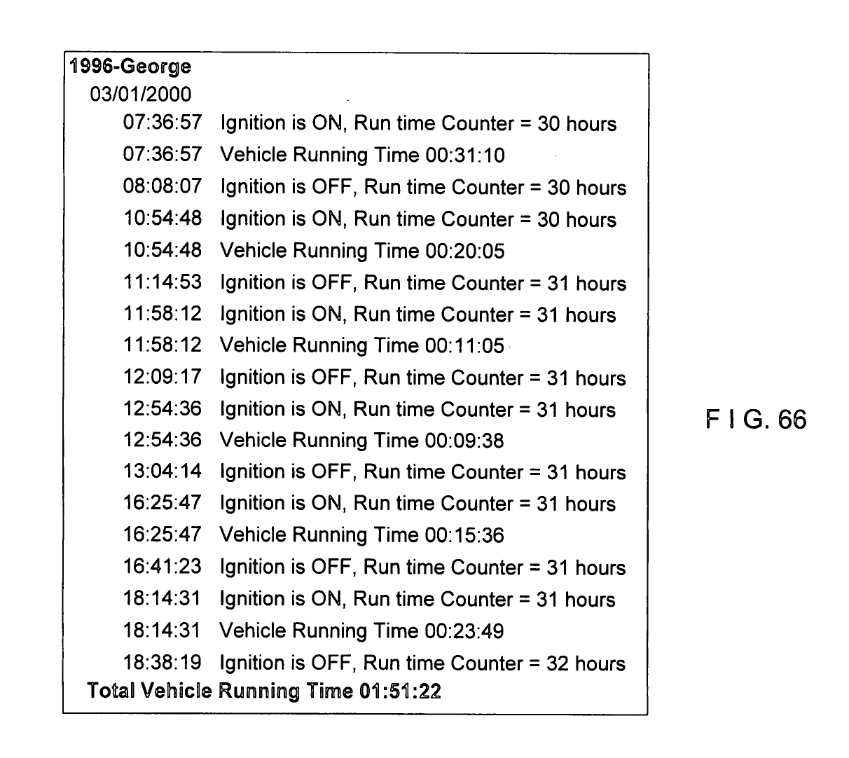

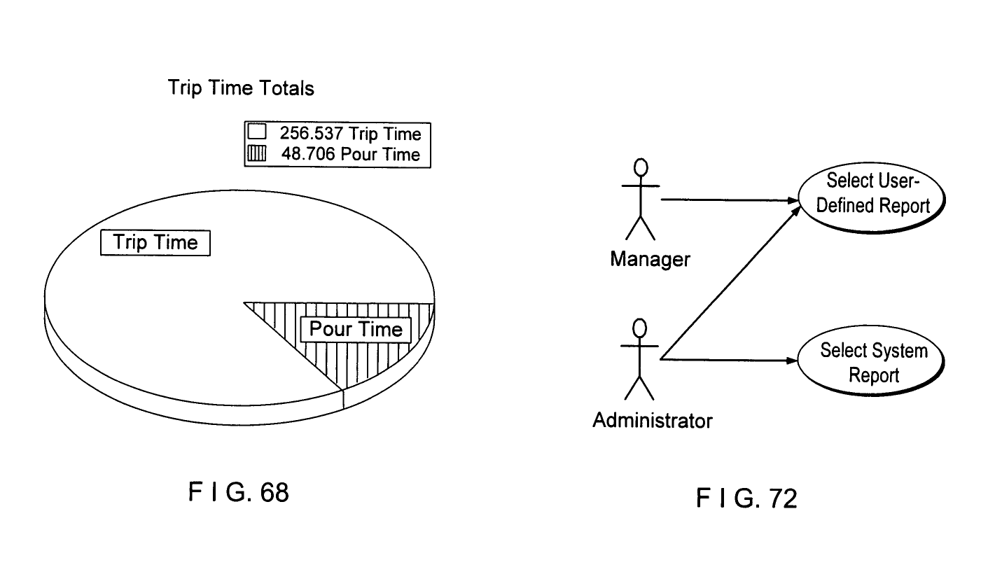

The group creation interface is shown in FIG. 65. The result of an example of a run time report created using groups is shown in FIG. 66. The time between each ignition on/off event is computed by the report and highlighted between the events. A ready mix operator may want to compare total time spent running the truck versus time spent pouring concrete. In this case two groups are created, one for ignition on/off events and one for start pour/end pour events. The total time performing these activities for the fleet can be summarized and shown in tabular or graphical form as shown in FIG. 67 and FIG. 68, respectively.

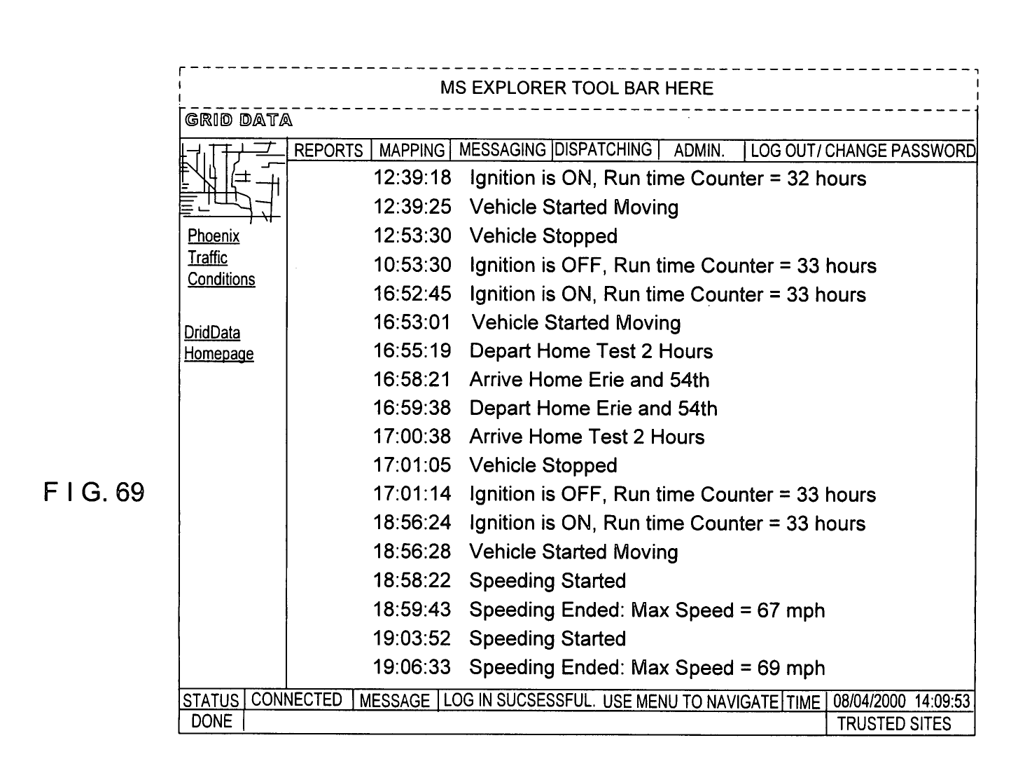

A further example of an event report showing multiple types of events is shown in FIG. 69. This report is just a part of a day for one vehicle, and shows events corresponding to engine ignition turning on and off, vehicle starting and stopping motion, site arrival and departure, and speeding events. For events that occur within a site, a house or tool icon is shown to the left of the event time to indicate the type of site in which it occurred. Clicking the mouse on this icon reveals details about the site. Further to the left is a vehicle information icon. Clicking this reveals the location (latitude/longitude or address) of the vehicle when the event occurred. Finally, clicking the left most icon reveals a graphical map showing the location of the vehicle where the event occurred.

The event report is able to provide this information through a combination of data reported from the vehicle, system database queries, and use of the mapping application. According to the location aware business logic, the tracker tags event reports with time and location data; this includes geographic position and the work site where the event occurred, if any. Other types of location information accompany certain reports: speeding reports are sent when the vehicle exceeds a preset speed and include the distance traveled while speeding, for example.

The gateway logs all messages received from trackers to the system database. When the user wants a generic event report, the user selects the vehicles and the time range which the report should span. The report generator then searches the system database for all events in the time span for the selected vehicles. It must retrieve the event type and associated location and work site information. For events that occur at work sites, a subsequent search is required to obtain the site types and site names for the report. The report is then displayed to the user. If the user selects the vehicle information or map icons, the web page containing the report then activates the Mapping application to obtain the address of the event or show the location of the event on the map. The operation of the map application was described earlier in this specification.

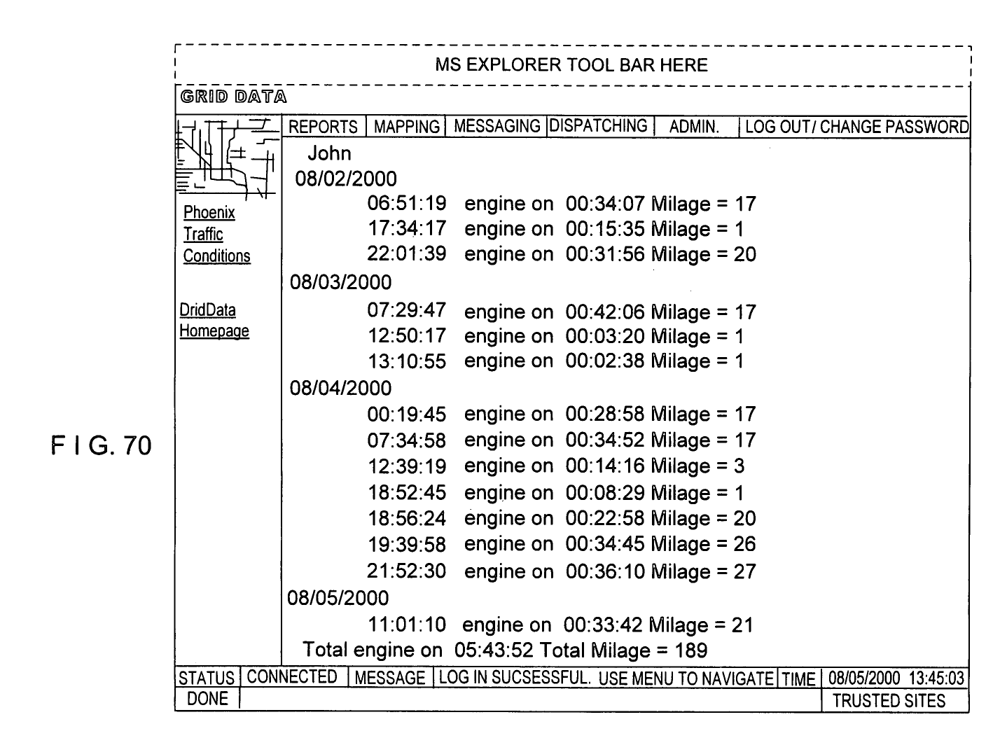

FIG. 70 shows an exemplary group report for engine on time. It shows the run time hours for a vehicle named “John” for four days. The Engine On Time report is a user created report. Here; the user has specified that a group called “engine on” is begun with an Ignition On event and ended with an Ignition Off event. The report generator then searches the system database for all Ignition On/Off pairs for the vehicles and time range specified for the report. For each matching pair found, the generator determines the time duration of the group as the time difference between the end and start events, the engine on time in this case. For engine on time, the report is also able to show distance traveled while the engine was on.

Ignition On/Off events reported by the tracker include vehicle mileage. The distance traveled is simply the vehicle mileage difference between the end and start events. The total run time and mileage for the time frame of the report are summarized at the bottom of the report.

Sophisticated reports can be generated by presenting combinations of groups to the user. Adding a group representing vehicle motion starting and stopping will provide total time in motion for the vehicle. The user can then display this with the engine on time to determine the proportion of time the engine spends idling. This is an important parameter in fuel usage for trucks and tax payments because idle time is not subject to fuel tax.

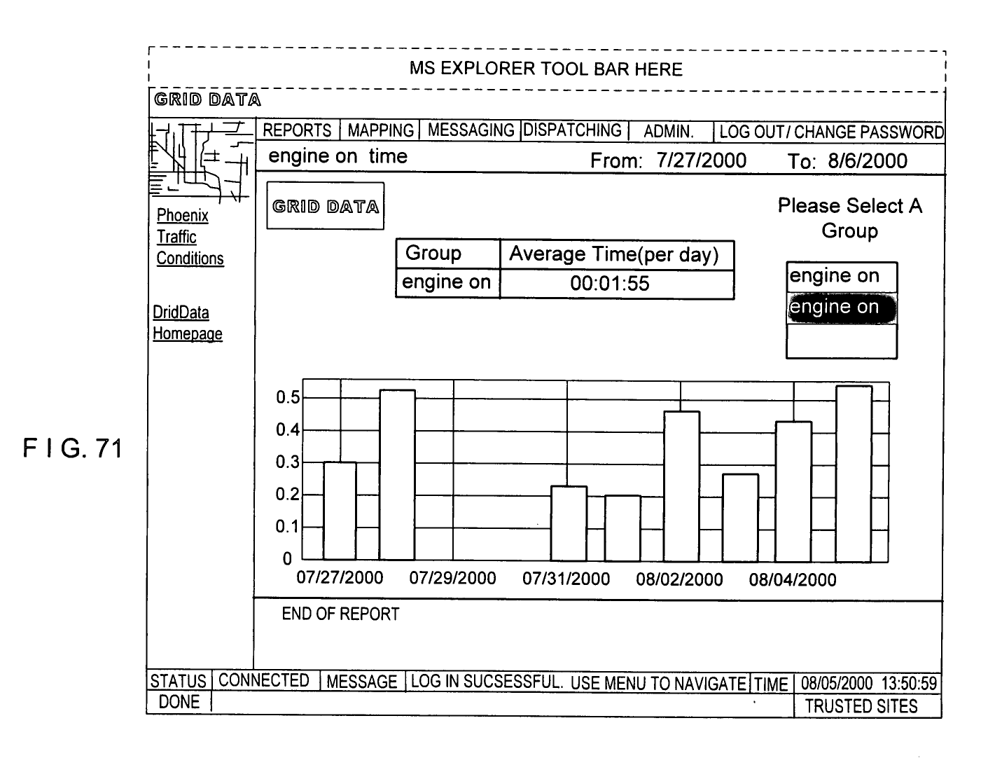

By way of a final report example, a trend report for engine on time is shown in FIG. 71. Trend reports aggregate events into daily summaries shown for a sequence of days. The data for each day are averaged across the vehicle or fleet. This is repeated for the specified number of days and presented in a bar chart. The figure shows the average engine on time, in hours, for each of ten days. The report shows the engine was not on for the days of July 29 or July 30. Trend reports on parameters of interest to the business manager enable him to measure progress in improving those parameters.

Use cases of the Reporting Function are described below. The structure of the Reporting Function is illustrated in the functional diagram of FIG. 72.

1. Select User-Defined Report

This use case is applicable when the customer wants to view or print a particular report. It provides the ability to select a user-defined report from a list of available reports for viewing and/or printing. The user is able to generate each report based on a given time frame. For example, he will select a report and ask to generate it for a given day, week or month. The report list displayed to the user will show the name (chosen by the customer). The ability for the user to download the report to Word or Excel for later reference is provided. The report must be selected before printing. The printing function is provided via the browser.

2. Select System Report

This use case is applicable when the system administrator wants to view a particular system report. It provides the ability to view a system report such as web site statistics, such as the number of hits per customer and so on.

Although certain presently preferred and exemplary embodiments and methods have been described herein to illustrate the best mode presently contemplated of practicing the invention, it will be apparent to those skilled in the relevant art that variations and modifications may be made without departing from the true spirit and scope of the invention. Accordingly, it is intended that the invention shall be deemed limited only to the extent required by the appended claims and the rules and principles of pertinent law.

1.-82. (canceled)

83. A navigation and communication system, comprising:
a navigation and sensor device comprising a GPS receiver for receiving GPS satellite signals, a processor for computing location of the GPS receiver based on the GPS signals received, and a short range transmitter for wirelessly transmitting a signal representing the computed location; and
a handheld device for operation over a cellular network, comprising a receiver for receiving signals from the short range transmitter representing the computed location from said navigation and sensor device, and an antenna for transmitting over said cellular network a signal representing the location of the GPS receiver.

84. The system of claim 83, wherein the handheld device comprises a cellular phone.

85. The system of claim 83, wherein the handheld device comprises a PDA.

86. The system of claim 83, wherein the short range transmitter and receiver use Blue Tooth communication protocols.

87. The system of claim 83, wherein the handheld device has a display for displaying transmitted information.

88. The system according to claim 83, wherein the navigation and sensor device is mounted to a vehicle to detect vehicle location.

89. The system according to claim 83, wherein the navigation and sensor device comprises at least one sensor for detecting the status of a parameter related to the vehicle, and wherein the short range transmitter transmits a status signal representative of the detected parameter and wherein the handheld device receives the status signal and transmits data representing the detected parameter over the cellular network.

90. The system according to claim 89, wherein the handheld device transmits the data automatically.

91. The system according to claim 83, wherein the handheld device comprises a cellular phone and a control module adapted to connect with the cellular phone through a data port, and wherein the receiver is in the control module.

92. The system according to claim 91, wherein the navigation and sensor device has a memory which stores location data when the handheld device is out of reception range of the short range transmitter, and wherein the device transmits the location data when the handheld device is within range.

93. A navigation and communication system, comprising:
a navigation and sensor device comprising a GPS receiver for receiving GPS satellite signals, a processor for computing location of the GPS receiver based on the GPS signals received, and a short range transmitter for wirelessly transmitting a signal representing the computed location; and
a handheld device for operation over a network, comprising a receiver for receiving signals from the short range transmitter representing the computed location from said navigation and sensor device, and an antenna for transmitting over said network a signal representing the location of the GPS receiver.

94. The system of claim 83, wherein the handheld device comprises a cellular phone.

95. The system of claim 83, wherein the handheld device comprises a PDA.

96. The system of claim 83, wherein the short range transmitter and receiver use Blue Tooth communication protocols.

97. The system of claim 83, wherein the handheld device has a display for displaying transmitted information.

98. The system according to claim 83, wherein the navigation and sensor device is mounted to a vehicle to detect vehicle location.

99. The system according to claim 83, wherein the navigation and sensor device comprises at least one sensor for detecting the status of a parameter related to the vehicle, and wherein the short range transmitter transmits a status signal representative of the detected parameter and wherein the handheld device receives the status signal and transmits data representing the detected parameter over the network.

100. The system according to claim 89, wherein the handheld device transmits the data automatically.

101. The system according to claim 83, wherein the handheld device comprises a cellular phone and a control module adapted to connect with the cellular phone through a data port, and wherein the receiver is in the control module.

102. The system according to claim 91, wherein the navigation and sensor device has a memory which stores location data when the handheld device is out of reception range of the short range transmitter, and wherein the device transmits the location data when the handheld device is within range.

103. A navigation and communication system, comprising:
a handheld cellular phone for operation over a cellular network, comprising a receiver for receiving by a short range wireless link location signals representing the computed location of a GPS receiver mounted on a vehicle which receives GPS signals, computes the location of the vehicle and transmits the location signals to the cellular phone over a short range, said cellular phone adapted to transmit over the cellular network signals representing the location of the vehicle.

104. The system according to claim 103, wherein the short range wireless link operates in Bluetooth format.

105. The system according to claim 103 further comprising a vehicle mounted parameter sensor device for detecting the status of a parameter related to the vehicle, and a short range transmitter for transmitting a status signal representative of the detected parameter, and wherein the cellular phones receives the status signal and transmits data representing the detected parameter over the cellular network.

106. A communication system for a vehicle, comprising;
a sensor device mounted on a vehicle for detecting the status of a parameter related to the vehicle,
a short range transmitter connected to the sensor device for transmitting a status signal representative of the detected parameter; and
a cellular phone having a short range receiver for receiving the status signal from the short range transmitter and for transmitting the status signal over a cellular network.

107. The system according to claim 106, wherein the sensor device on the vehicle comprises a GPS receiver for receiving GPS signals, a processor for computing location based on the received GPS signals, and wherein the short range transmitter transmits a location signal to the cellular phone indicating the location of the vehicle, and wherein the cellular phone transmits data representing the location over the cellular network.

108. The system according to claim 106, wherein the short range transmitter and receiver operate in Bluetooth format.

109. The system according to claim 106, wherein the cellular phone includes a module which has the short range receiver, said module being connected through the data port in the cellular phone and wherein the module controls the cellular phone to transmit the data.

110. The system according to claim 106, wherein the sensor device on the vehicle comprises a GPS receiver for receiving GPS signals,
wherein the short range transmitter transmits information output from the GPS receiver, and wherein the cellular phone receives the information output from the GPS receiver, and wherein the cellular phone includes a processor for computing location based on the received GPS signals and transmits data representing the location over the cellular network.
